(19) United States
(12) Patent Application Publication
(10) Pub. No.: US 2015/0377179 A1
(43) Pub. Date: Dec. 31, 2015

(54) Low Grade Thermal Energy Innovative Use

(71) Applicant: Ramesh C. NAYAR, Waldorf, MD (US)

(72) Inventor: Ramesh C NAYAR, Waldorf, MD (US)

(21) Appl. No.: 14/765,823

(22) PCT Filed: Feb. 8, 2013
(86) PCT No.: PCT/US2013/025405

§ 371 Date: Aug. 4, 2015

Related U.S. Application Data
(60) Provisional application No. 61/596,677, filed on Feb. 8, 2012.
(60) Provisional application No. 61/606,312, filed on Mar. 2, 2012.
(60) Provisional application No. 61/645,840, filed on May 11, 2012.
(60) Provisional application No. 61/661,446, filed on Jun. 19, 2012.
(60) Provisional application No. 61/696,557, filed on Sep. 4, 2012.
(60) Provisional application No. 61/722,425, filed on Nov. 5, 2012.
(60) Provisional application No. 61/739,324, filed on Dec. 19, 2012.
(60) Provisional application No. 61/749,546, filed on Jan. 7, 2013.

(51) Int. Cl. F02G 1/053

(52) U.S. Cl. CPC F02G 1/053

(57) ABSTRACT

The invention shows making useful work by using low grade thermal energy or even ambient thermal energy, via a thermodynamic cycle. The thermodynamic cycle uses heat addition at constant volume as a main building block, avoiding use of a pump and saving pumping power. The inventive thermodynamic may operate in a batched thermodynamic activity approach. In addition, a recuperation heat exchanger (782) may be utilized for a high degree of recuperation, i.e., recovery of the thermal energy from the cycle exhaust. Smart controls effect the process. The cycle, in a batched approach may include stop/realign/restart, as one option, taking 10, 15 seconds each, and the cycle itself every, for example, 2 minutes, to reduce the vessel (456) size.

### FIELD OF THE INVENTION

The invention shows a thermodynamic cycle, making useful work, using low grade thermal energy or even ambient thermal energy, as the thermal energy source.

### BACKGROUND OF THE INVENTION

As the power generation involving the use of fossil fuels needs to be addressed from the point of view of reducing the carbon emissions, alternative ways to produce useful work is needed. The invention lends itself to the use of very low grade waste thermal energy at existing fossil fuel powered facilities, thus retrofitting the facilities to produce what can be called fuel free additional MWe's, i.e. renewable sources of power. The low grade thermal energy as an option can also come from chemical plant facilities, refineries, etc., etc. Additionally there can be low grade thermal energy such as gathered from the Sun as the heat source, geothermal, ocean water, ground water, ambient air, some as direct ambient thermal energy sources.

### SUMMARY OF THE INVENTION

The invention at its core uses the approach of heat addition at constant volume, so that to make very high pressure working fluid, and at still at relatively modest temperature, as the working fluid to do work in an engine. Thus to get free, i.e. no pumping power based, very high pressure working fluid. This favors using low grade thermal energy, and increasing the overall efficiency of thermal energy use. The heat addition at constant volume approach then requires that the thermodynamic processes be undertaken in steps, i.e. batched approach. This batched approach then requires controls to facilitate the intended thermodynamic system to be orchestrated properly, via smart controls, and thus to work smoothly. Continuing, for heat addition at constant volume approach, and applying the batched approach, there will be three vessels, called primary vessels that have loose fabric anchored in the middle. The working fluid is drawn into a circulator from say below the fabric, circulated outside the primary vessel, via a recuperation heat exchanger and via another heat exchanger to add recuperated and new heat at constant volume. The working fluid is then reintroduced into the primary vessel, say above the loose fabric, till all the working fluid has thus been heated at constant volume. This is called heat addition at constant volume phase. The primary vessel is then isolated, and the working fluid at extremely high pressure is used to make work, in an engine, or any other suitable device such as screw expander, hydraulic motor, etc. This is called the work making phase. It should be pointed out that as the primary vessel is isolated, to go to the work making phase, and as more and more work is extracted, the pressure of the working fluid in the primary vessel goes down and down. The work is extracted by using the hot working fluid directly in an engine, i.e. direct use. As an alternate, the hot working fluid is used in a secondary vessel in which case there is loose fabric, anchored in the middle of the secondary vessel, and ambient temperature liquid at below the fabric. The extremely high pressure, hot working fluid, above the fabric, pushes out the ambient temperature working fluid, from below the fabric, into an engine. Continuing, from above, the primary vessel, and the secondary vessel, if applicable in the next phase is/are once again isolated, and the fresh working fluid is introduced below the fabric, thus pushing out what can be called the spent working fluid from above the fabric, and this is called fill/constant pressure expulsion phase. Thus, in brief, the primary vessels are to go through three phases, heat addition at constant volume phase, work making phase, and finally the fill/constant pressure expulsion phase. Continuing, the various thermodynamic steps to carry out the invention are, for each primary vessel, in sequence, heat addition at constant volume phase, work making phase, fill/constant pressure expulsion phase, carried out together, between the three primary vessels. Then the whole sequence is to start all over again. Thus primary vessels are interchanged, or reconfigured into the overall cycle. For the secondary vessels, there is work making phase, and then the fill/constant pressure expulsion phase, carried out together. This is applicable in the liquid push out approach. In the separate approach of using the working fluid directly in the engine, there is work making phase. This is followed by fill/constant pressure expulsion phase, carried out together. Thus to have three primary vessels, two secondary vessels in the indirect, or liquid push out approach, and also no secondary vessel in the hot working fluid directly into the engine approach, and one engine, or a cluster engines. The system is thus reconfigured three separate times, and goes on and on, rotationally, using smart controls.

### BRIEF DESCRIPTION OF THE DRAWINGS

FIGS. 1A and 1B show block diagram(s) to present the objective and the challenges of the concept, using a heat pump approach for the new heat. Separately, using the ambient heat etc., as is, and a refrigeration cycle into which heat is rejected. The heat rejected is the heat from recuperation heat exchanger cold side, heat of spent working fluid stream, the temperature of which to be restored to the starting temperature.

FIG. 2 shows the invention in its simplest form, using working fluid directly into an engine.

FIG. 3 shows the invention in its simplest form, using working fluid via liquid push out option.

FIG. 4 shows the basic concept in its simplest form.

FIG. 5 shows the concept in more detail.

FIG. 6 shows more of the thermodynamic cycle as based upon the heat addition at constant volume approach.

FIG. 7 shows more of the thermodynamic cycle as based upon the heat addition at constant volume approach to further clarify and propose variations.

FIG. 8 shows a thermodynamic, heat addition at constant volume approach, using refrigerant as the working fluid, both for the heat pump part and the working fluid itself.

FIG. 9 shows a variation to the thermodynamic using heat addition at constant volume.

FIG. 10 shows a variation to the thermodynamic using heat addition at constant volume.

FIG. 11 shows another variation to the thermodynamic that uses heat addition at constant volume approach.

FIG. 12 shows another variation to the thermodynamic using heat addition at constant volume approach.

FIG. 13 shows another variation to the thermodynamic that uses heat addition at constant volume approach.

FIG. 14 shows the thermodynamic using heat addition at constant volume approach, showing controls.

FIG. 15 shows interruption of the refrigerant and making work by applying the teachings of heat addition at constant volume.

FIG. 16 shows variations to the heat addition at constant volume based thermodynamic.

FIG. 17 shows the approach to the controls required, and the use of these controls as per the needs to carry out the invention.

FIG. 18 shows the controls as needed, and more discussion of, to carry out the batched approach based thermodynamic.

FIG. 19 shows the concept to reduce the compression work of compressors in the heat pump.

FIG. 20 shows a sub system that applies the pre pressurizing to the main cycle, using conventional pre pressurizing or pre pressurizing using heat addition at constant volume approach.

FIG. 21 shows the technologies in the engine as required to smooth out the work output.

FIG. 22 shows the engines and the approach to the controls required to carry out the work making phase, and to smooth out the work output.

FIG. 23 shows building blocks to address the issue of making uniform work.

FIG. 24 shows more building blocks to address the engine design to facilitate making uniform work.

FIG. 25 shows additional building blocks in the engine design to address the goals of making uniform work.

FIG. 26 shows the primary vessels, and the secondary vessels as needed, and the variations thereof.

FIG. 27 shows the design of the vessels to address the design challenges faced in high pressure resulting in very thick walls.

FIG. 28 shows the various ways of getting/using the low grade, or waste thermal energy, or even ambient thermal energy as the case may be, as the thermal energy source to make work, in the main thermodynamic cycle.

FIG. 29 shows the flue gas thermal energy to be cleaned up to be used in the heat addition at constant volume thermodynamic.

FIG. 30 shows the optimization of the compression work, machinery optimization and the negative work load optimization.

FIG. 31 shows building blocks for the compression optimization exercise, as part of the heat addition at constant volume thermodynamic.

FIG. 32 shows the single phase heat pump, to upgrade the low grade thermal energy to high grade thermal energy.

FIG. 33 shows the add on thermodynamic system at an existing Rankine cycle facility, that uses the heat addition at constant volume approach and uses the low grade thermal energy of some of the lower bleed streams.

FIG. 34 shows building blocks, and other engineering applications to carry out and expand upon the scope of the invention.

FIG. 35 shows making a gas into liquid to apply in the invention.

FIG. 36 shows the application of heat addition at constant volume in thrust production.

FIG. 37 shows the key thermodynamic cycle in clear form, and uses the values in the TABLES to establish the proof of concept, using a heat pump approach to upgrade the low grade thermal energy.

FIG. 38 shows the key thermodynamic cycle in clear form, to establish the proof of concept, using a heat pump approach as a dedicated refrigeration sub system to reject heat, from the cooler side of the recuperation heat exchanger spent working fluid stream.

FIG. 39 shows various building blocks, to carry out the thermodynamic with the main part as the heat addition at constant volume approach.

FIG. 40 shows more building blocks, to carry out the thermodynamic with the main part as the heat addition at constant volume approach.

FIG. 41 shows a thermodynamic cycle with heat addition at constant volume approach, with cylinders as the primary vessels.

FIG. 42 shows building blocks to carry out the invention that uses heat addition at constant volume approach.

### DETAILED DESCRIPTION

Some of the common components are as below:

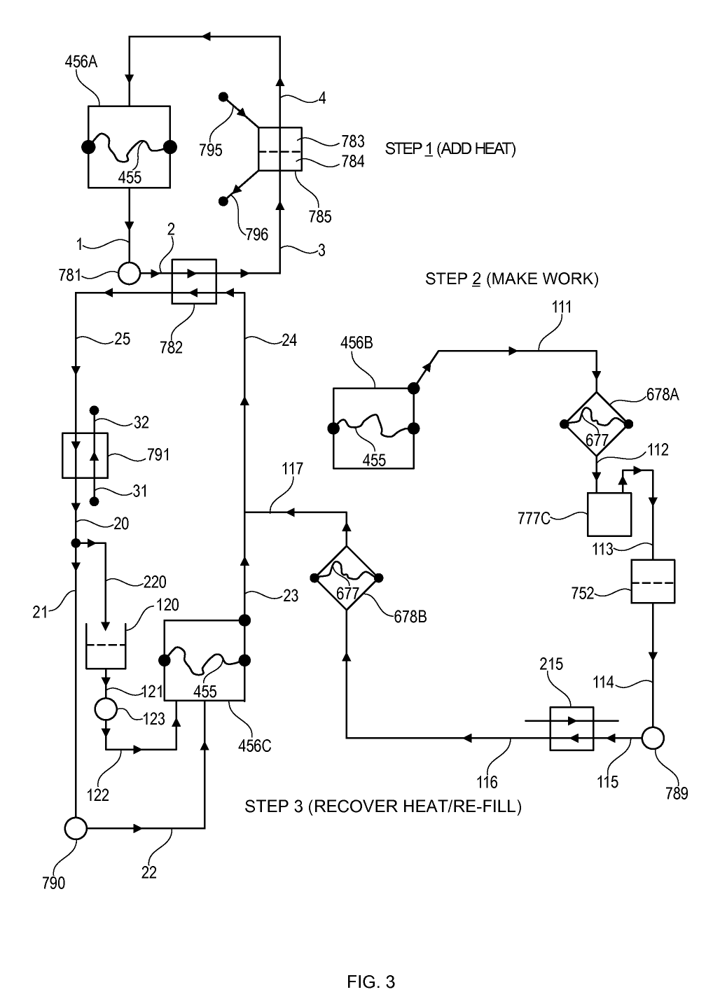

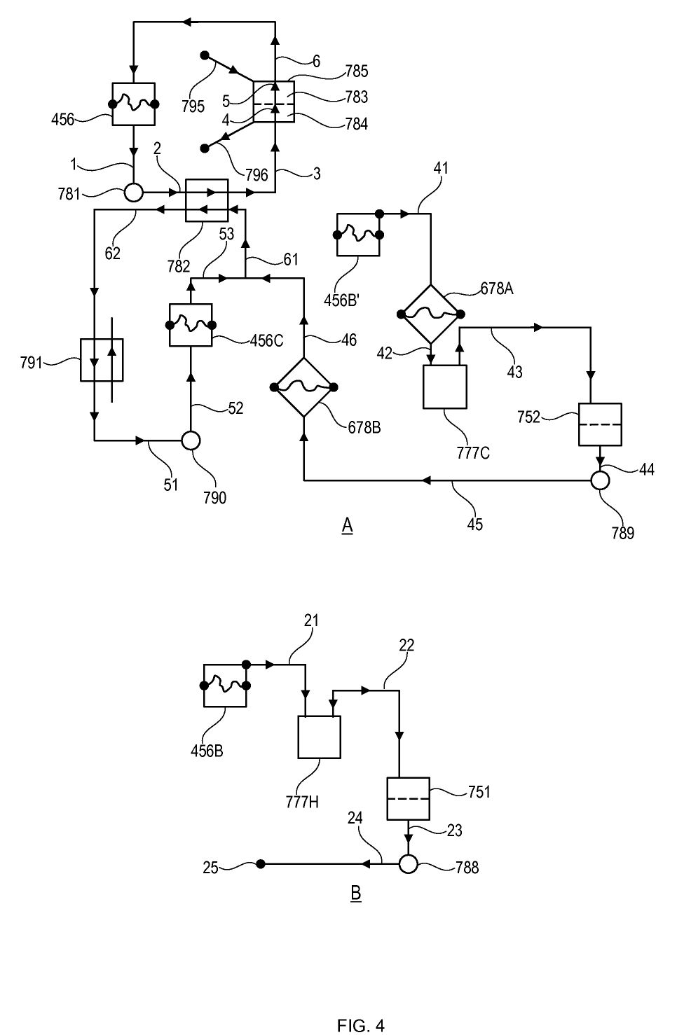

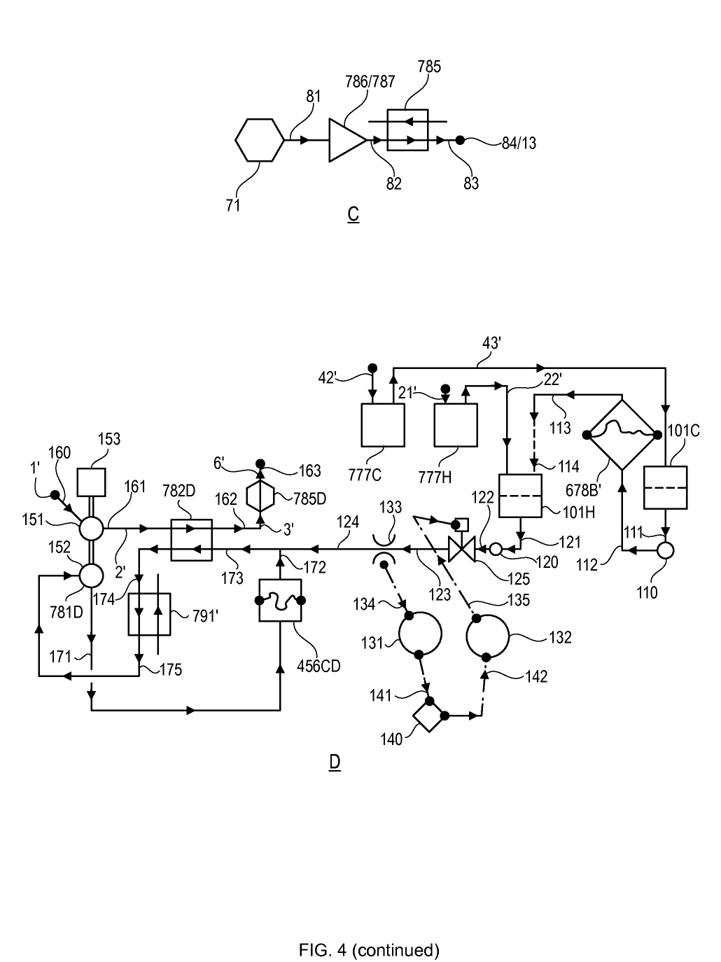

1. A circulator 781 in FIG. 3 facilitates circulation of the working fluid from one side of the fabric to the other side, outside of the primary vessel, to get the working fluid heated at constant volume.
2. A recuperation heat exchanger 782 in FIG. 3 facilitates the thermal energy recovery from the spent working fluid and into the working fluid in the heat addition at constant volume phase.
3. A main heat exchanger 785 in FIG. 3 is the heat exchanger with a condensing zone 783, drains cooling zone 784 to impart latent heat and sensible heat respectively, to the working fluid in the heat addition at constant volume phase.
4. The compressor, compressors for the heat pump are 786, 787 etc. in FIG. 4. Usually there is a single compressor, but there can be multiple compressors, applying multi pressure level of the heat pump approach, using a suitable refrigerant as the working fluid.
5. The hot spent working fluid transfer pump is 788 in FIG. 3.
6. The cold working fluid, which can be water or oil in the push out of liquid approach, the transfer pump is 789 in FIG. 3.
7. The pump that circulates the working fluid in the constant pressure expulsion phase is 790 in FIG. 3.
8. The heat exchanger to reject heat to the ambient is 791 in FIG. 3.
9. The primary vessels are designations 456's in FIG. 3.
10. The secondary vessels are 678's in FIG. 3.
11. The engine(s) are 777's in FIG. 3. A 777C designation is when for the work making phase, the option is the liquid push out via a secondary vessel, i.e. cold, ambient temperature working fluid enters the engine. A 777H is when extremely high pressure, higher temperature working fluid enters the engine. However in most cases 777 then represents the indirect working fluid into the engine option. The key is the 777 designation.

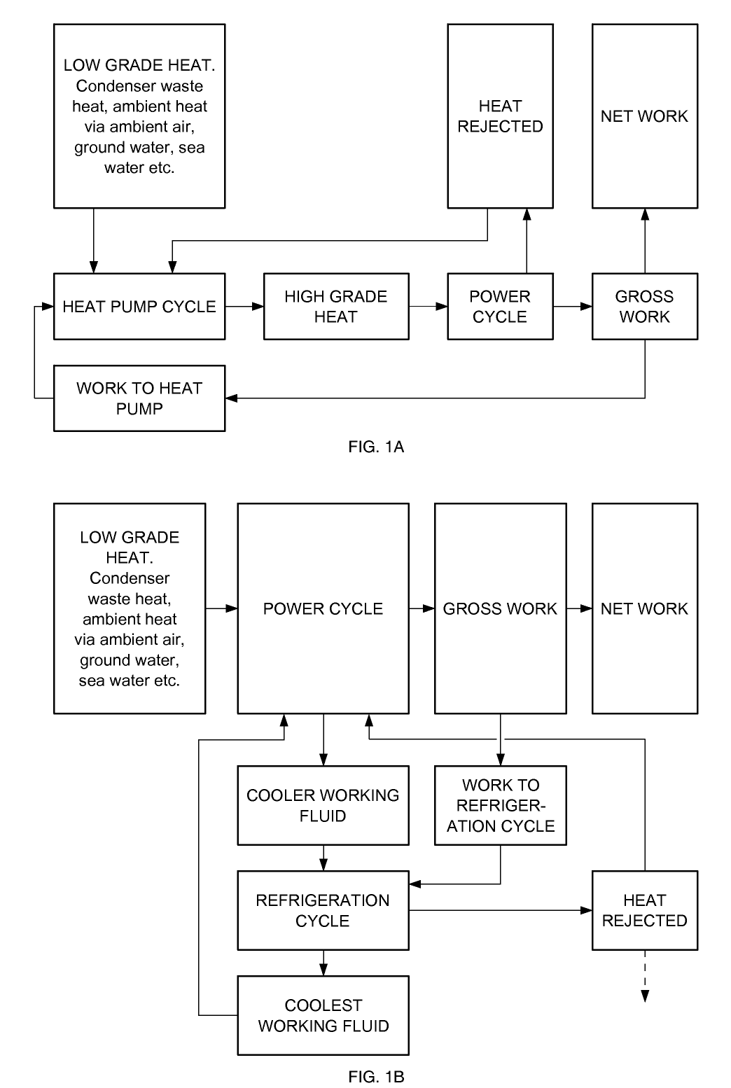

FIGS. 1A and 1B point out the energy flow. In this case, taking in ambient thermal energy, or low grade thermal energy, produce very low temperature vapor of a refrigerant, and then elevate it via compression of the refrigerant vapor to high grade thermal energy. This high grade thermal energy is then used in heat addition at constant volume thermodynamic cycle, that has very high thermal efficiency, thus giving us net work for the overall cycle, when compressor work to elevate the energy level is subtracted from the power cycle work.

Continuing, the transformation of ambient thermal energy to high grade thermal energy is via a heat pump, except that in case of a 2phase heat pump, the heater drain from the heat exchanger that facilitates the heat addition at constant volume, when introduced (the refrigerant heater drain) back into the thermal energy gathering sub system, (the refrigerant heater drain) has work potential via a 2phase turbine. When this work is extracted from the sub cooled heater drain of the refrigerant based, it helps to reduce the heat pump compressor parasitic load. Thus there is higher than conventional Coefficient Of Performance, COP, for the heat pump.

Additionally, the working fluid, say a suitable liquid as a choice, say water with glycol, (to prevent it from freezing, as it, water can be cooled in the evaporator of the heat pump), which, (the cooling of the water with glycol), is to start the heat addition at constant volume at very low temperature of the main working fluid. This approach of cooling the working fluid in the evaporator, alleviates the need of a conventional heat sink, such as river water, sea water, or even ambient air as in an air condenser, etc. as in conventional power plants.

Thus on the face of it, the claim of making net positive work, using ambient thermal energy is considered as violation of years of the way the technology has been understood. However a detailed discussion with numerical values as part of the discussion of the thermodynamic process will alleviate the skepticism.

To support the above claims the numerical values of the TABLES are to be looked at very closely, more later in the discussion of FIG. 3. Referring to FIG. 1B, the thermal energy is used directly as the new thermal energy. As in all the thermodynamic cycles there is heat to be rejected, this happens at the exit of the recuperation heat exchanger on the cold side. Thus the working fluid is to be restored to the temperature at the start of the heat addition at constant volume phase, a refrigeration cycle is introduced.

Thus a need to get the temperature rise in the heat addition at constant volume phase, is met either by raising the temperature of the thermal energy source available via heat pump approach, or by lowering the start temperature of the heat addition at constant volume phase, and using a refrigeration cycle to satisfy the need for heat rejection.

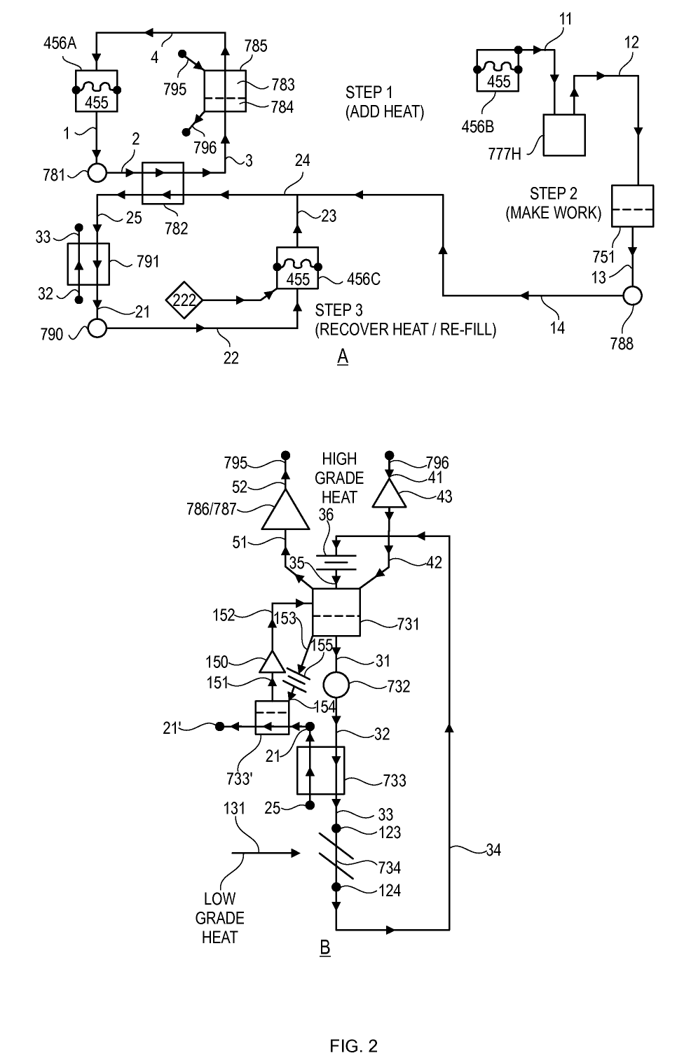

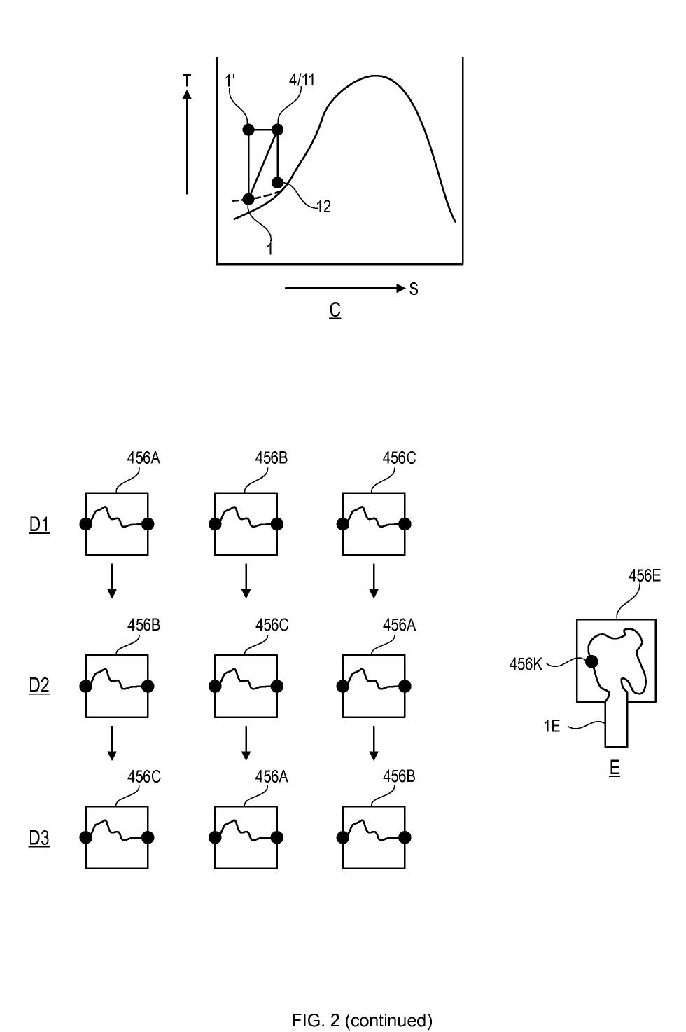

FIG. 2 to be reviewed in conjunction with FIG. 3, a thermodynamic cycle, in detail “A,” in its simplest form. To understand the cycle, the main components necessary to carry out the invention, are the specially designed vessels, the three primary vessels. The primary vessels 456A, 456B, 456C, have a very loose fabric 455, the fabric being anchored in the middle of the vessels. The fabric can be anchored all the way down, all the way up, or any place in between, as determined by experimentation, if needed. To draw cold working fluid, from one side of the fabric, say from below the fabric, add heat and discharge, (reintroduce) the working fluid on the other side of the fabric, say above the fabric. This facilitates the heat addition at constant volume, the key part of the invention. The heat addition at constant volume results in working fluid at extremely high pressure but without the accompanied pumping load. The process of heat addition at constant volume is thus passive in nature, by using a very generous quantity of the fabric. The working fluid, at the start for the heat addition at constant volume is tightly packed, and remains that way. As a backup, and to be sure that the system works as intended, there are pulleys, ropes, cameras etc., in voids, not shown, as option, to be sure that if there is a hitch such as the fabric getting stuck, the situation can be rectified. Continuing, for the ability to carry out the heat addition at constant volume phase, in detail “E,” a primary vessel 456E, outlet 1E, a bladder 456K (in communication with line 1E), to keep the two working fluids, cold vs. hot separate. Additionally, and not shown, the bladder can be in communication with the line at the top of the primary vessel, fluid stream 4 of detail “A.”

Continuing, heat addition at constant volume phase, called out as STEP 1, “ADD HEAT,” a primary vessel 456A, a path 1..4, loop one, a circulator 781, a recuperation heat exchanger 782, low grade thermal energy heat exchanger 785, with a condensing zone 783, a drains cooling zone 784. Low grade thermal energy via a vapor fluid stream, say water based vapor, i.e. steam or a refrigerant based vapor, a fluid stream 795. After giving up the latent heat and some sensible heat, a sub cooled heater drain fluid stream 796. This sub system, results in extremely high pressure working fluid in the primary vessel 456A, (at the end of heat addition at constant volume).

Continuing, it is pointed out that the primary vessels change functions, three basic functions for the primary vessels, every so often, say every 10 minutes. Thus in loop one, path 1..4, there is constant flow rate to transfer the entire working fluid from say below the fabric to above the fabric.

Continuing, another primary vessel 456B that has already gone through the heat addition at constant volume phase, from a previous 10 minute heat addition at constant volume phase, has extremely high pressure working fluid say at say 150 Deg. F., to start the work making phase. A path, 11..14, an engine 777H, working fluid stream 11, working fluid exhaust 12, hot spent working fluid, collected in a tank 751, a pump 788, to a path 14 for thermal energy recuperation, later. It should be pointed out that at the end of the work making phase, the temperature drop in the primary vessel 456B of the remaining spent working fluid is rather small. However the pressure drop is rather large say fro 7K psi to say 100 psi.

Continuing, as will become clearer later, the flow rates in fluid stream 11 over the 10 minute work making phase is not uniform. However flow rates in corresponding fluid streams 14, plus the flow rate from above the fabric, of the primary vessel 456C, i.e. flow rate in fluid stream 23 is to equal the flow rate in fluid stream 2.

Thus suitable smart controls, using flow rate readings, accumulated flows, etc. will be made available to the plant computer to facilitate these thermodynamic requirements. This will require the working fluid to be held in tank 751. There can be a choice of the entire flow rate required in fluid stream 24 to be met via fluid stream 23 flow only, or in combination with flow from fluid stream 14. Thus smart controls, component sizing etc. will come into play to carry out the invention as based upon teachings here. All of the above is called out as STEP 2, “MAKE WORK.”

Continuing, the thermal energy recovery/fill phase has the sub system that follows a path 21..25, a pump 790, thermal energy recovery via the recuperation heat exchanger 782, heat rejection 25/21 via a heat exchanger 791, the ambient heat sink 31..32. As will be disclosed later, that when using heat pump approach, the cooling 25/21 can be in the refrigerant evaporator, so that to get very low temperature at fluid stream 21, that results in higher pressure via heat addition at constant volume for the same hot side, fluid stream 4 temperature. All of the above is called out as STEP 3, “RECOVER HEAT/REFILL.”

Thus three distinct phases, heat addition at constant volume, work making phase, thermal energy recovery/fill phase. The vessels alternate to facilitate the thermodynamic cycle thus disclosed, via batched system approach and smart controls.

Continuing, as another thermodynamic tool, as part of the fill/constant pressure expulsion phase, a high pressure sub system to stuff in more liquid, into the primary vessel 456C, in a very short amount of time, and as part of the time frame of the fill/constant pressure expulsion phase, shown symbolically by 222, called pre pressurizing. This results in an initial pressure just prior to heat addition at constant volume, and results in higher pressure for the same temperature at fluid stream 4, or same pressure by using lower grade thermal energy than otherwise needed.

Thus, three primary vessels 456A, 456B, 456C running, synchronized, changing functions, rotationally, for say 10 minutes at a time; so that the flow rates in various loops are equal, to complete the three phases; then the three primary vessels switch functions, per TABLE 2, detail D's below. The key to all this is that the thermodynamic cycle uses batched process approach.

Thus, the thermal energy source for the thermodynamic cycle is 795/796. The system design uses a vapor fluid stream, with the saturated temperature of 150 Deg. F., in various TABLES. However, detail “B,” to use low grade thermal energy, waste thermal energy, or even ambient thermal energy, elevating it via a heat pump approach. A tank 731, a sub system 31..35, a restriction orifice 36, using a suitable refrigerant, a pump 732, low grade thermal energy shown symbolically by 131, a heat exchanger 733, is the same as heat exchanger 791 above, thus to use the refrigeration 32/33 to cool the working fluid stream 25, i.e. very low initial temperature, prior to heat addition at constant volume of fluid stream 21/22. Continuing, the working fluid of the primary vessel gets cooled to a temperature level that is supported by the heat pump evaporation temperature, or the temperature of fluid stream 32. As an additional thermodynamic tool, a path ..21..21′ via a dedicated refrigeration cycle, with an evaporator 733′, vapor compression path 151..152, compressor 105, with the liquid path 153..154 via a restriction orifice 155 is shown. Thus to further cool the working fluid stream 21 to much lower temperature 21′, all based upon teachings and optimization exercise. As an alternative, the saturation temperature in tank 731 can be lowered, which in turn will lower the temperature of fluid stream 21, and also will help with the ambient thermal energy 131 use in heat exchanger 734 by raising the ttd, temperature difference of the thermal energy source fluid stream vs. thermal energy user fluid stream.

A heat exchanger 734, between nodes 123/124, finned tubes, thus heats the refrigerant. Thus, to get two phase flow after the restriction orifice 36, the vapor part follows a path 51..52, a compressor 786/787, fluid stream 52/795 as the thermal energy source for the heat exchanger 785, with heater drain fluid stream 796/41, a path 41..42 via a 2phase turbine 43 to extract work.

Continuing, to demonstrate the workings of the invention, in this context, the following Notes for the Interpretation of various TABLES designated as 6's, 7's are:

1. When constant density in a column, it shows heat addition at constant volume.
2. When constant entropy in a column, it shows positive expansion work or negative compression work.
3. When constant enthalpy in a column, it shows flashing/throttling.
4. When constant pressure in a column, it shows heating, cooling as the case may be.

Thus if looking closely at TABLES 6's, TABLE 6A, (methodology, later), even for modest temperature for heat addition at constant volume, say 140 Deg. F., to get a thermal efficiency for the power cycle, of well over 60%. Then, even for very cold applications, TABLE 7B, using Isobutane, for an evaporator saturated vapor temperature of 20 Deg. F., so that the heat source temperature of say 30, 40 Deg. F., the COP of the heat pump is over 4. Thus applying the power cycle efficiency, and the COP, to get a work to work ratio of about 2.5, i.e. 1 BTU of compressor negative work results in 2.5 BTU of positive thermodynamic cycle work, a net cycle work of 1.5 BTU.

It must be emphasized here that in this discussion, using very conservative values, is simply to make a point of the ability of making positive work from very cold ambient conditions, i.e. very cold heat source.

For as the methodology, the approach applied is to calculate the cycle thermal efficiency, i.e. work done in the work making phase is first determined. Then, determine the loss at the recuperation heat exchanger 782 cold end. Then by applying the law of conservation of energy, ignoring the circulator energy, radiation loss etc., heat into the heat exchanger 785, i.e. new heat is determined. As the new heat equals work plus the recuperation heat exchanger 782 loss, the new heat is thus determined. The thermal efficiency then equals work divided by the new heat.

Continuing, in the cycle thermal efficiency calculation, in TABLE 8, there is Cp mismatch in the thermal energy source, fluid stream 24/25 vs. the thermal energy sink fluid stream 2/3. The pressure of the thermal energy fluid stream sink also goes up and up in the (10 minute) cycle duration, during heat addition at constant volume phase.

However the flow rates of the two working fluids in the recuperation heat exchanger 782 are equal. Thus, even with infinite recuperation heat exchanger heat transfer surface, there will be some loss, (due to Cp mismatch), a maximum of about 4%, the Cp mismatch per TABLE 8, conservatively. Then by looking at the TABLE 9, a 10 BTU loss used in TABLE 6A is considered very conservative, a value used in the calculation of the thermal efficiency.

The TABLE 10 shows some boundary conditions, for the heat source vs. the heat sink. To point out that the heat source has less than 3% excess enthalpy vs. enthalpy in the heat sink, (at the end of the 10 minute cycle). Thus a 10% loss in the recuperation heat exchanger 782, cold side is considered very conservative, in the calculations of the thermal efficiency.

Continuing, TABLE 6B shows the use of pre pressurizing, so that as an observation, to get to the same pressure via heat addition at constant volume, a lower temperature is needed, therefore a higher COP of the heat pump sub system. The relative lower energy required for pre pressurizing will be more than offset by this approach.

Continuing, thus the thermal efficiency calculation, and then determining the work to work ratio is to prove positive work.

Continuing, in detail “C,” a Ts, Temperature/Entropy diagram, a node 1 will give a node 1′ if conventional pumping was used. However, at the end of heat addition at constant volume, results in a condition 4/11, followed by work 4/11 to 12, at the end of work making phase.

Continuing, in details/rows “D1, D2, D3,” the primary vessels are as in rows D1, D2, D3, so that these primary vessels are reconfigured, say every 10 minutes, i.e. batched process, using smart controls. Thus, each of these primary vessels go through, in order, heat addition at constant volume phase, work making phase, fill/constant pressure expulsion phase.

The various disclosures are to have the three phases orchestrated very closely, as the overall cycle. There is radiation loss through the insulation when spent working fluid is left in various vessels. Then there is loss of refrigeration through the insulation, if in the fill/constant pressure expulsion of the spent working fluid, at refrigerated temperature is left in vessels as well. Ignoring these losses to the extent that positive work can still be produced, there can be thermodynamic sloppiness in the overall cycle design. In other words, the three phases can go on their own pace, cycle time, and heat addition at constant volume phase, work making phase, thermal energy recovery, etc., etc. take place producing power as needed, etc., i.e. decoupled.

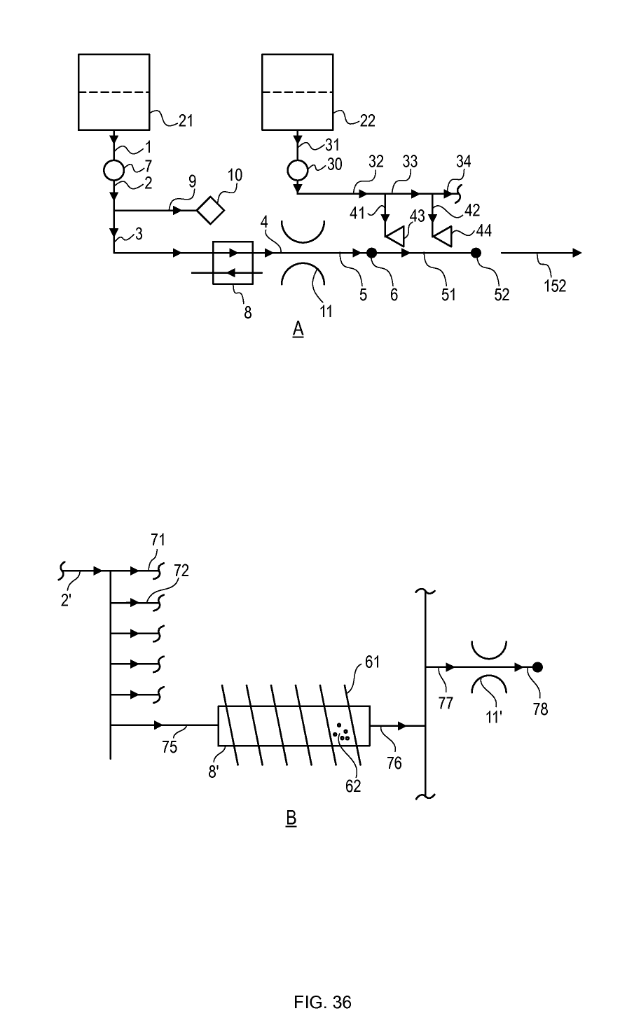

FIG. 3 shows a thermodynamic cycle in its simplest form. To understand the cycle, the main components necessary to carry out the invention, and for this discussion are, and also as disclosed in some detail in FIG. 36.

The secondary vessels are 678A, 678B. There is very loose fabric 677, anchored in the middle. The working fluid at extremely high pressure, and at relatively low temperature, say 150 Deg. F. range, above the fabric, with a suitable liquid working fluid at ambient temperature is below the fabric. The extremely high pressure working fluid above the fabric thus pushes out the working fluid below the fabric; and into a piston type of an engine, as one option to make work.

Continuing, heat addition at constant volume phase, called out as STEP 1, “ADD HEAT.” A primary vessel 456A, a path 1..4, loop one, has a circulator 781, a recuperation heat exchanger 782, low grade thermal energy heat exchanger 785, with a condensing zone 783, a drains cooling zone 784. Low grade thermal energy via a vapor fluid stream, say water based vapor, i.e. steam or a refrigerant based vapor, is a fluid stream 795. After giving up the latent heat and some sensible heat, a sub cooled heater drain fluid stream 796. In this sub system, resulting in extremely high pressure working fluid in the primary vessel 456A, at the end of heat addition at constant volume.

Continuing, the vessels change functions, three basic functions for the primary vessels, two for the secondary vessels, later, every so often, say 10 minutes. Thus, in loop one, a path 1..4, there is constant flow rate to transfer the entire working fluid, say from below the fabric to above the fabric.

Continuing, a vessel 456B, that has already gone through the heat addition at constant volume phase, from a previous 10 minute heat addition at constant volume phase, there is extremely high pressure working fluid say at 150 Deg. F., 7K psi, to start the work making phase.

The work making phase, a path 111..117, a secondary vessel 678A, an engine 777C, a tank 752, a pump 789. Thus hot working fluid stream 111 pushes out the ambient temperature liquid as pressurized fluid stream 112 into the engine 777C to push down the piston to produce work.

Continuing, a flow path from the tank 752, via the pump 789, a path 114..117 to push out the spent working fluid from another secondary vessel 678B, (from a previous 10 minute cycle), via a path 116/117. Over time, this ambient liquid, path 112..113, will get hotter and hotter via the engine 777C wall friction. Therefore a heat exchanger 215 is incorporated to use this thermal energy, every so often, as based upon optimization exercise, (to make vapor of the refrigerant at suitable pressure, disclosed elsewhere). To point out the thermal energy that is at hand, 115/116 via a heat exchanger 215.

Continuing, as will become clearer later, the flow rate in fluid stream 111 over the 10 minute work making phase is not uniform. Thus the flow rate in fluid stream 117 plus the flow rate in fluid stream 23 i.e. flow rate in fluid stream 24 is to be equal to the flow rate in fluid stream 2. Thus suitable smart controls, using flow rate readings, accumulated flows, etc. will be made available to the plant computer to facilitate these thermodynamic requirements. This will require the working fluid to be held in tank 752. There can be a choice of the entire flow rate required in fluid stream 24 to be met via fluid stream 23 flow only, or in combination with flow from fluid stream 117. Thus smart controls, component sizing etc. will come into play to carry out the invention as based upon teachings here. All of the above is called out as STEP 2, “MAKE WORK.”

Continuing, the thermal energy recovery/fill phase has the sub system that follows a path 20..25, a pump 790, thermal energy recovery via the recuperation heat exchanger 782, heat rejection 26/21 via a heat exchanger 791, the ambient heat sink 31..32. All of the above is called out as STEP 3, “RECOVER HEAT/REFILL.”

Thus three distinct phases, heat addition at constant volume, work making phase, thermal energy recovery/fill phase. The vessels alternate to facilitate the thermodynamic cycle thus disclosed, via batched system approach and smart controls.

Continuing, a sub system, called pre pressurizing, raising the pressure in the primary vessels after the fill phase. A tank 120, a path 121..122, a pump 123, to pre pressurize the system prior to the start of heat addition at constant volume phase. As an alternate, to dead head the pump 790, if the pre pressurizing level can be met that way, based upon teachings. When pre pressurizing is opted for, the fill/constant pressure expulsion phase takes place as usual, the excess liquid follows a path 220, into the tank 120 to be used as part of the pre pressurizing phase, a very short duration phase. Thus there is certain amount of the liquid that is used for low pressure filling of the primary vessel per fill/constant pressure expulsion phase, followed by more liquid that is stuffed into the primary vessel 456C via the pre pressurizing phase, thus to create a higher starting pressure for the heat addition at constant volume phase.

Thus, three primary vessels 456A, 456B, 456C running, synchronized, rotationally, for say 10 minutes at a time, so that the flow rates in various loops are equal, to complete the three phases. The vessels switch functions, TABLE 2. The key to all this is that the process is batched process approach.

Continuing, to demonstrate the workings of the invention, appropriate discussion in FIG. 36 applies, in terms of discussion of stream properties, etc.

FIG. 4 shows basic building blocks of a thermodynamic cycle that uses heat addition at constant volume approach as the main feature. Continuing, in detail “A,” a primary vessel 456A with water at say 40 Deg. F. as the starting point for the heat addition at constant volume phase. A working fluid flow path 1..6, has a circulator 781, a recuperation heat exchanger 782, a heat exchanger 785 with a drains cooling zone 784, condensing zone 783. The heat source working fluid, say a refrigerant based vapor, or water based vapor, i.e. steam is a fluid stream 795, vapor, and a liquid fluid stream 796 as sub cooled heater drain, thus imparting thermal energy to the working fluid, 795/796 vs. 3/6.

Continuing, in detail “B,” the work making phase starts, direct use of the hot working fluid into an engine approach. Another primary vessel 456B, a different but similar primary vessel, that has already gone through heat addition at constant volume from a previous cycle, and thus has extremely high pressure water as the working fluid. A piston based engine 777H. The working fluid flow path is 21..25, a tank 751, a pump 788, with 24/25 as the working fluid stream that requires thermal energy recovery by being combined with fluid stream 53 of detail “A.”

Continuing, again, in detail “A,” is another way of work making phase, liquid push out approach. A primary vessel 456B′, so that the working fluid, extremely high pressure water at say 150 Deg. F. follows 41.., into a secondary vessel 678A, wherein the ambient temperature water or a suitable liquid from the lower side of the fabric follows 42..43 via/into a cylinder, piston based engine 777C, an exhaust fluid stream 43 into a tank 752, to a pump 789, to a fill/constant pressure expulsion path ..44..45 so that the spent working fluid is pushed out of the secondary vessel 678B, from above the fabric, fluid stream 46. The secondary vessel 678B is from a previous work making phase cycle, having spent working fluid after the work is extracted via a work making phase. Another spent working fluid stream is via a path 51..53, a pump 790, from another primary vessel 456C that has gone through the work making phase, so that the path is ..61..62..51, with heat rejection via a heat exchanger 791. It should be pointed out that as will be seen later, when using a refrigerant based heat pump with an evaporator, the heat exchanger 791 is disposed in the evaporator itself, so that the heat 62/51 is rejected to turn refrigerant liquid into refrigerant vapor. The heat exchanger 791 can be in the pump discharge line, i.e. fluid stream 52.

Thus as can be seen there are three primary vessels 456's, and two secondary vessels 678's and the overall cycle is orchestrated via smart controls and batched process approach, i.e. the vessels go through the heat addition at constant volume phase, work making phase, fill/constant pressure expulsion phase, as will be disclosed in more detail later.

Continuing, in detail “C,” saturated vapor, or wet vapor shown symbolically by 71, from say a steam condenser, or using a refrigerant and ambient thermal energy via evaporation in an evaporator i.e. making low boiling refrigerant into saturated vapor, or wet vapor, or using any low grade thermal energy source. Then via compression, using a compressor 786/787, to a flow path 81..83, resulting in higher grade thermal energy at fluid stream 82, functionally similar to fluid stream 795 of detail “A,” to be used in a heat exchanger 785, to get sub cooled heater drain shown by final condition 84/13, functionally similar to fluid stream 796 of detail “A.”

Continuing, in detail “D,” first to point out that in the work making phase, the expansion is in the 2% range, which means that only about 2% of the extremely high pressure working fluid has to be released from the pressurized primary vessel, into the engine, either directly or via liquid push out option. Additionally, the 2% flow is not uniform. Therefore resulting in the decoupling of the thermodynamic processes in the work making phase vs. the fill/constant pressure expulsion phase, by having the spent working fluid stored in tanks, and the spent working fluid is then used via a uniform flow rate. Continuing, the two options have engines 777C, 777H, so that the fluid streams with dashes are the same as from details “A, B,” above. Therefore, the cold fluid stream 43′ follows into the cold tank 101C. The hot spent working fluid stream follows as 22′ into the hot tank 101H. A pump 110, a path 111..112, a secondary vessel 678B′ shows the hot spent working fluid stream 113 into the hot tank 101H. Thus there is the hot working fluid in tank 101H from the two options of work making phase. Thus only about 2%, to be determined by plant computers is to be transferred in the fill/constant pressure expulsion phase. Continuing, a pump 120, a path 121..124, an open/shut control valve 125, a flow rate instrument 133, sending signal 134 to a controller 131, a signal 141 to a plant computer 141, generating a signal 142 to another controller 132, generating a signal 135 to shut the control valve 125 when the spent working fluid quantity has been transferred from the tank 101H to the rest of the system here, i.e. to combine with fluid stream 172. Continuing, the two large pumps 151, 152, a common drive 153 have almost equal flow rates, except for the 2% part, so that the paths are 1′..6′ from detail “A,” above shown here by 160..163, via exhaust 782D, and 785D as part of the heat addition at constant volume. A path 171..172, via the primary vessel 456CD, combined with fluid stream ..124, to a path ..173..175, via a heat exchanger 791′. Thus the main part of the approach is the non uniform working fluid flow rate during the work making phase, so that the working fluid storage, as hot, spent working fluid approach, and uniform evacuation into the system is disclosed.

Thus the basic concept is of heat addition at constant volume approach, and then work making phase, fill/constant pressure expulsion phase etc., of the thermodynamic cycle are disclosed.

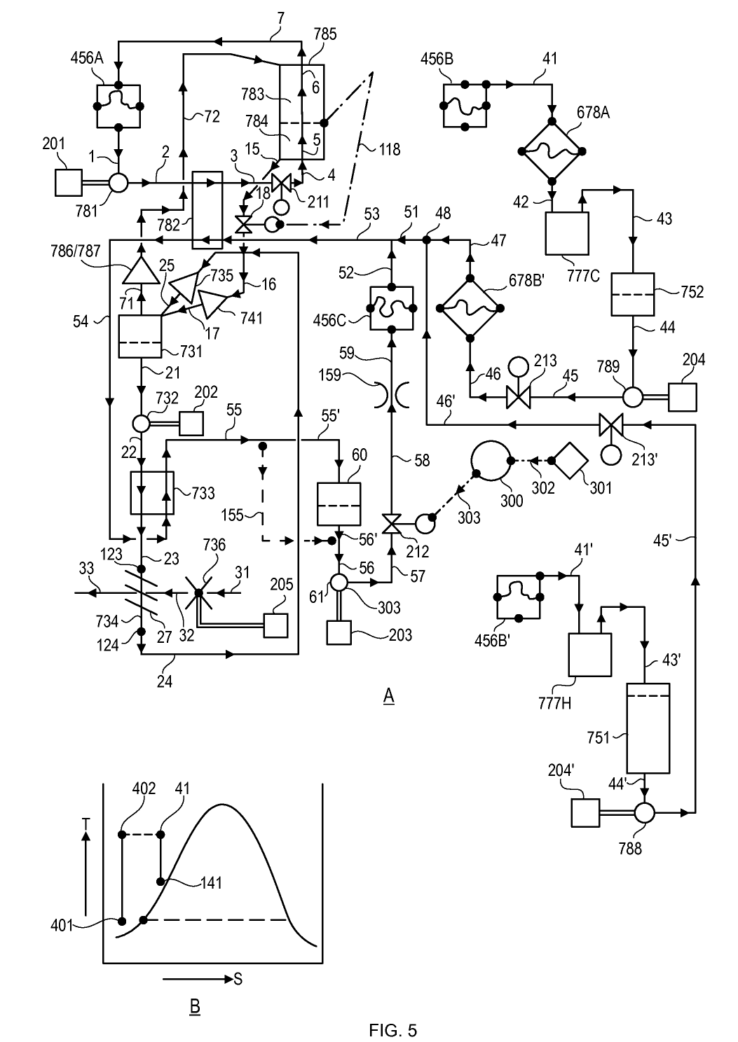

FIG. 5 shows, in detail “A,” is a thermodynamic cycle, based upon heat addition at constant volume approach. A working fluid is say water with glycol for very cold application, at say 40 Deg. F. A primary vessel 456A, to a flow path 1..7, from one side, bottom of a loose fabric, anchored in the middle of the primary vessel 456A, and shown by hand drawn line. The working fluid loop, has a circulator 781, recuperation heat exchanger 782, a heat exchanger 785, with a drains cooling zone 784, and condensing zone 783. The sub cooled drains from the heating source working fluid, a refrigerant follows 15..17, via a level control valve 18, using a signal 118 to control the liquid level in the heat exchanger 785. A screw expander, or a 2phase turbine 741 is to extract work, to the thermal energy gathering sub system tank 731.

The thermal energy gathering sub system follows, a tank 731, a refrigerant as the thermal energy gathering sub system working fluid, say R11, Isobutane, etc. a path 21..25, a pump 732, a heat exchanger 733 to cool the water/glycol working fluid, later. An ambient thermal energy intake via finned heat transfer surface shown by 123/124, a heat exchanger 734, fins 27, to a screw expander or 2phase turbine 735. The ambient air as the ambient thermal energy source follows, a fan 736, ambient air path 31..33. The refrigerant does work in the screw expander 735, or a 2phase turbine, not shown. Then via flashing, vapor is produced in tank 731, at certain saturation pressure, with an optional restriction orifice in fluid stream 25, not shown.

Continuing, the refrigerant as the working fluid in the thermal energy gathering loop, as the wet vapor or saturated vapor follows 71..72 via a compressor 786/787, to elevate the thermal energy level that is used in the heat exchanger 785. The pressure of fluid stream 71 is thus raised, negative work, to thus raise the saturation temperature of the fluid stream 72. Thus ambient thermal energy, via heat exchanger 785, along with the recuperated thermal energy via recuperation heat exchanger 782 is used for heat addition at constant volume phase of the primary vessel 456A. Thus the result is very high pressure of the working fluid, starting with ambient or very cold water, in fluid stream 1 in the primary vessel 456A, but without the accompanying pumping power.

Continuing, the screw expanders, 2phase turbines 735, 741 can be replaced by restriction orifices if the economics of extracting work are not favorable.

Thus the heat addition at constant volume phase of the cycle that uses a batched approach.

Continuing, the work making phase, has another primary vessel 456B with very high pressure water, from a previous batched approach of heat addition at constant volume phase. The working fluid follows 41..42, via a secondary vessel 678A in which using the liquid push out approach, i.e. ambient water or any other suitable liquid is pushed out via fluid stream 41, on the other, (lower side) of the fabric. An engine 777C using cylinders, pistons technology produces work, by the liquid pushing the piston down while the intake valves of the cylinders remain open during the entire downward working stroke. Then the exhaust stroke follows, a path ..43, into a tank 752. It should be pointed out that in order to maintain uniform work output, the flow rate in path 41.., and 42..43 will not be uniform, as the pressure of the working fluid goes down and down, as work is extracted. Therefore this work making phase happens on its own terms but say in 10 minutes, the time 10 minutes is the batched approach cycle time, i.e. all the batched approach actions happen in this time frame. This is followed by the switching of the primary vessels and the secondary vessels, reconfiguring the entire system/cycle, the batched approach, to carry out three thermodynamic process(s) being the key.

Continuing, during the work making phase, the pressure of the working fluid goes down and down, as more and more work is extracted. Thus over (cycle) time (of say 10 minutes), the work contained, or the work capability per lb. of the working fluid also goes down and down.

Continuing, the next phases are the fill/constant pressure expulsion phase, so that the paths are ..44..47, via an engine 777C, a tank 752, a pump 789, to a node 48 via another secondary vessel 678B that has the spent working fluid from a previous work making phase. The spent working fluid is thus pushed out, ..47..48.

Continuing, as an alternate to the liquid push out approach, as an option to use the water working fluid at extremely high pressure, and at modestly high temperature as the working fluid in the engine 777H, directly. A vessel 456B′, and the working fluid then follows 41′.., into the engine 777H. The exhaust follows ..43′.., into a tank 751, shown bigger as the hot spent working fluid will have to be gathered. The thermal energy recovery follows, a path 44′..46′, a pump 788, into the node 48 as before. A control valve 213′. Thus to use either/or approach to extract work, either liquid push out approach of primary vessel 456B, or without the secondary vessel 678A approach, shown by primary vessel 456B′, (to make work). Thus having fluid streams 51, 52 as the spent working fluid push out fluid streams, from the various vessels, which then follows ..53..59, doing the fill/constant pressure expulsion phase of the primary vessel 456C, as well. The spent working fluid from a previous work making phase is path ..52. The water at fluid stream 55 is about 40 Deg. F., not a rigid number.

Continuing, water as working fluid follows ..53..55..55′..56′..56..59. Thermal energy recovery 53/54, followed by cooling to very low temperature, 54/55, to a tank 60. The spent working fluid in the primary vessel 456C is thus pushed out. As an alternate to the use of a tank, the system can be hard piped, a path ..55..155..56 into the pump 61, i.e. without a tank 60 in the system.

Continuing, the batched approach will need controls, more detail later. A controller 300, a plant computer 301 with incoming signals 302 has outgoing signal 303 to a control valve 212. There are many control valves, 211..213, 213′ etc., all orchestrated by the controller 300. There are various motors, such as 210.., that will get RPM setting signals as well. Then many flow measurement points, such as flow in fluid stream 58, shown by the flow instrument 159 that will feed the flows back into the plant computer, to keep track of the working fluid transferred, to satisfy the 10 minute cycle requirements, and then realignment of the whole system, as part of the batched approach.

Continuing, in detail “B,” a Ts diagram, Temperature/Entropy diagram, a node 401 represents a sub cooled working fluid. If using a pump, the pump discharge is 402. However in the heat addition at constant volume approach getting point 41, from 401. The work is represented by 41/141, thermal energy recovery, not shown, from the hot fluid stream 141.

Thus disclosing a batched approach based cycle configuration, with heat addition at constant volume approach as the main feature, amongst others.

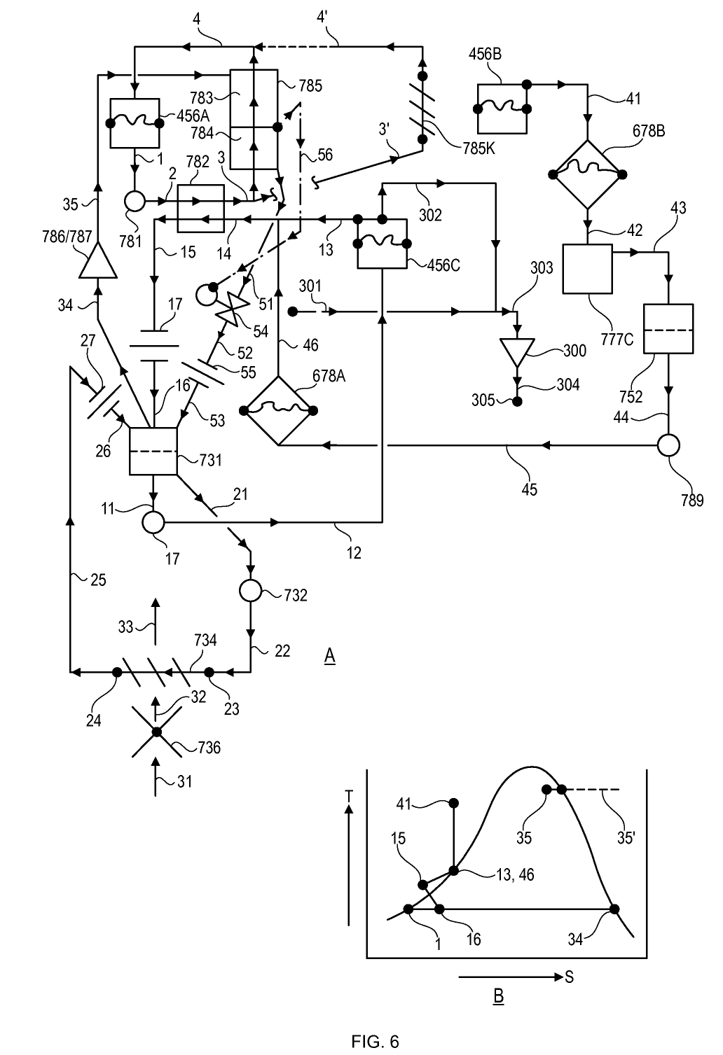

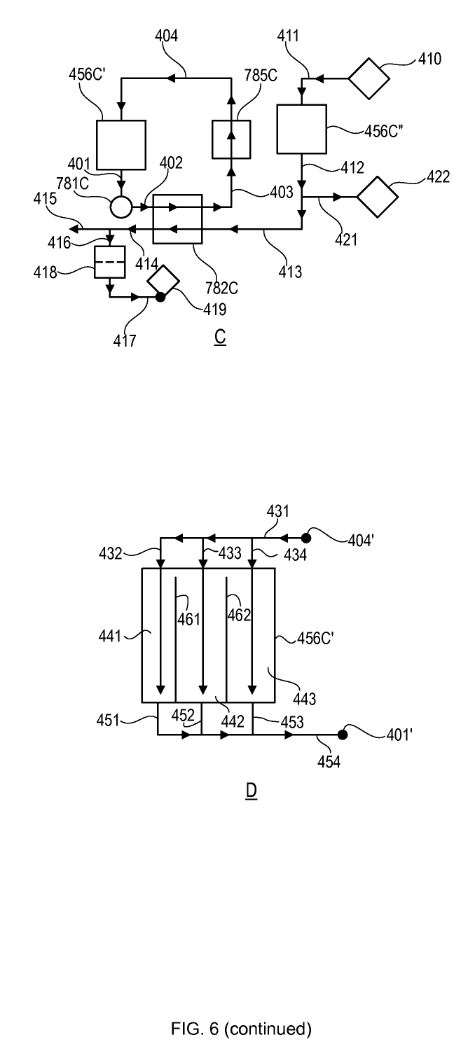

FIG. 6 shows a thermodynamic cycle, as based upon heat addition at constant volume approach. In this case the main working fluid is also a refrigerant. In detail “A,” a vessel 456A, a path 1..4, later. A parallel path 3′..4′ using ambient or low grade or waste thermal energy directly, a finned tube heat exchanger 785K, via ambient air blown over, sea water, ground water etc., for very cold starting temperature at fluid stream 2, and no recuperation heat exchanger 782 as an option, TABLE 11 shows some numerical values, addressing the vapor formation in fluid stream 14/15, when no recuperation heat exchanger, the vapor that gets compressed, as part of the heat pump fluid stream 34. Thus the working fluid in the heat addition at constant volume phase can start with very low temperature, so that most of the new heat can be via direct use of the low grade thermal energy, waste thermal energy, ambient thermal energy. The teachings can be applied if the main working fluid is water with glycol, and the additional thermal energy can be produced by a refrigerant based heat pump. This heat pump approach is thus used to pre refrigerate the water with glycol to very low temperature, in say desert heat applications. Continuing, a circulator 781, a recuperation heat exchanger 782, for recuperated thermal energy, new thermal energy heat exchanger 785, with a condensing zone 783, a drains cooling zone 784. This represents the heat addition at constant volume phase. The work making phase has a vessel 456B with the working fluid that follows 41..43, a liquid push out secondary vessel 678B. The working fluid stream 42 makes work in a hydraulic motor, screw expander, a cylinder based engine etc. The exhaust fluid stream 43, say water, to a tank 752, with the fill/constant pressure expulsion sub system, a pump 789, a path 44..46. The work making phase can be designed to result in a two phase working fluid in both the primary vessel, and the secondary vessel. Thus initially in the fill/constant pressure expulsion phase, via controls to detect the presence of vapor, and at the end of it, and to a liquid path ..14 to the recuperation heat exchanger 782, the vapor part, initially, to a path 301, 302 to 303..304, to a node 305 that the becomes the thermal energy source, with compression via a compressor 300.

The other part of the fill/constant pressure expulsion has the sub system, a tank 731 with a very cold working fluid, a suitable refrigerant, a pump 17, a path 11..13, to a combined fluid stream path ..14..16, restriction orifice 17. The ambient thermal energy gathering sub system follows, a pump 732, a path 21..26, restriction orifice 27, with the finned heat transfer surface 23/24, 734, ambient air flow via a fan 736, a path 31..33. A heat pump approach sub system 34..35, a compressor 786/787, with the refrigerant heater drain 51..53, a restriction orifice 55, a level control valve 54, to maintain liquid level in the heat exchanger 785, a signal 56. Thus sub system(s), heat addition at constant volume phase, heat pump phase, work making phase, fill/constant pressure expulsion phase to be orchestrated using smart controls, a power making cycle using ambient thermal energy.

Continuing, in detail “B,” a Ts diagram, Temperature/Entropy diagram, work produced via expansion 41/13, 46, a dotted line 35′, compressor exit condition. The vapor part of the diagram is drawn as such for the sake of simplicity, as via the determination of properties node 35 is slightly wet, and the vapor line will curve inwards. The cooling 13/15 is to recover the thermal energy in heat exchanger 782, to throttling 15/16. The throttling can be replaced by a screw expander if the economics are there to extract work, all based upon teachings.

Continuing, detail “C,” the primary vessels is without the fabric, and by accepting some thermodynamic sloppiness, a primary vessel 456C′, with an optional churner to mix the working fluid, not shown, a working fluid path 401..404, a circulator 781C, a recuperation heat exchanger 782C, a heat exchanger 785C using new thermal energy as part of the heat addition at constant volume phase, realizing that due to mixing of the working fluid, post heating, fluid stream 404, with the cooler working fluid remaining in the primary vessel, the temperature at fluid stream 401 will not be constant over the heat addition at constant volume phase. The heat addition at constant volume phase stops when the fluid stream 401 temperature becomes close the fluid stream 404 temperature. Another primary vessel 456C″, after the work making phase, having spent working fluid, so that a compressed air sub system 410, a compressed air path 411 pushes out the spent working fluid, at say atmospheric pressure, a path 412..415, a fluid stream 415 path when the temperature is such that the thermal energy recovery is not economical, a path 416, a tank 418, when the temperature is such that thermal energy recovery is economical, a path 417, a thermal energy recovery sub system 419, the thermal energy recovery can be into the heat pump etc. As an alternative, a path ..412..421.., to a sub system 422 to evaporate the refrigerant, at different pressure (s), as part of the heat pump. Continuing, as long as we use the spent working fluid thermal energy, via thermal energy recovery into the recuperation heat exchanger 782C, and/or into the heat pump, net positive work will result.

Continuing, detail “D,” a primary vessel 456C′, with the inlet working fluid stream 404′, and exit working fluid stream 401′, from detail “C,” with the primary vessel being divided up, internally, into several compartments, in communication with each other, using plates 461, 462, with exit fluid stream paths 451..454, from different parts of the primary vessel, and hot side working fluid streams 431..434, discharging way deep into the compartments. Thus by making compartments, and using on/off valves, not shown, to draw working fluid, and discharge working fluid, into compartments, some working fluid separation is affected.

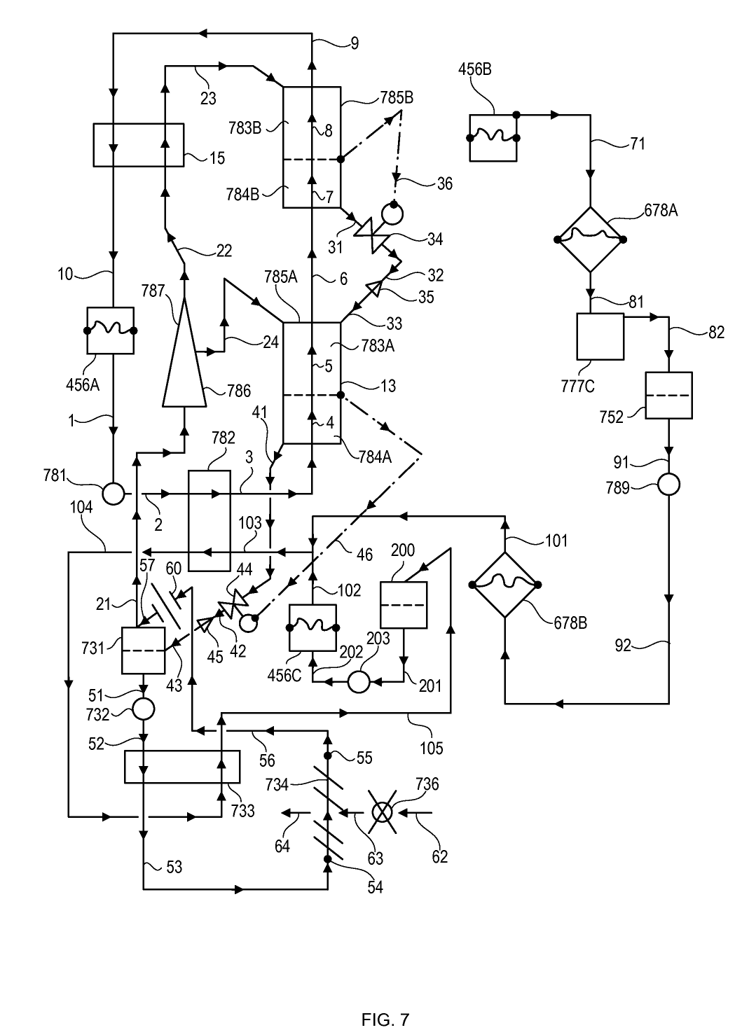

FIG. 7 shows a thermodynamic cycle using the heat addition at constant volume approach. A primary vessel 456A with water as working fluid, refrigerated and with glycol as an option, follows 1..10, a circulator 781, heating(s) via a recuperation heat exchanger 782, a heat exchangers 785A, 785B via condensing zone(s) 783A, 783B, and drains cooling zone(s) 784A, 784B. Super heat recovery via a heat exchanger 15, 9/10 vs. super heat 22/23.

Continuing, the ambient thermal energy gathering sub system, a tank 731, with a suitable refrigerant as the working fluid in this application, say R11 etc. A refrigerant path 51..57, a pump 732, a heat exchanger 733 to cool the water working fluid, finned heat transfer surface 54/55, 734, to boil off the refrigerant. A restriction orifice 60. The ambient thermal energy, a fan 736, air flow 62..64. Vapor is thus formed by using the ambient thermal energy, a vapor path 21..23, via compressors 786, 787, a two stage compression approach, super heat use 22/23, to a heat exchanger 785B, and a lower heat exchanger 785B, with thermal energy source, fluid stream 24. The sub cooled liquid drains from heat exchanger 785B, a path 31..33, a level control valve 34, maintaining liquid level shown via a signal 36, optional screw expander, or a 2phase turbine 35 to make work. Another sub cooled liquid drain from heat exchanger 785B a path 41..43, a level control valve 44, maintaining liquid level shown via a signal 46, an optional screw expander or a 2phase turbine 45 to make work.

Continuing, another primary vessel 456B from the previous heat addition at constant volume phase, a path 71.., as the work making phase, a primary vessel 456B, working fluid above the fabric deflates, into a secondary vessel 678A, the working fluid push out approach, a path 81..82, via a cylinder based machine 777C, into a tank 752. The liquid then follows, a pump 789, a path 91..92, into another secondary vessel 678B with spent working fluid from a previous work making phase. Thus a fill/constant pressure expulsion phase, a path ..101.

Continuing, from a tank 200 that holds very cold water, the fill/constant pressure expulsion phase follows via a pump 203, a path 201..202, into the primary vessel 456C from a previous work making phase, with spent working fluid from above the fabric gets pushed out via fill/constant pressure expulsion phase, so that the path is ..101, ..102, ..103..105.

Thus a power cycle, with a batched process approach, with heat addition at constant volume phase, work making phase, a fill/constant pressure expulsion phase etc., using the ambient thermal energy as the thermal energy source as disclosed.

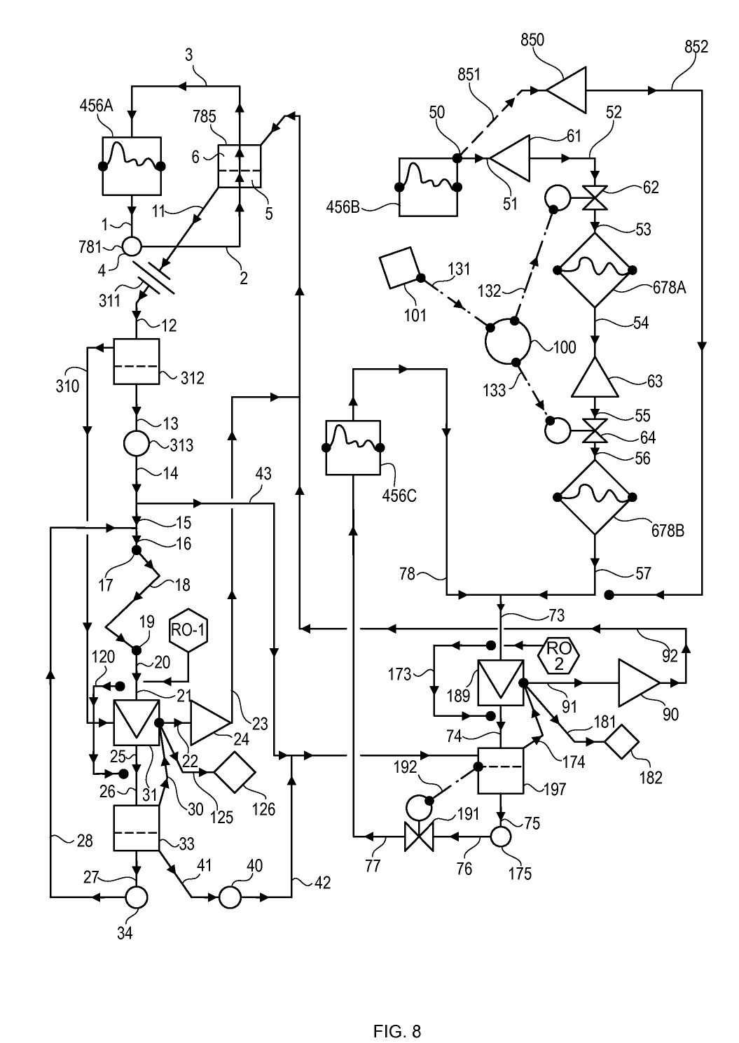

FIG. 8 shows, making usable thermal energy from ambient thermal energy and a low temperature overall cycle, a primary vessel 456A, the heat addition at constant volume phase, a path 1..3, a circulator 4/781, a heat exchanger 785, a drains cooling zone 5, a condensing zone 6, with sub cooled heater drain, to gather thermal energy using ambient thermal energy, heater drain path 11..21, a restriction orifice 311, (optional screw expander/2phase turbine to extract work, as an option), based upon the economics, to a tank 312, to a very low temperature liquid path ..13.., pump 313, a path 13..21, a restriction orifice, RO1 in fluid stream 20, to result in a 2phase fluid stream 21, to the sub system to gather thermal energy in heat exchanger 18, a moisture separator 31, a tank 33, vapor paths 310 from the tank 312, compression path 22..23, a compressor 24 to make higher grade heat, liquid re circulation path 27..28, a pump 34, an equalizing vapor line 30. A path ..125, to compression 126, shown symbolically, the compression can be in various alternate ways, to minimize compression work, as based upon optimization exercise, such as via two pressure levels etc., as disclosed in great detail elsewhere. An alternate path 120 that is without a moisture separator, thus using wet fluid streams for compression, for design flexibility, etc. Thus to recap, a sub system to gather ambient thermal energy, using vapor re compression to make higher grade, useful thermal energy.

Continuing, a primary vessel 456B, in the work making phase, a path 51..57, an expander 61, a control valve 62, secondary vessels 678A, 678B, in path 53/54, the working fluid 53 pushes out the liquid fluid stream 54, in a path, an expander 63 to extract more work, a controller 100, a plant computer 101, sending a signal 131, generating signals 132, 133 to position valves 62, 64 to trim the pressure, as needed, but as little a pressure drop in control valve 62 as possible, to make most of the work in the expander 61, to the remaining pressure use in expander 63, with fine trimming as needed to keep the back pressure at fluid streams 57 per design.

Continuing, an alternate simpler path 851..852, an expander 850. All of the above is by way of design flexibility.

Continuing, a path ..73, a moisture separator 189, a non moisture separator option path shown symbolically by 173, a tank 197, a pump 175, a liquid, fill phase path ..75..77, a control valve 191, a signal 192 to maintain liquid level in tank 197, to another primary vessel 456C, with spent working fluid push out, a path ..78, to combine with fluid stream 852/57 as the case may be. The vapor path follows 91..92, a compressor 90, a path ..181, to 182 to point out other compression options, two pressure levels etc., as based upon optimization exercise, and as disclosed in great detail elsewhere.

Thus, to recap, making pressure in primary vessel 456A, heat addition at constant volume approach, make work in primary vessel 456B, work making phase, and then secondary vessels to provide the large expansion volume, etc., etc., so that the pressure(s) in fluid streams 12, 57 etc., via over expansion etc. are equal, and compatible with the ambient heat source temperature available, and the vapor resulting from over expansion etc. become part of the heat pump approach etc., to make usable temperature level.

The key here is the throttling of the spent working fluid, fluid streams 57/852, 78 to get the working fluid at the original conditions of fluid stream 1, the start of the heat addition at constant volume, as fluid stream 75.

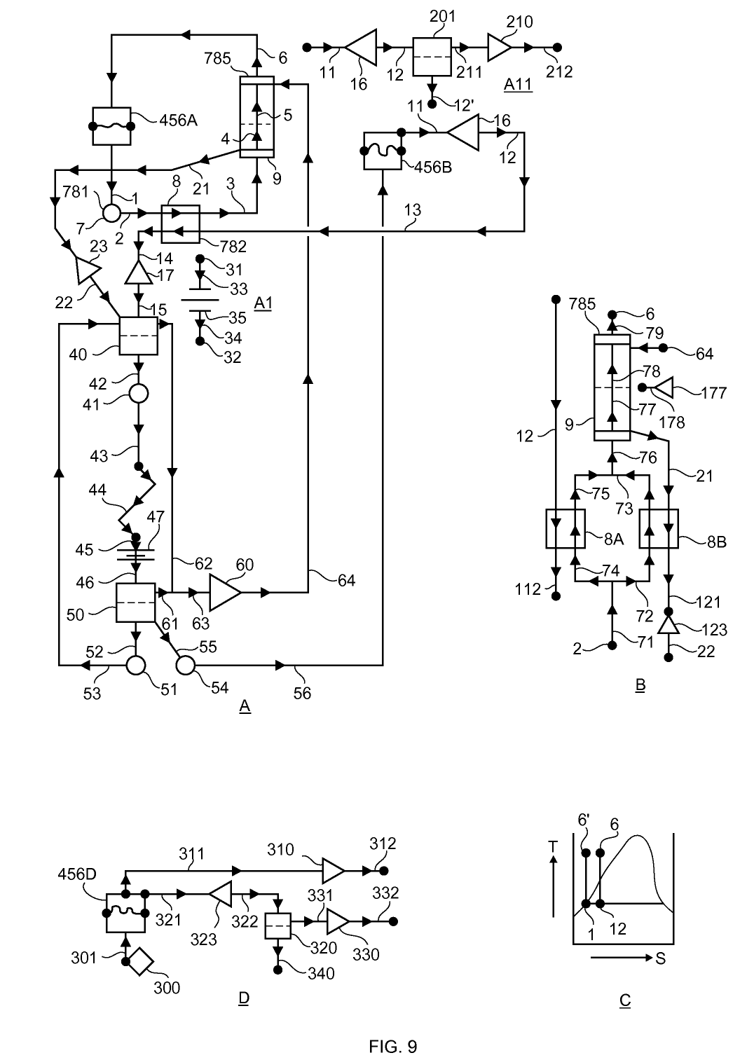

FIG. 9 shows, in detail “A,” a cycle using heat addition at constant volume approach. The working fluid from a primary vessel 456A, a path 1..6, circulator 7/781, a recuperation heat exchanger 8/782, heat addition via a heat exchanger 9/785, a drains cooling zone 4, a condensing zone 5. Another primary vessel 456B, after the heat addition at constant volume phase, is going through the work making phase, a path 11..15, a screw expander/2phase turbine 16, thermal energy recovery 13/14, another screw expander/2phase turbine 17 into a tank 40 as part of heat gathering sub system. The heat gathering sub system, a tank 40, a circulator 41, a path ..42..46, into another tank 50, the ambient thermal energy coming in via 44, a restriction orifice 47 to make two phase working fluid stream 46, to the vapor paths follow ..62, 61 to 63..64, a compressor 60 using the heat pump approach. The heater drain fluid stream ..21..22, via a screw expander/2phase turbine 23. The liquid path follows, a circulator 51, a path 52..53. As an alternate, in detail “A1,” instead of screw expanders 17, 23, restriction orifice(s) 35, a path 31..32. Thus to recover the thermal energy via heat exchanger 8/782, and then make the deficient/deficit usable grade thermal energy via the heat pump, the path ..61..64.

In all this, the negative work of the compressor 60, and the positive work of the working fluid in the primary vessel 456A, 456B, wherein making free pressure via heat addition at constant volume approach, to get net positive work, shown by TABLES, with stream properties.

Continuing, in detail “B,” optimizing the heat exchangers 8/782, 9/785, by imposing heat capacity matching, a path 2..6 of detail “A,” the two ends, then paths 71..79, the heat exchanger 9/785, the drains cooling heat exchangers 8A, 8B, the vapor coming in, fluid stream 64, drains path 21..121..22, a screw expander 123. The other path 12..112, and 177, 178 to point out a varying drains cooling effectiveness, or no drains cooling at all, so that the heat exchanger 8B does the entire drain cooling in this path. Thus detail “B,” is the optimization of the heat sink 2..6 vs. the heat sources, fluid stream 64, and fluid stream 12, all based upon optimization exercise.

Continuing, in detail “C,” a Ts diagram, to point out the conventional liquid pump, the liquid 1 follows 1..6′, lot of pumping work, with low temperature end point 6′, below critical temperature. To the heat addition at constant volume approach, to get 1..6, to the expansion at the start of the work making phase 6..12, to further clarify the thermodynamic cycle.

Continuing, detail “A11,” the disclosure in detail “A,” is such, so that the working fluid stream 12 is liquid. However the expansion sub system of the expander 16 cluster is such, that to expand to all the way of back pressure, and get a two phase working fluid, the working fluid follows 11..12, an expander 16, a tank 201, the vapor part gets continuously evacuated, path 211..212, a compressor 210, the working fluid stream 212 is part of the heat pump approach, i.e. gives up its latent heat. The very cold liquid working fluid stream 12′, follows the fluid stream 12 of detail “A,” or if no useful thermal energy is left in it, then gets sent to tank 40, via a screw expander if economics permit that.

Continuing, in detail “D,” the primary vessel 456D, going through the work making phase, the sub system is a path 321..322, expander (a cluster) 323, to thus get two phase working fluid stream 322, a tank 320, to very cold liquid fluid stream 340. The vapor fluid streams get continuously evacuated, a path 311..312, a compressor 310, a path 331..332, a compressor 330, so that the fluid streams 312, 332 are at pressure(s) to give the useful latent heat, i.e. heat pump approach of the vapor that gets formed. The symbol 300, a path 301 represents the fill/constant pressure expulsion phase, after the initial extremely high pressure working fluid makes work, and the constant pressure expulsion takes over this way.

Thus to recap, to elevate the thermal energy grade via heat pump approach, the refrigerant vapor forms from using ambient thermal energy, fluid streams 61, 62, to compression via compressor 60. The work making phase can be above the liquid line, and then gets throttled to get back to very low temperature, or the expansion can be all the way down to the back pressure compatible with the fill temperature/pressure of the vessel, for heat addition at constant volume approach. There is also the tool of the constant pressure expulsion after the work is extracted, down to the liquid line, etc., etc., all based upon teachings.

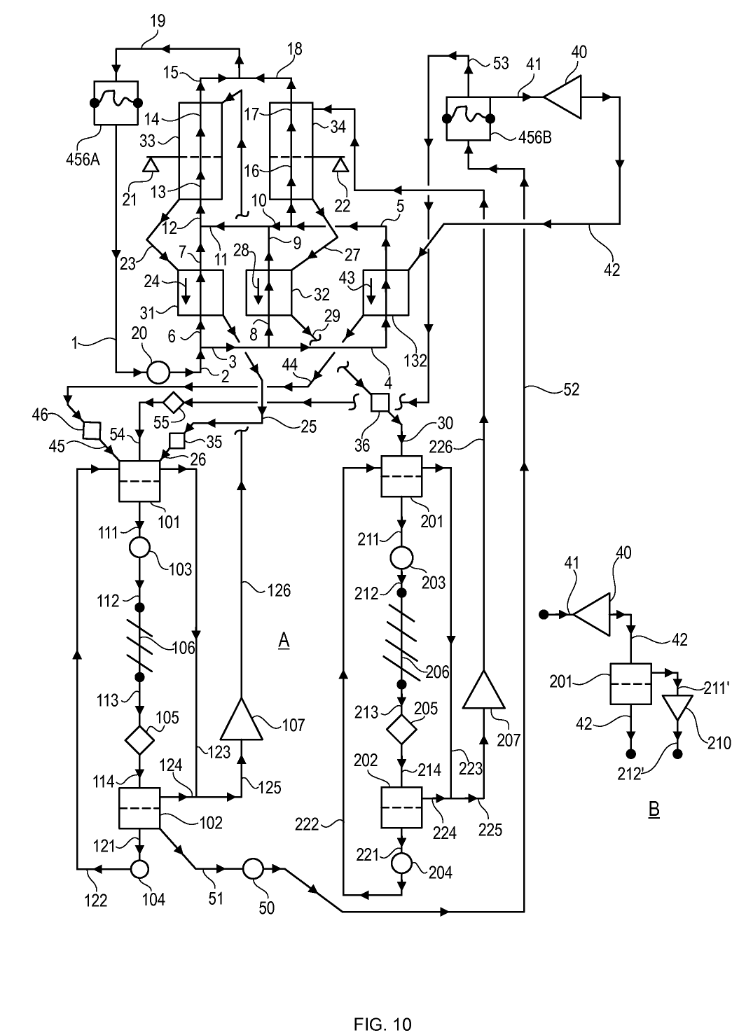

FIG. 10 shows, in detail “A,” an optimization exercise with the explanation that for very low temperature cycles, the use of refrigerant as working fluid becomes a choice, elevate the thermal energy grade via a heat pump approach, thus using low grade or ambient thermal energy to get usable higher grade thermal energy, i.e. to start with very cold vapor via evaporation of the refrigerant using say ambient thermal energy, and then compression to make higher grade thermal energy. At the same time, use a refrigerant as the working fluid in the heat addition at constant volume approach, to make free pressure of the working fluid. As optimization exercise what refrigerant to be used is an issue as well, i.e. R245fa, R134, R11, Isobutane, etc., etc. For example for heat pump not only the COP, Coefficient Of Performance, but the specific volume etc. comes into play which, the specific volume, in turn has an effect on compressor size for the compression of the refrigerant vapor in heat pump application. Same, similar issues for the work making phase of the overall cycle, in selection of the refrigerant. Thus a cycle configuration to have the flexibility of using two refrigerant(s), one for the heat pump part and the other for the work cycle, i.e. the work making phase part. The work making part of the overall cycle will also result in vapor formation to get back to very low temperature, back into the primary vessels for heat addition at constant volume approach. This vapor part is also compressed to make higher grade thermal energy. Thus there is no heat sink in the cycle.

Continuing, the primary vessel 456A, the heat addition at constant volume phase, a circulator 20, the working fluid path 1..19, lower heat exchangers 31, 32, 132, upper heat exchangers 33, 34, using the latent heat of the vapor, of the heat pump sub system, with drains cooling zone(s) 13, 16, condensing zones 14, 17, shown, with symbols 21, 22 to point out the flexibility of the drains cooling zone(s), i.e. how much drains cooling effectiveness in these heat exchangers, 33, 34. The heater drains follow 23..26, 27..30, via screw expander/2phase turbine, and or restriction orifice(s), 35, 36, into the tanks for heat gathering sub system.

Continuing, the primary vessel 456B, going through the work making phase, a path 41..41..45, expander, cluster, 40, screw expander, and/or restriction orifice 46.

Continuing, the heat gathering sub system(s), tanks 101, 102, circulator(s) 103, 104, very cold fluid stream, a path 111..114, ambient thermal energy coming in, 106, screw expander, and/or restriction orifice 105, so that incoming ambient or low grade thermal energy, as disclosed. Then liquid recirculation path, a circulator 104, a path 121..122. The compression, as part of the heat pump approach, paths 123..124, 125..126, a compressor 107. The other heat gathering sub system is via components, fluid stream numbers shown by 200,s, right of the sub system just described.

Continuing, in detail “B,” the disclosure in detail “A,” is such that the working fluid stream 42 is liquid. However a design option, the expansion sub system of the expander 40, cluster, so as to expand to all the way of back pressure, that results in a two phase working fluid, the working fluid follows, a path 41..42, expander 40, a tank 201, the vapor part gets continuously evacuated, a path 211′..212′, a compressor 210, the working fluid stream 212 is thermal energy source, as part of the heat pump approach, i.e. gives up its latent heat. A very cold, liquid, working fluid stream 42 then follows, same as the fluid stream 42 of detail “A,” or if no useful thermal energy left in it, fluid stream 42, then it gets sent to tank 101, via a screw expander if economics permit that.

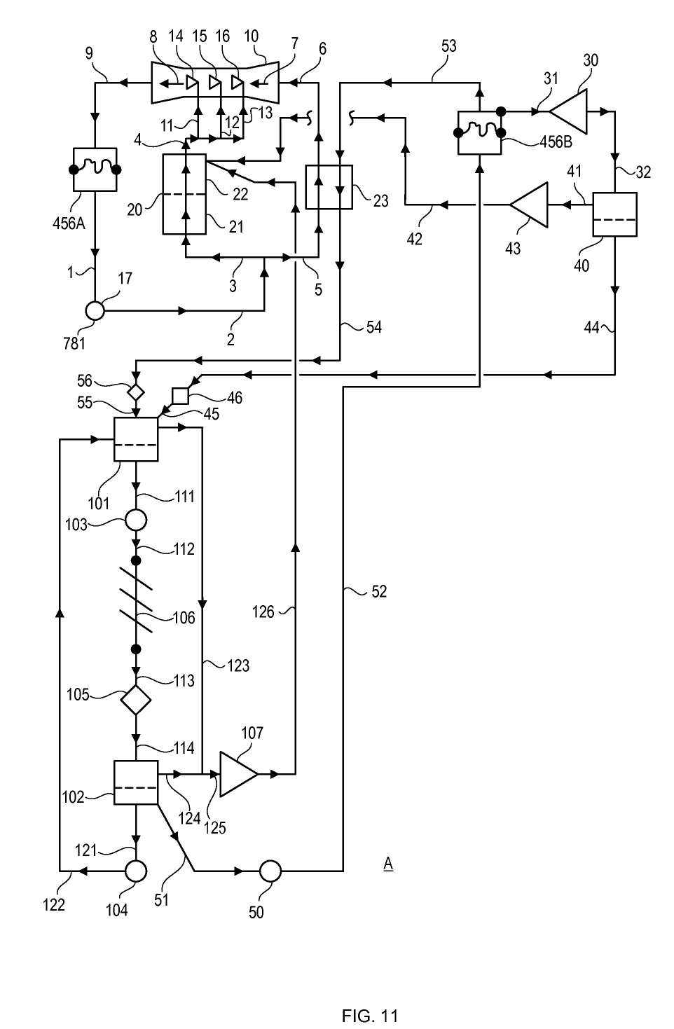

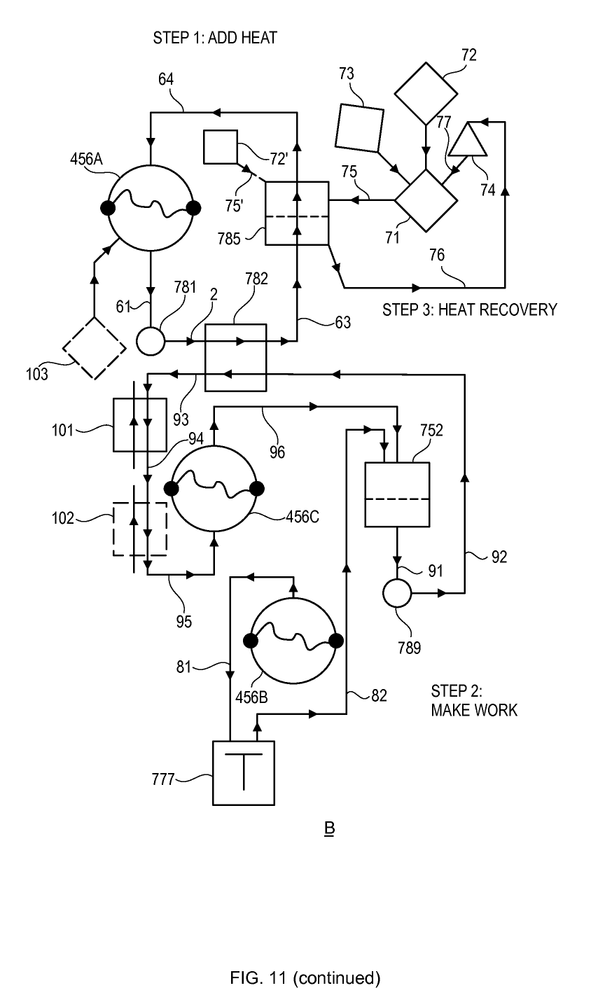

FIG. 11 shows an approach, wherein the working fluid can be expanded to as low a remaining pressure in the vessel, but just before the vapor appears.

The left behind working fluid can be used as the thermal energy source for heat addition at constant volume approach.

Continuing, a primary vessel 456A, the heat addition at constant volume, a path 1..2..5..9, a circulator 17/781, and ..3..4 as another path, heat exchanger 20, drains cooling zone 21, condensing zone 22, another heat exchanger 23. An ejector 10, higher working fluid via paths ..4..11..13, nozzles 14..16, momentum transfer, stagnation to get the extremely high pressure working fluid stream 9. Thus two temperature levels, fluid streams 4, 6, as the thermal energy sources which heat the working fluids 3, 5 to different temperature(s), and therefore pressure levels.

Continuing, a vessel 456B, to the work making phase, a path 31..32, an expander (cluster) 30, resulting in the two phase fluid stream 32, into a tank 40. The vapor part gets continuously evacuated, a path 41..42, a compressor 43 thereby resulting in the heat pump approach.

The liquid part, a path 44..45, via a restriction orifice and/or screw expander/2phase turbine 46, into the tank 101. The thermal energy source, via fill/constant pressure expulsion, a path ..53..55, a restriction orifice, and/or screw expander/2phase turbine 56 into the tank 101.

Continuing, the heat gathering sub system(s), tanks 101, 102, circulator(s) 103, 104, a very cold fluid stream path 111..114, ambient thermal energy coming into 106, using ambient air, sea water, ground water, etc., not shown, a screw expander, and/or restriction orifice 105. A liquid recirculation path, a circulator 104, a path 121..122. The compression as part of the heat pump approach, a path 123..124, 125..126, a compressor 107. Thus the latent heat is made available by fluid streams 126, 42 via heat pump approach.

Continuing, another very cold liquid fluid stream path 51..52, a pump 50 as the fill/constant pressure expulsion phase of working fluid in the vessel 456B, pushing out the fluid stream 53 to a path 53..55, with screw expander/2phase turbine 56, so that as an option, if there is useful thermal energy in fluid stream 53, it is used as disclosed, all based upon teachings.

Thus the point is the basic approach with variations etc., to cover all the possibilities of the basic approach of using ambient thermal energy to make work, with heat pump approach as disclosed, etc., etc. Continuing, detail “B,” A STEP 1, heat addition at constant volume phase, a primary vessel 456A, a path 61..64, a circulator 781, a recuperation heat exchanger 782, a heat exchanger 785, a thermal energy source with a heat pump sub system 71, low grade, ambient thermal energy 72, work input, negative work 73, thus a upgraded thermal energy path 75, a heater drain path 76..77 of the refrigerant from the condenser, heat exchanger 785, a 2phase turbine 74, to extract work, thereby getting extremely high pressure at the end. The 2phase turbine can be, instead a screw expander, a restriction orifice as well. A STEP 2, a work making phase, a primary vessel 456B with extremely high pressure from a prior heat addition at constant volume phase, a path 81..82, 82 the spent working fluid, exhaust fluid stream, an engine 777. A STEP 3, fill/constant pressure expulsion phase, a tank 752, a pump 789, a path 91..96, thermal energy recovery via the recuperation heat exchanger 782, more cooling, a heat exchanger 101 which is the evaporator of the heat pump 71, another heat exchanger 102, optional further cooling, via a dedicated refrigeration sub system, thereby getting very low temperature fluid stream 95, pushing out the fluid stream 96, from above the fabric. Another thermodynamic tool pre pressurizing, shown symbolically by 103, to pre pressurize in a short amount of time primary vessel 456A prior to the start of the heat addition at constant volume phase.

Continuing, an entirely different approach, a different cycle is, thermal energy shown symbolically by 72′, i.e. direct use of the thermal energy such as condenser steam thermal energy, ambient thermal energy, low grade thermal energy, i.e. no heat pump in upgrading the thermal energy. The heat exchangers 101, 102 are evaporator (s) of dedicated refrigeration sub system, a two stage cooling of fluid stream 93. Thus creating a temperature gradient, fluid stream 95, which is the fluid stream 61 of the heat addition at constant volume phase, and fluid stream 64, end of the heat addition at constant volume phase. Thus the heat pump, refrigeration type of sub system is to cool the fluid stream 93/95, and not the main thermal energy, path 75/76.

Continuing, thus looking closely at the TABLES, the work per lb. during the work making phase is about 20 BTU/Lb. The COP to refrigerate the cold side of the spent working fluid out of the recuperation heat exchanger, (COP of) cooling 93/95 is about 2. The recuperation heat exchanger can be designed to have the cold side enthalpy difference of about 8 BTU per lb. as low as possible; i.e. liquid to liquid heat transfer. Thus the negative work of the refrigeration sub system is about 4 BTU/Lb., resulting in about 16 BTU/Lb. of net work. As the thermal energy is free, the cycle thermal efficiency is not relevant.

Continuing, the work making phase is most complex if constant work output is designed for, as the flow rate through the engine will vary a lot, from start to finish, and the flow rate has to evacuate the primary vessel in a cycle time. Therefore, as a remedy, four, or even more primary vessels to be designed into the system, so that there are two, or even more primary vessels for the work making phase, so that there can be sloppiness in the work making phase, all based upon teachings.

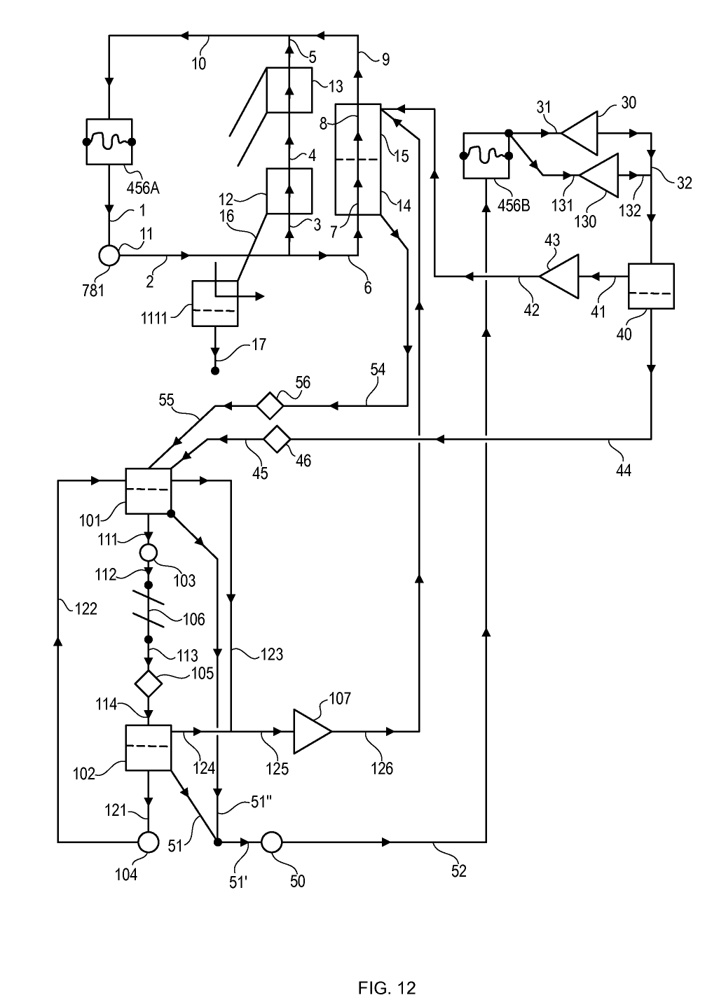

FIG. 12 shows an approach of work making phase, to continue to just before the vapor appears, i.e. emptying the vessel but not having the vapor appear, i.e. to the saturation line.

Continuing, a primary vessel 456A, to heat addition at constant volume phase, a path 1..10, a circulator 11/781, path, ..3..5, ..6..9, the heating(s) via condenser waste thermal energy flowing up steam, liquid coming down, fluid stream 16, a condenser 1111, condensate 17, to regenerative heating using lower bleed streams, shown symbolically by 13. The heating in a parallel path, drains cooling zone 14, vapor condensing zone 15, thermal energy sources fluid streams 126, 42 later.

Continuing, a vessel 456B, work making phase, handling both the initial use of the extremely high pressure working fluid, and then constant pressure expulsion, a path 31..32, expander (cluster) 30, a two phase fluid stream 32, into a tank 40. The vapor part gets continuously evacuated, a path 41..42, a compressor 43, resulting in the heat pump approach. The liquid part, a path 44..45, a restriction orifice and/or screw expander/2phase turbine 46, into a tank 101. The heater drain, a path ..54..55, a restriction orifice, and/or screw expander/2phase turbine 56, to the tank 101. Continuing, when the fill/constant pressure expulsion starts, via push out fluid stream ..52, an expander cluster 130, a path 131..132. Thus to make work via the working fluid stream from extremely high pressure to saturated liquid, and then below the saturated liquid line, etc. Thus two paths ..31, ..131.. to address the conditions of the working fluid from the primary vessel 456B, in the work making phase and the fill/constant pressure expulsion phase.

Continuing, the heat gathering sub system(s) are tanks 101, 102, circulator(s) 103, 104, the very cold fluid stream path 111..114, ambient thermal energy coming into 106, screw expander/2phase turbine, and/or restriction orifice 105, to bring in the ambient or low grade thermal energy via 106. To liquid recirculation path, the circulator 104, a path 121..122. The compression as part of the heat pump approach, paths 123/124, to a path 125..126, a compressor 107. Thus the latent heat made available by fluid streams 126, 42 via heat pump approach, used in the heat addition at constant volume.

Continuing, a very cold liquid fluid stream path 51..51′..52, another path 51″ for design flexibility, to get very cold refrigerant working fluid, a pump 50 as the fill phase/constant pressure expulsion phase in the vessel 456B, pushing out the fluid stream 53, to a path 53..55, with screw expander/2phase turbine 56, so that as an option if there is useful thermal energy in fluid stream 53 then it is used as disclosed here, all based upon teachings.

Thus, the basic approach of heat addition at constant volume, with variations etc., to cover all the possibilities, and using ambient thermal energy to make work.

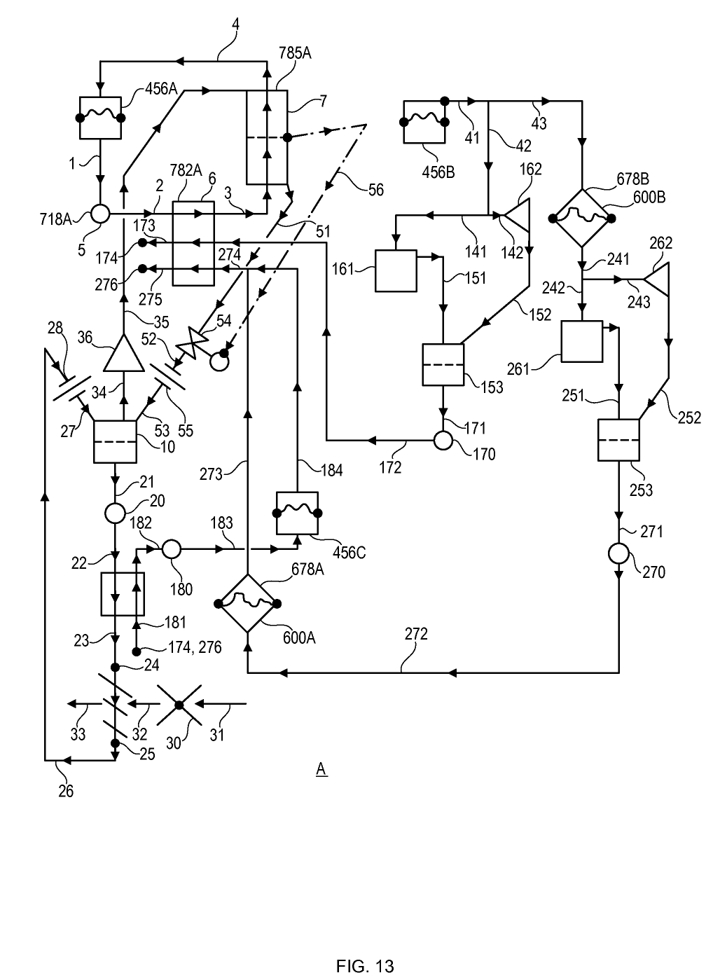

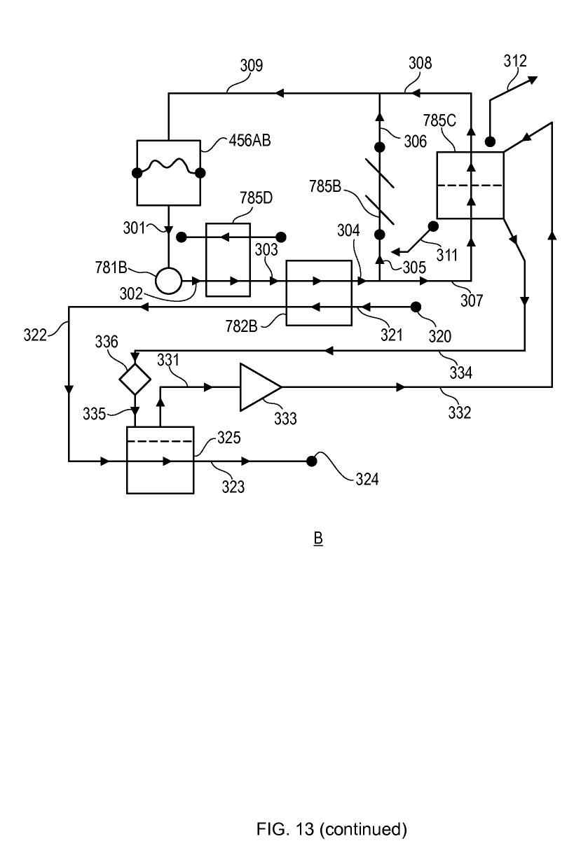

FIG. 13 shows heat addition at constant volume approach, in detail “A,” a vessel 456A, a path 1..4, a circulator 5/781, a recuperation heat exchanger 6/782A, new thermal energy heat exchanger 7/785A.

The work making phase, a vessel 456B, a path 41.., the working fluid makes work, paths 41..42, 41..43, via a cylinder based engine 161, or hydraulic motor etc. 162. the exhaust paths 151, 152, into a tank 153, which now has hot working fluid, a pump 170, a path 171..173, to a node 174, via recuperation heat exchanger 6/782, thus the thermal energy is recovered.

Continuing, the alternate, the liquid push out option, a secondary vessel 600B/678B, paths 41..43..241..243, and 41..43..241..242, a cylinder based engine 261, or hydraulic motor etc., 262, to exhaust fluid streams 251, 252, into a tank 253, a pump 270, working fluid path 271..272, with constant pressure expulsion of the vessel 600A/678A from the previous cycle, to fluid stream path 273..274..275, to a node 276. Thus work produced, either via direct use of the working fluid at pressure, or the liquid push out option as described.

Continuing, the ambient thermal energy gathering sub system, a pump 20, a path 21..27, restriction orifice 28, with the finned heat transfer surface 24/25, ambient air via a fan 30, a path 31..33.

Continuing, the working fluid to be cooled, nodes 174/276 from above, a pump 180, a path ..181..184, fill/constant pressure expulsion phase of vessel 456C, as the fluid stream 183 is the fill phase of primary vessel 456C.

A sub system, a path 34..35, a compressor 36, heater drain, a path 51..53, a restriction orifice 55, a level control valve 54, to maintain the liquid level in the heat exchanger 7/785, applying a signal 56. Thus sub system(s) heat addition at constant volume phase, heat pump phase, work making phase, constant pressure expulsion etc.

A plant computer, not shown, smart controls, not shown, to orchestrate this power making cycle using ambient thermal energy. Continuing, as an option, the thermal energy 3/4 can come from the lower bleed streams of a Rankine cycle as well, as based upon teachings. It should be pointed out that there is very large thermal energy recovery via recuperation, recuperation heat exchanger 6/782, reason for very high thermal efficiency to a large extent.

Continuing, in detail “B,” there is direct low grade thermal energy, waste thermal energy, ambient thermal energy say in a desert, that can be used directly for the heat addition at constant volume phase. However, it is also desired to get the working fluid at very low temperature, say 40 Deg. F., or even lower with water plus glycol, so that in addition to pre pressurizing as a thermodynamic tool, the new thermal energy level can be rather low. Continuing, part of the heat addition at constant volume phase follows, a primary vessel 456AB, a path 301..306, a parallel path 307..308, to a fluid stream 309. The heat exchangers are 785D, later, recuperation heat exchanger 782B, 785B, new thermal energy heat exchanger, using ambient thermal energy say air via finned tubes, condenser waste thermal energy etc., a heat exchanger 785C for using the thermal energy of a heat pump sub system. A node 320 represents the spent working fluid, for thermal energy recovery, and a path 321..324, to a node 324 that represents the very cold working fluid for the fill/constant pressure expulsion phase. An evaporator 325, with the refrigerant vapor fluid stream path 331..332, a compressor 333 to elevate the thermal energy grade, to the heat exchanger 785C, to refrigerant liquid sub cooled heater drain path 334..335, via 336 that can be a restriction orifice, screw expander, 2phase turbine as the economics permit. Continuing, a path 311 so that the heat exchanger 785C can be in fluid stream 305, a path 312 to point out that to discard/reject the thermal energy of the heat pump sub system to the outside, and a heat exchanger 785D another location of the use of the heat pump generated thermal energy. Thus the main objective of this disclosure is to have the ability of pre cooling, pre refrigeration of the working fluid, when a large heat pump for the entire thermal energy load is not needed. Continuing, detail “B,” and in TABLE 12, is to point out that the hot side working fluid temperature can be as low as 40 Deg. F., using water as the working fluid, and get the same amount of work as say 140 Deg. F. as the hot side. Thus the Tcold can be very low, so that most of the new heat can be via direct use of the thermal energy, ambient, low grade, waste thermal energy, etc., without the use of a heat pump. Using water with glycol the starting temperature can be even lower, so that the ambient thermal energy at very low temperature can be used as is, simplifying the system. The heat pump will however be used in cooling to very low temperature the recuperation heat exchanger cold side spent working fluid, as the starting Tcold temperature. Thus as an example, the heat addition at constant volume phase can be from say minus 100 Deg. F. to zero Deg. F., with the inside of the primary vessel insulated to avoid the metal pressure part becoming brittle. The properties for water glycol mixture are not available, hence this exercise.

Continuing, in a similar manner, TABLE 13 shows the COP for a large temperature lift, i.e. to move thermal energy from say minus 100 Deg. F. to 80 Deg. F., +/. Thus if there is say 8 BTU worth of cooling needed, fluid stream 133/134, on the cold side of recuperation heat exchanger, a work penalty of about 4 BTU per lb. of working fluid can be expected, resulting still in a positive work.

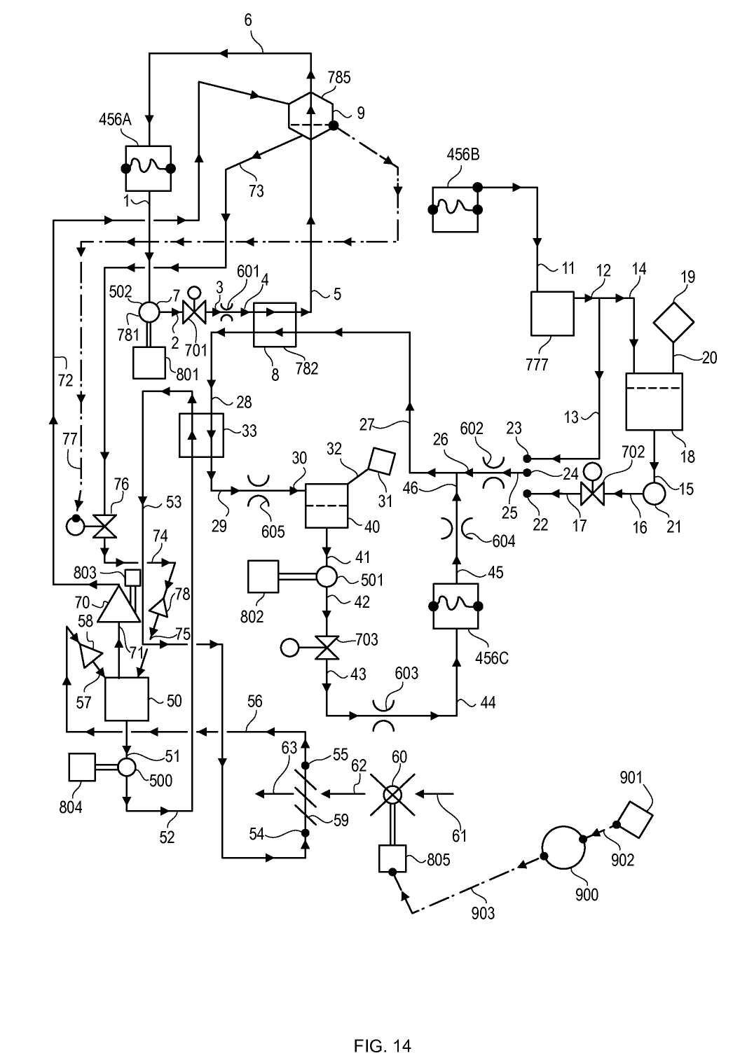

FIG. 14 shows heat addition at constant volume approach based thermodynamic cycle that has many components controls etc., later. For the heat addition at constant volume, a vessel 456A, working fluid say water at 40 Deg. F. a path 1..6, a circulator 7/502/781, a recuperation heat exchanger 8/782, new heat, (via ambient thermal energy use via a heat pump approach) to a heat exchanger 9/785, with a drains cooling zone. Thus there is extremely high pressure in primary vessel 456A as a result of heat addition at constant volume phase.

Continuing, another vessel 456B goes through the work making phase, the working fluid follows a path 11..12, a cylinder based engine 777, (can be hydraulic motor etc.), has two options. In one option the spent working fluid is collected in a tank., a path 11..12..14, a tank 18, a pressure maintaining system 19..20 (if required), to prevent flashing of still hot water. Another path 11..12..13.., as an option, if the system design is such that there is constant use of the thermal energy, later. Thus two fluid streams, nodes 22, 23, a path ..15..17, a pump 21, a control valve 702. Thus two alternate approaches of using the thermal energy of the spent working fluid.

Continuing, a path ..25..30, into a tank 40, combined with another fluid stream 46, later, to cool the entire working fluid stream, 27 via a recuperation heat exchanger 782, then fluid stream 28 via another heat exchanger 33, part of the ambient thermal energy gathering system. Thus fluid stream 29 is chilled.

Continuing, the very cold water then follows ..41..46, a the vessel 456C that now has spent working fluid from a previous batched process goes through the fill/constant pressure expulsion phase, i.e. very cold fluid stream 44 pushes out fluid stream 45 that eventually gets cooled as well.

Continuing, for the ambient thermal energy gathering system, a tank 50, a path 51..57, finned tubes for ambient thermal energy coming in, ambient air, a path 61..63, a fan 60, a screw expander 58. Thus vapor of a refrigerant using ambient thermal energy, fluid stream 71.

Continuing, for the heat pump approach, a path 71..72, a compressor 70, the condensed refrigerant, sub cooled heater drain, a path 73..75, a level control valve 76, maintaining liquid level via a signal 77, a screw expander 78.

Continuing, to recap, a heat addition at constant volume approach based thermodynamic cycle in which not to apply the liquid push out approach, instead the use of the extremely high pressure, directly in a cylinder based engine.

Continuing, for the controls, a controller 900, receiving signals 902 from a plant computer, to generate many signals such as a signal 903 to control the RPM, i.e. load of the motor of the air mover fan. Similarly other control based components, flow rate signal components series 600, control valves series 700, motors series 800, pumps series 500 etc., etc. Thus as an example, to impose equal flow in recuperation heat exchanger 8/782 via the controller, or flow rate in the ambient thermal energy gathering system, fluid stream 52, etc., etc. Not all the necessary controls are shown, and there may be some redundant control components. However, once the process is well understood, then the teachings of the controls disclosed here to be applied to make the system work, knowing that all this is a batched process.

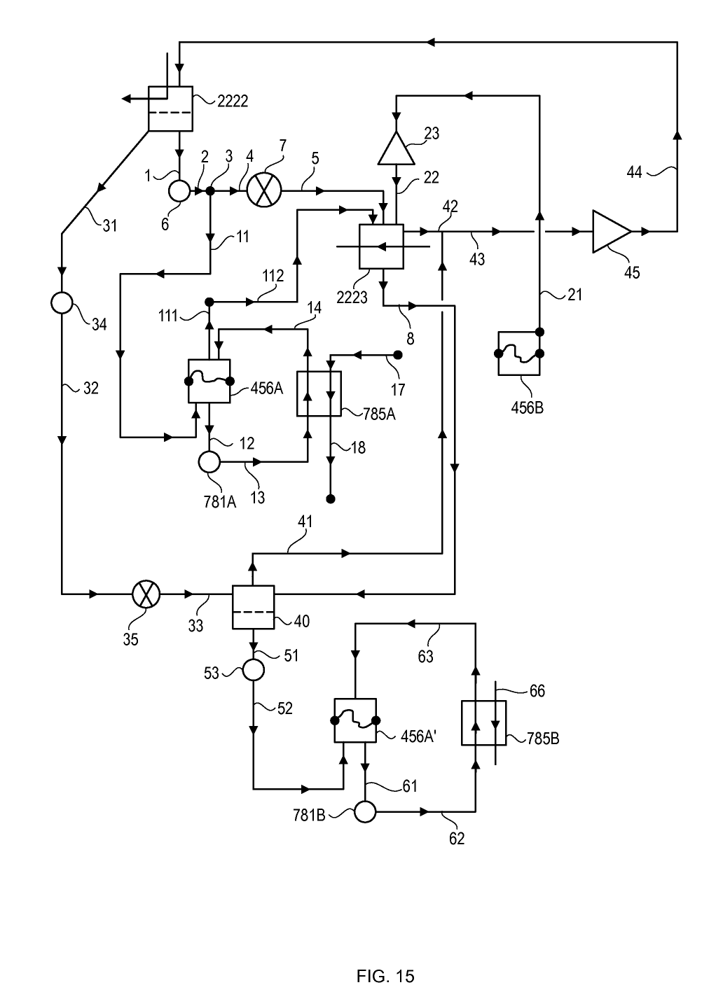

FIG. 15 shows interrupting, at two liquid stages, a heat pump or an air conditioning system, that uses a refrigerant, and vapor compression approach. The approach of heat addition at constant volume, a batched process is disclosed, the interruption is at the condenser hot well and/or after the throttling valve, i.e. an either/or or both approach, as based upon optimization exercise.

Continuing, a refrigerant condenser 2222, a refrigerant say R11 as the working fluid a path 1..5, to an evaporator 2223, via a pump 6, a throttling valve 7, to get a two phase working fluid at fluid stream 5. The interruption path 1..3..11 as the fill phase for the primary vessel 456A, and the heat addition at constant volume follows, a path 12..14, a circulator 781, a heat exchanger 785A, thermal energy source path 17..18. The thermal energy source is solar or the low grade thermal energy from the air conditioning system itself, etc., etc. A line 111..112 is the constant pressure expulsion line as part of the three step batched system. To the work making phase from another primary vessel 456B, a path 21..22 via a 2phase turbine 23. Thus work in this sub system.

Continuing, the other interruption of the liquid refrigerant, a path 31..33, a pump 34, a throttling valve 35 to get a two phase working fluid at fluid stream 33, (very cold temperature in this case), to a tank 40. The working fluid then follows as the fill phase, a path 51..52, via a pump 53. The vapor follows 41..42..43..44 via a compressor 45, the excess liquid from the evaporator 2223 follows as a fluid stream 8.

Continuing, the heat addition at constant volume follows from a primary vessel 456A′, a path 61..63, a circulator 781B, a heat exchanger 785B to use very low grade thermal energy or even ambient thermal energy, as such (as fluid stream 62 is very cold), or thermal energy via another heat pump etc., to get free pressure in the primary vessel 456A′ i.e. via heat addition at constant volume. To the work making phase via another primary vessel 456B, from the prior discussion.

Thus interrupting, an ambient temperature refrigerant liquid, a path 11, or made into very cold refrigerant liquid, a path 31.., throttling valve 35, and apply heat addition at constant volume, to make work. This reduces the air conditioning or the heat pump compression load. The teachings can be applied by interrupting the heat pump that is then incorporated into the main heat addition at constant volume thermodynamic cycle that uses say glycol based very cold water in the heat addition at constant volume, thus reducing the heat pump compression work.

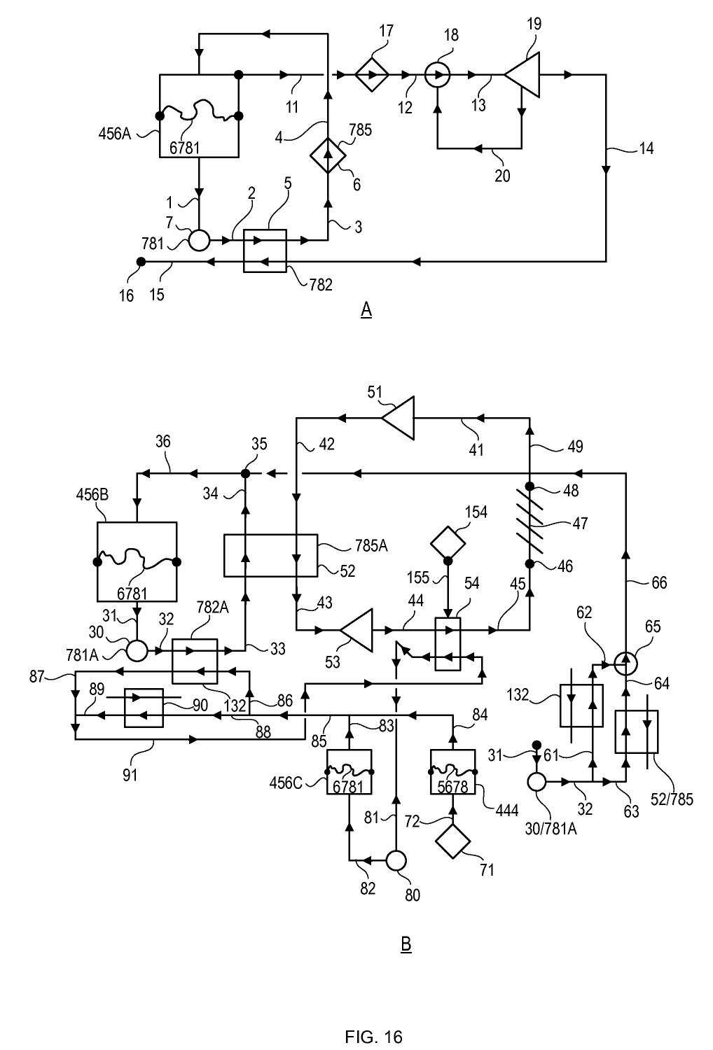

FIG. 16 shows a cycle with CO2 as working fluid. In detail “A,” a vessel 456A, that first goes through a heat addition at constant volume approach phase, a path is 1..4, a circulator 7/781, a recuperation heat exchanger 5/782 to use the final exhaust thermal energy, more thermal energy from say a topping steam cycle etc., shown symbolically by 6/785, to get the working fluid in the vessel, free pressure made via heat addition at constant volume approach.

Continuing, the work making phase has a path 11..16, thermal energy addition shown symbolically by 17, a turbine 19, topping ejector 18, induced fluid stream 20, so that the final exhaust, gets cooled, in a simpler approach, thermodynamic sloppiness to some extent.

Continuing, higher grade thermal energy via a closed Brayton cycle, can be an open cycle as well. A heat pump approach using say Helium, air etc., a vessel 456B with heat addition at constant volume approach phase with a circulator 30/781A, working fluid stream path 31..36, making working fluid at pressure. The heat pump then follows 41..49..41, a compressor 51, an expander 53, using thermal energy in a heat exchanger 52/785A via heat capacity matching, having very cold fluid stream 44, thereby providing refrigeration, later, ambient thermal energy coming in shown by finned heat exchanger 47, (or any waste thermal energy etc.), say condenser waste thermal energy and so on. Then shown symbolically by 154, low grade thermal energy, from elsewhere in the cycle to make more refrigeration, that flows into heat exchanger 54, shown symbolically by 155. Continuing, as based upon many discussions, two types of vessels, 456C, and 444 type, liquid pushed out via a hydraulic motor, so that the spent working fluid from two vessels to be restuffed into the single 456 type vessel. Continuing, shown symbolically by 71, 72 the push out of the spent working fluid, via back pressure on a hydraulic motor, and the other path is a pump 80, path 81..83, combined with fluid stream 84, ..91..81. Continuing, to impose heat capacity matching on heat exchanger 132, to thus free up the thermal energy in a heat exchanger 90 to make refrigeration, as an example. Thus to restuff the spent working fluid from two vessels into one vessel, as one building block of the overall cycle.

Continuing, the heating 33/34 can be in a different manner, (the right hand side), heat exchangers 132, 52/785A, the heat exchangers which are part of the heat addition at constant volume approach phase, are in parallel, so that the paths are ..31..32, a circulator 30/781A, to 61..64, an ejector 65 to mix the two fluid streams, 62, 64 at different pressure(s) to a final path ..66..36.

Thus the key here is the use of ambient thermal energy via a heat pump. As a variation, instead of CO2 as the working fluid, to have say air at ambient, or even refrigerated, at say 100 psi initial pressure and then put through the heat addition at constant volume approach phase etc., using ambient, elevated thermal energy source via a heat pump, all as based upon teachings and optimization exercise.

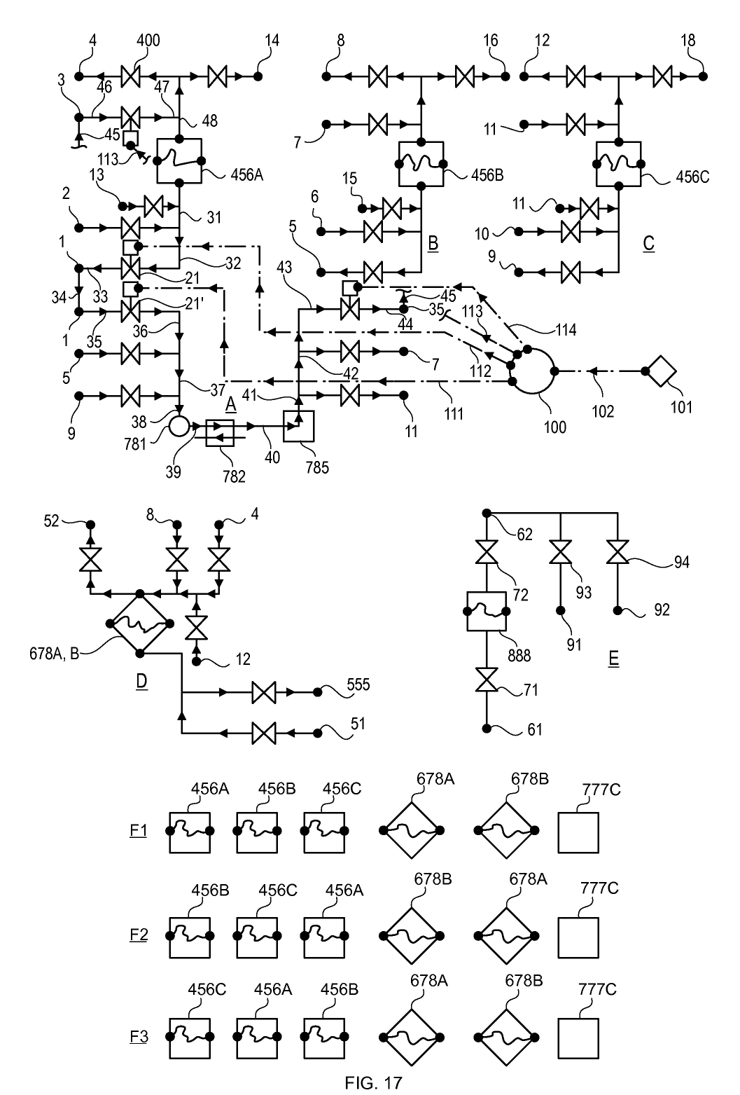

FIG. 17 shows satisfying the need of reconfiguration of the system, sub systems and the overall thermodynamic cycle, say every 10 minutes, as part of the batched approach, as the system works on a rotationally batched approach.

Continuing, are various primary vessels 456A, 456B, 456C, and secondary vessels 678A, 678B, an engine 777, and various system configurations. Say the cycle goes for 10 minutes, in each of the phases, i.e. heat addition at constant volume phase, work making phase and then finally fill/constant pressure expulsion phase, for the primary vessels. This is followed by the work making phase, and the fill/constant pressure expulsion phase for the secondary vessels as applicable. Then the whole system gets reconfigured, every 10 minutes. This is orchestrated by various open/close valves that are orchestrated by a controller, signals etc., etc.

Continuing, the various open/close valves are shown by say valve 21 in detail “A,” with a motor, an incoming signal 112, a controller 100, with a plant computer 101 with incoming signals to the controller shown by 102, the outgoing signals such as 111..114.. to various open/close valves. The various paths are nodes such as 1, hard piping 31..33..1..34..35..47. This demonstrates the heat addition at constant volume approach sub system, a path 31..47 to have the primary vessel 456A in the heat addition at constant volume phase, with a circulator 781, recuperation heat exchanger 782, and thermal energy from the thermal energy gathering via a heat exchanger 785. Thus via the open valves 21, 21′, the system configuration as desired, i.e. heat addition at constant volume phase of the primary vessel 456A can thus take place.

Continuing, then various open/close valves are shown by symbols 400, top left hand, and then various nodes such as 4, to be connected i.e. hard piped with say node 4 of detail “D,” later. Thus, say 3 inlets, 1, 5, 9 of the heat addition at constant volume approach sub system, and corresponding nodes, 1, 5, 9 of other details connecting other vessels, i.e. hard piped via open/close valves. Thus configuration of the overall system for various phases, incorporation of various vessels, engine, sub system(s), etc., in basically three time based cycles, rotationally. The overall system gets reconfigured in certain way three times, and then all over again from the start.

Continuing, in details “B, C,” the next primary vessels 456B, 456C have the relevant in/out nodes. To paths 13 . . . 14, 15 . . . 16, 17 . . . 18 are for constant fill/pressure expulsion phase, and so on.

Continuing, in detail “D,” the secondary vessels 678A, 678B with work making phase, inlet nodes 4, 8, 12, from the three primary vessels 456's. The outlet node to the engine 777 is shown by a node 555, and constant pressure expulsion inlet node 51. The associated outlet node 52, to be hard piped to the appropriate sub system(s), not shown, all based upon teachings.

Continuing, in detail “E,” an arbitrary vessel 888, with two flow paths, via nodes 61, 62 with related open/close valves 71, 72. Thus more nodes 91, 92, with open/close valves 93, 94 to point out a junction type of configuration of the overall system, for essentially three system line ups, all based upon teachings.

Continuing, sometime there is no flow arrow shown on a fluid stream, indicating that the flow changes direction as part of rotational reconfiguration. There may be some missing components, though the understanding is clear, such that the various components are reconfigured. Additionally may not be needed open/close valves, two in number in each flow path by careful design of the overall system, as based upon teachings and the system needs, once all the aspects of the invention are well understood.

Continuing, in details “F1, F2, F3,” there are the some of the major components, three primary vessels 456A, 456B, 456C, two secondary vessels 678A, 678B, and an engine 777C. The various sub systems, such as a circulator, a recuperation heat exchanger and a heat exchanger 785, and say the thermal energy gathering sub system, etc., are not shown. Then say every 10 minutes, the whole cycle is reconfigured, realigned using various open/close valves, not shown, so to have the three reconfigurations, realignments shown in “F1, F2, F3.” Thus controls via the plant computer are designed to satisfy the need of a batched process approach, all based upon teachings.

Thus the goal is to configure the system in three ways, via appropriate open/close valves, controller etc., to facilitate all that, all based upon teachings.

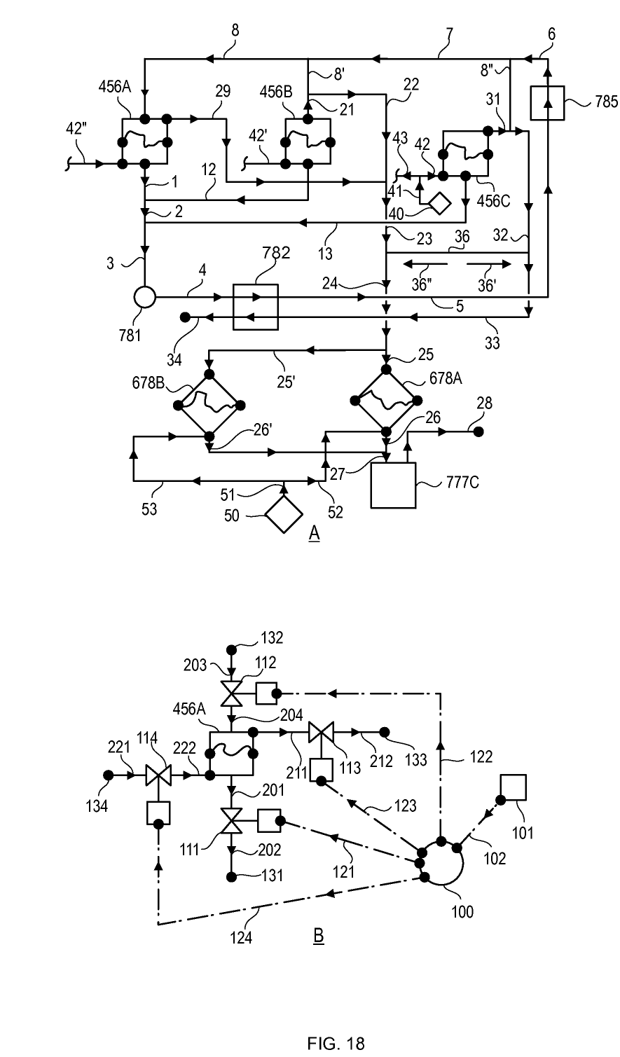

FIG. 18 shows in detail “A,” further illustration of the controls required as based upon the need that there are basically 3 primary vessels, 2 secondary vessels, an engine and other sub systems, that are part of the system reconfiguration say every 10 minutes. Thus there are three distinct cycles, phases, which are, in order, heat addition at constant volume phase, work making phase, fill/constant pressure expulsion phase. This requires reconfiguration of the overall cycle. As the plant runs, the overall cycle reconfiguration is to satisfy these needs, say every 10, 15, 20, 30, minutes, as based upon optimization exercise. To accomplish this there will be several lines, hard piped, and open/close valves, not shown, orchestrated via a controller, not shown, controls, not shown.

Continuing, in detail “A,” the set up shows one phase of all the primary vessels in function, 456A, 456B, 456C. The heat addition at constant volume phase of primary vessel 456A, a flow path is 1..8, a circulator 781, a recuperation heat exchanger 782, imparting new heat via a heat exchanger 785. At the same time, the primary vessel 456B is going through the work making phase. The path is 21..25, into the secondary vessel 678A, to the engine 777C, a liquid push out approach, a path 26..27, an exhaust 28. As based upon teachings, the non liquid push out approach can be incorporated as well. The primary vessel 456C is going through the fill/constant pressure expulsion phase, shown symbolically by a system 40, push out path 41..42. The spent working fluid follows 31..32..33..34, via the recuperation heat exchanger 782. The system is running for say 10 minutes, and then the reconfiguration comes into play. For this, several additional lines, conduits as needed, are shown, but not all those that are required, by any means, for the sake of simplicity. However enough are shown for covering the needs of the invention, and pointing out the teachings. As few of many examples, say lines 12, 13 to do heat addition at constant volume phase of the next primary vessels, lines 8′, 8″ as part of the same reconfigurations. Continuing, the fill/constant pressure expulsion phase to the other primary vessels, a path ..43, then paths 42′, 42″ symbolically same as path 42. Continuing, a line 36, so that flow direction 36″ is the fill/constant pressure expulsion phase, spent working fluid path of primary vessel 456B, path 21..22..23..36′..33..34. For the work making phase of primary vessel 456C, a path 31..32..36″..24.., and so on. Continuing, again, shown symbolically by 50 the spent working fluid push out of secondary vessels 678A, 678B, so that the paths for secondary vessels are 51..52, 51..53. Thus to have all these hard piped for the overall system, with open/close valves to suit to switch the three phases, between all the primary vessels, the secondary vessels, engine, sub systems, on a rotational basis, as orchestrated by smart controls, not shown.

Continuing, in detail “B,” the primary vessel 456A so that it is going through the heat addition at constant volume phase, with flow nodes 131 suction to the circulator, not shown, path 201..202, and hot working fluid node 132, path 203..204, via the heat addition at constant volume phase. This goes on for the cycle, phase, so that the path 211..212, node 133, the path for the work making phase is closed, and the node 134, path 221..222 for the fill/constant pressure expulsion phase is closed as well. Continuing, a controller 100, a plant computer 101, incoming signals shown symbolically by 102, so that the open/close valves are 111..114, with electric motors or pneumatic actuators, then the signals 121..124 to open, close these open/close valves as orchestrated by the controller 100. There is slight off setting of these valve actuation(s) to avoid water hammer etc., all based upon teachings.

Thus to recap, once the invention is well understood, the controls and other piping needs discussed here, and resulting in teachings, would have taught those who have sufficient knowledge of designing such systems to design the thermodynamic cycle that works, and runs.

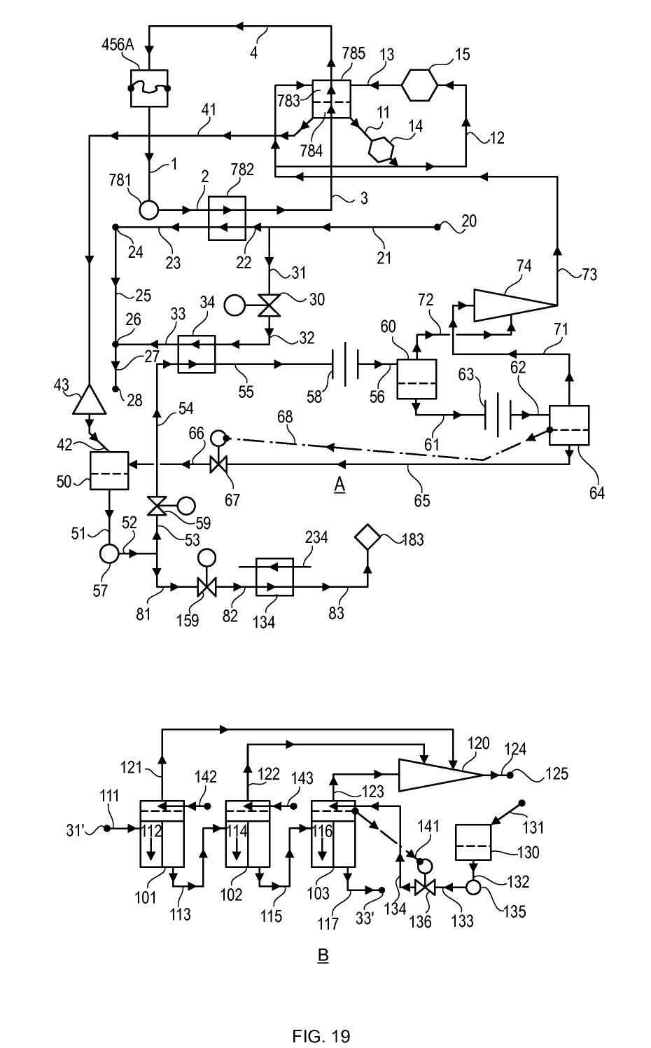

FIG. 19 shows, in detail “A,” a part of the thermodynamic cycle that uses heat addition at constant volume approach. For the sake of discussion say water is the working fluid in the primary vessel 456A a path 1..4, a circulator 781, a recuperation heat exchanger 782, a heat exchanger 785, condensing zone 783, drains cooling zone 784. A node 20 represents the thermal energy of the spent working fluid, from another primary vessel 456C, not shown, a path, in part 21..24 to recover the thermal energy. This part of the disclosure is as based upon the recognition of the fact the heat capacity of fluid stream 22/23 is larger than the heat capacity of fluid stream 2/3. The objective therefore is to free up some of this thermal energy via imposing heat capacity matching on recuperation heat exchanger 782, i.e. equating m dot Cp. It is also recognized that as the pressure of fluid stream 2 goes up and up, the mis match in the heat capacity thus goes up and up as well. Thus the smart controls will come into play to configure this part of the cycle, dividing up the flow rate as desired, into and around the recuperation heat exchanger 782.

Continuing, the ambient thermal energy gathering sub system follows 11..13, flashing etc., shown symbolically by 14, and the heat pump etc., shown symbolically by 15. The heater drain of the refrigerant then follows 41..42, a screw expander or a biphase turbine shown by 43. The spent working fluid then follows 20, a path 21..28 for node 28 to discharge the waste heat to the ambient or to the evaporator of the main heat pump. Then via heat capacity matching in recuperation heat exchanger 782, a path 31..33, via a heat exchanger 34, a control valve 30 via smart controls via m dot Cp matching controls. Thus it is the thermal energy 32/33 thus freed up is the object of this sub system.

Continuing, a tank 50 for the refrigerant, a path 51..56, a pump 57, a control valve 59 to modulate the flow to address the varying amount of thermal energy 32/33, a restriction orifice 58. Then a tank 60, a path 61..62, a restriction orifice 63, to another tank 64, fluid stream 65 via a control valve 67, a signal 68 to maintain the liquid level in tank 64. The throttling makes vapor fluid streams 71, 72, a compressor 74, compressed refrigerant path 73. Thus vapor fluid streams 71, 72, at pressure(s) higher than the pressure of the vapor out of the evaporator of the main heat pump, resulting in lower negative load of the vapor compression. Thus thermal energy 32/33 is being freed up, path 31.., via heat capacity matching in recuperation heat exchanger 782 as disclosed.

Continuing, a path 81..83 of the refrigerant, a control valve 159 functionally similar to control valve 59, a heat exchanger 134 functionally similar to heat exchanger 34, the additional thermal energy source, shown symbolically by 234, coming from anywhere in the system such as jacket cooling etc. Continuing, 183 then represents the flashing etc., of the path ..53.., to make refrigerant vapor fluid streams at higher pressure(s), i.e. use the thermal energy 234, to reduce the thermal energy gathering load via ambient i.e. sub system 11..13 becomes smaller in size, and is compensated via a refrigerant vapor path ..73.

Continuing, thus the key is to optimize the system via heat capacity matching in recuperation heat exchanger 782, and also via the use of the thermal energy from various parts of the system, via a heat exchanger 134.

Continuing, in detail “B,” the thermal energy source is a path 31′..111..117..33′ so that 31′, and 33′ are the liquid thermal energy sources, such as 32/33, thus resulting in refrigerant boil offs in heat exchangers 101..103. Here the vapor rises in the tubes, at say three pressure levels so that the vapor paths follow 121..123. A compressor 120 to the vapor fluid stream 124 at elevated pressure, a node 125 as the thermal energy source for heat exchanger 785, for heat addition at constant volume. The returning refrigerant liquid fluid stream 131, into a tank 130, a liquid refrigerant path 132..134, a pump 135, a level control valve 136, maintaining liquid level in the heat exchanger 103 via a signal 141. The other functionally similar liquid fluid streams into other heat exchangers are 142, 143, same as fluid stream 134 with controls etc. Thus making three pressure level refrigerant vapor fluid streams, using the thermal energy via imposing heat capacity matching in heat exchanger 782 of detail “A.”

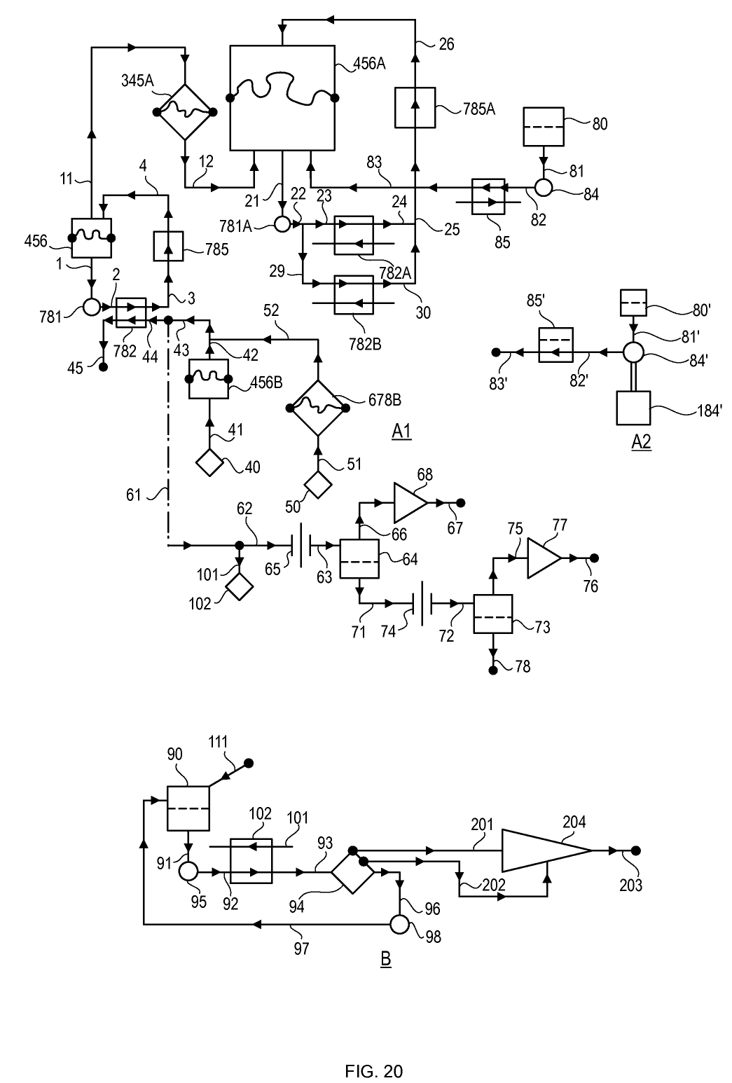

FIG. 20 shows pre-pressurizing of the primary vessel 456A by an add on sub system, and in the main detail “A1,” the add on sub system has its own primary vessel 456. The heat addition at constant volume phase follows, a path 1..4, a circulator 781, recuperation heat exchanger 782, main heat exchanger 785, to get very high pressure, in vessel 456, using thermal energy, i.e. using ambient thermal energy, low grade thermal energy, waste thermal energy etc. Then during the fill/constant pressure expulsion phase of the main cycle, the primary vessel 456A, after it (the primary vessel 456A) has been stuffed with say very cold water, and open up a path 11..12, via a secondary vessel 345A that uses the pressure from primary vessel 456 from above the fabric, and pushes out the liquid from below the fabric, and the pressure in the primary vessel 456A is raised, say from 1000 psi to say 3K, 5K, psi, etc., i.e. it is pre pressurized before its own heat addition at constant volume phase. In doing so, during the heat addition at constant volume phase of the primary vessel 456A, getting even higher pressure for the work making phase of the primary vessel 456A, or as an alternate needing lower grade thermal energy in the main heat exchanger 785A. Thus pre pressurizing has these benefits. It should be reemphasized that the primary vessel 456 is kept ready, and then stuff more water or any other liquid that was the working fluid of the main cycle, into the main cycle's primary vessels 456's. Thus the stuffing more liquid is to be part of the, the fill/constant pressure expulsion phase of the primary vessels 456's, i.e. the whole fill/constant pressure expulsion phase and the pre pressurizing is to be in that cycle/phase time of say 10 minutes, using suitable smart controls, as based upon teachings.

Continuing, as an alternate, a tank 80, path 81..83, a pump 84, a heat exchanger 85 in the thermal energy gathering evaporator, to cool/refrigerate the fluid stream 82, to stuff in more liquid. A conventional pumping sub system, for pre pressurizing of the primary vessels as part of the fill/constant pressure expulsion phase. The stuffing in of more such liquid takes place in a very short time, to have the primary vessels, one at a time, at elevated pressure prior to the heat addition at constant volume. This pre pressurizing lowers the thermal energy level in the primary vessel needed to make certain pressure via heat addition at constant volume. Continuing, in detail “A2,” the functionally similar components are shown by dashes, and 85′ is the evaporator of the cycle, or any other stand alone refrigeration sub system. The liquid in tank 80′ can be at very low temperature thus avoiding the cooling 82′/83′. As the pump 84′ discharge pressure needs be higher and higher in a short amount of time, as pre pressurizing goes on, a very strong electric motor 184′, as an option, having varying RPM, as needed, to minimize the pressure loss via some dead heading of the pump.

Continuing, for the primary vessel 456A, the heat addition at constant volume phase follows 21..26, a circulator 781A, recuperation heat exchanger(s) 782A, 782B, main heat exchanger 785A so that the recuperation heat exchanger(s) use the thermal energy recovery of this main cycle, as based upon discussion of the main cycle. A parallel path 29..30, a heat exchanger 782B so that if based upon heat capacity matching in heat exchanger 782A, creating a heat sink 29/30 for the thermal energy recovery that comes from the pre pressurizing sub system. This parallel path option is as based upon optimization exercise, and the economics of the overall system, and offers system flexibility.

Continuing, for the pre pressurizing sub system, the vessels 456B, 678B from the previous cycles, have the fill/constant pressure expulsion phase shown symbolically by 40, a path 41, push out fluid stream 42. Another fill/constant pressure expulsion phase sub system is shown symbolically by 50, a path 51, with the push out liquid fluid stream 52, to a combined fluid stream path ..43..45 via the recuperation heat exchanger 782. Thus the thermal energy of this pre-pressurizing sub system is recovered.

Continuing, the thermal energy of fluid stream 43/44 can follow, if the working fluid is a refrigerant, to a path 61..63, a restriction orifice 65, to a flash tank 64, vapor follows 66..67, via compressor 68, to get the fluid stream 67 as the thermal energy source. Cascading path 71..72, another restriction orifice 74 to a flash tank 73, vapor then follows 75..76, a compressor 77 to get the thermal energy source a fluid stream 76, the remaining liquid fluid stream 78 for the sub system to continue. Continuing, pre pressurizing via the heat addition at constant volume approach of a sub system.

Continuing, a path 101 represents the thermal energy to a symbolic heat exchanger 102, in detail “B,” its use, so that, using a refrigerant as working fluid, a tank 90, with the incoming refrigerant heater drain via a 2phase turbine, a fluid stream 111, a path 91..93, a pump 95, a heat exchanger 102 that uses the thermal energy of fluid stream 44/45 from detail “A.” A diamond 94 represents symbolically the flashing sub system, as disclosed above, shown here symbolically, the liquid return shown by a path 96..97, a pump 98. The flashing sub system generates vapor fluid streams 201, 202, to be compressed using a single compressor 204, to a higher pressure fluid stream 203 as the thermal energy source, etc., etc.

Thus pre pressurizing sub system, using the heat addition at constant volume approach and then the thermal energy recovery, all based upon teachings and this additional disclosure.

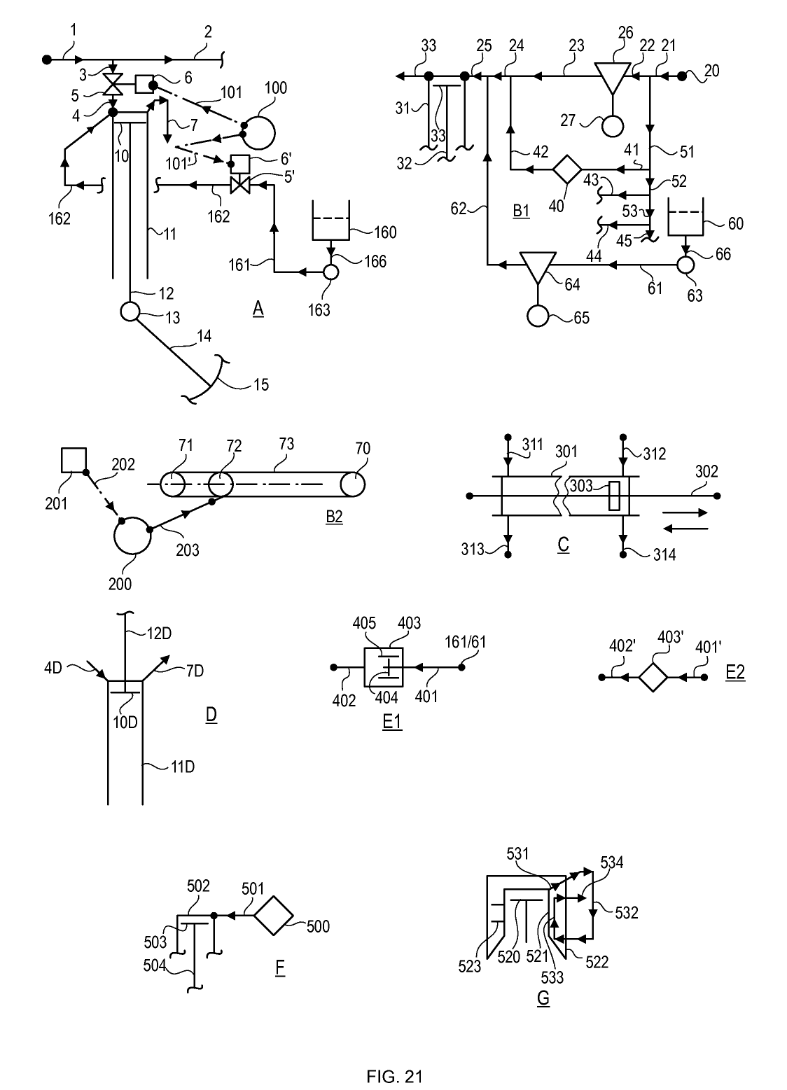

FIG. 21 shows, in detail “A,” a piston 10, a cylinder 11, a piston rod 12, a hinge 13, another rod 14, making circular motion 15 type of engine. Thus there is a very long stroke, as an objective. This long stroke option is to introduce another thermodynamic tool of controlled opening of the pressurized working fluid, paths 3..4, to make work as desired. This is to address the working fluid pressure going down and down as work is extracted, i.e. a pressurized working fluid header 1..2, in which the pressure goes down and down during the work making phase. Thus the work is made only for part or full stroke length as desired. An exhaust path 7.

Continuing, in detail “A,” the pressurized working fluid follows 1.., a header 1..2, to feed several such cylinders, a path 3..4 to the cylinder 11, a controller 100 receiving the signals from a plant computer, not shown, sending a signal 101 to a solenoid valve 6, to open/close the valve 5 to let in the pressurized water at some start/end points of the full stroke, as directed by the plant computer for work making need, etc., etc.

If working fluid ..4 enters only for the part of the stroke, as an option, the cylinder 11 is to be full of liquid so that to not initiate any water hammer or any other types of system functioning problems. For this, a tank 160, suction line 166, a pump 163, and a path ..161..162, via an open/close valve 5′, via a solenoid 6′, via receiving a signal 101′. Thus when path ..4 is not open, path ..162 is open, thus filling up the cylinder 11 with water from the tank 160, still the work is made via liquid fluid stream 4 and not liquid fluid stream 162.

Continuing, in detail “B1,” the objective of detail “A,” is met via the use of cams vs. the use of solenoids. A cylinder 31, a piston rod 32, a piston 33, working fluid exhaust path 33. Then at pressure working fluid header 20..25, to have several parallel paths ..22, ..41, ..43, ..44 an so on. Continuing, the pressurized working fluid follows ..22..24, a lift valve 26, a cam 27. Another path is ..41..42, another lift valve cam combination shown symbolically by 40. The purpose of parallel paths is to have these cams open/close the lift valves at different parts of the stroke, thus giving the work making option as dictated by the plant computer. Continuing, a tank 60, and paths 66, 61..62, lift valve 64, cam 65 has the same objective as in detail “A.” Several parallel paths to the path ..61.., with different cam timing, etc., other parallel paths not shown for the sake of simplicity. Thus work is extracted for parts or the full stroke, as desired to make uniform work, as much as possible, as the working fluid pressure of 20 goes down and down as more and more work is extracted.

Continuing, in detail “B2,” controls to activate parallel paths of detail “B1,” a driver 70, a chain 73, several cam driving shafts shown symbolically by 71..72.., a plant computer 201, sending in a signal 202, a controller 200 processing the information and sending a signal 203 to activate say an electric/magnetic clutch. Thus the appropriate cam turns, via continuously turning wheels 71.., i.e. there is a clutch between 71.., and the cam to be activated.

Continuing, in detail “C,” a double acting cylinder 301, piston rod 302, piston 303, paths 311..314, in, out, to make work. Additionally to configure the double acting approach in such a way that the piston rod when making work is in tension, as an option for that hardware design, using the rest of the teachings from above.

Continuing, in detail “D,” to be reviewed in conjunction with detail “A,” with designations “D,s” as per detail “A,” a piston rod 12D to make work while in tension, as hardware design option. Thus the working fluid pushes the piston 10D down, making work.

Continuing, in detail “E1,” 161/61 represent the fluid streams from above details “A, B1,” to fill the cylinders with dummy, i.e. not at pressure water when the pressurized water is not entering the cylinders. A path 401..402 into the appropriate cylinders, with a chamber 403, holes 404 in the line, a rubber sleeve 405. Thus water is constantly wanting to enter the cylinders, and does enter when the pressurized water is not entering.

Continuing, in detail “E2,” the paths are 401′..402′, functionally similar to as in detail “E1,” except in this case 403′ represents a suitable check valve, vs. a rubber sleeve option.

Continuing, in detail “F,” a cylinder 502, a piston 503, a piston rod 504, water at pressure shown symbolically by 500, a check valves etc., etc., all based upon teachings. Thus a path 501 constantly at some low pressure is made available to fill the cylinder all the way from the bottom dead center, to the exhaust stroke. Thus to fill the cylinder fully, and to thus avoid any collisions of the piston with the partially filled cylinder, to avoid any mechanical problems, etc., etc. all based upon teachings.

Continuing, in detail “G,” a cylinder 521, double wall with a jacket 522, fins 523 so that the liquid exhaust fluid stream follows 531..534, i.e. via the jacket, picking up the thermal energy, the thermal energy made due to piston 520 wall friction. The thermal energy is later used in the overall cycle.

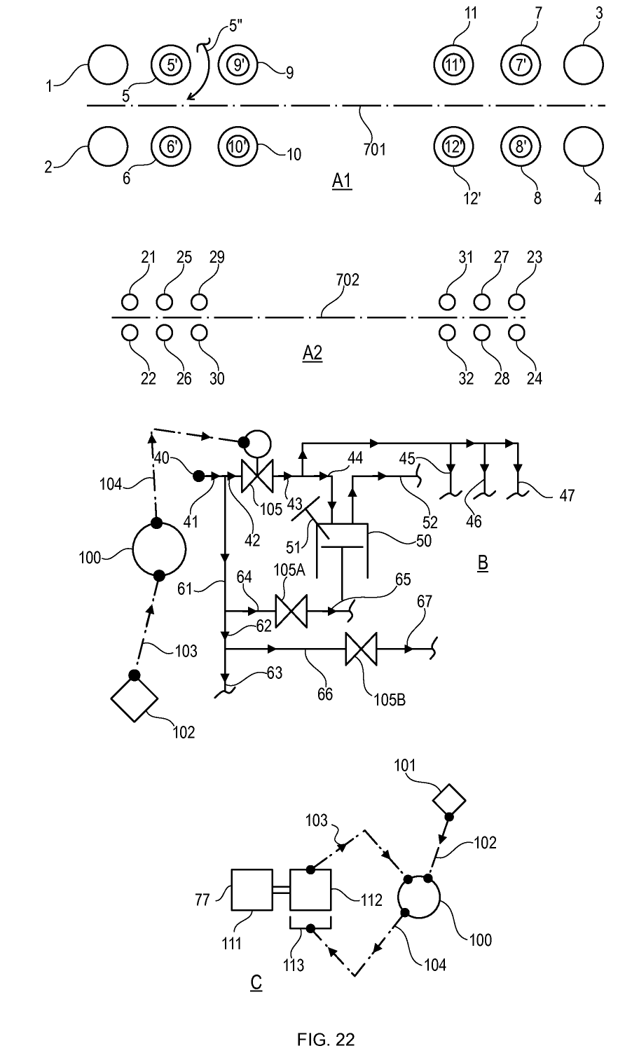

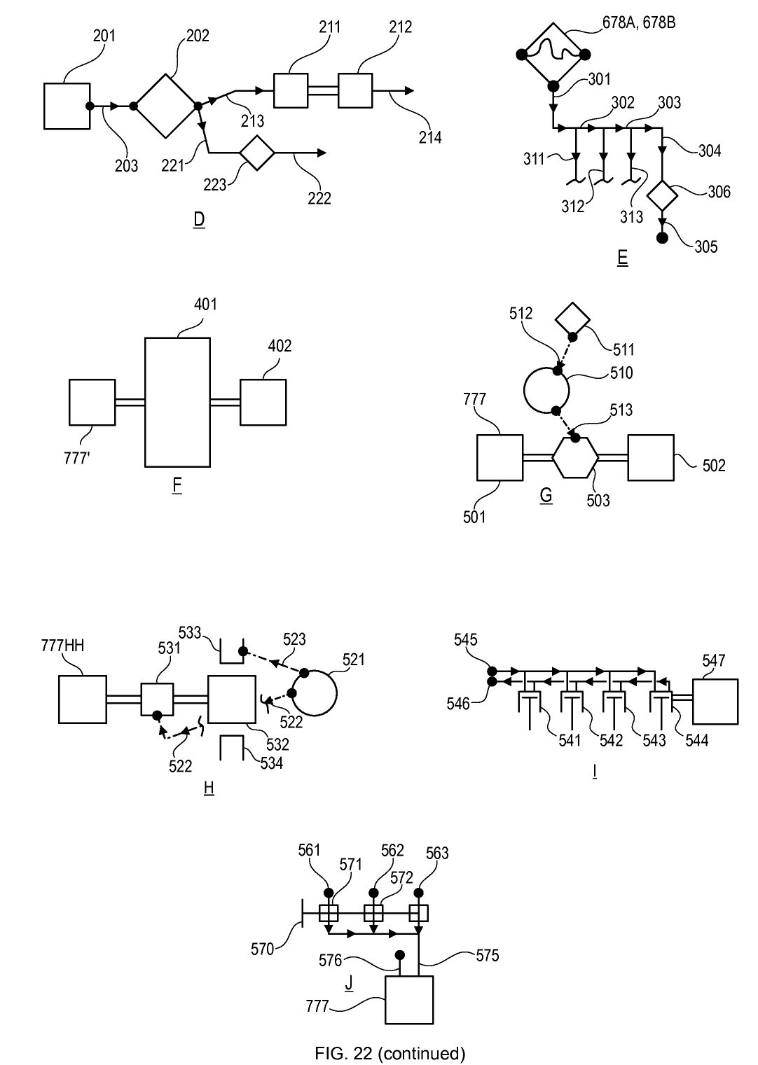

FIG. 22 shows first recognizing the fact that, in the work making phase, the pressure of the working fluid goes down and down, as more and more work is extracted, and then addressing this to have uniform work output.

Continuing, in details “A1, A2,” as a package, a shaft lines 701, 702, with say V (“VEE”) cylinders, to open up to the working fluid, say 4 cylinders at a time to receive the working fluid at pressure. The sets of four cylinders are 1..4, 5..8, 9..12, and so on, to address the engine mechanical balancing. Similarly the other sets of four cylinders are 21..24, 25..28, 29..32. It is to be pointed out that the diameters of the cylinders and the stroke lengths are such that there are large cylinders in detail “A1,” and small cylinders in detail “A2.” Between the diameter and the stroke lengths, the work(s) produced are incremental. Thus a bridge, between these two sets of 4 cylinders at a time approach, later. Thus, to start making work with say cylinders 1..4 via being opened to the working fluid. As the pressure goes down and down, four cylinders at a time, the small ones, are opened up incrementally, 21..24, open, first four, then four more, 25..28, total eight now, and so on, till all the small cylinders in detail “A2,” are open. Then all the small cylinders close, and four more cylinders in detail “A1” are opened. In other words the sets of four small cylinders at a time in detail “A2,” are the bridge between opening of four cylinders at a time in detail “A1.” The cylinders in the two details can be of different diameters, stroke lengths, to optimize the design.

Continuing, and additionally, flywheels to smooth out the work output as much as, in this particular approach.

Continuing, the shafts 701, 702 imply that there are two separate engines. That is an option. However by way of flexibility, and to have a single generator etc., all the cylinders, large ones and the small ones can be part of a single engine, positioning the cylinders and the opening sequence such that the engine mechanical balancing is satisfied, and with the understanding of exposing cylinders, sequentially, to the working fluid, via suitable controls, later. Thus disclosing and addressing the pressure going down and down issue, all based upon teachings.

Continuing, in detail “B,” the working fluid at pressure is shown symbolically by a node 40, a controller 100, a plant computer 102 receiving signals 103, generating a signal 104 to open/close valve 105. Thus the working fluid follows 40, ..41..47. A cylinder 50, with its own intake valve 51, exhaust path 52 is exposed to the working fluid for certain amount of time, number of strokes. The paths 45..47 are to the other three of the four cylinder(s) as a package, from the discussion above. Then paths 61..67 are such that the other open/close valves 105A, 105B functionally similar to open/close valve 105 are paths to the other four cylinder packages. These controls of exposing four cylinders at a time to the working fluid apply to small and large cylinder combinations.

Thus the controls to facilitate the four cylinders at a time being open, or close, as applicable to small cylinders, thus exposed or not exposed to the working fluid, as needed to smooth out the work output. The four at a time large cylinders are part of this smoothing out the work output approach, all based upon teachings, using the same/similar controls.

Continuing, in detail “C,” an engine as above, 111/777, to a DC generator 112, to have the ability to vary the field strength of the DC generator and thus the output of the DC Generator. Continuing, a controller 100, with a plant computer 101, send out signals 102, receives the MWe signal 103 from the DC Generator, generates a signal 104 to vary the strength of the generator field 113. Thus the field of the DC Generator acts as a brake, and allows to set up the system for a constant MWe output which then comes from the engine RPM going up and up, for constant cylinder system, employing the cylinder sequencing opening etc. Thus this DC Generator with a varying field strength acts as another tool to make constant DC MWe. Continuing, using gears, not shown, between 111, and 112 to have engagement for the two to have step based relative RPM variations, etc.

Continuing, in detail “D,” a DC Generator 201, connected to the engine, not shown, with a battery storage system 202, so that paths, one energy flow path 213..214, 211 is a DC motor, 212 is an AC generator, with 214 as the AC send out energy. The other path is energy flow 221..222, so that 223 then represents the water electrolysis system, with send out energy in the form of Hydrogen, fluid stream 222. Thus the battery storage system acts as the energy flywheel, with options of the energy flow as disclosed.

Continuing, in detail “E,” the liquid push out approach based secondary vessels 678A, 678B, with the working fluid path 301..305, so that 306 represents the cluster of hydraulic motors or screw expanders. The other parallel paths can be 311..313. Thus the cluster of hydraulic motor(s) screw expander(s) to extract work and smooth out the work output by employing controls, i.e. on/off approach, controls as based upon teachings, need etc., etc. The approach can be applied to the direct use, application of the hot working fluid in these hydraulic motor(s), screw expander(s), all based upon teachings. The use of clusters is very wide in application, first the clusters in each of the parallel paths, and then the cluster of the parallel paths themselves.

Continuing, in detail “F,” the engine 777′, has a very large flywheel 401, and a generator 402, AC or DC etc. The very large flywheel is disclosed here to smooth out the work output.

Continuing, the gear option, the gear between the engine and the generator etc. to vary the relative RPM as another tool to smooth out the work output. Continuing, in detail “G,” there is the engine, 501/777, a generator 502 with a gear box shown symbolically by 503, with a controller 510, a plant computer 511 sending in signals 512 to generate a signal 513 to position the gear box for certain RPM ratio between the engine and the generator. This is another tool to assist a uniform work output in the work making phase, all based upon teachings.

Continuing, in detail “H,” to address the uniform power, an engine 777HH, an AC generator 532, with a step change of RPM, gears etc. 531. A controller 521, with send out signals 522 to facilitate the RPM step change, a signal 523 to vary the field strength, and the number of poles that are activated, the poles shown as 533, 534, and many more. Thus varying RPM, field strength, and number of poles in an AC generator as the user of the cycle output. Continuing, TABLE 3C, to start with four cylinders 1..4, to satisfy the need of the load, say 50 MWe, and then as the pressure deteriorates, small steps via small cylinders, 21..32, many small steps, bite size output leveling, and then another set of cylinders, say four at a time, say the ones with dashes, 5′.., pointing out that the subsequent cylinders can be smaller size, or larger size, shown symbolically by 5″, to satisfy the need for more and more cylinder capacity, for uniform work output as the pressure deteriorates. As based upon teachings, the bite size pieces, small cylinders, with a varying number to add design flexibility, and then add on cylinders, of even different sizes, as well, again as part of design flexibility. To be pointed out that as the pressure deteriorates, the cylinder wall thickness needed will be less as well. Thus to start with, there are MWHr's available, to be released on a uniform basis, using the capacity of the cylinders, RPM as another thermodynamic tool, etc., based upon teachings. Continuing, detail “I,” cylinders 541..544, inlet, exhaust headers, with node points 545, 546 as in working fluid inlet, exhaust points, feeding, exhausting the various cylinders, so that all the cylinders are active during the entire cycle, with a very large flywheel 547 to smooth out the output. Thus for very short cycles, (better, more economical for vessel capacity as well), all the cylinders are active, to simplify the system, just like a single cylinder internal combustion engine using flywheel to smooth out the output. As a minimum, for short cycles, the intermediate small cylinder stepping approach can be done without, so that in the main engine more and more cylinders are activated as the pressure deteriorates, together with very large flywheel to smooth out the output. Continuing, detail “J,” the three primary vessels in the work making phase with fluid streams 561..563 coming in, feed the working fluids to the engine 777, inlet working fluid stream 575, exhaust fluid stream 576, spent working fluid, (the engine has its own lift inlet, exhaust valves for each stroke), with the on/off valves say solenoid operated valves, one at a time, opening closing, sequentially are 571..573. Another option, a wheel 570, running of off the engine 777 itself, via suitable gearing, timing belt, etc., with the use of cams 571..573, instead, to admit, and close the working fluid, for each of the work making phase (s), from each of the primary vessels, one at a time, sequentially, based upon teachings.

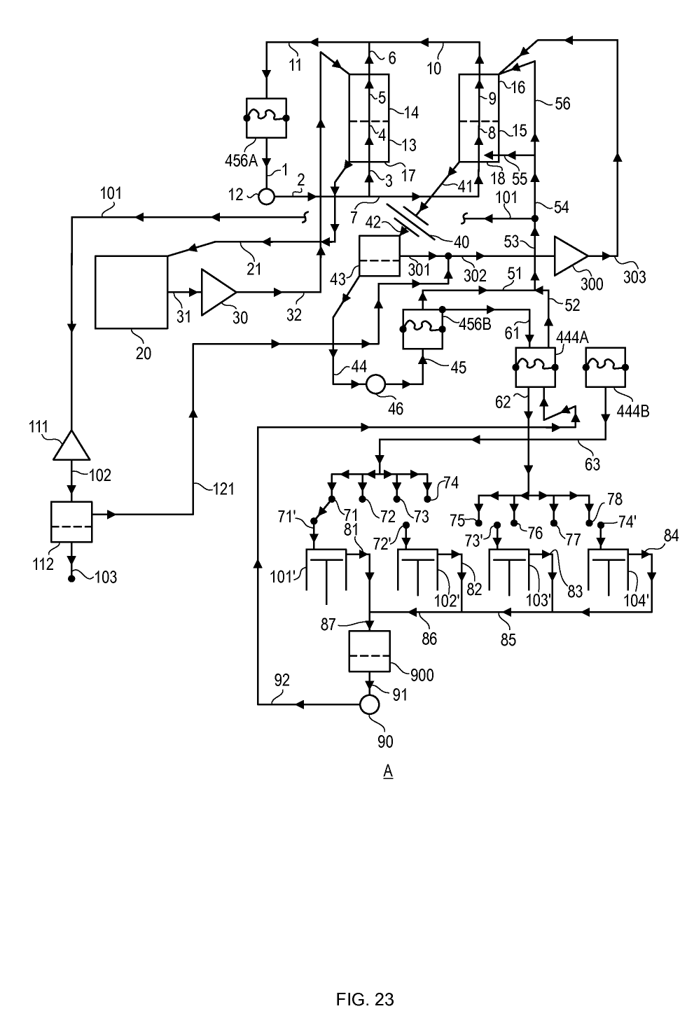

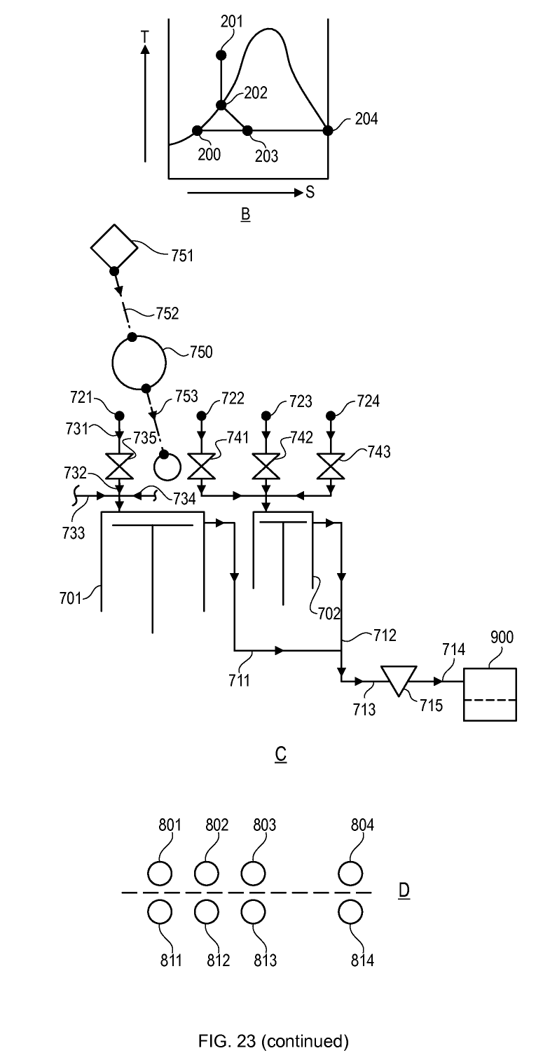

FIG. 23 shows an easy to follow thermodynamic cycle as based upon teachings etc., using a refrigerant that uses ambient thermal energy as the thermal energy source. Continuing, the part, easy to understand shown in detail “B,” the Ts diagram. A condition 200 is the very cold liquid, for the vessel fill for heat addition at constant volume phase, to get condition 201 as the working fluid, very high pressure working fluid without a pump, i.e. free pressure. The work is extracted in the 201/202 expansion of the working fluid, hitting the saturated liquid line, condition 202. Thus the point 202, which in its simplest form, gets throttled to point 203 to give the liquid part 200, and the vapor part 204 that gets compressed i.e. the heat pump approach for making usable grade thermal energy. There are variations, such as an expander to use the useable thermal energy of 202, i.e. have a screw expander at 202 to make work, to get a two phase working fluid, etc.

Continuing, still on the Ts diagram, to get back to a liquid state shown by 200. There is sensible heat in 202. Then first, use the sensible heat of 200, the heat sink being the working fluid 2 etc., of detail “A.” Then to be understood that infinite heat transfer surface to cool 202 to 200 will be needed, the starting temperature, not practical. Thus throttling or making work to get to a two phase condition is the only practical way. Thus by cooling 202, to as low a temperature as possible via fluid stream 2 etc., as heat sink will minimize the vapor part of the two phase working fluid, a good thing, i.e. minimum of vapor. This understanding gets incorporated in the detail “A,” when to actually design the system.

Continuing, in detail “A,” a vessel 456A, to the heat addition at constant volume phase, paths 1..11, a circulator 12, parallel paths, to enable a different refrigerant in the ambient thermal energy use, and a different refrigerant in the work making phase etc. Then shown symbolically by 20, to get vapor, via evaporation using ambient thermal energy, the vapor at very low temperature say 20 Deg. F. The vapor becomes the working fluid of a heat pump, a path 31..32, a compressor 30. The heat exchangers for the heat addition at constant volume, drain cooling zones 13, 15, condensing zones 14, 16. The liquid drains for the ambient thermal energy use follow a path ..21, to make more vapor using ambient thermal energy. The heater drain from the other heat exchanger, a path 41..42, into a tank 43, via a restriction orifice 40, to get to the liquid at condition 200. Continuing, after heat addition at constant volume, the primary vessel 456B, the work making phase, a path 61, into another vessel 444A which has a fabric etc. A liquid as working fluid gets pushed out, a path 62.., keeping in mind that the pressure at fluid stream 61, and hence fluid stream 62 goes down and down. The configuration of various systems, vessels, to be reconfigured as based upon the batched approach of the thermodynamic cycle, i.e. the vessels 456B etc. have multiple activities as pointed out.

Thus there are three such primary vessels to smooth batched approach operation, i.e. make pressure via heat addition at constant volume phase, then work making phase, then fill/constant pressure expulsion phase.

Continuing, the vessels 444A, 444B are for working fluid being pushed out, paths ..62.., ..63, to many outlets 71..78, cylinders 101′..104′, receiving these working fluids at pressure, say inlets 71′..74′, being fed via working fluids from 71..78, via on/off valves, the overall system thus gets orchestrated via a controller to make the piston/cylinder based engine, using a flywheel run smoothly at constant RPM and load. The exhaust working fluid, paths 81..84, ..85..86 to a tank 900. A pump 90, a path 91..92 is fill/constant pressure expulsion part of the cycle, i.e. the saturated liquid is pushed out at condition 202, paths 51..56, into the vapor space, of heat exchangers, and a path ..55 below the liquid level, or a path 101..102, via a screw expander/2phase turbine 111, to two phase fluid stream 102, into a tank 112, then very cold liquid 103 back into tank 43, not shown. The vapor part, a path 121. A liquid path 44..45, a pump 46 is the fill/constant pressure expulsion of the vessel 456B.

The thermal energy upgrading for this sub system of the work making part follows 301..303, including vapor path ..121, via a compressor 300.

Thus to recap, the system is batched process, i.e. sub systems go through different phases and get realigned for smooth operation. The thermal energy comes from the heat pump approach, with additional vapor, for compression/upgrading, the latent heat (for refrigerant evaporation) coming from the ambient thermal energy i.e. for the evaporation of the refrigerant liquid, and the vapor from the work making part of the cycle via throttling etc. The work comes from the expansion 201/202, and via pushing out of the liquid as working fluid and into cylinders at deteriorating pressure(s), as work is extracted.

Continuing, same refrigerant as working fluid in the ambient thermal energy gathering part and the work making part of the cycle can be used. The liquid fluid streams 62, 63 can be water or oil etc.

Continuing, the work making phase can be via hydraulic motors as well. And then, instead of making work via this indirect pushing out of the liquid, using fluid stream 61 into screw expander(s), hydraulic motors, 2phase turbine etc., as based upon disclosures before and teachings.

Continuing, shown in detail “C,” it is to address the deteriorating pressure for the liquid push out approach, cylinders 701, 702 and many more cylinders are of varying diameter and swept volume. This will facilitate to make a fairly uniform work, using a flywheel as well, for uniform MWe's.

Continuing, in detail “C,” the exhaust fluid streams a path 711..715, into a tank 900 from detail “A,” via a lift valve 715. The working fluid coming in, nodes 721..724 are hard piped into various push out liquid sources. The on/off control valves 735, 741..743, and other paths 733, 734 have a controller 750, with a plant computer 751, sending in signal 752 to generate a signal 753, to open the control valve 741 to make the working fluid from node 722 flow into the cylinder 702. All the other fluid streams, (not numbered for simplicity), to restress, any of the push out liquid can be fed into the various cylinders, all based upon teachings. Thus to recap, the cylinders of various swept volumes that receive working fluid, liquid push out at ever going lower and lower pressure, thus by incorporating more and more swept volume, the lower and lower liquid pressure produces fairly uniform work.

Continuing, in detail “D,” cylinders 801..804, 811..814 in a “V,” configuration of equal diameter, stroke, and as based upon discussion above, to open more and more cylinders to the working fluid, per controls and controller as discussed above, as the pressure deteriorates, as more and more work is extracted.

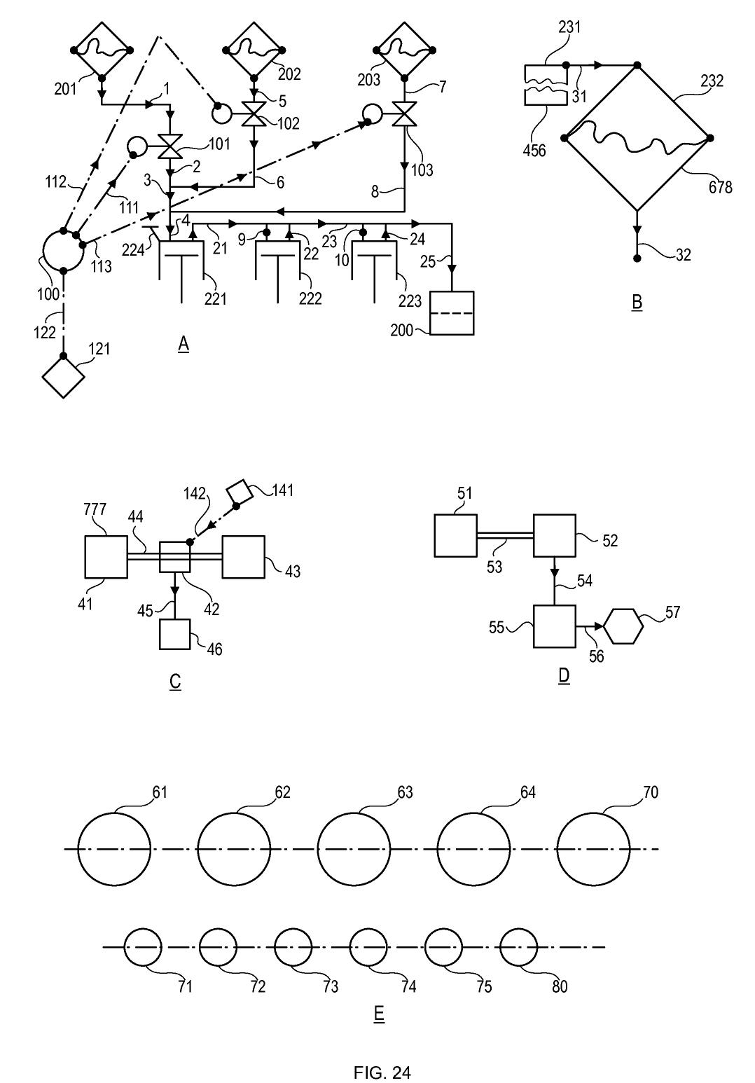

FIG. 24 shows addressing by first reorganizing that say in the liquid push out option, and direct use of working fluid in an engine, say cylinder based engine, the pressure of the working fluid and the pressure of the liquid being pushed out goes down and down. Therefore, in order to have fairly constant power output, in addition to using a flywheel, opening more and more cylinders. Thus start with say 7K psi, and the pressure goes down to say 50 psi, at the end of work making phase. Thus to start with 1 cylinder, and then go all the way to say 25 cylinders, with the same cylinder size, stroke etc., to make the same power. It is also to be understood that opening more and more cylinders is a step change in the power output.

Continuing, in detail “A,” secondary vessels 201..203, discharging the liquid push out working fluid, the discharge being out of phase. Then cylinders 221..223, so that each cylinder has the ability to receive the working fluid from any of the secondary vessels, path(s) 1..4, 5..6, 7..8, into inlets 4, 9, 10, via on/off control valves 101..103. As an example, the cylinder 221 receives the working fluid from the open control valves, keeping in mind that the individual cylinder intake valve 224 opens, closes via say cam mechanism. Thus the working fluid a path ..4, in the liquid push out option, the engine valve 224 remains open during the entire descent, or the entire working stroke of the cylinder. At the bottom dead center, the valve 224 that opened at the top dead center to start the working stroke, closes, and the corresponding exhaust valve, not shown, opens, with the exhaust header shown by 21..25 to carry the working fluid into a tank 200. Thus the cylinders are opened to working fluids from various secondary vessels, or primary vessels in case of direct use of the working fluid in cylinders, and is orchestrated by a controller 100, receiving a signal 122 from the plant computer 121, generating signals 111..113, to open, close the control valves 101..103. The control valves remain open till the decision by the plant computer is made to expose the cylinder to a working fluid from a different secondary vessel, or primary vessel in case of direct use of the working fluid, etc., etc. Thus to recap, the ability to have the cylinders make different amount of work is made possible here, to address the pressure going down and down reality. Thus there is the flexibility of the working fluid coming from primary vessels in case of direct use of the working fluid in an engine, coming from secondary vessels in case of the working fluid push out approach, into a cluster of cylinders, to smooth out the overall work output.

Continuing, in detail “B,” a primary vessel 231/456, very large vessel shown by a break line, that has extremely high pressure working fluid via heat addition at constant volume approach, a secondary vessel 232/678, the liquid push out vessel, thus both very large vessels, so that a very long duration work making phase, making it easy to make constant power, etc., etc., another thermodynamic tool to address the pressure going down and down reality.

Continuing, in detail “C,” a cylinder based engine 41/777, a shaft 44, a DC generator 42, an AC generator 43, so that the DC generator to have a varying power output, facilitated by a controlled, varying of the field 141, via a path 142. The DC power is used to make Hydrogen, via electrolysis sub system 46, power input shown symbolically by a path 45. The AC power is then sent out. So a constant AC output via smoothing out the total power output via an intermediate DC generator, load variation, a relatively easy thing to do, etc., etc. Thus a DC generator via power send out to the electrolysis sub system smooths out the AC generator output, with flywheel, not shown to aid in this. In other words, a mechanical flywheel, and an electrical flywheel, a DC generator with varying load are to have fairly constant AC generator output.

Continuing, in detail “D,” a cylinder based engine 51, a shaft 53, a DC generator 52, DC output power 54, into a large battery storage sub system 55, with DC power flow 56 to make AC power, shown symbolically by 57. Thus a battery storage sub system to smooth out the AC power output, the battery storage acting as an electric flywheel, etc., etc.

Continuing, then to recap, an extremely high pressure working fluid, water say at 150 Deg. F., which is the part of the system of making work in cylinder based engine(s). Then as an observation, that during the very first stroke when the work making phase commences, certain amount of work is produced, in say a single cylinder engine. As more and more strokes take place, the working fluid pressure goes down and down and the work in each subsequent stroke also keeps going down and down. In order to make the work rather uniform, flywheel, mechanical option, electrical flywheel, via DC energy storage using batteries. Then to add more and more cylinders, so that as the work per lb. of water per stroke goes down, more and more cylinders are engaged, so that the overall shaft work is uniform, as much as possible. In other words, if the starting pressure is say 7K psi, then 3.5 psi, the deteriorated pressure will need, two similar cylinders, as the work is proportional to pressure, if all else such as the cylinder diameter, stroke length, RPM are the same. That brings another thermodynamic tool as an option, i.e. RPM variation. To start with, say 1800 RPM, and then keep on adding cylinders, and then when cylinders become too many, resulting the RPM to say 3600, and rearrange the number of cylinders doing the work etc., etc. Additionally, to design a cylinder based engine of say 10, 20, 50 MWe rating. Then to use a cluster of such engines at a facility to get the desired plant size, etc., etc., etc.

Continuing, in detail “E,” the pressure of extremely high pressure working fluid, whether using the liquid push out approach, or using the working fluid directly in a cylinder based engine, the pressure goes down and down. Then to activate cylinders, at will, via suitable controls, by control valves. Then say 10 cylinders, large size 61..70.

Then smaller cylinders, say 10 in quantity 71..80. Thus the work of each cylinders, 71..80, pressure times area times stroke, in smaller cylinders equals to one tenth of the same in cylinders 61..70 in larger cylinders. To start with say a single cylinder 61, when the pressure of the working fluid is at the highest. Then as the pressure deteriorates, opening up cylinders 71..80, one at a time, till all the cylinders are open. Then closing all these cylinders, 71..80, and open up the next larger cylinder, 62, and so on. In other words, in opening more and more large cylinders, intermediate small cylinders are opened one at a time, as bridge, to smooth out the overall work produced.

Continuing, then to recap, to start with a large cylinder, then to make uniform work, to employ small cylinders one at a time, i.e. add on small cylinders, till all the small cylinders have the work that is equal to a next large cylinder. Then to replace all the small cylinders, close these, and replace with, open, the next large cylinder; and start opening the small cylinders all over again, till the next large cylinder is justified, and so on and so on. The various cylinders are positioned, and have the crank shaft angular design for each to balance the overall power output very uniform.

Continuing, it should also be pointed out that once understanding the use of stepping stone approach of the large, small size cylinders, and the sequence of these cylinders opening up to working fluid, the cylinders can be on different engines as well, say all the small cylinders on one engine and all the large cylinders on another engine. The configuration can be more than these two engines, several engines, cluster of engines, as part of optimization exercise, etc.

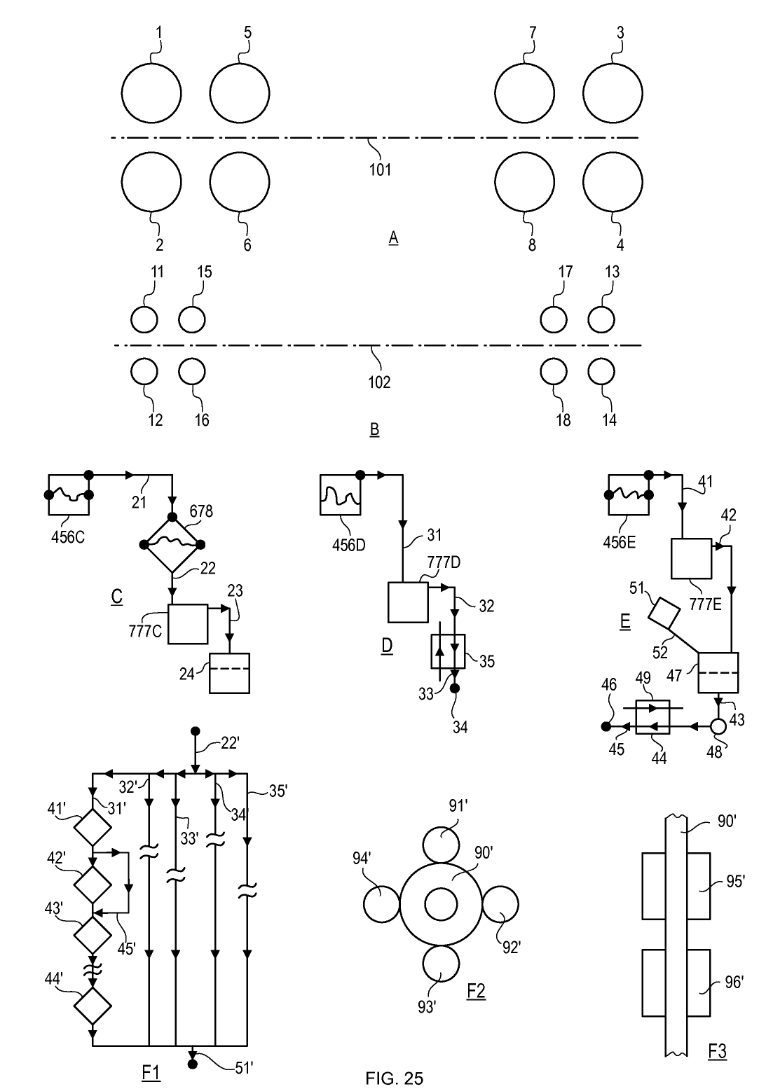

FIG. 25 shows, in details “A, B,” the use of large and small cylinders, so that as more and more large cylinders, then as an intermediate step, small cylinders are opened, till all the small cylinders are open, and then the next large cylinder opens. Here, is to be pointed out that, the sum of power of these small cylinders will then equal to the next set of large cylinders, +/, keeping the power output fairly uniform.

Continuing, to address the balancing of the engine, one engine with large cylinders is shown by shaft line 101, and for small cylinders is shown by shaft line 102. As another feature it is a “V,” engine in both the cases. Then to open 4 cylinders at a time so that to start with cylinders 1..4, then the small cylinder engine adds cylinders, four at a time, first cylinders 11..14, then next step as the pressure of the working fluid goes down cylinders 15..18, and so on till all the small cylinders are opened up. Then the next step change happens, large cylinders 5..8 open up, and all the small cylinders close, and the next sequence of opening four small cylinders at a time restarts, and so on and so on.

Thus to recap again, the thermodynamic tools at our disposal, are, cylinder cross section area, stroke length, liquid pressure that varies and is the object of all this, and lastly RPM. For the RPM part making DC power for the smaller engine, the small steps in between the opening of large cylinders.

Continuing, more building blocks to point out the extremely high pressure liquid working fluid for these above cylinders, in detail “C,” the work making phase from the extremely high pressure working fluid from the vessel 456C, as a result of the heat addition at constant volume approach. the working fluid follows 21..23, engine 777C, using the liquid push out approach, via a vessel 678, into a tank 24.

Continuing, shown in detail “D,” the work making phase so that the work making phase working fluid from vessel 456D using extremely high pressure working fluid, as a result of the heat addition at constant volume approach, has the working fluid follow 31..34, engine 777D so as to recover the thermal energy via a heat exchanger 35 on a continuous basis as the work making phase happens. This option to design the system for a constant flow in fluid stream 31. However for uniform power output design, as the pressure goes down and down, other system configuration options are to be used.

Continuing, in detail “E,” the extremely high pressure working fluid, as a result of heat addition at constant volume approach, from a vessel 456E follows 41..46, an engine 777E, a tank 47 that has a pressure maintaining sub system 51, 52, if required, to prevent flashing of the of water (spent working fluid), if that is the liquid used. The tank that collects the hot working fluid on a continuous basis for eventual continuous thermal energy recovery, has a pump 48 for the fill phase etc. The working fluid follows ..43..46, via a heat exchanger 49 to recover the thermal energy (via heat capacity matching if warranted, based upon economics and optimization exercise), etc., for the next heat addition at constant volume phase.

Continuing, in detail “F1,” the work making phase, an extremely high pressure working fluid liquid, a path 22′..51′, to push the liquid at pressure via a cluster of hydraulic motor(s), parallel paths 31′..35′, hydraulic motor(s) 41′..44′, by passing these hydraulic motor(s) as option, a path 45′. All this to have a constant load capability, as the working fluid pressure goes down and down. Continuing, the liquid follows 51′, into a vessel, with certain back pressure sub system, not shown.

Continuing, shown in detail “F2,” a large shaft 90′, with the hydraulic motor(s) cluster shown by 91′..94′, making the shaft 90′ rotate.

Continuing, shown in detail “F3,” the large shaft has the hydraulic motor(s) clusters along the length of the big shaft shown by 95′, 96′.., etc. Thus the point is to use the work of the hydraulic motor(s), cluster, and combine it all to make a big shaft do the work, and/or the use of chains, etc., not shown, to make many hydraulic motor(s) transfer work to a single shaft for a large MWe facility.

Continuing, the discussion addresses primarily the use of cylinder based engines. As the screw expanders and the hydraulic motors are also positive displacement machines to make work, a cluster as per optimization exercise, for uniform work.

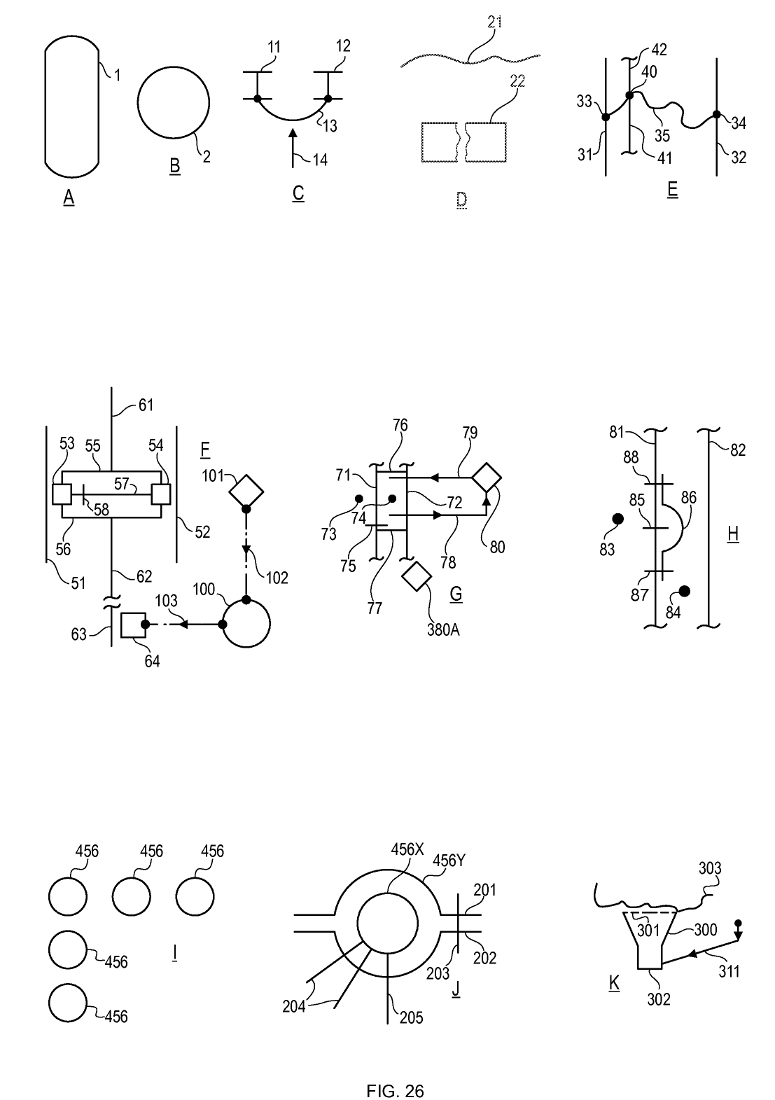

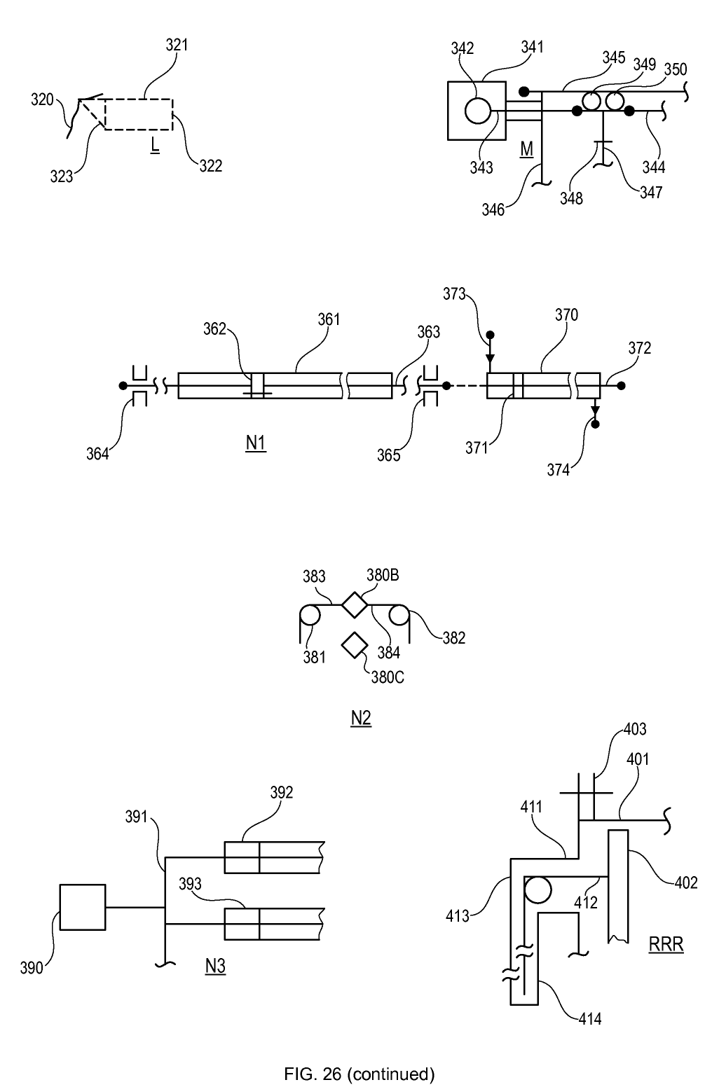

FIG. 26 shows vessel related items, so that in detail “A,” a conventional vessel 1, a cylindrical vessel with curved heads. The curved heads can be concave or convex as based upon optimization exercise.

Continuing, in detail “B,” the vessel can be a sphere shown by 2.

Continuing, in detail “C,” the vessel can be via the use of structural members, such as say I beams shown by 11, 12, and then curved plates shown by 13, the pressure direction is shown by 14. The vessel is constructed by structural components, and then the empty parts/spaces/openings filled by the curved plates. The vessel is in any suitable shape, cylindrical, spherical etc.

Continuing, in detail “D,” the vessel shown by 22 is way underground, the ground 21, so that by being buried, the wall thickness is reduced. The vessel 22 can be vertical, horizontal, or even inclined as based upon the design optimization. The vessel as an option is tightly packed in soil, dirt, and stand vertical, etc., etc. A vertical vessel can be hammered into the ground like piles, and then the inner dirt removed, thus a tightly packed vessel in dirt. The key here is to reduce the metal required to contain the internal pressure in the various vessels.

Continuing, in detail “E,” the vessel walls are 31, 32, with the loose fabric 35 anchored shown by 33, 34. The fabric has an assist by ropes 41, 42, in case it is needed, to pull up or down, using pulleys, and appropriate controls as to the rate of the assist, the pulley sub system to be in voids in the vessels, not shown, as heat addition at constant volume takes place. There are cameras, not shown, in the vessel voids to see what is going on, to facilitate the heat addition at constant volume phase, work making phase, fill/constant pressure expulsion phase etc., etc.

Continuing, in detail “F,” the vessel walls are 51, 52, with structural construction of a dam, parts 53, 54, 55, 56, so that a stretched fabric, or very thin metal plate 57, and pin hole(s) 58 to equalize pressure on two sides during heat addition at constant volume phase. Thus instead of very loose fabric approach, a piston made up this way, is used. The linear motion is via rods 61..63, a mechanism 64 to cause the linear motion. A controller 100, a plant computer 101, sending signals 102, and generating signal 103 to modulate and thus control the rate of linear motion of the piston, via a signal 103. Thus the three phases via linear, controlled motion of a piston like dam, divider is disclosed.

Continuing, in detail “G,” a double wall construction as the vessel is made from structural steel components, and to smooth out the walls of the internal vessel so that the system runs smoothly, or say if the working fluid has very high temperature, than to expose the outer pressure vessel to, thus resulting in the outer pressure boundary to be exposed to the ambient temperature only. The two walls of a double wall system, are 71, 72, 73, 74 the pressure of the two compartments, with a pin hole 75 to equalize the pressure, a confined volume via 76, 77, a cooling sub system via a path 78..79, so that 79 represents a pump, heat exchanger, controls etc., for heat removal sub system. Thus the outer liquid volume can be at ambient temperature.

Continuing, in detail “H,” the two walls are 81, 82, pressure(s) shown by 83, 84, a pin hole 85, a cover 86 for the pin hole, the cover that uses a flexible material and anchored shown by 87, 88. Thus the flexible cover 86 equalizes the pressure of the two bodies of liquid.

Continuing, in detail “I,” to address the vessel wall thickness, a cluster of vessels, 456's to be piped into a header, not shown. Each cluster represents a vessel by way of the actual phase, i.e. all the vessels are to be taken as a single vessel by way of the cycle phases.

Continuing, in detail “J,” a two wall sphere or any other shape is outer vessel 456Y, inner vessel 456X, with flanged connections 201, 202, bolts 203. As a manhole 204, (multiple as the operation, inspection require), designed conventionally, suitably), and a line 205. The small space between the walls is pressurized, with a varying pressure, per discussion elsewhere.

Continuing, in detail “K,” a funnel type of contour 300, with very large inlet 301, having a large number of very small holes, a smaller diameter outlet 302, the fabric 303, is to prevent the fabric being sucked into the circulator at the end of heat addition at constant volume. A path 311, one of many paths from distances, so that if one inlet gets gagged by the fabric, prematurely, other suction lines are still there.

Continuing, detail “L,” the perforated suction is 321, 322, fabric 320, an inclined perforated inlet 323, so that the fabric droops over the inlet(s) without completely gagging the suction lines. Continuing, detail “M,” a housing 341, with a motorized, controlled for linear motion rate of the piston, a fishing type of mechanism with a pull in reel 342, fishing or any other material lines 343, 344, with the vessel pressure wall 345, with the cover plate 346, flat, convex, concave as the case may be, with a piston 347, with a pressure equalizing hole, multi hole, 348, with the inflatable, or any other type of rings 349, 350. Thus the piston is moved in both the linear direction via a fishing line, several, as needed, in a housing, as part of the vessel. Thus the piston is pulled in both directions by a number of fishing lines, controlled via the plant computer, controlling the linear motion rate to satisfy the thermodynamic cycle.

Continuing, as based upon teachings, in the overall system, the circulator can be done without, so that the fishing line approach makes the working fluid circulate via outside heat exchangers, both the recuperation heat exchanger, and the new heat adding heat exchanger, and the rest of the sub system that the working fluid has to move through, i.e. the working fluid circulation via motorized, controlled fishing sub system, all based upon teachings. To emphasize, there can be 10, 20, 30 motorized, controlled fishing lines, pulling the piston, (with a hole or two for pressure equalizing), (pulling) mindlessly, say 2, 3, 4 minutes, from one end of the cylinder to the other, pushing the working fluid through the sub system outside the vessels, all based upon teachings. Continuing, detail “N1,” a cylinder 361, with a piston 362 with a hole for pressure equalizing, piston rod 363 for pull of the piston from one end to the other, with system 364, 365, using screw etc., for controlled linear motion. thus the piston back and forth, in a controlled linear motion for the thermodynamic process, etc., all based upon teachings. Thus the phases, heat addition at constant volume phase, and the fill/constant pressure expulsion can be via this positive displacement pump approach, including moving the spent working fluid that has gone through the engine, all based upon teachings. Continuing, the linear motion can be via a cylinder, piston approach, a cylinder 370, a piston 371, a piston rod 372, with the hydraulic working fluid at pressure, in/out, fluid streams 373/374, the pressure developed by a sub system, not shown, making the piston move back and forth, to do the same in the vessels, 361. The vessels 361 can be in cluster, with various piston rods connected to a common structure, to be pulled, back and forth by a single hydraulic cylinder 370. There can be two hydraulic cylinders on each side of cylinder 361 so that the piston rod 363 is always in tension, etc., etc., all based upon teachings. Continuing, detail “N2,” right hand middle of the page, the vessels, pistons, via suitable structure, including a cluster approach, the structure, cylinders, pistons etc. shown symbolically by 380A, 380B, 380C can be made to move linearly, back and forth using chain(s) 383, 384, and sprockets 381, 382, including controlled drive etc., to satisfy the need of the thermodynamic cycle. The sub system is coupled with the three primary vessels sequentially, via pulling the cluster of pistons, etc., i.e. engaging one primary vessel at a time for the duration of the phases. The linear movement can be by any other similar, suitable means, to have controlled linear motion, such as a carriage as based upon teachings. Thus a single pull sub system for the three phases of the primary vessels is disclosed. Continuing, detail “N3,” almost at top, right hand side, several very long cylinders 392..393 . . . , having piston rods, gathered/grouped, joined together, structurally, shown by 391, with a common to the cylinder cluster, so that the single such mechanism serves the various clusters, by applying robotics approach, repositioning itself, a pull mechanism, means, 390, such as a carriage, hydraulic cylinder, linear electric motor, linear motion using a very large turning screw, etc., to pull all the pistons, or individual pistons, as appropriate, for the duration of the various phases, heat addition at constant volume phase, fill/constant pressure expulsion as part of the thermodynamic cycle.

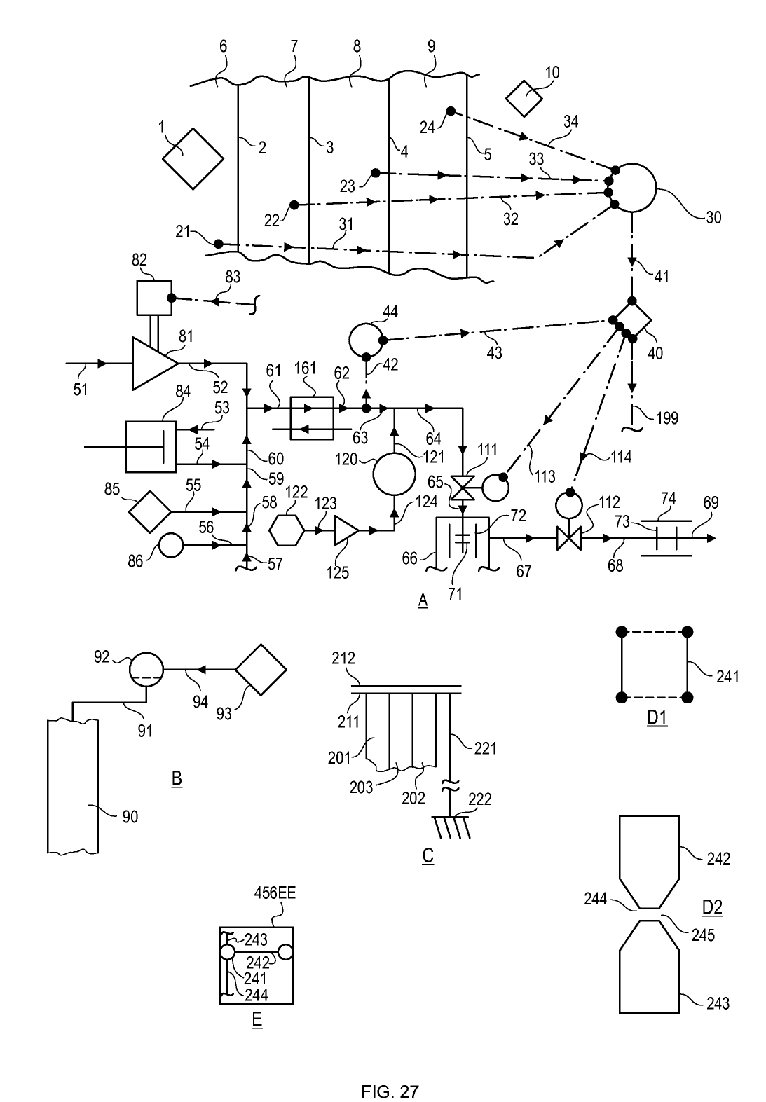

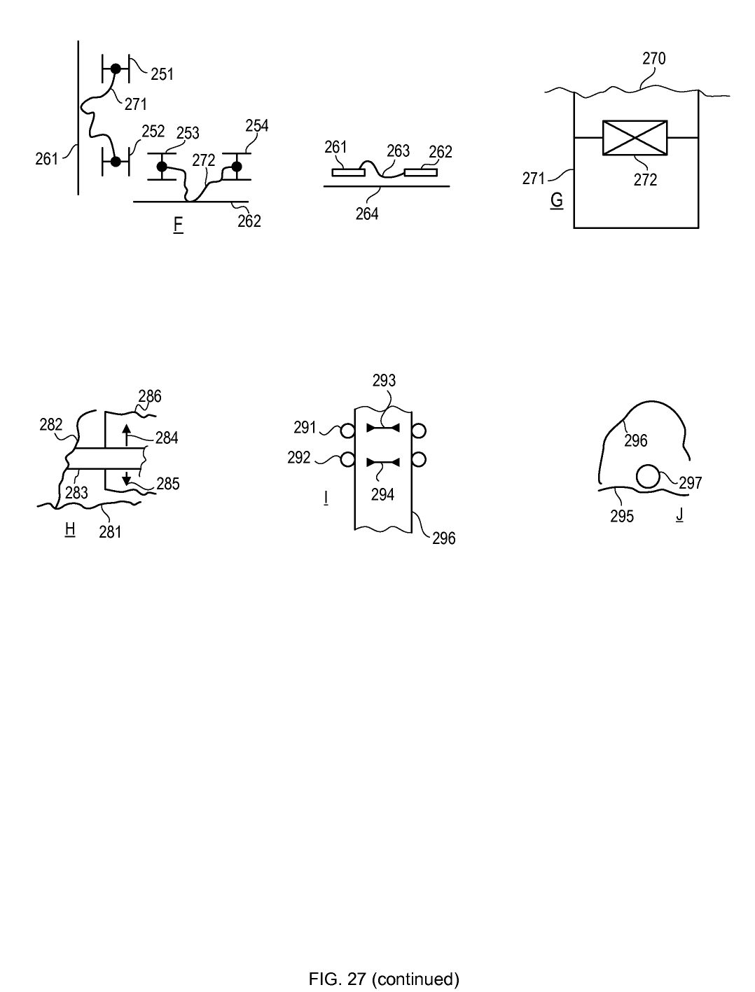

FIG. 27 shows, in detail “A,” a way to address the vessel wall design if the wall thickness becomes too large to be practical. The pressure is addressed via a multi wall design. It is to point out that the pressure to be contained goes up and up in the heat addition at constant volume phase and goes down and down in the work making phase. Thus the pressure in various compartments, between walls, will need to be varied in a controlled manner, thus containing the pressure. The walls are thus not over stressed either via the differential external pressure or the differential internal pressure.

Continuing, the working fluid pressure, that varies is shown symbolically by 1. The atmospheric pressure is shown symbolically by 10. The compartments are 6..9, walls 2..5, with various pressure(s), 21..24. The pressure signals 31..34, to a plant computer or another instrumentation sub system 30. Thus to import the pressure values from various compartments. Then via the plant computer, not shown, to calculate the pressurizing air needs, to pressurize the compartments. Another sub system is pressure reading signal 42, and the pressure communicating signal 43 for the pressurizing air sub system.

Continuing, the pressurizing air sub system is paths 51..61, ambient air use, so that the pressurized air is a fluid stream 61, cooled if needed via a heat exchanger 161. The pressure generation is by a rotary compressor 81, a positive displacement compressor 84, or any other redundant compressor 85, a liquid air source as an option to boil off air at pressure 86, etc., etc., i.e. to have highly reliable compressed air sub system, including an accumulator.

Continuing, there is pressure recovery when air is let out, the pressurized air being let out shown symbolically by 122, a path 122..124, a compressor 125, an accumulator 120, with compressed air reliable part 121. Thus a very reliable pressurized air sub system is disclosed.

Continuing, a path ..65 is to pressurize the compartment shown symbolically by 66, an on/off control valve 111, a signal 113, a path 65 opens up for air coming out via holes 71, a rubber sleeve 72, and air is let into the compartment 66, i.e. to satisfy the inflation need. The deflation need is via another path 67..69, a control valve, on/off valve 112, signal 114, holes 73, rubber sleeve 74. Thus the inflation/deflation capability to get the desired pressure of air between the walls i.e. in compartments.

To recap, a pressurized air sub system, a very reliable sub system to pressurize the compartments in a multi wall vessel design. The teachings can be used to have a liquid based sub system.

Continuing, in detail “B,” the compartment(s) 90, to fill the compartments with a suitable liquid, say treated water, a line 91, from an accumulator 92, that has the pressurizing system shown symbolically by 93, i.e. varying pressure, very reliable pressurized air shown symbolically by a path 94, an accumulator 92. Thus the compartments are pressurized via a pressurized accumulator using say air, and a liquid in the compartment(s) combination, all based upon teachings.

Continuing, in detail “C,” a RCC method, i.e. Reinforced Cement and Concrete as the pressure boundary. Very thick walls are 201, 202, the inbetween vessel space 203, flanged connections 211, 212 for the dome, not shown. To avoid transferring the weight of the dome to the RCC walls, via a series of columns shown symbolically by 221, thus transferring the load to the ground shown symbolically by 222.

Continuing, in detail “D1,” the vessels, via stacking rings, shown by 241, so that the size of the rings, axial length and the diameter is determined by the transportation limitations, size, weight etc. Continuing, in detail “D2,” the rings, 242, 243 are stacked, shown in part, add field welding shown by voids 244, 245 in the pre-prepared weld contour surface etc.

Continuing, detail “E,” a vessel 456EE that has a ring 241 with buoyancy to have it float, a stretched dam using a suitable fabric, with a pin hole, to equalize the pressure, with stretched ropes 243, 244, with pulleys, not shown, controls, not shown, that moves this dam up and down at will, and at a rate to facilitate the thermodynamic process of the three phases, and for the secondary vessel to suit. Continuing, detail “F,” the primary vessel is in dirt, shown by 261, 262, thus the pressure pushes out the dirt, making it denser and denser over time, a steel structure, via structural steel components 251..254, with very loose membrane, of lasting material, that over time pushes out the dirt to a stable density, consistency. As an alternate, the steel part can be flats, 261, 262, ground, dirt 264, with very durable flexible fabric 263, so the extremely high pressure pushes on the dirt, and over time the system gets stable, via dirt compression, and resettlement.

Continuing, detail “G,” has the ground shown by 270, and then the three sides 271 by hammering in the structures, and removing the dirt to create a vessel. The structure is predesigned to be hammered in, to maintain the original ground dirt compactness. Then the structure is modified in place to accommodate the very loose membrane, thereby creating the pressure vessel on the three sides by having the loose membrane against the dirt as the pressure boundary. The cover 272 will then be via heavy structural construction, supported by suitable columns, not shown, thereby reducing the overall vessel cost.

Continuing, detail “H,” top left, the vessel can be formed in a mountain region, ground 281, mountain face 282, a working tunnel 283, with designing the tunnel for work space 284, 285, up and down and sideways, to form the vessel 286. Eventually the opening 283 will be changed to a manhole type of maintenance feature.

Continuing, detail “I,” top right, a vessel 290, with a series of braided steel ropes 291, 292, to be tightened in place via a screw type of tightener(s) 293, 294, thus pre stressing the vessel walls.

Continuing, detail “J,” further down, a ground 295, vessel 297, with a mountain of man-made pile of dirt, sand etc. to bury the vessel, and systems, with maintenance access.

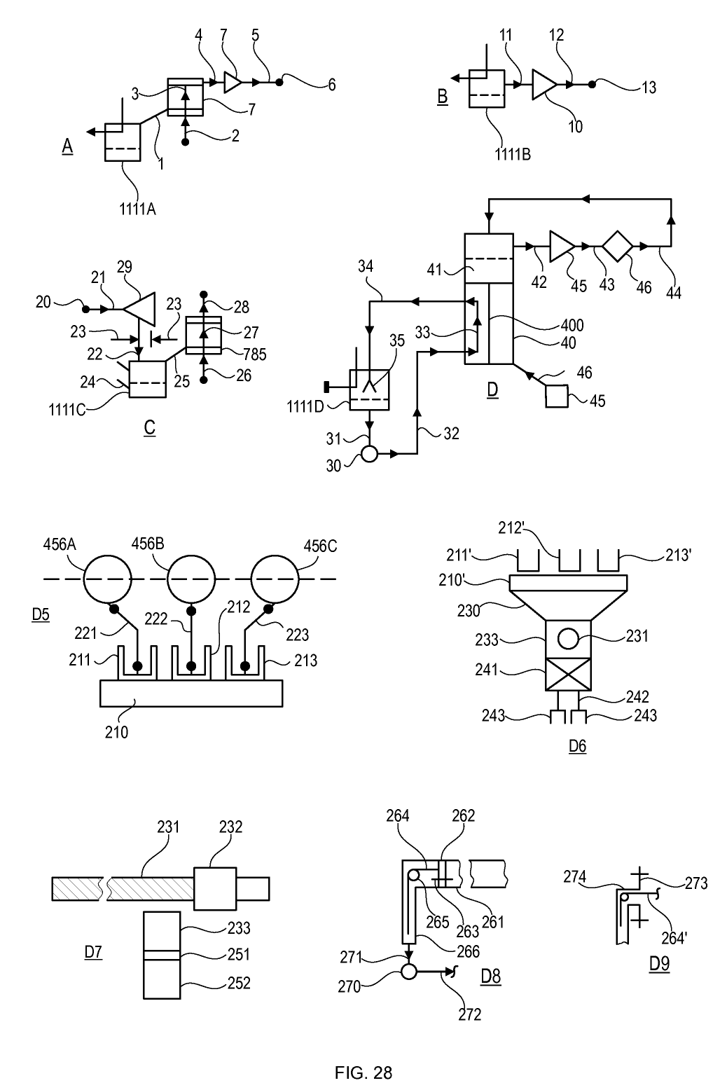

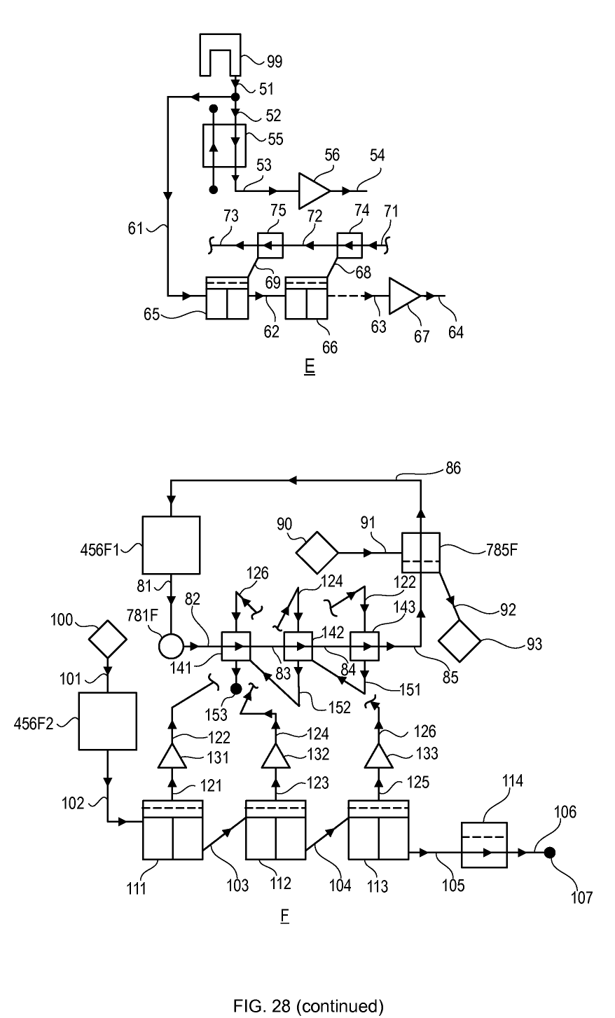

FIG. 28 shows pointing out various ambient, low grade or waste thermal energy, or any other thermal energy sources, the thermal energy to be used in the heat addition at constant volume approach thermodynamic cycle.

Continuing, in detail “A,” a Rankine cycle for steam, or any other working fluid, a condenser 1111A, with the refrigerant vapor making heat exchanger, an evaporator 7, the refrigerant flow path, in part 2..4, resulting in wet vapor or saturated vapor fluid stream 4, compression 4..5, node 6, a compressor 7, node 6 represents the thermal energy source for the heat addition at constant volume phase, the saturation temperature of refrigerant fluid stream at node 6 to be say 150 Deg. F. to say 250 Deg. F., as an example. Thus the low grade, or waste thermal energy source is path 1, vapor goes up, and condensate drains back into the condenser 1111A, followed by compression to raise the grade of the thermal energy to a useable level.

Continuing, in detail “B,” the condenser vapor itself can be recompressed to get the desired saturation temperature for the thermal energy source. Continuing, a condenser 1111B, vapor path 11..13, a compressor 10, the recompressed vapor at node 13 with the desired saturation temperature as the elevated thermal energy source. This option permits to have least interference with the parent Rankine cycle, for the add on thermodynamic cycle, that uses heat addition at constant volume approach.

Continuing, in detail “C,” the last turbine 29 has the working fluid path 20..21, exhaust fluid stream 22, 23/23 represents the last few rows of turbine blades which are removed. It raises the exhaust pressure, into the condenser 1111C, now functionally a tank. This transformed tank is reinforced if needed, for higher pressure in a retrofit option, reinforcement shown symbolically by 24. Thus the exhaust of an existing turbine now coming out at higher pressure than the original design, with the saturation temperature of the exhaust that is suitable for the add on thermodynamic that uses heat addition at constant volume approach. The thermal energy use has vapor flowing up, drains back, path 25. The heat addition at constant volume phase, a heat exchanger 785, the working fluid path 26..28.

Continuing, in detail “D,” a condenser 1111D with a hot well pump 30, hot well liquid path 31..34, the thermal energy source returning fluid stream 34, after giving up its sensible heat, to discharge into the vapor space as fine spray, as condensate to be reheated. An evaporator heat exchanger 40, the refrigerant vapor path via evaporation from a liquid body 41, and via tubes 400, resulting in wet vapor, or saturated vapor of the refrigerant, to a path 42..44, a compressor 45, thermal energy use in the heat addition at constant volume phase, heater drain etc., all shown symbolically by 46. The heater drain fluid stream 44 back into the liquid body 41, via a 2phase turbine, etc., not shown, to get more thermal energy, and to become vapor fluid stream 42, and so on and so on. Continuing, the thermal energy source in this case is the condenser hot well liquid, fluid stream 31. The thermal energy then elevated via compression 42/43. As a variation, other liquid thermal energy sources such as sea water, ground water, etc., etc., all shown symbolically by 45, a path 46, to boil off refrigerant, all based upon teachings. The thermal energy for making the refrigerant into vapor, via the heat transfer surface 400 to be finned tubes having ambient air blown over these finned tubes, not shown, as another ambient thermal energy option to evaporate the liquid refrigerant into vapor, all based upon teachings.

Continuing, in detail “E,” use of the flue gas from a boiler 99, or from any other facility, flue gas fluid stream 51 is at say 250 Deg. F. to 300 Deg. F., a path 51..54, a heat exchanger 55, a heat exchanger for the heat addition at constant volume phase of the cycle, a fan 56. Thus the flue gas thermal energy is imparted directly to the working fluid of the thermodynamic cycle, that uses heat addition at constant volume approach.

Continuing, in an alternate path of using a heat pipe approach, the flue gas path 51..61..64, a suitable working fluid (can be different working fluid in each of the boil off stages), boil off heat exchangers 65, 66, .., a fan 67. The wet vapor goes up, condensate drains back, via fluid streams 68, 69. The thermodynamic cycle that uses heat addition at constant volume approach with the working fluid path 71..73, heat exchangers 74, 75. Thus via evaporation, wet vapor at different pressure(s), using wet vapors as the thermal energy source.

Continuing, in detail “F,” a non fabric primary vessel 456F1, working fluid path, heat addition at constant volume phase, 81..86, new heat via heat exchanger 785F, with a drains cooling zone, a heat pump for thermal energy gathering sub system shown symbolically by 90, thermal energy path 91, heater drain, 2phase turbine etc., shown symbolically by 93, a path 93. The work making phase, not shown, and the constant pressure expulsion phase, compressed air sub system 100, compressed air path 101, pushing out spent working fluid, thermal energy recovery, a path 102..106, 107 very cold working fluid for the fill phase. Various evaporators 111..113, an evaporator 114 of the main heat pump 90, refrigerant vapor fluid streams, at multi pressure (s), and compression via compressors 131..133, paths 121..122, 123..124, 125..126, to heat exchangers 141..143, with drains cooling zones, cascading heater drain paths 151..153, the fluid stream 153 reintroduced into evaporators 111..113. Thus a non fabric primary vessels, and the system based upon heat addition at constant volume phase.

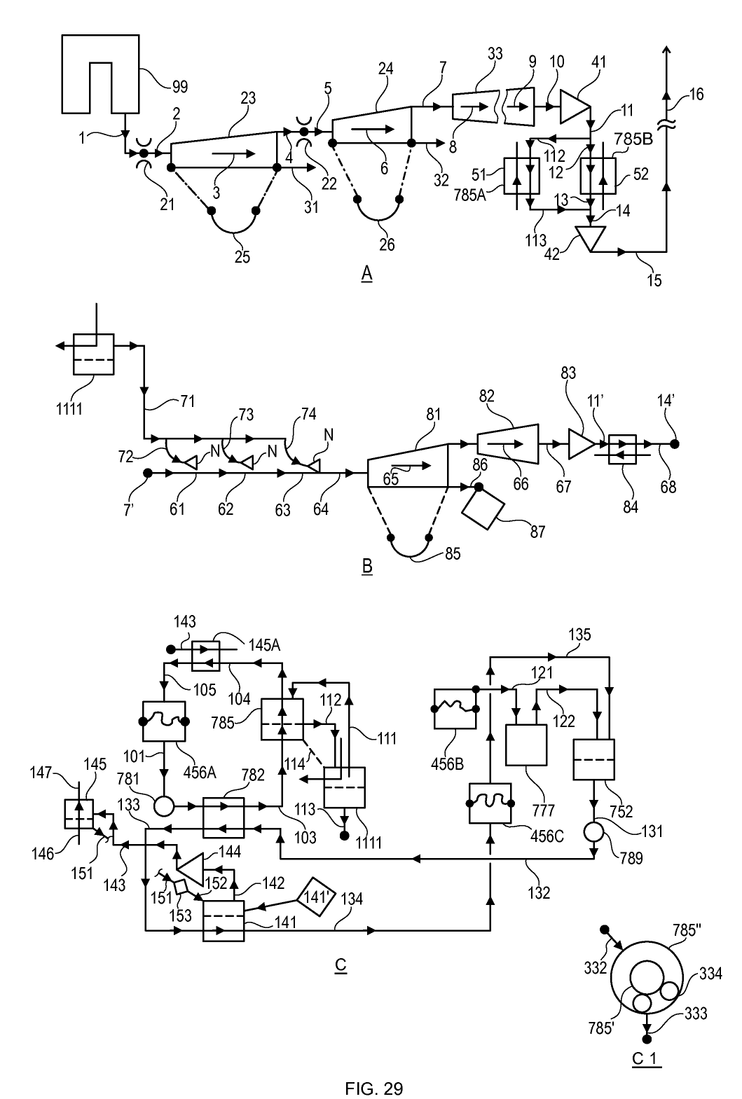

FIG. 29 shows, in detail “A,” a boiler 99, with flue gas leaving the boiler at about 300 Deg. F., a path 1..16, to generate thermal energy for using in a thermodynamic that applies heat addition at constant volume. The thermal energy is first cleaned up to be compatible for extremely high pressure components. Thus the system for flue gas clean up, nozzles 21, 22, to have the fluid stream 2 at very high velocity and very cold temperature. Thus the nozzle(s), via converting thermal energy to kinetic energy, cools the flue gas, thereby condensing out water, acid, via being cooled to below dew point temperature level(s). Continuing, there is a divergent part, eccentric cross section, curved shown symbolically by 25 so that the liquid part slips through shown by a path 31, the vapor part continues, ..4.. Another nozzle 22 which makes the flue gas travel faster, and gets even cooler, to water, acid dew point. Another divergent part shown by 24, curved part shown symbolically by 26, liquid slips through shown by 32, vapor follows ..7..10, stagnation via 33. Thus very clean flue gas results at fluid stream 10, that needs to be compressed, a compressor 41 then thermal energy recovery, paths 11..14, 112..113, heat exchangers 51/785A, 52/785B. The thermal energy in these heat exchangers is for heat addition at constant volume approach. Continuing, the flue gas is at a fairly low temperature, fluid stream 14, and gets expelled, a path ..14..16, a fan 42.

To be pointed out that acid dew point, and water dew point are different. Thus two expansions, nozzles 21, 22 to address that, in the order as applicable. Thus the key is a hard pull on the flue gas, to make it very cold, and the junk, solids, mercury etc., all comes out. There can be refrigeration recovery of fluid streams 31, 32 as well, if the material and the economics permit that.

Continuing, in detail “B,” nodes 7′, 11′, 14′ that represent the system conditions, functionally, representatives, from detail “A.” A further improvement, interruption of the process of detail “A,” a condenser 1111, waste thermal energy, condenser steam, (can be lower bleed streams), a path 71..74, nozzles “N.” The fluid stream at high velocity, and very low temperature, 7′, a path 61..67..11′..68..14′, so that the latent heat of waste steam imparts velocity to the main path 61.., via duct resizing to address the increasing velocity. To partial stagnation, via an eccentric, divergent part 81, curved shown by a path 85, liquid spin out path 86, 87 that represents the liquid collection, clean up, back to the system as condensate, full stagnation, component 82, divergent part, compressor 83, thermal energy recovery, use via a heat exchanger 84. Thus we make use of the condenser waste steam, waste thermal energy.

Continuing, in detail “C,” heat addition at constant volume phase, a primary vessel 456A, working fluid path 101..104/105, a path terminating at 104, when refrigeration cycle thermal energy is not used, a path to 105 when using the high grade super heat, or even latent heat thermal energy of the refrigeration sub system, via a heat exchanger 145A, a circulator 781, a recuperation heat exchanger 782, a heat exchanger 785, a condenser 1111, condensate leaving path 113, a waste thermal energy, vapor, steam as an example path 111, a sub cooled condensate path 112 when there is a drains cooling zone, and an alternate path 114, with vapor flowing up, liquid draining back, thereby use of latent heat, and in drains cooling zone option sensible thermal energy. Another primary vessel 456B, post heat addition at constant volume, a work making phase, a path 121, an engine 777, an exhaust path 122, a tank 752, with the thermal energy recovery, a pump 789, a path 131..134, a very cold fluid stream 134, another primary vessel 456C, that has the spent working fluid, a fill/constant pressure expulsion phase, path ..134..135 to the tank 752. A dedicated refrigeration sub system, an evaporator 141, refrigerant vapor path 142..143, a compressor 144, to a thermal energy rejection heat exchanger 145, thermal energy sink path 146..147, the sub cooled (as one option) refrigerant, preferably saturated refrigerant, to extract most work, if via a 2phase turbine, a path 151..152, via a restriction orifice, preferably a 2phase turbine, shown symbolically by 153, thus extracting work. Continuing, 141′ shows symbolically that the refrigeration sub system can have multiple evaporator (s), as per optimization exercise, i.e. reducing the compression work. The thermal energy 143/151 can be used in the main heat addition at constant volume path 101..104, as based upon optimization exercise. Thus the recuperation heat exchanger cold side, fluid stream 133 is cooled to a very low temperature, that allows to use the main thermal energy 111/112 as is. This thermal energy, 103/104 can be ambient thermal energy, waste thermal energy, or any other thermal energy available as is, because the cold side temperature of the heat addition at constant volume, fluid stream 101 temperature is very low, using a dedicated refrigeration sub system, evaporator 141, condenser 145 refrigeration sub system. Continuing, detail “C1,” upper left, if condenser steam is used as the thermal energy source, then instead of the insulation, the primary vessel 785′, studs 334 to support the outer shell 785″ against atmospheric pressure vs. inner below atmospheric pressure, condenser steam supply line 332, condensate drains 333, thereby maintaining the inner extremely high pressure, when the primary vessel is laid away over time.

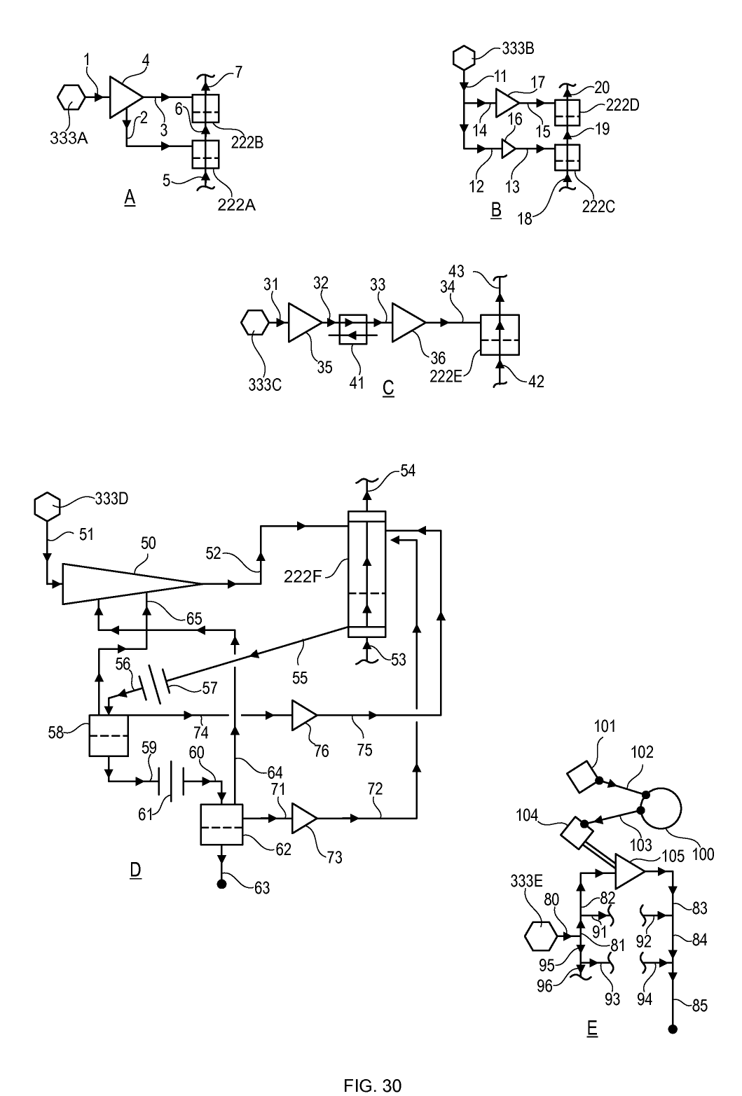

FIG. 30 shows the compression of the refrigerant vapor, of the sub system, that is thermal energy gathering sub system. This vapor is generated via evaporation, using heat sources such as the ambient thermal energy, or very low grade, or waste thermal energy etc. The compression is to raise the pressure of the refrigerant vapor, and make it useful for the heat addition at constant volume phase. This disclosure is to optimize the refrigerant vapor compression part, i.e. to minimize the compression work and the hardware cost, system simplification etc., etc. Various heat exchangers 222's in this figure are functionally similar to heat exchanger 783, 784, 785, for heat addition at constant volume approach.

Continuing, in detail “A,” the refrigerant vapor, shown symbolically by 333A, compression paths 1..2, ..3, a compressor 4, the compression is at two pressure levels. For the heat addition at constant volume phase, working fluid path 5..7, via heat exchangers 222A, 222B. Thus compression in two pressure stages is employed, using a single compressor. As based upon teachings there can be more than two pressure stages, as well.

Continuing, in detail “B,” the refrigerant vapor is shown symbolically by 333B, the refrigerant vapor compression paths 11..12..13, a compressor 16, another path 11..14..15, a compressor 17. Thus two dedicated compressors, 16, 17 with compression ratios to suit. The heat addition at constant volume phase heat exchangers 222C, 222D, the working fluid path 18..20. Thus two stage compression via two compressors. As based upon teachings, there can be more than two stages of compression as well, all based upon optimization exercise.

Continuing, in detail “C,” the refrigerant vapor is shown symbolically by 333C. Compression path 31..34, compressors 35, 36, inter cooling via a heat exchanger 41, heat addition at constant volume phase, with the working fluid path 42..43, via a heat exchanger 222E. Thus employing compression inter cooling. There can be more compression stages as based upon optimization exercise.

Continuing, in detail “D,” one of the objectives is to avoid the use of the screw expanders, 2phase turbine etc. to extract work from the refrigerant heater drain, as in various disclosures. The refrigerant vapor shown symbolically by 333D, a compressor 50, with the main compression path 51..52, to the heat addition at constant volume phase heat exchanger 222F, with drain cooling and condensing zones of the heat exchanger 222F. The heat addition at constant volume phase working fluid heating path is 53..54, to a sub cooled heater drain path 55..56. The heater drain of liquid refrigerant follows via a restriction orifice 57 into a flash tank 58. The next flashing path ..59..60, via a restriction orifice 61 into another flash tank 62, with the final liquid refrigerant, a path ..63, back to the thermal energy gathering sub system. Continuing, the first higher pressure flash vapor follows a path 65, a lower pressure flash vapor path 64. This reduces the overall compression work for the same heating load of heat exchanger 222F. As an alternate, a dedicated compressors for the compression of flashed vapor fluid streams, a path 71..72, a dedicated compressor 73, another path 74..75, another dedicated compressor 76. There can be variations, such as different pressure(s) of fluid streams 72, 75, to introduce multi pressure level heat addition at constant volume phase heating of fluid stream 53..54, say three pressure levels, three different pressure(s) of fluid streams 52, 75, 72, employing three 222F type of heat exchangers, with cascading heater drains, etc., etc., all based upon teachings.

Continuing, in detail “E,” to address the very large refrigerant amount and flow rates, for compression of vapor. To employ parallel refrigerant vapor compression paths. The refrigerant vapor is shown symbolically by 333E, with the compression parallel paths, 80, ..81..85, 95..96, individual additional compressor paths 91..92, 93..94. A controller 100, a plant computer 101 with incoming signals 102, generating a signal 103 to turn on the compressor drive, such as an electric motor etc., shown by 105, to bring into operation a compressor 105. Thus to bring into operation one compressor at a time addressing the heating load of the heat addition at constant volume phase thermodynamic cycle, and the very high specific volume of the refrigerant vapor to be compressed as the case may be.

Thus to optimize the refrigerant vapor compression as part of the overall heat addition at constant volume approach thermodynamic cycle.

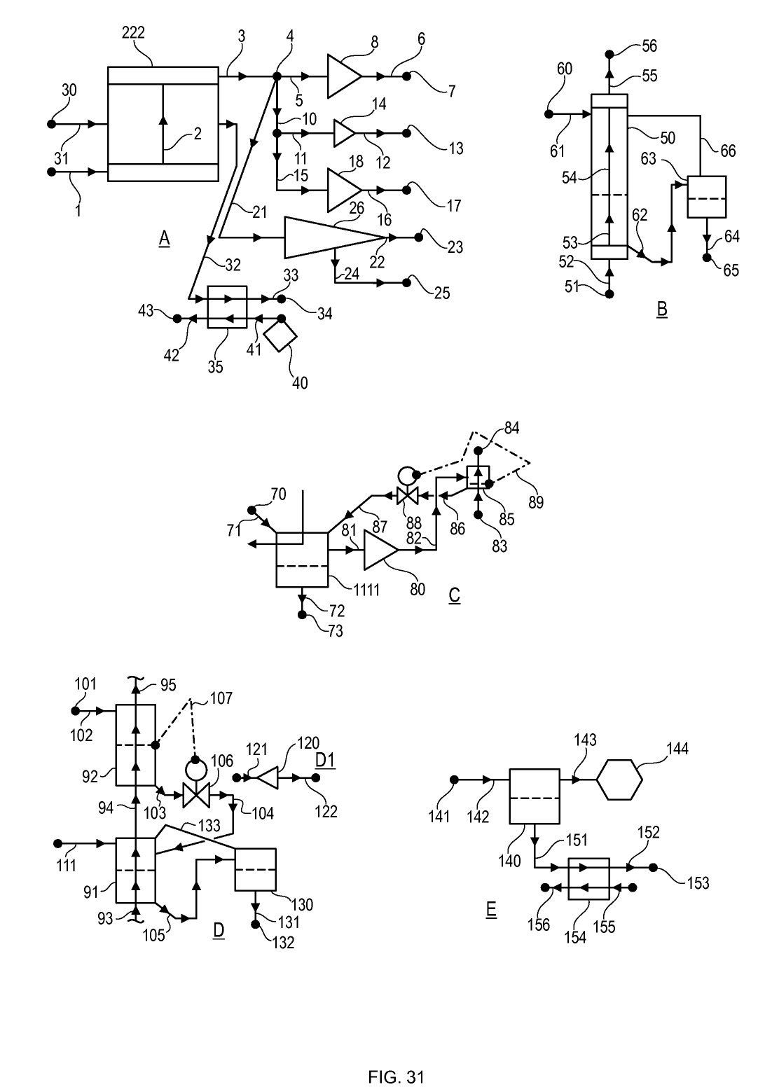

FIG. 31 shows building blocks. In detail “A,” a very large heat exchanger 222, with the refrigerant, to become vapor, as low grade thermal energy gathering working fluid, a path 1..3, the fluid streams 3 is vapor, and the liquid after vapor gives up its latent heat and the sensible heat in the main cycle applying heat addition at constant volume, not shown, gets recirculated. The various vapor compression paths as part of optimization exercise, starting at point 4, a simplest path ..4..5..7, a compressor 8 to get suitable single pressure at 7. A path ..4..10..11..13, a compressor 14, ..15..17, a compressor 18 to get pressure(s) P1, P2, for working fluid heating, i.e. making two pressure(s) to save compression work. A path ..4..21..23, a compressor 26, one pressure at 24..25, another pressure at 23, to make two pressure(s). The low grade thermal energy source then follows 30, 31..34, a heat exchanger 35 as the heat sink for the lowest sink temperature available. A working fluid path, say a two phase fluid streams shown symbolically by 40, a path 41..43 to use the heat sink at the lowest temperature.

Continuing, in detail “B,” a heat exchanger 50 for the work making working fluid, a path 51..56 to get heated by using the heat pump based thermal energy, a path 60, 61..62, a tank 63, equalizing line 66, to heater drain fluid streams 64..65, so that the sub cooled fluid streams 62 is collected in the tank. To notice the dotted line as liquid level line.

Continuing, in detail “C,” a condenser 1111, liquid coming out 72..73, with the two phase fluid streams coming in, shown 70..71, to use the vapor of the condenser as heat pump working fluid streams, a path 81..82, a compressor 80, the working fluid thus gets heat via a path 83..84, via a heat exchanger 85, with heater drain path 86..87, a level control valve 88, a signal 89. The key here is the minimization of the condensation (in the condenser), of the working fluid that makes work, and then using the vapor part to make higher grade heat, via recompression, rather than losing its latent heat, etc., etc.

Continuing, in detail “D,” employing two stage heating of the work making fluid stream, a path 93..95, getting heated by two pressure levels thermal energy sources, a path 101..105, heat exchangers 91, 92, with sub cooling zones, a first heater drain 103..104, a second heater drain 105, into a tank 130, the liquid to be used for heat gathering sub system, a path 131..132. As an alternative shown in detail “D1,” instead of the level control valve, a path 121..122, with a screw expander 120. Thus showing the use of two pressure levels of heat pump thermal energy. To notice the dotted lines, and tank 130, with equalizing line 133 as passive system for the heater drain control.

Continuing, in detail “E,” ambient temperature water as the low grade thermal energy source, a path 141..142, into a flash tank 140, a cooler liquid path 151..153, a heat exchanger 154 as the lowest temperature heat sink, a working fluid path 155..156. A path ..143, a vapor at very low temperature, and gets compressed, shown symbolically by 144, all the options of compression disclosed in detail “A,” one pressure, two pressure levels etc., thus using the ambient water low grade thermal energy via a heat pump, etc., etc.

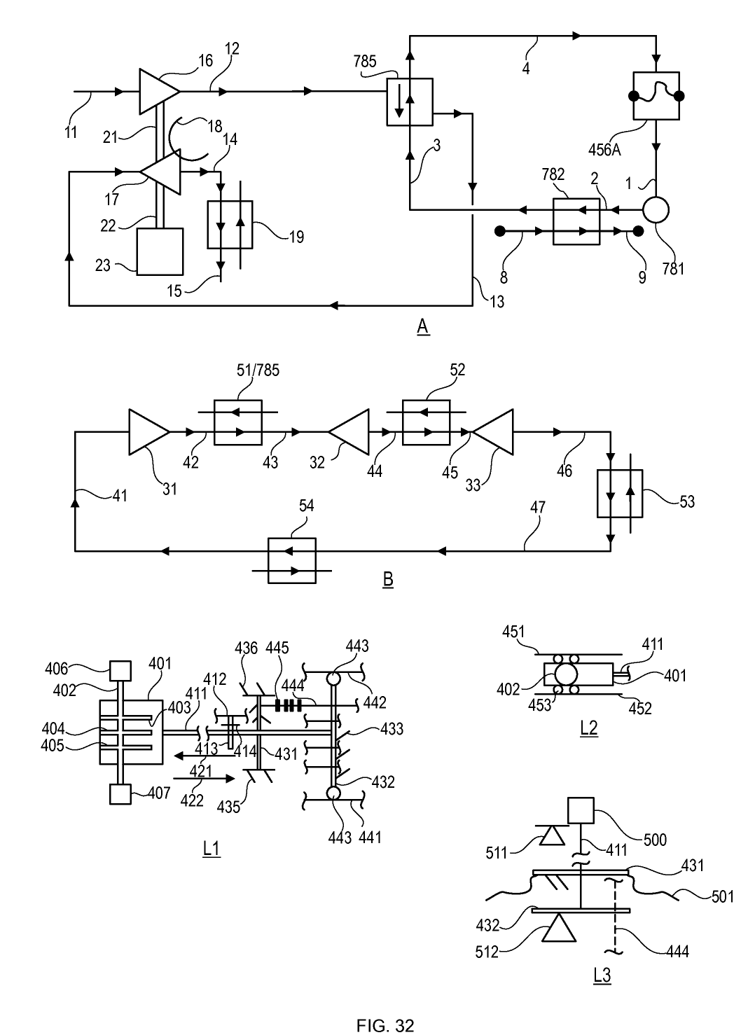

FIG. 32 shows a what can be called a single phase heat pump, i.e. the heat pump working fluid remains a gas. Thus there is no condenser, evaporator in the heat pump. In detail “A,” using ambient air as the working fluid, in an open heat pump cycle approach, the heat addition at constant volume has a primary vessel 456A, and the working fluid, which can be gas or liquid, follows 1..4, a circulator 781, a recuperation heat exchanger 782, a heat exchanger 785, spent working fluid path for thermal energy recovery, 8..9. Continuing, the ambient air as the heat pump sub system follows 11..15, resulting in the higher grade thermal energy 12/13, a compressor 16, a turbine 17, with 18 that represents optional reheat. A heat exchanger 19 to use the refrigeration if available at a level that can be used for, such as the cooling of the working fluid of the heat addition at constant volume thermodynamic cycle to a very low initial temperature. Shafts 21, 22, a motor 23. Thus an open loop heat pump, using ambient air, is the sub system of choice for the thermal energy gathering sub system.

Continuing, a closed loop, single phase thermal energy gathering sub system, with working fluid say air at pressure, N2, Helium, etc., etc. The sub system has a compressor 31, turbines 32, 33, reheating 44/45 via a heat exchanger 52 using thermal energy from the ambient or from the cycle itself. The closed loop follows 41..47. A heat exchanger 51/785, as a heat exchanger 785 symbolically from detail “A.” A heat exchanger 53 to use the refrigeration thus made available for the working fluid pre cooling etc. A heat exchanger 54 to bring in the low grade thermal energy such as from ambient air, ambient water, sea water, condenser waste steam etc., etc., i.e. bring in the low grade thermal energy 47/41, to make higher grade thermal energy and use it 42/43.

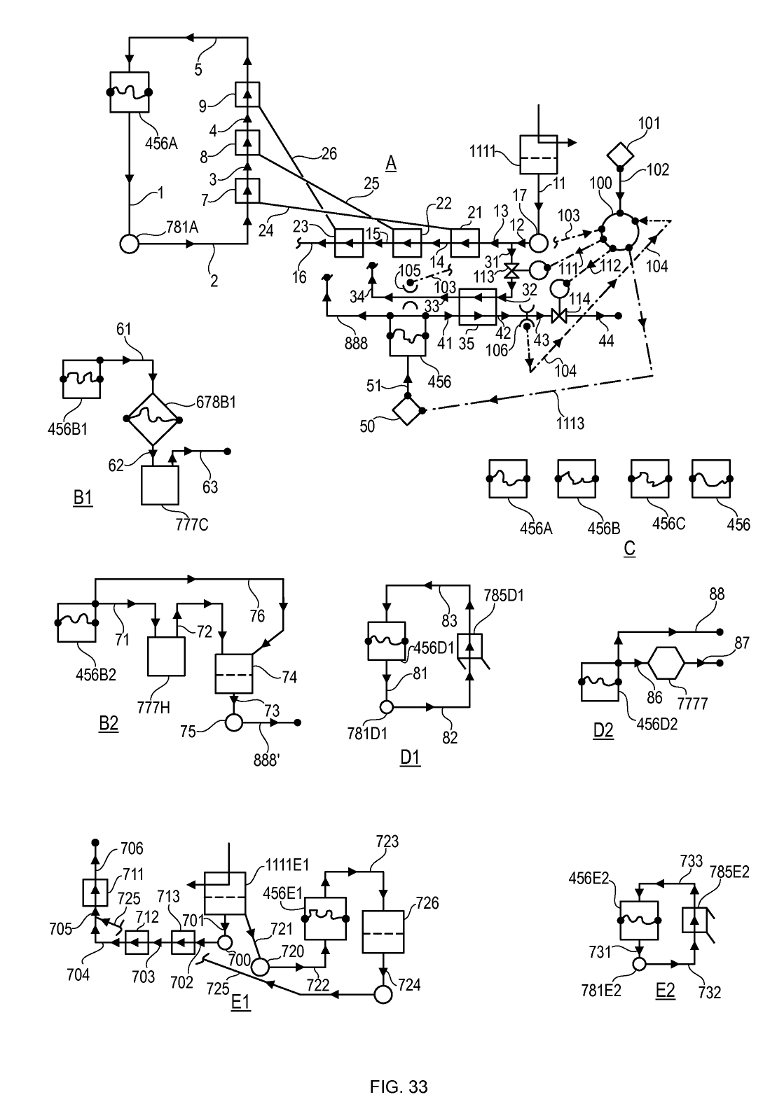

FIG. 33 shows a variation so that there are two things going on here; one, using the heat addition at constant volume approach thermodynamic cycle as add on peak power cycle, at an existing facility, say a water Rankine cycle, and the other, that is employed, the teachings of using low grade thermal energy from a Rankine cycle, that uses water or any other working fluid, say an Organic Rankine cycle. Thus using lower bleed streams, as the low grade thermal energy source, directly, and therefore without the refrigerant based heat pump approach of elevating the grade of the Rankine cycle low grade thermal energy.

Continuing, in detail “A,” the heat addition at constant volume phase follows, a primary vessel 456A, is very large primary vessel, or cluster of primary vessels for peaking power, and say water as working fluid, at ambient temperature in this case, to a path 1..5, a circulator 781A, heat exchangers 7..9. The parent Rankine cycle has a condenser 1111, and condensate that follows, (lower part of condensate heating), a path 11..16, a condensate pump 17, to condensate heating heat exchangers 21..23, using bleed streams, not shown, heater drains not shown, sending steam up, condensate down via paths 24..26, thermal energy sources for the heat addition at constant volume phase heating in a regenerative manner, using thermal energy of lower bleed streams.

To be pointed out that it is arbitrary, the three heat exchangers/bleed stream thermal energy sources, can be more, can be less, as based upon optimization exercise. Thus heat addition at constant volume phase, say at night, or while the parent Rankine cycle is at low load, as the parent Rankine cycle plant is running. For peak power, the stored, extremely high pressure water in primary vessel 456A as the working fluid. More on this later, for non peak, thermal energy recovery etc.

Continuing, in detail “B1,” the primary vessel 456B1 going through the work making phase, a path 61.., to the secondary vessel 678B1 using the liquid push out approach, a path ..62, engine 777H, exhaust fluid stream 63.

Continuing, similarly for the work making phase, in detail “B2,” using the direct working fluid into the engine approach, a primary vessel 456B2, a path ..71.., engine 777H, exhaust fluid stream 72, into a tank 74. To the thermal energy recovery path 73..888′, a pump 75, to the fill/constant pressure expulsion phase, the exhaust i.e. push out of the spent working fluid stream 76, into the thermal energy recovery tank 74.

Continuing, again in detail “A,” the thermal energy recovery phase has two options. Say, a controller 100, getting signals 102 from a plant computer 101, sends a signal 113 to a system for fill/constant pressure expulsion phase of the spent working fluid, from primary vessel 456A, shown symbolically by 50, a path 51, of the primary vessel 456A, spent working fluid push out fluid streams 888, into the parent Rankine cycle condensate fluid stream, a simpler version.

Continuing, then another path 41.., later. The fluid stream 888 enters the main condensate path of the parent Rankine cycle at a suitable place as based upon its temperature, i.e. between the condensate heaters so that the lower heater outlet is cooler and the upper heater inlet is hotter than its, fluid stream 888's temperature.

Continuing, to keep the working fluids of the parent Rankine cycle and this add on heat addition at constant volume approach based thermodynamic cycle system separate, i.e. no working fluid interchange, for thermal energy recovery, a path 41..44, heat source, a path 31..34, heat sink. The fluid stream thus 34 reenters the condensate, same criteria as fluid stream 888 entry point. Thus to equalize the flow rates in the heat exchanger 35, using flow rate signals 103, 104, and send out signals 111, 112 modulating the flow control valves 113, 114 to equalize the flow rates, 41 vs. 33. The fill/constant pressure expulsion phase is common for the two options, i.e. simpler path 888, and the other path for other reasons, a path 41 . . . , all based upon teachings.

Continuing, in detail “C,” cluster of primary vessels 456A.., etc. to point out that for peaking power or even otherwise, having several extremely high pressure based working fluid primary vessels, going through the thermodynamic cycle phases. These primary vessels can be out of phase for the work making phase, to smooth out the power output. Additionally, the multi vessel approach is to make the vessel wall thickness manageable. Continuing, and additionally, the multiple primary vessel or even secondary vessel approach is to address the wall thickness issues, disclosed elsewhere as well. In other words a multiple of vessels is used to satisfy the need for the amount of working fluid in each of the cycles. Continuing, again, the vessels go through cycling, i.e. pressure going down and down, and starting with top pressure again, which then introduces fatigue based stress etc. In addition, to design the plant so that the vessels are melted and reconstructed every so often as the fatigue etc. come into play.

Continuing, to recap, a very simple and shown symbolically in details “D1, D2.” In detail “D1,” a primary vessel 456D1, heat addition at constant volume phase, a path 81..83, a circulator 781D1, to several heat exchangers shown symbolically by 85, regenerative heating of the fluid stream 82/83, steam flows up, condensate drains back, into the condensate heating heat exchangers of the parent Rankine cycle, not shown, thus making extremely high pressure working fluid, part of the heat addition at constant volume approach thermodynamic cycle. In detail “D2,” work making phase, shown symbolically by a path ..86..87, liquid push out approach, or direct working fluid use approach, shown symbolically by 7777, to the thermal energy recovery phase, hot working fluid paths, ..88, ..87 liquid push out approach or direct working fluid use option, back into the condensate fluid stream of the parent Rankine cycle.

Continuing, as the round trip efficiency in this case is very high, to have this add on system of heat addition at constant volume approach thermodynamic cycle, make more revenue than just as the peak power option.

Continuing, in details “E1, E2,” so that in detail “E1,” a condenser 1111E1, with a condensate pump 700, a condensate fluid stream, path 701..706, lower bleed stream heating heat exchangers 711..713. The add on system has a pump 720, with the fill/constant pressure expulsion phase, a path 721..725 via a primary vessel 456E1, to a tank 726, the spent working fluid reenters condensate feed stream, matching the temperature of the condensate feed stream vs. the temperature of fluid stream 725. In detail “E2,” the heat addition at constant volume has another primary vessel 456E2, with a circulator 781E2, the liquid fluid stream that follows 731..733, via regenerative heating heat exchangers shown symbolically by 785E2. Thus to divert the condensate from the condenser, a path ..721, add heat via heat addition at constant volume, to work making phase, not shown, and reintroduce the spent working fluid, ..725, thereby giving a heat to work efficiency of 100%.

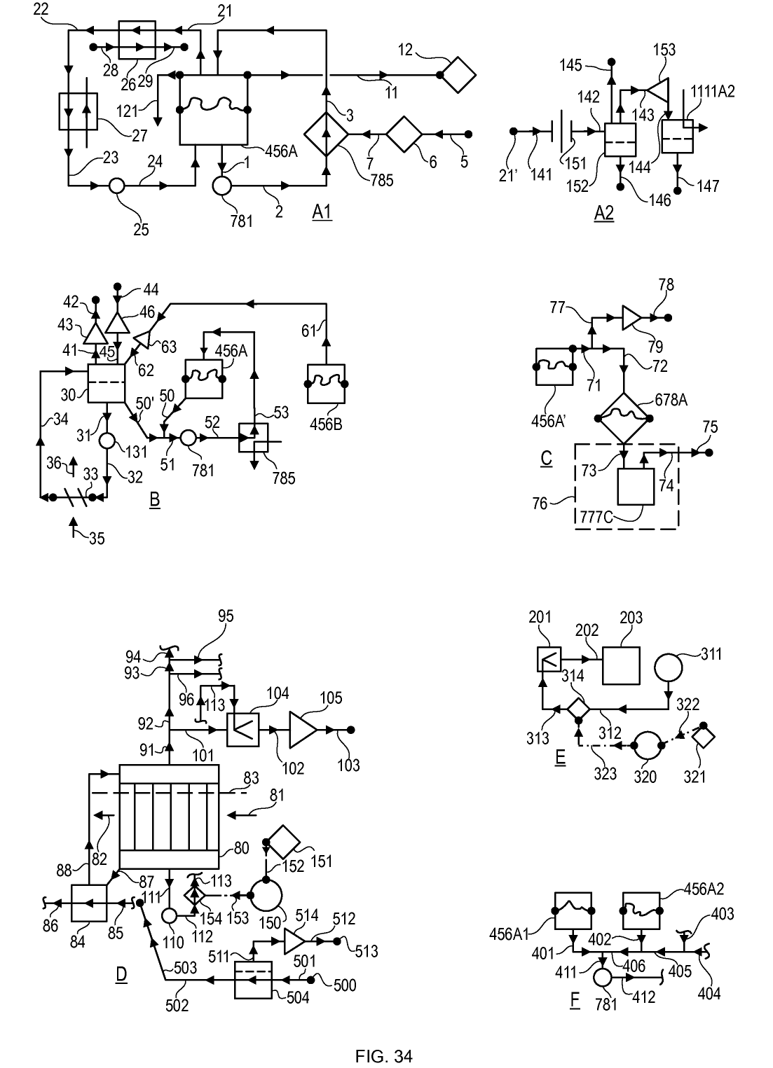

FIG. 34 shows, building blocks as based upon teachings, in detail “A1,” is the energy storage option, by using ambient thermal energy, or bleed stream thermal energy from the parent Rankine cycle. A primary vessel 456A, has the working fluid, say water to a 1..3, a circulator 781, a heat exchanger 785, ambient thermal energy shown symbolically by 5, a heat pump shown symbolically by 6, high grade thermal energy follows shown symbolically by 7 into the heat exchanger 785. A work making phase, a path 11.., to the work making phase sub system shown symbolically by 12. Thus to store and use the energy in the primary vessel 456A. At another time, the fill/constant pressure expulsion phase etc., a path 21..24, a pump 25, a heat exchanger 26, a condensate slip stream fluid stream 28..29 to recover the thermal energy into the parent Rankine cycle condensate fluid stream, via imposing heat capacity matching in heat exchanger 26, to heat rejection to ambient via a heat exchanger 27, to having the primary vessel 456A for the next cycle all over again. During the fill/constant pressure expulsion phase, as an alternate, a fluid stream 121, spent working fluid, is introduced directly, via a pump if needed, into the parent Rankine cycle condensate feed stream, at a point suitable, temperature wise. Thus the hot spent working fluid stream 21, now fluid stream 121 is introduced directly into the parent Rankine cycle condensate feed stream, so that the pump 25 suction line 23 draws water from the parent Rankine cycle condenser hot well. Thus in essence parent Rankine cycle condenser hot well water is the working fluid in the primary vessel 456A for heat addition at constant volume, and the spent working fluid is returned to the condensate feed stream of the parent Rankine cycle, all based upon teachings.

Continuing, in detail “A2,” is to address the large quantity of spent working fluid, fluid stream 21, to be used up by the parent Rankine cycle, so that the spent working fluid follows 141..144, a restriction orifice 151, a tank 152, a turbine 153, a condenser 1111A2, condensate fluid streams 146, 147 to be reintroduced into the parent Rankine cycle, even the condenser. A path 145 is to the parent Rankine cycle turbine train, if the capacity and other design parameters permit. The main objective here is to make low pressure steam via flashing. The flashing can be in multiple pressure stages, depending upon the temperature of fluid stream 21.

Continuing, in detail “B,” a tank 30, a refrigerant say R11, as liquid, for the thermal energy gathering system, using the ambient thermal energy, a path 31..34, a pump 131, ambient air 35..36, ambient thermal energy coming in via finned tubes shown by dots, 32/34 as a path. A path 41..42, via a compressor 43 is the vapor compression as part of the heat pump approach. A path 44..45, a 2phase turbine 46 is the heater drain. The add on sub system, a path 50′.., to a heat addition at constant volume thermodynamic cycle, a path 50..51..52..553, a circulator 781, thermal energy coming in via a heat exchanger 785, ambient thermal energy, or thermal energy from the engine jacket etc., etc. A primary vessel 456A as part of heat addition at constant volume. To the work making phase, another primary vessel 456B, a path 61..62, a 2phase turbine 63. Thus to interrupt the liquid refrigerant, which is part of the ambient thermal energy gathering sub system, and is at the very cold stage, used to make work, via interruption and an add on sub system, a building block, to the main disclosure.

Continuing, in detail “C,” a primary vessel 456A′, that has already gone through the heat addition at constant volume, to the work making phase, a path 71..75, and the main working fluid is a refrigerant that becomes a 2phase spent working fluid, a secondary vessel 678A, an engine 777C, exhaust fluid stream 75. The pressure in fluid stream 72 at the end of the work making phase is below atmospheric, thereby adding the need of a boundary 76, such that in the engine 777C, the pressure below the piston is below atmospheric. Additionally a vapor path 77..78, a compressor 79, works as a heat pump sub system from this approach, when using a refrigerant as an alternate to water in the primary vessel as the working fluid.

Continuing, in detail “D,” an evaporator 80, using a refrigerant, say R11, Isobutane etc., to an ambient air path 81..82, with liquid level in the finned tubes, 83. The refrigerant boils, and becomes vapor. Additionally, a water with glycol, of the main cycle, a path 85..86, a heat exchanger 84, a liquid refrigerant path 87, becoming vapor, partially, the vapor rising in path 88. The refrigerant vapor has parallel compressor paths, a header, parallel paths 91..96. A parallel path to show the sub system, 101..103, an enclosure 104 to make the vapor wet to reduce compressor work, a compressor 105, resulting in the fluid stream 103 as the high grade thermal energy source for the heat addition at constant volume thermodynamic cycle. Thus the main evaporator is used to pre cool the working fluid of the main thermodynamic cycle, fluid stream 86.

Continuing, a pump 110, a liquid refrigerant path 111..113, a regulating valve 154, a controller 150, a plant computer 151, sending signal 152, to generate a signal 153 to position the regulating valve to optimize, (and to minimize the compression work), (optimize) the flow rate of the mist, fluid stream 113.

Continuing, in detail “D,” to further optimize the compression, using the thermal energy of fluid stream 85, that needs to be refrigerated, an upstream path, from a node 500, the cold end fluid stream of the recuperation heat exchanger, a path 501..503, to continue to fluid stream 85, an evaporator 504, to produce refrigerant vapor fluid stream 511, at a higher pressure, to a compression path 511..512, a compressor 514, to a node 513 that is the thermal energy source. Thus compressor work is reduced by generating vapor fluid stream 511 at a higher pressure.

Continuing, in detail “E,” an immediate benefit of the technology is to make Hydrogen to be used in internal combustion engines. An intake manifold 201, air/Hydrogen mixture path 201, internal combustion engine 203. A Hydrogen tank 311, at a suitable pressure to carry on board Hydrogen, to a Hydrogen squirting system, a path 312..313, a controller 320, with an on board computer 321, receiving all the necessary information, internal combustion engine load, make, RPM etc., generating a signal 323 to position the regulating valve 314 to adjust the Hydrogen that is squirted into the intake manifold combustion air. Thus Hydrogen is used to displace some of the gasoline, Diesel use etc., etc. Using teachings, to use natural gas as the supplemental fuel, in the tank 311.

Continuing, in detail “F,” it can be a choice to have very large timing cycles, i.e. vessel cycles say after 30, 40 minutes, a conservative approach as the switching of the functions of the vessels to be minimized. In order to satisfy this need very large vessels, so that for each of three primary vessels, there are several of such vessels 456A1, 456A2.., cluster. Thus a circulator 781 has a common suction line 411, to a discharge line 412. Thus to have a header/individual lines 401..406, i.e. relatively smaller but a multiple of vessels, as cluster.

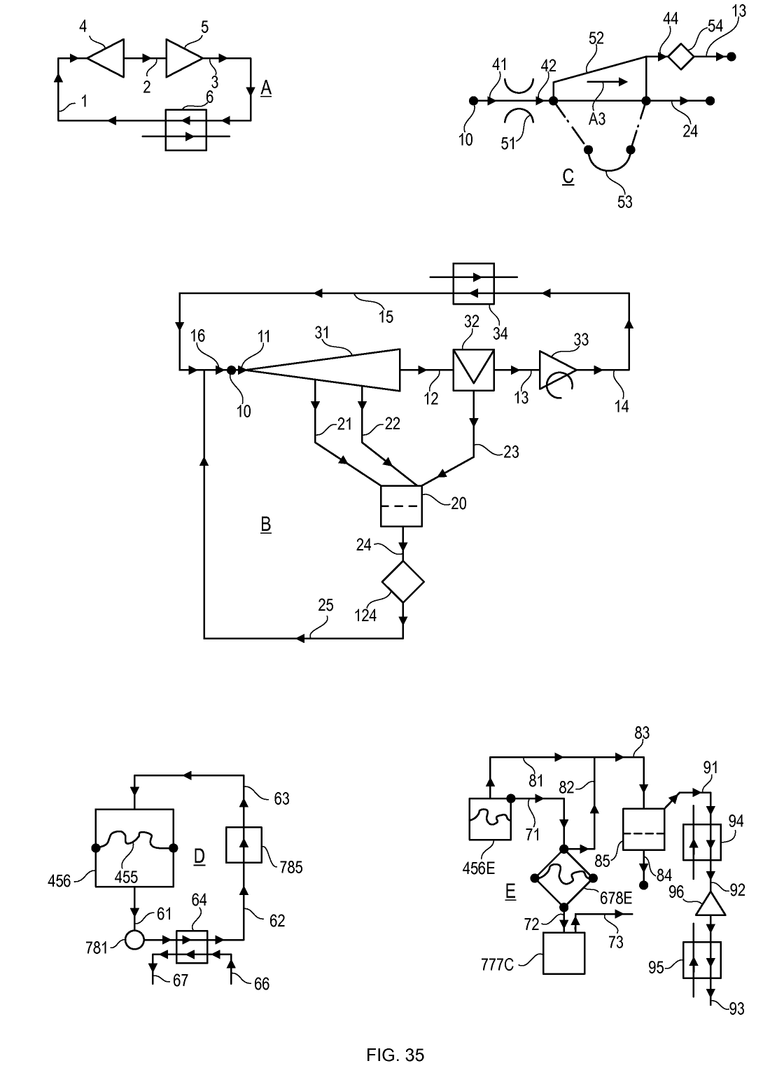

FIG. 35 shows making liquid air, etc., etc. The teachings can be used to make liquid Hydrogen as well. Continuing, in detail “A,” a discussion to build up the case, with say Helium as the working fluid, a path 1..3, an expander 4, a compressor 5, a heat exchanger 6 to bring the fluid stream 3 back to the original temperature of fluid stream 1. In this case there will be net negative work, compressor work minus the turbine work, which equals to the heat loss via heat exchanger 6.

Continuing, in detail “B,” using say Helium, air mixture at node 10, and the thermodynamic loop is path 11..16, an expander 31, a moisture separator 32, a compressor train 33, with inter cooling etc., a heat exchanger 34 to bring temperature of fluid stream 14 back to the starting point. Thus, as the mixture expands, and the air comes out as liquid, paths 21..23, into a tank via appropriate controls, not shown. Thus the latent heat of air gets to do work in the expander 31. Continuing, the liquid air path now follows ..24..25, and 124 represents symbolically, the heat addition at constant volume approach based thermodynamic cycle, (or a Brayton cycle as an option), etc. Thus to make liquid air with minimum of the work penalty, as the sensible heat and the latent heat of air has done work in the expander 31.

Continuing, in detail “C,” as an alternate to the expander 31, a node 10, a path 41..44, a nozzle 51, to get very wet fluid stream 42. An eccentric, slightly expanding cross section, resulting in slight stagnation, a curved path shown symbolically by 53. The liquid working fluid part slips through, a path 24, and the vapor path follows ..44, to complete stagnation shown symbolically by 54, to a fluid stream 13, functionally similar from detail “B,” for recompression.

Continuing, in detail “D,” if the liquid air is used in the primary vessel 456, for heat addition at constant volume approach thermodynamic cycle, a circulator 781, a path 61..63, refrigeration recovery via a heat exchanger 64, a path 66..67. Thus heat is being at added at constant volume, via heat exchangers 64, and 785. To point out the refrigeration available and its recovery as a commodity is a useful thing, and can be used in details “A, B,” above as part of optimization exercise.

Continuing, in detail “E,” the work making phase of the primary vessel 456E, a path 71..72, via a secondary vessel 678E, to an engine 777C, with an exhaust fluid stream 73. To point out that at the end of the work making phase, the spent working fluid, air in this case will be very wet. As part of fill/constant pressure expulsion, paths ..81, ..82, to 83, to a tank 85, with the liquid air fluid stream 84 to be used for fill/constant pressure expulsion of the primary vessels. The air as gas, a path 91..93, with refrigeration recovery via heat exchangers 94, 95, and an expander 96 (if the pressure at fluid stream 91 warrants the pressure recovery into work). Thus the fact that the air at the end of the work making phase will have large liquid component is thus addressed. The plant layout in terms of relative elevations will be such that liquid air push out from primary vessel and the secondary vessel is very effective in terms of complete evacuation of the liquid air, from all the vessels.

FIG. 36 shows, in detail “A,” making thrust, by applying heat addition at constant volume approach, using liquid air, or say liquid Nitrogen as an example. A tank 21, with say liquid air, a tank 22 with water, so that a path 1..6, a pump 7, a heat exchanger 8 for heat addition at constant volume approach, parallel paths such as 9, so that 10 then represents the heat addition at constant volume. To point out alternating parallel paths. Continuing, an extremely high pressure at fluid stream 4, starting with liquid air and applying (to liquid air), ambient heat addition at constant volume approach. Continuing, a nozzle 11 to get extremely high velocity at fluid stream 5, a node 6 which is very cold, though superheated air. To water as the thermal energy source, a path 31..34, header, a pump 30, parallel paths 41..42, nozzles 43..44, etc. Thus very cold temperature air flowing at very high velocity, and then water in fine spray is introduced providing heat in this case. This creates a mixture of water based ice particles, the mixture getting to even higher velocity at node 52, via the heat addition from fine water mist, which, the mixture, then via proper duct design, cross section etc., goes out as fluid stream 152 to make thrust for propulsion.

Continuing, in detail “B,” the fluid streams, and other components with dashed numbers are functionally similar to fluid streams and other components of detail “A.” A fluid stream 2′ has several parallel paths 71, 72 etc., in one of these parallel paths, 75..76, a heat exchanger 8′ with lot of metal, internal and external fins shown by 61, with steel wool stuffed in shown by 62 to effect very efficient heat transfer from the ambient air to liquid air as batched approach.

Thus to get extremely high pressure working fluid in heat exchangers designated as 8′. To path(s) 77..78 via nozzle(s) 11′ from the above discussion. Thus, a cluster of parallel paths as sub systems, to have continuous thrust, using liquid air, making extremely high pressure via heat addition at constant volume, adding water as fine mist etc. as the heat source, all based upon teachings. The water mist is optional, in the above, and is based upon optimization exercise.

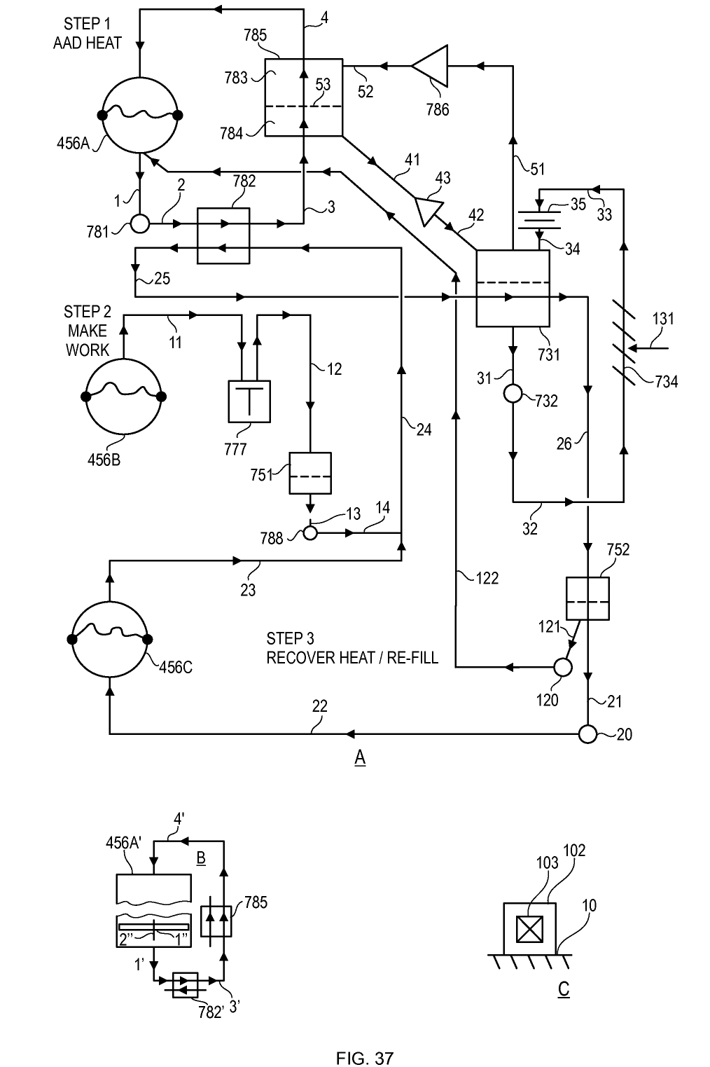

FIG. 37 detail “A,” shows further clarifying the heat addition at constant volume thermodynamic cycle, a primary vessel 456A, with a working fluid path 1..4, a circulator 781, a recuperation heat exchanger 782, main thermal energy heat exchanger 785, a condensing zone 783, drains cooling zone 784. Another primary vessel 456B going through the work making phase, a path 11..12, an engine 777, a tank 751, a pump 788, a spent working fluid path 13..14. Another primary vessel 456C after the work making phase, having spent working fluid, for the fill/constant pressure expulsion phase, a tank 752 with very cold working fluid, a pump 20, a path 21..23, combining with fluid stream 14, to a path ..24..26, thermal energy recovery 24/25 in the recuperation heat exchanger, cooling 25/26 in the heat pump evaporator 731, to very cold working fluid stream 26.

Continuing, for the main, new thermal energy source via a heat pump approach, an evaporator 731, a pump 732, with using the ambient or any other low grade thermal energy shown by 131, coming in via a finned heat exchanger 734, a path 31..34, a restriction orifice 35, so that we make refrigerant liquid to vapor. The vapor compression, a compressor 786, a path 51..52, with saturated liquid surface 53, sub cooled heater drain path 41..42, via a 2phase turbine 43. Thus using thermal energy from the ambient or very low grade thermal energy to produce positive work, TABLES 14, 15, to show the stream conditions. As an additional thermodynamic tool, a pump 120, a pre pressurizing path 121..122, to get very high initial pressure just prior to the start of the heat addition at constant volume phase.

Continuing, detail “B,” the primary vessel 456A′, with an active piston 1″, with a hole 2″ for pressure equalization, to move the working fluid, has the working fluid path 1′..4′, with the recuperation heat exchanger 782′, and the new heat use heat exchanger 785′. Thus the piston itself moves the working fluid around for heat addition at constant volume phase, fill/constant pressure expulsion, via controlled linear movement, based upon teachings.

Continuing, detail “C,” the vessels to be designed using sound engineering practices, such as using close to yield strength, etc. A ground 101, the vessels and the other cycle parts 103, with a large enclosure 102, with no personnel allowed policy to address catastrophic failure, howsoever rare.

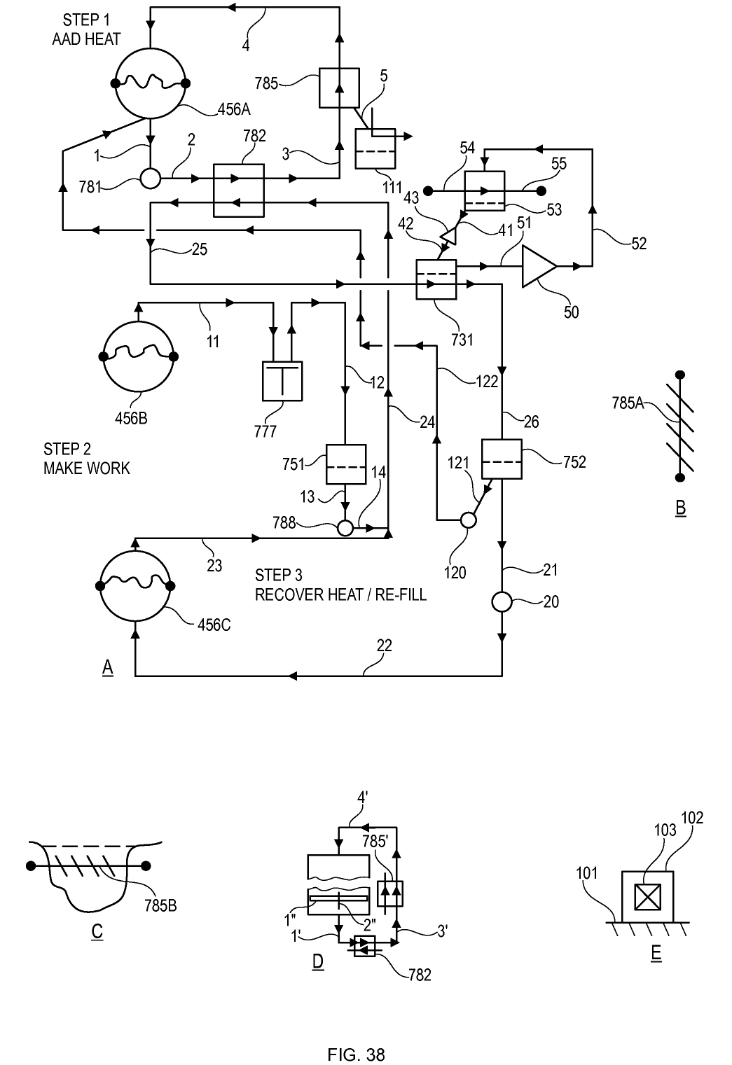

FIG. 38 shows, detail “A,” to use the main, new thermal energy as is, and not via upgrading via a heat pump approach, and to further clarifying the heat addition at constant volume thermodynamic cycle.

In this case, the working fluid prior to the heat addition at constant volume phase is at very low temperature, thereby necessitating the use of a refrigeration sub system for heat rejection, more later. A primary vessel 456A, with a working fluid path 1..4, a circulator 781, a recuperation heat exchanger 782, main thermal energy heat exchanger 785, getting thermal energy via a stem up, condensate down path 5, waste steam thermal energy from a condenser 1111. In detail “B,” the thermal energy can be via finned heat exchanger 785A using ambient thermal energy. In detail “C,” via finned heat exchanger 785B via river water, or any other thermal energy source, key being using it, the thermal energy directly.

Another primary vessel 456B going through the work making phase, a path 11..12, an engine 777, a tank 751, a pump 788, a spent working fluid path 13..14. Another primary vessel 456C after the work making phase, having spent working fluid, for the fill/constant pressure expulsion phase, a tank 752 with very cold working fluid, a pump 20, a path 21..23, combining with fluid stream 14, to a path ..24..26, thermal energy recovery 24/25 in the recuperation heat exchanger, cooling 25/26 in the refrigeration sub system evaporator 731, to very cold working fluid stream 26.

Continuing, for the heat rejection, and cooling of the fluid stream 25 to the starting temperature of fluid stream 1, a refrigeration sub system, an evaporator 731, refrigerant vapor compression a compressor 50, a path 51..52, with a heat exchanger 53, heat rejection to the ambient thermal energy sink path 54..55, or using the thermal energy 52/41 in any part of the main loop 1..4, depending upon the optimization exercise, a saturated heater drain path 41..42, via a 2phase turbine 43.

Thus using thermal energy from the ambient or very low grade thermal energy directly, and not via upgrading via a heat pump approach, to produce positive work.

As an additional thermodynamic tool, a pump 120, a pre pressurizing path 121..122, to get very high initial pressure just prior to the start of the heat addition at constant volume phase.

Continuing, detail “D,” the primary vessel 456′, with an active piston 1″, with a hole 2″ for pressure equalization to move the working fluid, has the working fluid path 1′..4′, with the recuperation heat exchanger 782′, and the new heat use heat exchanger 785′. Thus the piston itself moves the working fluid around for heat addition at constant volume phase, fill/constant pressure expulsion, via controlled linear movement, based upon teachings.

Continuing, detail “E,” the vessels to be designed using sound engineering practices, such as using close to yield strength, etc. A ground 101, the vessels and the other cycle parts 103, with a large enclosure 102, with no personnel allowed policy to address catastrophic failure, howsoever rare. Continuing, in brief, relatively long cylinder(s) (cluster) based vessels, with a piston, a piston rod in tension only, or in tension/compression, to move the piston back and forth, with a stop/realign/restart approach, with an engine with a series of cylinders that either stay open all the time, or open in sequence during the cycle phase, is the cycle as one of the configurations. The rapidity of the piston movement is as based upon optimization exercise. In TABLE 19, order of values as a guideline, number of strokes per hour to be based upon optimization exercise, and other mechanical issues.

Continuing, the cycle, as an option to be used as refrigeration as product as well, if the temperature (s) 3 vs. 4 are low temperature (s) for a chillier heat transport loop to give its thermal energy in heat exchanger 785. The refrigeration mode is shown in TABLE 17, using ISOBUTANE. However water with glycol can be used as well. In such an application of refrigeration as the main objective, the heat exchanger 53 can be disposed in fluid stream 4 to use the thermal energy to make even higher pressure via heat addition at constant volume phase. Thus positive work and refrigeration in this mode.

Continuing, in TABLE 18, using an air temperature of 0 Deg. F. as the thermal energy source, and ISOBUTANE as the primary vessel working fluid and the refrigeration cycle working fluid, there is positive work. The exercise of using ISOBUTANE as the working fluid is undertaken because water and glycol mixture properties for the temperature range needed are not available, to show the cycle proof of concept.

Thus using thermal energy from the ambient or very low grade thermal energy directly, and not via upgrading via a heat pump approach, to produce positive work.

Continuing, the system as an option to be used in the heating mode as well, by using the heat exchanger 53 thermal energy output for space, comfort heat. Additionally, the power produced can be used in a heat pump as well. Thus in winter, heating and power production.

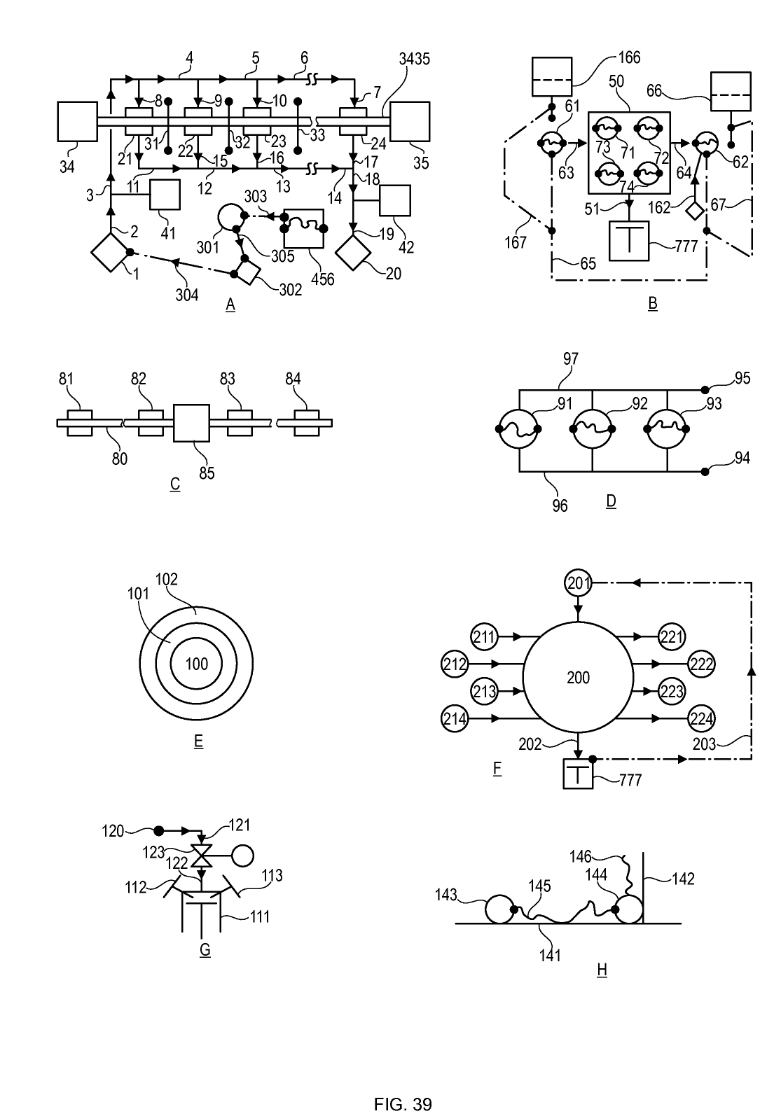

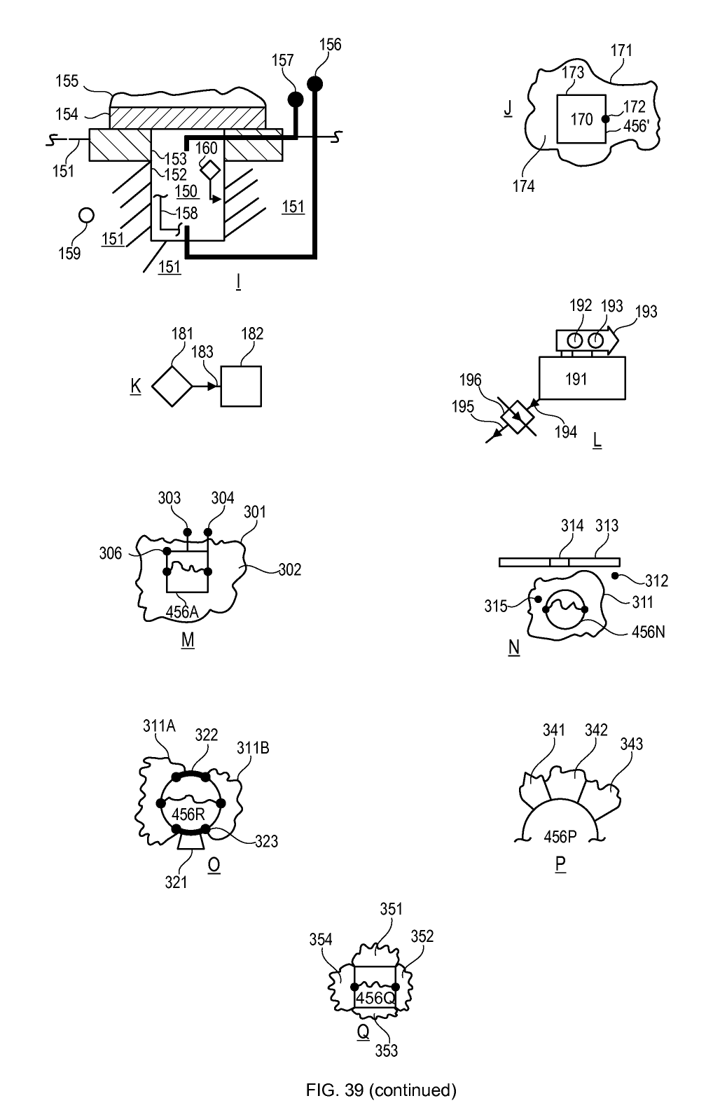

FIG. 39 shows various building blocks to carry out the invention, with detail “A,” to address very large flows, a long shaft 3435, drives such as motors 34, 35, with 1 that represents the controls, primary vessels etc. to commence the working fluid circulation, a path with suction line 2 from a primary vessel, a path ..2..10 to various pumps 21..24, with the discharge lines 11..19, to another sub system 20 into the other side of the primary vessel. As the system can be designed for stop/realign/restart every so often, the sub systems 41, 42 to absorb the working fluid pressure swings and to avoid water hammer. This sub system applies to say heat addition at constant volume phase, and fill/constant pressure expulsion, so that there can be another set of pumps 31..33, with a similar system to for the other working fluid circulation. Thus all this represents that a number of pumps to address very large flow rates, and the water hammer issue. Continuing, a primary vessel 456 with suitable signals 303, pressure, temperature etc., generating similar signals 305 to a controller 301, then eventually to the plant computer 302 to generate signal 304, so that the system stops when the thermodynamic calculations based upon various signals determines that the primary vessel has gone through the entire working fluid being circulated. There is a small cushion of working fluid that can be left from being processed, such as in the heat addition at constant volume phase the system stops just before all the working fluid has been sent from one side of the fabric to the other side, so as to avoid the fabric being sucked to an extent to starve the circulation pumps, as based upon optimization exercise.

Continuing, detail “B,” there is need to make the entire process very flexible, so that there are primary vessels 61, 62 normally running in tandem at least in the heat addition at constant volume phase, fill/constant pressure expulsion, along with a primary vessel in the work making phase. A cluster of primary vessels 71..74 are all available for the work making phase, so that to smooth out the work output, as there is lot of stored energy, running these vessels out of phase etc., and making the vessels come out with spent working fluid. In one scenario, at least two primary vessels can be working in tandem for the heat addition at constant volume phase, fill/constant pressure expulsion. However that can be modified, as the spent working fluid can be evacuated from the vessels very rapidly, and stored in large tank 66, for thermal energy recovery, thereby freeing up the thermodynamic coupling of the heat addition at constant volume phase and fill/constant pressure expulsion. Thus the thermodynamic tying up is shown symbolically by 65, 67, and the primary vessels follow ..63 to the work making phase primary vessels cluster, and exit as ..64 with the spent working fluid from the primary vessel 62 to be used as is or to be evacuated in a hurry into the tank 66. The evacuation can be via conventional, previously disclosed ways, i.e. part of the fill/constant pressure expulsion, or as an alternate using compressed air shown symbolically by 162, i.e. stored, or compressed air via a compressor can be used to push out the spent working fluid. Additionally, to further decouple the three phases, the refrigerated water can be stored in a tank 166, tied via suitable instrumentation, paths, etc. shown symbolically by 167. Thus the main three parts of the overall cycle, heat addition at constant volume phase, work making phase, fill/constant pressure expulsion can all be running independent of each other in a multi vessel scenario, giving enormous design flexibility.

Continuing, detail “C,” a shaft 80, many engines 81..84, spinning a single electric generator 85, so that the many engines have varying power outputs to smooth out the total output.

Continuing, detail “D,” if the vessel size is an issue, using a cluster of vessels 91..93, acting as a single vessel, with headers, lines 96, 97, with outside connections shown by 94, 95. Thus very large vessel diameter is addressed.

Continuing, detail “E,” a composite design for the pressure vessel 100, a metal shell 101, say using Aluminum, a reinforcement 102 using say Carbon fiber, Fiberglass etc., to address the tensile strength design requirements.

Continuing, detail “F,” has the heat addition at constant volume approach cycle 200, with thermal energy coming in options, i.e. heat supplied options, 211 condenser waste thermal energy, 212 lower bleed streams in a regenerative manner, 213 ambient thermal energy, 214 any suitable thermal energy source elevated via the heat pump approach. The heat rejected options, from the cold side of the recuperation heat exchanger, to restore the temperature of the spent working fluid exhaust fluid stream to the start temperature of the heat addition at constant volume phase, options are, 211 conventional way cooling using ambient as the thermal energy sink, 222 into the evaporator of the heat pump, if heat pump is an option in the heat supplied option, 223 flashing, when the cycle working fluid is a refrigerant, so that to get a 2phase spent working fluid, and to then recompress the vapor part for converting back to liquid via condensation using a suitable heat sink, 224 a dedicated refrigeration cycle when the start temperature for heat addition at constant volume phase is very low. The work output follows 202, with the engine 777, with a part of the work output that follows shown symbolically by 203, to 201 that is one or more uses, various pumps, circulator etc., and big use as in a heat pump approach for the heat supplied option, a dedicated refrigeration cycle in the heat rejected option.

Continuing, detail “G,” shows a cylinder 111, intake, exhaust valves 112, 113, with the pressurized working fluid 120, a path 121..122 via an on/off valve 123, path open during which the cylinder is activated.

The intake valve timing is such that it remains open during the piston entire downward stroke, and based upon the slight expansion of the working fluid available, the intake valve to close ever so slightly before the bottom dead center, so that the working fluid expansion does some work, before the exhaust valve opens, very slightly before the bottom dead center, as the exhaust stroke starts. Thus a slight amount of work available based upon the ability of the working fluid expansion, slight non-compressibility, is addressed, though the major amount of work is via direct use of the working fluid pressure. Continuing, to look it another way to be clear, say that at start the working fluid pressure is 7K psi, the cylinder has 100 inches long stroke, so that the very first stroke will have say 1.5 inches left in the working fluid as its own expansion, i.e. expansion ratio based upon certain non-compressibility as based upon the stream properties. Thus the intake valve will need to close when the cylinder still has 1.5 inches of travel left. It is also to be understood that as more and more work is extracted, this 1.5 inches of expansion potential will become less and less. There can be variable intake valve closing time, based upon the complexity vs. the gains to be expected. The exhaust valve will need to open prior to any upward movement of the piston.

Continuing, detail “H,” shows dirt, ground, base, sides 141, 142, with structural steel 143, 144, say piping, round cross section type of construction, with very loose liners of suitable fabric, 145, 146 to push against the dirt, and over time dirt settling down to make the pressure boundary.

Continuing, detail “I,” shows the primary vessel to be below ground, shown symbolically by 150, with soil, ground at various locations, shown by 151, with a sub system 160 that can be the use of suitable chemicals, bonding materials to be injected in to the face of the soil walls, ground etc. to get suitable consistency, etc. First as an option, plies, structural steel components 159 are hammered into the ground, in a pattern suitable for final vessel contour, dimensions. Then a large cavity 152 is dug out, with an internal liner 158, with a hole for pressure equalization. The soil based surfaces with structures now exposed are then put through the next step of closing up of the openings using suitable, very loose fabric, per detail “H.” Thus a large part of the vessel, sides, and the bottom are configured, constructed this way. The top opening has a very large reinforced concrete slab 153, with a cover 154, reinforced concrete or any other structure, with a load, weight using soil, shown by 155. The working fluid lines 156, 157 are shown in dark. Thus a large cavity, below ground with the three sides using loose fabric as the pressure communicating surface, with a cover construction, reducing the overall cost of a large primary vessel.

Continuing, detail “J,” shows the use of abandoned structures, such as bunkers, abandoned mines, tunnels etc. 171, filled with water 174, that can be used for the external pressure, after testing for integrity, and undertaking repairs etc. for pressure integrity. The actual primary vessel (s) 170, fabric, not shown, for the actual thermodynamic cycle, using heat addition at constant volume approach. There is a very small hole 172 to equalize the pressure, or using a flexible material barrier, disclosed elsewhere to equalize the pressure, so that the pressure wall 173 for the primary vessel is only a barrier, enough to be strong structurally, i.e. with very small differential pressure.

Continuing, detail “K,” shows a power making system 181, making current, i.e. electric production, 183 for “I” squared “R” heating, say melting steel scrap, thereby not worrying about the load changing, as the work making phase can be very short, as long as we thrust the electric energy to produce heat, with even varying intensity.

Continuing, detail “L,” an internal combustion engine 191, carrying compressed Hydrogen in say Scuba diving gear type of cylinders 192, 193, at pressure, to be squirted into the intake manifold to reduce gasoline etc. use, with the exhaust path 194..195, liquid coming out via condensation, via a heat exchanger 196 to condense out water vapor, as an option. The water as liquid can be discharged or collected on board to be discarded under controlled circumstances.

Continuing, detail “M,” shows a primary vessel 456A, with a pressure equalizing, hole 306, on either side of the fabric, preferably on the cold side, or other pressure equalizing means, via a barrier, disclosed elsewhere, with some of the working fluid related lines 303, 304, with a balloon 301 to be constructed in a factory, and in place, to communicate the working fluid pressure to soil which is in a large cavity in the ground, underground, or above ground, manmade large soil mountain burying the primary vessels, so that the pressure is eventually transferred to the soil.

Continuing, detail “N,” shows a primary vessel 456N, a metal shell, with pressure equalizing, not shown, a body of water 315, a fabric balloon 311, with a sand medium 312, or any other artificially made granular packing material, etc., etc. to communicate pressure to the walls, bottom of the very large cavity in the ground, a cover 313, with a manhole 314 to fill all the cavity with sand as balloon, primary vessel is filled with liquid. Thus before pressurizing the entire system, the system is checked for integrity, system continuity to transfer pressure, first at atmospheric pressure, so that the pressure is communicated from the primary vessel to the liquid body 315 to the fabric balloon 311, to the sand and ultimately to the soil, cavity walls, cover plate, etc., based upon teachings.

Continuing, detail “O,” shows the primary vessel 456R, with the very thick wall etc., 322, 323 to satisfy the calculated stresses, with two balloons 311A, 311B, instead of a large single balloon. This option to be reviewed in conjunction with other similar ways to contain pressure is to address the challenge in wrapping very large primary vessels in a single balloon.

Continuing, detail “P,” shows a primary vessel 456P, with multi balloon option, balloons 341..343, with appropriate structural metal, steel construction, and with appropriate holes, not shown, for pressure equalization. Thus a very large primary vessel with multi balloon option, the primary vessel pressure transfer to the body of water to sand to the large cavity walls, transfer of pressure, all based upon teachings.

Continuing, detail “Q,” shows a cylindrical primary vessel 456Q, with balloons 351..354 shown, using teachings, for pressure transmission etc. The cylindrical primary vessel can have a large pillow cover type of very large sleeve to be slipped over etc., all based upon teachings.

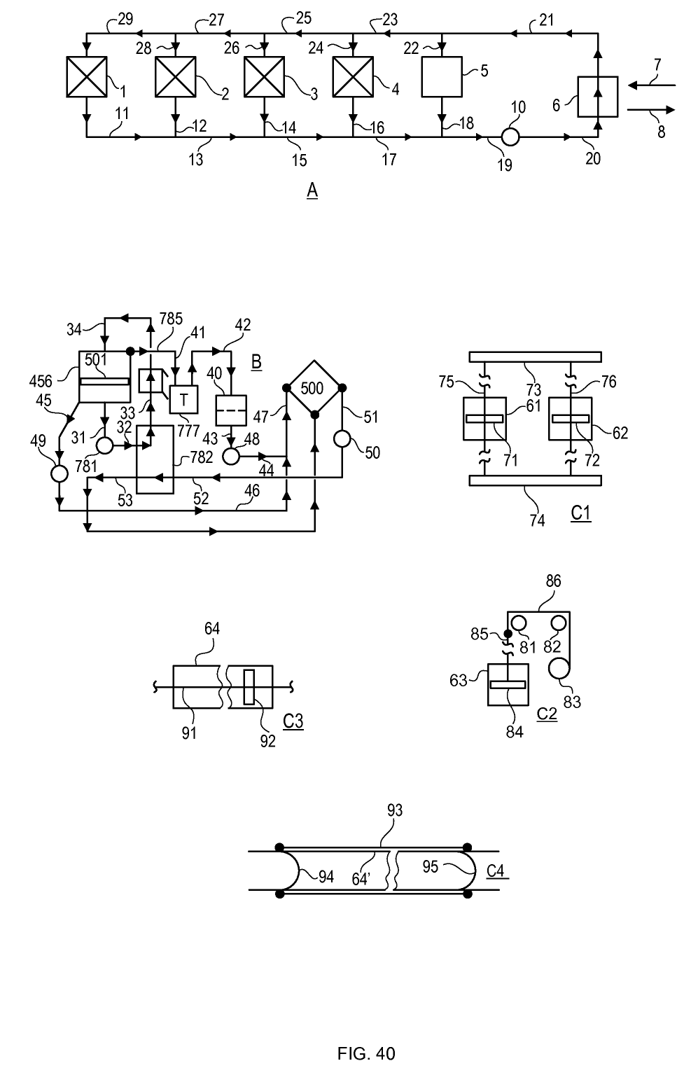

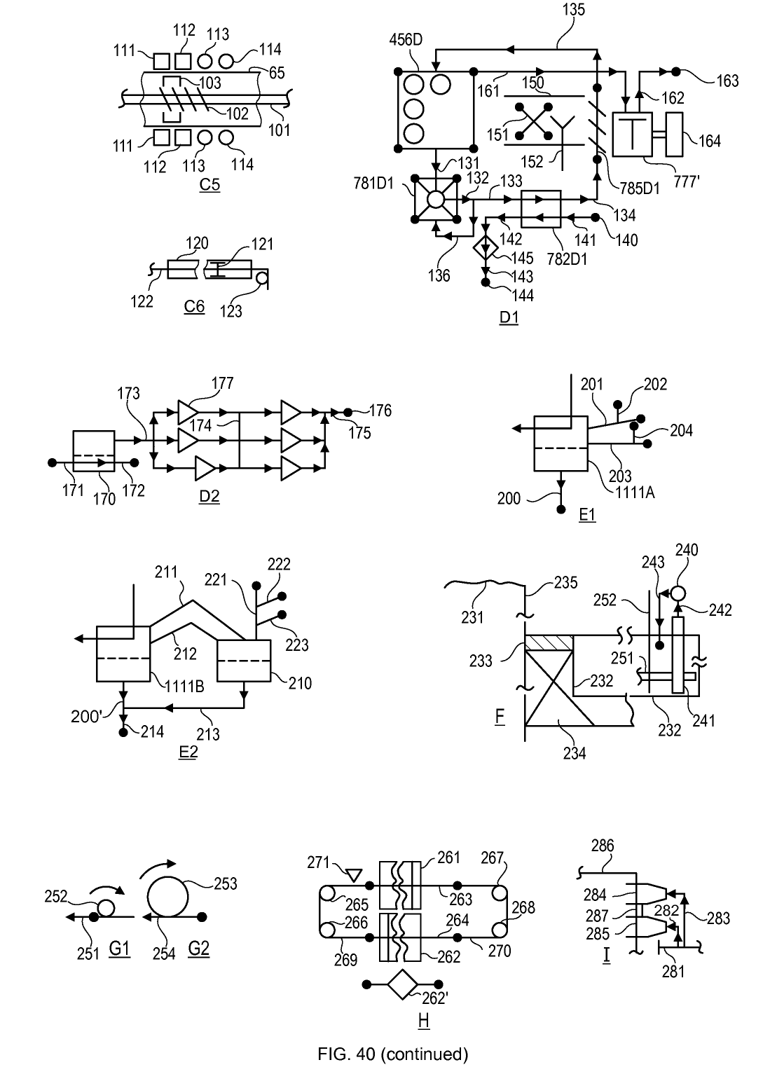

FIG. 40 shows more building blocks to carry out the invention, as in detail “A,” for storing of working fluid, hot, or cold, and to reduce the tank capacity needed. Continuing, tanks 1..5, with tanks full 1..4, and an empty tank 5, with the heat exchanger 6 with thermal energy directions 7, 8, i.e. thermal energy being used, or being imparted to the working fluid stream 20, as the case may be, with working fluid streams 11..20, with a circulating, working fluid transfer pump 10. Thus working fluid is drawn from one tank at a time, and discharged after being heated or cooled, into the empty tank, thus freeing up a tank at a time. This continues till all the tanks have working fluid heated, or cooled, as the case may be, or only part of the working fluid inventory heated or cooled as based upon needs of the thermodynamic cycle.

Continuing, detail “B,” shows the energy storage approach, with a very large primary vessel 456, with the working fluid path 31..34, at low load, via a recuperation heat exchanger 782, new heat based heat exchanger 785 using lower bleed streams in a regenerative manner. The work making phase via an engine 777 follows 41..42 into a tank 40, with the hot working fluid transfer step, path 43..44 via a pump 48, and another hot working fluid path the spent working fluid path 45..46, via a pump 49, to a common path fluid stream 47 to the tanks 500, using teachings of detail “A.” For the thermal energy recovery phase, a pump 50, a path 51..53 back to the tanks, to have now cooled water for the fill phase. There can be further cooling using a heat exchanger, not shown, in the fill phase part of the optimization exercise, if the ambient temperature goes down, using ambient as the heat sink etc., with pre pressurizing as another thermodynamic tool.

Continuing, detail “C1,” with a cluster of vessels, 61, 62, with pistons 71, 72, with the rods, or cables 75, 76, so that the structures 73, 74 form the cluster, thereby moving the pistons up and down, via pull in either direction.

Continuing, detail “C2,” has the vessel 63, piston 84, with a cable/rod path 85..86, with the direction change pulleys 81, 82, with a drive mechanism 83 to move the piston up, a similar arrangement, not shown, to move the piston down, etc.

Continuing, detail “C3,” shows the vessel 64, piston rod 91, piston 92 to point out the cylinder configuration to be horizontal.

Continuing, detail “C4,” shows a cylinder 64′, with the end covers 94, 95, convex or concave, with a fiber wrap 93 to reduce the cylinder wall thickness, with the wrap boundaries shown by dots, with the overhang of the cylinder part, past the pressure boundary, so that the wrap augments the pressure containment, the overhang shown exaggerated, say the metal part.

Continuing, detail “C5,” shows a cylinder 65, with a shaft 101, with the use of a screw 102 for effecting the linear motion of the piston 103, with a hole for pressure equalization. To augment the cylinder wall thickness for pressure containment, rings 111, 112, say flat cross sections, 113, 114 say round cross section, or any other cross section, are shrunk over, by heating the rings first, rings sized suitably, rings slipped over the cylinder, and the rings are shrunk over the cylinder by getting cooled. The spacing of the rings is based upon optimization exercise.

Continuing, detail “C6,” shows a cylinder 120, a piston with a pin hole 121, a fishing line 122, with a motorized, controlled fishing reel 123 to pull the piston.

Continuing, detail “D1,” shows some features to have a demonstration plant, using components available in the market place, with minimum of changes, so that a cluster of cylinders, making a primary vessel 456D1, with a circulator 781D1, with a pump available in the market place, anchored inside an enclosure, with a pressure equalizing line 136, so that the pressure inside the pump casing is the same as the pressure outside the pump casing. The working fluid path for heat addition at constant volume phase, 131..135, recuperation heat exchanger 782D1, heat exchanger 785D1, a duct 150, a fan 151, supplementary firing 152 to get certain temperature in this heat source, i.e. hot air flowing over the heat exchanger 785D1. The work making phase path 161..162, an engine 777′ say a single cylinder for simplicity, with a flywheel 164. The thermal energy recovery part, a node 140 the hot spent working fluid, a path 141..143, to a node 144, refrigerated working fluid, the commercially available refrigeration cycle shown symbolically by 145. Thus with minimum of development cost, a 2, 5 MWe demonstration plant is disclosed.

Continuing, detail “D2,” another option for a demonstration plant for the thermal energy source, pressurized refrigerant, node 176, an evaporator 170, with the spent working fluid 171..172 being cooled in the evaporator, other sub system related to the evaporator, ambient thermal energy coming in etc., not shown, then refrigerant vapor compression path 173..175, (not all the fluid streams are numbered, a pressure equalizing line 174, compressors 177, not all are numbered), for the compression of the refrigerant of this heat pump approach. Thus the commercially available compressors are used in clusters, parallel, series paths to get the desired design conditions for the pressurized refrigerant, node 176.

Continuing, detail “E1,” shows a condenser 1111A, hot well liquid path 200, and using the condenser steam waste thermal energy, at as is pressure, or elevated pressure in an as is retrofit by raising the exhaust pressure by deigning the steam condensation at permitted back pressure of the existing steam turbine, or by removing certain last rows of turbine blades, so that the condenser steam, or any other working fluid based vapor at elevated pressure is the thermal energy source. In a retrofit, there is the need to get the steam out of the building, via many lines, 201, 203, constantly sloping towards the condenser, to avoid low point drains, steam going up, condensate flowing back, with branches 202, 204 to the add on heat addition at constant volume approach based thermodynamic. The point is that there will be several such lines from the condenser, snaking out of the building, to provide the necessary cross section to communicate steam, all lines sloping towards the condenser, continuously.

Continuing, detail “E2,” shows a condenser 1111B, with hot well liquid path 200′..214, with steam lines 211, 212, sloping up, and then down as shown, to avoid the need of low point drains, to another hot well 210, that then communicates steam via lines such as 221, with various branches etc., to the heat addition at constant volume approach based thermodynamic cycle, with the liquid communicating via a line 213.

Continuing, detail “F,” shows a ground 231, then a cavity, very deep, with the primary vessel 232, with a very strong cover, in part, 233, to support the bladder/balloon upward pressure, with the space shown by 234 to communicate pressure via bladders/balloons etc. disclosed elsewhere, approach. The idea is to have the pressure vessel way down so that the existing ground part 235 is deep enough to withstand the pressure, thus getting free pressure vessel wall thickness, using relatively thin wall thickness, for the sides and the bottom part of the pressure vessel, key being very deep location of the pressure vessel. Continuing, for very large energy storage projects, a circulator pump 240, with a suction line 241, all the way down to the bottom of the vessel, a working fluid path 241..243, for heat addition at constant volume phase, discharging above the piston 251, with controlled up and down movement using a screw 252 type of approach for linear motion, etc., all based upon teachings.

Continuing, detail “G1, G2” to amplify linear motion 251, turns a small gear 252, that turns another much larger gear 253, on the same shaft, that in turn produces much larger linear motion 254. The first linear motion 251 is via a hydraulic cylinder approach, a cam based linear motion, etc. The amplified linear motion pulls the cluster of cylinders, etc.

Continuing, detail “H,” a very long primary vessel cylinder 261, and a longer hydraulic cylinder 262, working via pressurized oil, say, the power source to move the piston in cylinder 261, piston rods 263, 264, direction change rollers, or sprockets when using chains, 265..268, support rollers for long cables or chains, not shown, cables, or chains 269, 270 as shown. Thus one drive via hydraulic cylinder 262, moving back and forth moves the piston of the working cylinder back and forth, and the system configuration in its simplest form is configured such that all the piston rods are in tension, when transmitting forces. A series of position signals for the position of the piston in cylinder 261 such as 271 to transmit the position of the piston in cylinder 261 is to stop the relevant motion of the hydraulic cylinder, when the piston in cylinder 261 has reached the end of its travel. The system is then reconfigured etc., etc., to carry out the thermodynamic cycle, via the plant computer. As based upon teachings, the hydraulic cylinder based linear motion can be substituted by any other technological application, such as a linear motor 262′, etc., etc., with the objective of the piston of the primary vessel to be moved back and forth in a controlled manner. As based upon teachings, there can be a linear motion sub system on each end of the primary vessel, pulling the piston, ensuring piston rod under load to be in tension, for a back and forth motion, or a single such activation sub system, for pull, push of the primary vessel piston, i.e. back and forth motion.

Continuing, detail “I,” for the recuperation heat exchanger and other heat exchangers the very high tube side pressure has a header 281, which feeds smaller tube sheets 284, 285, and the very large tube sheet 287 to accommodate a large number of smaller tube sheets, with a shell 286. Thus when the shell side thickness is manageable, and the tube side thickness becomes too thick, multi tube sheets, 284 . . . , in a single tube sheet 287, fed via a working fluid header 281, is disclosed.

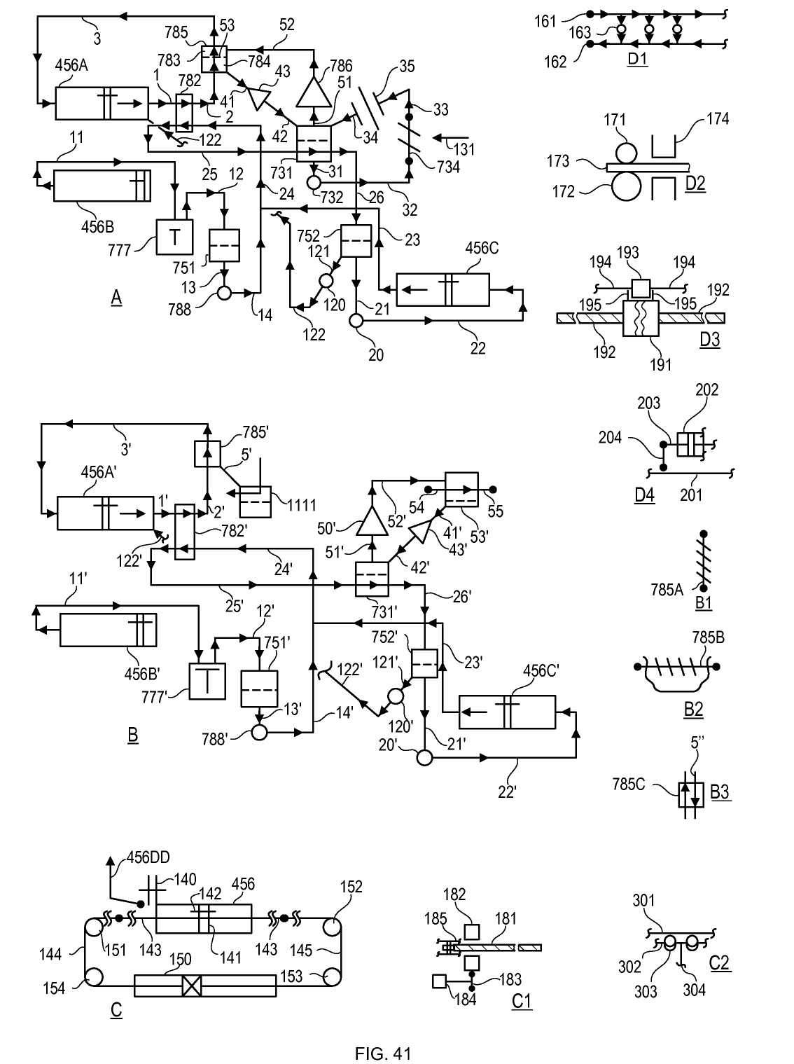

FIG. 41 detail “A,” shows the heat addition at constant volume thermodynamic cycle, with the piston travel directions, shown in various cylinders, acting as primary vessels. A primary vessel 456A, with a working fluid path 1..34, a recuperation heat exchanger 782, a main thermal energy heat exchanger 785, a condensing zone 783, drains cooling zone 784. Another primary vessel 456B going through the work making phase, after having gone through the heat addition at constant volume phase, a path 11..12, an engine 777, a tank 751, a pump 788, a spent working fluid path 13..14. Another primary vessel 456C after the work making phase, having spent working fluid, for the fill/constant pressure expulsion phase, a tank 752 with very cold working fluid, a pump 20, a path 21..23, combining with fluid stream 14, to a path ..24..26, thermal energy recovery 24/25 in the recuperation heat exchanger 782, cooling 25/26 in the evaporator 731 of the heat pump sub system, to very cold working fluid stream 26. Continuing, for the main, new thermal energy source via a heat pump approach, an evaporator 731, a pump 732, for using the ambient thermal energy or any other low grade thermal energy source, shown by 131, coming into the thermodynamic cycle, via a finned heat exchanger 734, a path 31..34, a restriction orifice 35, to make refrigerant liquid fluid stream 32 to a liquid vapor mixture fluid stream 34 via flashing. The refrigerant vapor compression follows, a compressor 786, a path 51..52, with saturated liquid surface 53, sub cooled heater drain path 41..42, via a 2phase turbine 43. Thus using thermal energy from the ambient or very low grade thermal energy to produce positive work. TABLES 14, 15, show the stream conditions. As an additional thermodynamic tool, a pump 120, a pre pressurizing sub system, a path 121..122, to get very high initial pressure just prior to the start of the heat addition at constant volume phase in the cylinder, i.e. primary vessels 456's.

Continuing, detail “B,” is using the main or new thermal energy as is, and not via upgrading via a heat pump approach, (for the heat addition at constant volume thermodynamic cycle). In this case, the working fluid prior to the heat addition at constant volume phase is at very low temperature, thereby necessitating the use of a refrigeration sub system for heat rejection, more later. A primary vessel 456A′, with a working fluid path 1′..3′, a recuperation heat exchanger 782′, main thermal energy heat exchanger 785′, receiving the thermal energy via a steam up, condensate down path 5′, i.e. waste steam thermal energy from a condenser 1111.

In detail “B1,” the thermal energy is via a finned heat exchanger 785A, bringing in ambient thermal energy. In detail “B2,” via a finned heat exchanger 785B via thermal energy from the river water, ground water etc. In detail “B3,” the heat exchanger 785C, disposed in the fluid stream 2′, a fluid stream 5″ is the warmer water, part of the chilled water loop, from a building cooling system; so that the this cycle produces chilled water via the low grade thermal energy use in fluid stream 2′/3′, i.e. in addition to making work, by suitably designing for the needs of a building cooling system, a system that produces building comfort cooling and power is disclosed. The un-upgraded thermal energy can be any other thermal energy source, key being using it, the thermal energy, directly. Another primary vessel 456B′ going through the work making phase, after having gone through the heat addition at constant volume phase, to make pressure, a path 11′..12′, an engine 777′, a tank 751′, a pump 788′, a spent working fluid path 13′..14′. Another primary vessel 456C′ after the work making phase, having spent working fluid, for the fill/constant pressure expulsion phase, a tank 752′ with very cold working fluid, a pump 20′, a path 21′..23′, combining with fluid stream 14′, to a path ..24′..26′, thermal energy recovery 24′/25′ in the recuperation heat exchanger 782′, cooling 25′/26′ in the refrigeration sub system, evaporator 731′, to a very cold working fluid stream 26′, same temperature as the fluid stream 1′ at the start of the heat addition at constant volume phase. Continuing, for the heat rejection, and cooling of the fluid stream 25′ to get to the starting temperature of fluid stream 1′, a refrigeration sub system, has an evaporator 731′, for the refrigerant vapor compression, a compressor 50′, a path 51′..52′, with a heat exchanger 53′, for heat rejection to the ambient, thermal energy sink path 54..55, or using the thermal energy 52′/41′ the latent heat of the refrigerant of the refrigeration sub system, in any part of the main loop 1′..3′, in series, parallel, etc., to the main thermal energy heat exchanger 785′, depending upon the optimization exercise. Continuing, a saturated refrigerant heater drain path 41′..42′, via a 2phase turbine 43′. Thus using thermal energy from the ambient or very low grade thermal energy directly, and not via upgrading via a heat pump approach, to produce positive work. As an additional thermodynamic tool, a pump 120′, a pre pressurizing path 121′..122′, to get very high initial pressure just prior to the start of the heat addition at constant volume phase. Continuing, the cycle can be used for refrigeration as product as well, if the temperature of fluid stream 3′ is very low i.e. heat exchanger 785′ is for a chillier heat transport loop, to give its thermal energy (in heat exchanger 785′), i.e. fluid stream 5″, the thermal energy source. The refrigeration mode is shown in TABLE 17, using ISOBUTANE. However water with glycol can be used as well. In such an application of refrigeration as the main objective, the heat exchanger 785C, detail “B3,” to be disposed in fluid stream 2′/3′ to use the thermal energy for heat addition at constant volume phase. Thus positive work and refrigeration are the products in this mode. Continuing, in TABLE 18, using an air temperature of 0 Deg. F. as the thermal energy source, and ISOBUTANE as the primary vessel working fluid and the working fluid for the refrigeration cycle ..51′.., etc., for heat rejection, 25′/26′, there is positive work. The exercise of using ISOBUTANE as the working fluid for very cold ambient temperature application, is undertaken because water and glycol mixture properties for the temperature range needed are not available, and is thus to show for the cycle as proof of concept. Thus using thermal energy from the ambient or very low grade thermal energy directly, and not via upgrading via a heat pump approach, to produce positive work.

Continuing, detail “C,” the primary vessel 456, the piston 141, which is designed, constructed in a structural sense using very light weight materials, to minimize its weight, thus facilitating the linear motion, piston with a very small hole 142 for pressure equalization, with 140 as the flanged cover for maintenance, with curved, concave, convex, or preferably flat heads, flat head option to minimize the clearance volume. Continuing, to address the issue of piston weight to be dragged along the cylinder walls, 456DDD is to point out that a vertical cylinder configuration is an option, for system, design optimization exercise. Continuing, the piston rods 143, with a chain, or cable 144, 145, with direction changing rollers 151..154, sprockets, etc., when using chain, for long cable, chain, support rollers, sprockets, not shown. Continuing, a linear motor 150, (or say linear motion via long hydraulic cylinders, keeping its piston rod in tension), to provide for very long stroke for the primary vessel 456 which is a cylinder. The linear motion, or the strokes are designed, for back and forth motion, so that for very long stroke, the piston rods when under load are in tension, thereby avoiding the buckling due to load in compression, i.e. relatively small diameter piston rods.

Continuing, detail “C1,” a very long, structurally strong screw type of rod, with a very strong nut, a suitable gear ratio type of gear 183, with a motor 184, to transform the rotational motor movement into linear motion, with guide, etc. 185 to prevent rotation of threaded shaft 181, all this in turn makes the piston 141, detail “C,” to go back and forth. As an alternate, the threaded shaft 181 is rotated, and the nut 182 thus has the linear motion for the purpose of making the piston 141 of detail “C,” move back and forth. Thus based upon teachings, and optimization exercise, one of a suitable means to produce the cylinder 456 strokes. This type of screw based linear motion can be applied in a number of configurations, to create strokes in the cylinder, primary vessel of detail “C,” such as, a similar dedicated sub system, on each end to pull the rods 143, or such system within the cylinder, so that the piston has a nut type of core that travels on the screw inside of the cylinder, etc., etc.

Continuing, detail “C2,” bottom right hand side, the cylinder wall 301, has relatively long, longitudinal, round plate structure 302, part of the piston, long along the axis of the cylinder, supporting the actual piston, dam, 304, with multiple of sealing rings 303 . . . , in the recesses, so that due to the very large diameter of the cylinder, and piston, when applicable has the piston when pulled, with sufficient support, to stay symmetrical, etc., etc., based upon teachings.

Continuing, detail “D1,” on top right hand side, the working fluid inlet/outlet 161/162, with headers, and cam, very small, or open, close solenoid valves etc., 163, the system to provide for being able to use small flow, diameter, open, close options, i.e. using a header, and several parallel paths with multiple of cam operated, or other valves.

Continuing, detail “D2,” the wheels 171, 172 for activating the cams, showing different diameter wheels, can be equal size wheels, the linear motion using a quick acting linear motor 174, engaging the teeth on the wheels, with the teeth on the linear motion part 173. Thus all the various fluid stream lines for the realignment of the overall system are routed to a common location, for the open, close of various lines, to realign the system. The system can be at relatively very rapid linear motion of the pistons in the primary vessels, and at the end of the stroke, a very brief stop, very rapid system realignment, and then the very rapid restart of the next cycle, i.e. the piston stroke. Thus the overall cycle will look, feel like a continuous thermodynamic cycle, using heat addition at constant volume approach. Continuing, therefore, the cylinder as the primary vessel with very rapid piston movement processes very large flow rates for the heat addition at constant volume approach thermodynamic cycle. As the pressure goes up to 7K, 10K psi, as based upon optimization exercise the piping systems to be designed for very large fluid velocities, for economic reasons. However the heat exchangers and other systems will need to be designed for conventional velocities.

Continuing, detail “D3,” part of a single structure, very robust carriages 191, very long, with three separate channels, for each cylinder, 191 moving left to right, three, each channel serving each cylinder, with back and forth linear motion capability, say using a screw approach, very rugged screwed shaft 192 giving back and forth linear motion, per detail “C1.” This linear motion to be via any other means, such as linear electric motor, hydraulic cylinders, etc. A catch, not catch block 193, one such for each cylinder, into the paper, thus gets the linear motion back and forth, with cables, chains 194 etc., to thus move the pistons back and forth. The block 193 gets attached to the block 191 via catch on mechanism 195, that will thus slide along the length of block 191, so that the three pistons are capable of moving back and forth in any order, left to right, right to left, or stay stationary for the work making phase, by how the blocks 193's for each cylinder, and block 191 are connected. Thus a single sub system for serving the three cylinders for the three phases of the cycle is disclosed. Thus there can be changes as based upon teachings, so that the structure catches block 193, to facilitate the motion of each of the pistons, left to right, right to left, or left behind for work making phase, to be caught in the next go around, etc., etc. The teachings can be used for the cylinder in a vertical configuration.

Continuing, detail “D4,” a channel 201, part of the large structure that moves linearly, say left to right, back and forth, using a common linear motion sub system, a cylinder 202, one of the three or more cylinders, piston rod 203, with a structure 204 that gets caught by the channel in motion, with slight pause at the end of each stroke. Thus each of the pistons can be moved left to right, right to left, or remain in place for the work making phase, thereby using a single linear motion sub system, all based upon teachings.

Continuing, detail “D5,” shown on FIG. 28, the three, (or more cylinders), 456A, 456B, 456C, spread farther apart, for large diameter design, has a very rugged structure 210 that moves linearly, in and out of the paper, catching, not catching, very rugged arms 221..223, that pulls, for piston rods to be always in tension to avoid very large piston rod design, the arms being caught, not caught by the grab mechanism in the three, (or more) channels 211..213, that move linearly in and out of the paper as part of the other very rugged structure 210. Thus the thermodynamic cycle is carried out by this additional disclosure for the piston movements, and remaining stationary for the work making phase, etc., etc., all based upon teachings.

Continuing, detail “D6,” shown on FIG. 28, the three, (or more) channels 211′..213′, attached to a structure 210′, have another very rugged structure 230, connected to a very rugged nut 233 with internal, female threads, with a shaft 231 with compatible threads, using a drive 232 to turn the shaft 231. This in turn imparts linear motion to the whole structure via the nut 233, back and forth movement of the channels, catching, not catching, part of the disclosure from before, thus facilitating implementation of the thermodynamic cycle.

Continuing, the back and forth linear motion of the structure 230 (into the paper) is via a carriage 241, driven by electric motors, not shown, carriage wheels 242, railing(s) 243, for the implementation of the thermodynamic cycle.

Continuing, detail “D7,” shown on FIG. 28, the linear motion back and forth (into the paper) has the structure part 233, with teeth 251 at the bottom, and a wheel 252 with similar teeth, 251, engaged, the wheel driven/turned by an electric motor, or other suitable means, not shown, thus resulting in the required linear motion.

Continuing, detail “D8,” shown on FIG. 28, top right hand side, a very long cylinder 261, piston 262, a very small hole 263 for pressure equalization, has the piston pulled using a chain 264, around a motor driven sprocket, the motor enclosed in a housing as part of the cylinder, or external to the cylinder, the chain in tension, with a deep vertical part of the housing 266 to accommodate the chain moving up and down. The similar system on the other side of the cylinder, for linear, back and forth piston movement. Continuing, a pump 270, a path 271..272, to the other side of the piston to address the stagnant working fluid in the housing 266, as an option, or other similar arrangement, as based upon teachings.

Continuing, detail “D9,” shown on FIG. 28, the cylinder head a flanged option 273, with a housing 274 attached to the flanged head, with the chain 264′, a different system layout than detail “D8,” based upon teachings. There are a number of such housing(s), around the circumference, to pull the piston uniformly, based upon teachings.

Continuing, detail “RRR,” FIG. 26, towards the top, and in the middle of the page, very long cylinder 401 as primary vessel, 402 the piston to be pulled, back and forth using a chain and mechanism, flanged, bolted head, cover 403, with one of the multiple of bolted housing(s) 411, located along the piston circumference, for symmetrical pull of the piston, and the sub system having a chain 412, with a sprocket 413, and a deep housing 414 to accommodate the chain as it is moved right to left, in tension. Thus the piston is pulled by such a sub system on each end.

Continuing, shown in TABLE 6E is the work, 7K psi to 3K psi, and then incremental works to go to a lower and lower engine exhaust pressure. As there is less and less incremental work available, and the engine cylinder capacity has to go up dramatically to get uniform output, it is to be based upon optimization exercise i.e. how low the engine exhaust pressure to go to, based upon this data as the guideline. Continuing, a 7K psi to 1K psi is reasonable range, thereby requiring the cylinder capacity to increase seven fold, via say smaller step cylinder approach. Continuing, TABLES 15, 15A, 15B in this context, to demonstrate clearly the thermal efficiencies in reducing the engine size. In TABLE 15B vs. TABLE 15A, the exhaust pressure in the primary vessel is preserved at say 1K psi engine exhaust, when there is the thermal energy recovery phase, and the cooling, refrigeration phase of the spent working fluid, etc., i.e. the fill/constant pressure expulsion are at, as a result of the higher exhaust pressure, are also at the elevated pressure. Thus an optimization exercise to determine various design parameters of the actual thermodynamic cycle.

Thus there are strokes lasting say 15, 20, 30, 60 seconds per optimization exercise and other mechanical design issues, with a brief pause at the end of each stroke, for the system to realign. This implementation of this type of cycle will seem like the engine running at constant load. However the engine to be designed for say 6, 8 step changes, via increase in the cylinder capacity, with cylinders opening in such number of steps, during the 15, 20, 30, 60 second time span, till the engine inlet for the working fluid communicates with the next cylinder.

Continuing, to re-cap, detail “A,” the overall system operation is three steps, Step 1, ADD HEAT at constant volume as piston moves from one end to the other, Step 2, make work, as the piston stays at the other end, i.e. does not move, Step 3, fill/constant pressure expulsion, as the piston moves from one end to the other, getting filled with new working fluid, while the spent working fluid is expelled for the thermal energy recovery. In-between the three steps, the three steps lasting say one minute each, as an example, there is a brief pause, lasting say one, two seconds for the cam operated, or other valves to change positions, close/open, open/close as the case(s) may be, to re-align the system, i.e. the three cylinders and the other parts of the overall cycle. Or to look at it in another way, cylinders 456A, 456B, 456C change positions, functions, rotationally, sequentially, say every one minute, (with a brief pause, lasting 1, 2 seconds each, between the three steps, for valves to re-position, and re-align the overall system), as explained in great details, and teachings of TABLE 2, for only the Primary vessels, cylinders being the primary vessels. The same applies to the other cycle option, detail “B,” of cylinders 456A′, 456B′, 456C′, based upon teachings.

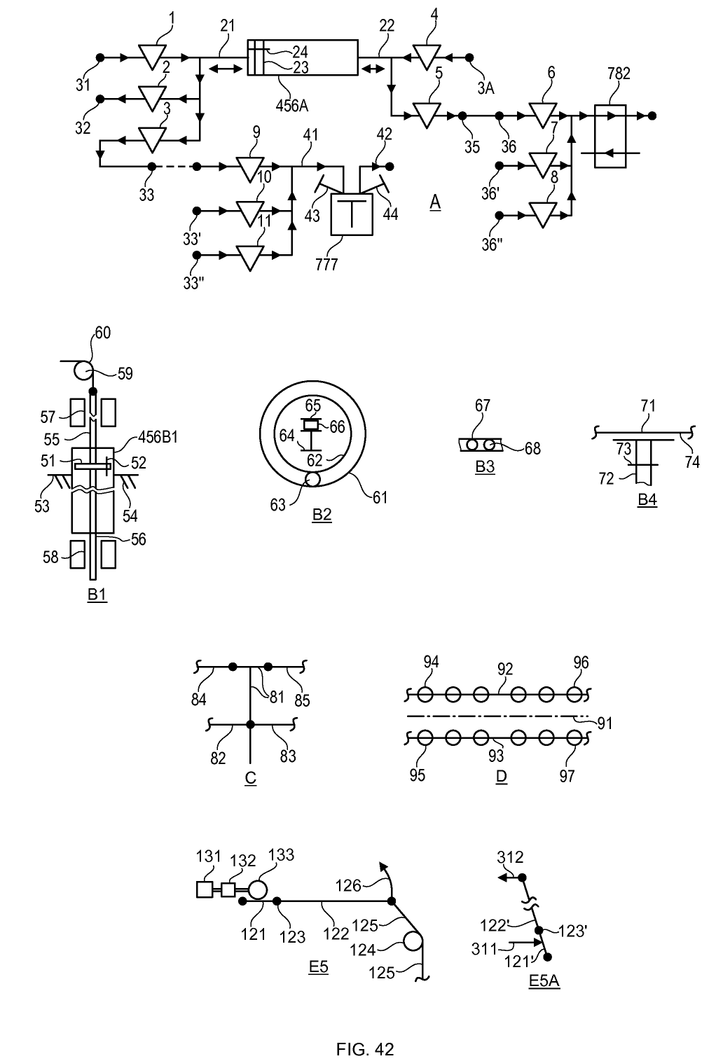

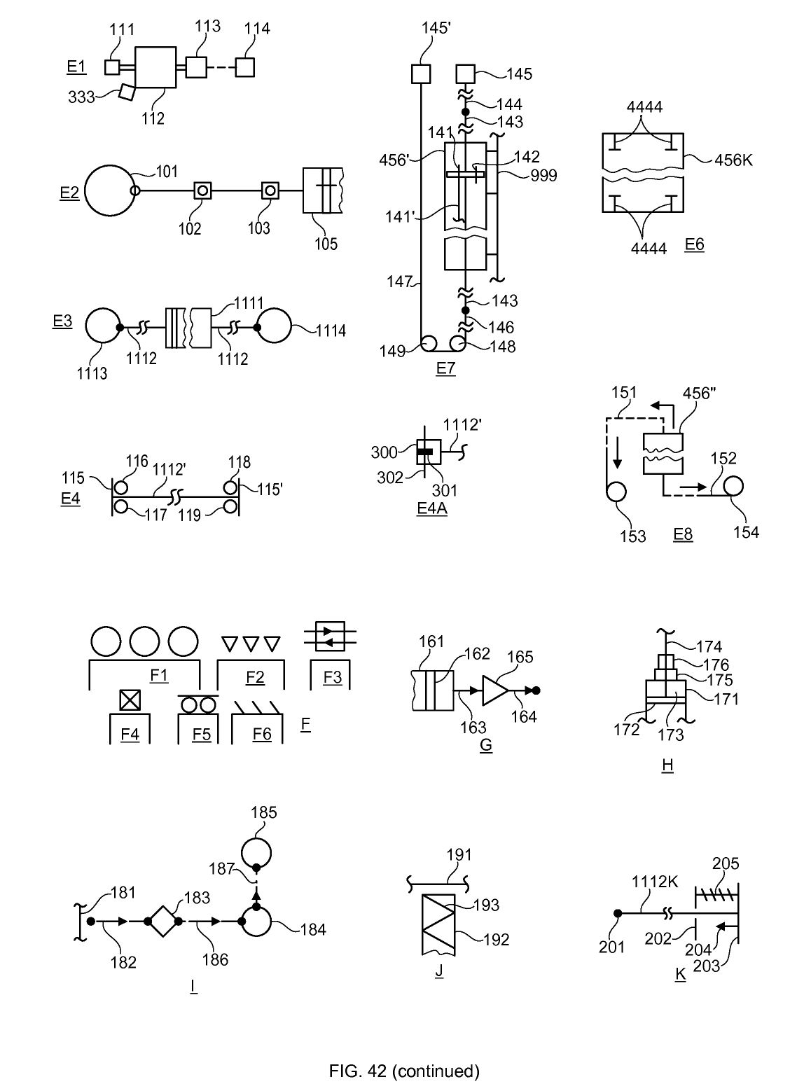

FIG. 42, building blocks to carry out the invention, shows in detail “A,” the primary vessel 456A which has requirements for 5 working fluid in/out points, shown by cam operated valves 1..5, needed for the cylinders as the primary vessels, and cam operated valves 6..8 needed for the recuperation heat exchanger, cam operated valves 9..11 needed for the engine, etc., Thus there are other such cam operated valves, not shown, and the overall system to be configured per the teachings of this discussion. Additionally, valves 1..11 may be actuated by mechanisms other than cams, such as solenoids under the control of a controller (not shown in FIG. 42). Continuing, as an example for the various system line up(s), the flows are shown, including fluid streams 21, 22 where the flow is in both directions, a certain direction for a certain part of the cycle. Thus the three nodes 31..33 are, node 31 for the hot working fluid inlet for the heat addition at constant volume phase, node 32 for the spent working fluid exit for the fill/constant pressure expulsion, and node 33 for the work making phase system line up. Similarly, node 35 is the working fluid flow path for the heat addition at constant volume phase, and node 34 for the very cold working fluid returning to the cylinder for the fill/constant pressure expulsion. Similarly, nodes 33′, 33″, 36′, 36″ are for the identical points for the primary vessels 456B, 456C. The working fluid path to the engine 777 are, in part fluid stream ..41, exhaust ..42, and the cam operated valves 43, 44 to point out that there are the engine valves for the implementation of the engine strokes. Thus the quick acting, open/close cam operated valves are disclosed, for the system line up (s), to carry out the three distinct thermodynamic steps, etc., etc. Thus the quick acting cam operated valves to realign the system.

Continuing, detail “B1,” shows the primary vessel/cylinder 456B1 in a vertical configuration to address the weight of the piston, in relation to the wall friction, and in facilitating the piston linear motion, a cylinder 456B1, piston 51, small hole 52, cylinder anchors 53, 54 at say ground level, pointing out that some of the cylinder height is below, and underground to reduce the tall structure cost for the system support for large size units. Continuing, the piston rods 55, 56, linear motion, say linear motors 57, 58 in this case, as an option, with any of the other methods of linear motion are applicable as well. Continuing, a sprocket 59, and a chain 60, a sub system to support the weight of the piston when the system is not in use and to assist in the up linear motion, as an option.

Continuing, detail “B2,” shows, exaggerated, the cylinder wall 61, piston outline 62, a number of rollers 63, into the plane of the drawing, to support the piston weight. Continuing, an I-beam or other suitable structure cross section 64, a structure 65 which is part of the piston, long rollers, a number of these rollers, into the plane of the drawing, (rollers) 66, to support the piston weight. Continuing, detail “B3,” shows the rollers 63, a number of these 68.., in several housing(s) 67, along the cylinder circumference to support the piston weight. The spaces accommodating these parts are stuffed with suitable material, to keep the integrity of the piston as a component as much as possible, for pushing the working fluid.

Continuing, detail “B4,” shows the cylinder wall 71, a piston 72, hole 73, a relatively long, preferably, round piston structure 74, to keep the piston symmetrical during its linear motion.

Continuing, detail “C,” shows a piston 81, with the very strong chain 82, 83, providing most of the pull the force i.e. the main piston pull, in the center, more chains 84, 85, along the piston circumference to maintain the piston symmetry, with all the chains, both sides of the cylinder, in tension, taught, to make piston linear motion, i.e. chains on both sides of the piston, in strong tension, with pull in both directions, alternately, with a work making phase pause etc., etc.

Continuing, detail “D,” shows the engine center line 91, cylinder center lines 92, 93, with cylinders such as 94..97, opening at the start of the work making phase, say 4 cylinders, followed by opening four more cylinders at a time, in say 4, 6, 8 steps, to smooth out the work output. Thus for relatively short, time wise, work making phase, these steps of adding cylinder capacities to facilitate the work making phase, smooth out output, so that due to short work making phase cycle duration, a simpler approach. To point out, the cam operated valve 9 of detail “A,” remains open for the duration of the work making phase cycle, then more cam operated valves, not shown, will direct the working fluid 41 of detail “A,” into more and more cylinders of detail “D,” in steps, with individual stroke cam operated valves 43, 44 of detail “A,” to be there as well.

Continuing, detail “E1,” shows a small capacity piston engine 111, or alternately a screw expander, a hydraulic motor, etc., that runs on short duration cycles, with a very large flywheel 112, shown as such, (for the very large flywheel, for startup, a motor with appropriate gearing shown by 333, till the required RPM of the engine, electric generator etc. train has reached the required RPM), then (the large flywheel) to smooth out the output, driving an electric generator 113, with the energy flow, shown dotted, as an option to a battery storage 114, all this for very small size skid mounted units. Continuing, the linear motion in detail “E2,” shows rotary motion via 101, such as in a steam engine, or positive displacement pumps etc., with the extreme positions 102, 103, imparting linear motion to the piston in cylinder 105, as per the thermodynamic cycle needs, using a catch, no catch approach for the piston movement. Thus for small size use, a relatively simpler approach. Continuing, other linear motion options such as linear motor etc. not shown, is applicable as well, based upon teachings. Continuing, detail “E3,” shows the cylinder 1111, with piston rod 1112, using the cam technology to cause linear motion, cams 1113, 1114, moving the piston back and forth or up and down as the case may be. Continuing, detail “E4,” shows plates 115, 115′, with cams 116..119, that via a tension only approach on the piston rod 1112′, as an option, move the piston rod 1112′ back and forth, or up and down as the case may be. The cam profile is designed for implementing the piston strokes, first a full stroke for heat addition at constant volume phase, then a no linear motion for the work making phase, thus using up the 360 degrees of the cam rotation, till the next stroke. And then next stroke for the fill/constant pressure expulsion, from the other cam, first a no linear motion, for the work making phase, coinciding with the first cam, and then the fill/constant pressure expulsion stroke, thus using up the 360 degrees of the cam rotation, etc., etc. Thus the two linear motions punctuated by a pause, or no linear motion of the piston, for the work making phase are implemented by one of the approaches for small size, skid mounted thermodynamic cycle using heat addition at constant volume approach.

Continuing, detail “E4A,” shows a housing 300, a cam 301, a cam shaft 302, imparting linear motion to the piston rod 1112″, the piston rod in tension, with a similar system on the other end of the cylinder, pulling the piston rod to implement strokes. The drives for the cam, ns, are two individual drives, or a single drive (for the two ends of the cylinder) using chain. Or two drives each for each of the cams, for symmetrical turning. Continuing, detail E5A shows the linear motion can be imparted via amplification of the linear motion of the cams, and as based upon the teachings disclosed in detail E5. In detail E5A, A fulcrum 123′, lever arms 121′, 122′, cam linear motion 311, amplified linear motion 312, pushing on the housing 300 of detail E4A. A dummy cam on the other face of the arm 121′, to keep the mechanism in precise motion, and to avoid jerky motions, the dummy cam is opposite to the cam that provides the actual force. Other suitable components, such as guides for the arms, ns, to facilitate smooth operation. Continuing, for very large cams, housing etc., relatively weak piston rods, required supports, guides, not shown, the structures to use light weight materials, such as carbon fiber, to minimize the weight that moves back and forth, in very quick succession.

Continuing, when using the options of details “E4, E4A,” to address the unequal wear and tear in the rubbing of the cam mechanism, or for any other system hardware precision related issues, as an option, a slight “give” to be built in into the cam system base anchor mechanism, while maintaining the rigidity of the two cams to pull in the piston rods in the applicable directions. This is to ensure that the cams do not damage the system by not being precisely synchronized.

Continuing, the “give” can be built into the two piston rods, via very strong spring loaded or hydraulic shock absorbers, “giving in” a very small linear motion, before the actual pull takes effect. This is to allow for the manufacturing/machining sloppiness of the cam system. As one of the two cams is pulling the piston in either direction while the other is following in each stroke, the “give” or the shock absorbers prevent the piston rods from being “over pulled.” Additionally, as another option the cam sub system is designed for “float.”

Continuing, using teachings of details “E4, E4A,” for the three cylinders, there are 6 sets of cams. By using chains, pulleys, and having the three cylinders anchored side by side, a suitable size common drive can be configured, using the teachings, thus driving the 6 sets of cams, for the required movements of the three pistons. The design based relative positioning of the profile(s) of the cams is to facilitate the three pistons in the three cylinders to have liner motions, as well not have the linear motion, as part of the cycle design, all well synchronized, and to stress, using a single drive sub system.

Continuing, detail “E5,” shows a motor 131, an optional gear box 132 for RPM reduction, driving a fairly large cam 133, that pushes down, or downward linear motion, of the shorter arm 121, a fulcrum 123, a much longer arm 122, thereby amplifying the linear motion that the cam 133 produces. Continuing, the arm 122 moves along a path 126, pulling a chain, rope 125 etc., via a pulley 124 that keeps the part 125′ vertical, to pull the piston in a vertical cylinder configuration. The teachings can be used for a horizontal cylinder configuration as well, using a cam option for the linear motion, with amplification, as the main disclosure here. The teachings are to be used in amplifying the linear motion of a hydraulic jack, or any other linear motion that is opted for. The amplification approach disclosed can be applied by having the arm 122 pushing the plates 115, 115′ of detail E4 directly to move the piston, instead via a chain mechanism. Thus as an example a 2 feet cam linear motion can be amplified to a 100 feet linear motion, no theoretical limits.

Continuing, detail “E6,” shows the cylinder 456K, with four (or more, or less) hydraulic bumpers, shock absorbers 4444, to take the possible collision force of the piston, in case of a system malfunction, with applicable sensors to stop the linear motion of the piston in time, by reaching the applicable piston driving sub system, all based upon teachings.

Continuing, detail “E7,” shows a tall primary vessel 456′, i.e. a tall cylinder, piston 141, small hole 142, piston rods 143, in tension, per design, to avoid designing for buckling, ropes 144, 146, 147, direction changing pulleys 148, 149, using/applying the proven technology of overhead cranes 145, 145′. The use of overhead crane technology, delivering usable linear motion, at suitable velocities by designing for the velocities, forces etc. is to be used, and as based upon teachings, the sub system is used for a horizontal cylinder configuration as well, applying linear motion in a piston rod pull, etc., etc. Continuing, to keep the piston symmetrical, and avoid any interference with the cylinder walls, for large diameter applications, guides 141′, part of the cylinder so that the piston slides over it, or part of the piston (guides) to be thus sliding out of the cylinder, i.e. dummy piston rods, per optimization exercise of the overall system design. Continuing, the retrofit is at an existing boiler facility, shown by 999, which is part of the boiler that has tall structures, to support the tall primary vessels, by using these structures as is, or by reinforcements. The teachings apply to any other tall existing structures to add this facility, all this to reduce cost.

Continuing, detail “E8,” shows, as per teachings of detail “E7,” a tall cylinder 456″, with two ground based winch(s) 153, 154, of suitable design, strength, velocities that can be delivered, by proper redesign of the proven technologies, with controls for start/pause/restart, etc., for the thermodynamic cycle needs, to move the piston, via/with lines 151, 152 in tension, pulling on the piston rods, not shown, per teachings of detail “E7.”

Continuing, detail “F,” shows the skid mounted, sub system option for relatively small size units, with a skid “F1,” for the three cylinders, with drives, say cam etc., a skid “F2,” for all the clusters of cams, a skid “F3,” for the recuperation heat exchanger, a skid “F4,” for the heat pump, refrigeration unit, a skid “F5,” for the tanks, pumps, etc., etc., and additional skids as needed. These skids will then have mostly the piping installation as the field work, interconnecting various junctions to deliver a running power unit. The skids are barge mounted, barge “F6,” that then gets anchored at the power plant location, when a waterway is available. The same applies for a railroad, or truck mounted option, for factory made small power units, all based upon teachings.

Continuing, detail “G,” shows the long cylinder 161, with the piston, and no hole option, the heat addition at constant volume phase flow path 163..164, with an optional check valve 165, for evaluation, and optimization exercise, all based upon teachings.

Continuing, detail “H,” shows the cylinder 171, piston 172, small hole 173, with the rope 174 for pull as is, and not via a smooth solid, metal piston rod. The braided rope for direction change etc., i.e. for the parts that go through the stuffing box, braided rope using very small diameter wires, making the surfaces as smooth as possible, but can still bend etc., with a suitable lacquer etc., or other coatings, for the rope to be still flexible etc. Continuing, several stuffing boxes, 175, 176, in series, and stuffing box over another stuffing box, not shown, as another option to minimize the working fluid leakage, etc. Thus a specially designed rope with smooth surface by proper coating etc., as part of the piston movement sub system.

Continuing, detail “I,” has a suitable part of the cylinder and piston movement sub system 181, with a piston position transmission signal 182, a plant computer 183, generating a signal 186 to stop the piston movement sub system driver, via a signal 186, to a controller 184, another signal 187 to the piston activation sub system 185. Thus the piston stroke is implemented, in a safe manner, using smart controls, as based upon the teachings here.

Continuing, detail “J,” the cylinder wall 191, with a piston design in the form of a box, shown by 192, with internal reinforcements, 193, as ribs, cross structures, for structural strength of the piston, using very light weight materials such as fiber glass, carbon fiber, etc. Thus the piston weight is minimized for the objective of the ease of piston linear motion.

Continuing, detail “K,” shows a node 201, that moves the piston rod, using the disclosures, such as in detail “E4A,” using cam, housing, etc., with the piston rod 1112K in tension. A fixed plate 202, a plate 203 attached to the piston rod, a cluster of springs 205, so that when the cam moves the piston rod linearly, it at the same time stores the compression energy in the cluster of springs, via motion 204 of the plate 203 squeezing the springs against plate 202. The cluster of springs 205 can be quite large, if it works, the cluster being many parallel rods, with many springs in series on each of these rods, nicely packed, in slight compression to start, suitable support structure for the moving/sliding plate 203, etc., etc. The sliding plate 203 can be on rollers, not shown. The cam profile thus has 120 (+/−) degrees to move the piston, and stare the compression energy, next 120 (+/−) degrees to have no linear motion, and the remaining 120 (+/−) degrees for the other stroke via letting the cluster of springs to release the stored compression energy. For system re-alignment, 120 degrees each to be modified for such. The slight variation to the exact 120 degrees is for the system re-alignment, all based upon teachings.

Continued, detail “L1,” (bottom of FIG. 32), shows a housing 401, a shaft 402, multiple cams 403..404, drives, including reduction gears etc. 406, 407, for a symmetrical operation. The pull sub system disclosed thus pulls a piston rod 411, cylinder wall 412, piston 413, small hole 414 to equalize pressure, system having a fixed plate 431, a moving plate 432, reinforcements for these plates shown as 433, fixed plate anchors 435, 436, guides, weight supporting structures 441, 442, rollers as required, 443's, multiple of rods 444, as guides, sliding through the appropriately designed guides/sleeves through the moving plate 432, (the rods) to accommodate a cluster of springs, stacked springs in series 445. The pull system imparts a cam based linear motion 421, piston rod 411 in tension, that concurrently squeezes the springs and stores compression energy, which gets released to result in linear motion 422, piston rod 411 in tension. The profile of the cams is divided up in three 120 degree (+/−) profile parts. The first 120 degree (+/−) profile part, say, pulls in the direction 421, say add heat at constant volume phase, the second 120 degree (+/−) profile part to support a no piston motion step, make work, the third 120 degree (+/−) profile part permits the springs to result in linear motion as in direction 422, spent working fluid expulsion/re-fill phase, by the force of springs moving, i.e. pushing on plate 432, resting on fixed plate 431. The small changes in the 120 degrees divisions is to accommodate the system re-alignment, as required, by having a no motion for a very brief period of time. Continuing, detail “L2,” shows the housing 401, shaft 402, guides, load support structures 451, 452, rollers 453's. Continuing, detail “L3,” shows the disclosure for the cylinder in a vertical configuration, ground 501, fixed, anchored plate 431, moving plate 432, piston rod 411, upward pull sub system 500. Thus the system as disclosed is applicable for a horizontal, and a vertical cylinder configuration, as based upon teachings. Continuing, the compression energy stored in spring can be combined with many other features, options, such as non-cam related linear motion options, hydraulic cylinders, linear motion amplification, etc., all based upon teachings. Sprigs as the energy storage option can be replaced by any other suitable option, as well.

The piston linear motion can be by the piston rods in tension, for structural reasons. However depending upon the optimization exercise, and other considerations, the teachings can be used to design the piston rod linear motion so that the piston rods can be in compression, by applying overall design and economics considerations.

Thus, as based upon teachings, and for those familiar with the art, variations such as common drives for rotating multiple of cams, using chains, ropes, direction change pulleys, reduction gears, etc., and applying other disclosures in various configurations, per teachings, to meet the needs of the thermodynamic cycle disclosed, and other applications, are all within the scope of the present invention, the invention not being limited to the above disclosed exemplary embodiments.

### POINTS Based Upon Teachings:

1.0 A thermodynamic process, essentially three separate sub systems, or phases, which are, heat addition at constant volume phase, work making phase, fill/constant pressure expulsion phase.
1.1 A STEP 1, a vessel, called a primary vessel that has a very loose fabric, anchored in the middle of the vessel, or at any other suitable location, that facilitates heat addition at constant volume. A bladder as an option, in lieu of the fabric approach.

A circulator that draws the cold working fluid from below the fabric, circulates it, outside of the primary vessel, cold working fluid flow is run through essentially two heat exchangers, a recuperation heat exchanger, using the recuperated thermal energy, and a heat exchanger that uses new heat, as thermal energy source; and subsequently, (the circulator), reintroduces the working fluid above the fabric. This sub system continues to run, till all of the cold working fluid has been transferred that way, from below the fabric to above the fabric; which results in extremely high pressure of the working fluid, heated from a temperature of say 40 Deg. F. to a temperature of say 140 Deg. F., (the extremely high pressure) of the order of say 7K psi, used in various calculations, and thus getting the extremely high pressure is without the negative load of a pump.

1.2 A STEP 2, a work making phase, using the extremely high pressure working fluid, from a different primary vessel, the primary vessel is post heat addition at constant volume phase primary vessel, the extremely high pressure working fluid is allowed to flow through a piston based engine, to push down the piston and produce work. The way to produce work can be a screw expander, a hydraulic motor, as options. At the end of this work making phase, the working fluid left behind, called the spent working fluid is at very low pressure, say 100 psi, and only a few Deg. F. cooler than where the work making phase was started. The work making phase can be via a secondary vessel in which the working fluid above the fabric pushes the ambient temperature working fluid from below the fabric and into an engine, screw expander, hydraulic motor etc.
1.3 A STEP 3, the working fluid at ambient temperature or cooled, refrigerated, introduced into below the fabric, fill phase, so that the spent working fluid from above the fabric is pushed out, for thermal energy recovery via the recuperation heat exchanger, the push out thus called the constant pressure expulsion phase, hence the entire sub system is called the fill/constant pressure expulsion phase. When using a secondary vessel option, the spent working fluid from above the fabric is also pushed out.
1.4 The refrigeration to pre cool the working fluid, in the above, is via the evaporator of the heat pump, or a standalone refrigeration sub system. Thus the heat rejected on the cold end of the recuperation heat exchanger (the spent working fluid stream), is used in converting refrigerant liquid to refrigerant vapor as part of the heat pump. The refrigeration of the working fluid allows more working fluid to be stuffed into the primary vessel, prior to the heat addition at constant volume phase.
1.5 As an additional thermodynamic approach, a thermodynamic tool, once the primary vessel is stuffed with the working fluid, more working fluid is pushed in, i.e. more working fluid is stuffed into the primary vessel, in a very short amount of time as part of the fill/constant pressure expulsion phase, thereby resulting in a higher starting pressure for heat addition at constant volume phase, called pre pressurizing of the primary vessel. This results in a lower temperature of the thermal energy source for the heat addition at constant volume phase.
1.6 A no fabric approach in the primary vessels, by accepting the thermodynamic process to be less than ideal.
1.7 The Thigh vs. T-low takes into consideration the pressure created, as a result of heat addition at constant volume. Thigh can be using low grade thermal energy, waste thermal energy, or even ambient thermal energy as is, as one option. And, via upgrading using heat pump approach. T-low can be via thermal energy rejection to the ambient. And via the system heat pump evaporator. And a lower temperature than that, by a dedicated heat pump, i.e. heat rejection via a dedicated refrigeration system on the recuperation heat exchanger cold side.

### 2.0 The Hardware.

2.1 Conventional pressure vessels, such as a cylindrical with curved heads, the heads are concave or convex, a sphere, plate structures.
2.2 Vessels fabricated from structure steel cross sections such as “I” beams, etc. The vessel skeleton is thus designed, the open spaces, to the outside, filled in with contoured plate structures.
2.3 The vessels to be double wall, as another option, the outer pressure boundary to contain the pressure, an inner liner to have a smooth working fluid holding vessel, creating a path of the working fluid to the liquid between the two boundaries, such that the inner plate liner is not subjected to a differential pressure.

### 3.0 The Controls.

3.1 The controls to orchestrate the overall thermodynamic cycle, the primary vessels, and the secondary vessels, if applicable, change places, go through the system, rationally, every so often, say every 5, 6, 10 minutes.
3.2 The controls will thus open/close a number of such valves, with the appropriate system piping, instrumentation such that there are three plants, and not one, in certain way of looking at it. Thus the system is completely reconfigured, per the disclosure, facilitating the three phases, heat addition at constant volume phase, work making phase, fill/constant pressure expulsion phase, over and over again, rotationally.
3.3 The system designed with slight staggering of the system realignment, as an option, avoiding any water hammer, piping vibrations etc. As an alternate, the system be completely shut down, as another option, for a very brief period, matter of seconds, realigned, using open/close valves, the plant computer, controls, restarted with new alignment, all in very short amount of time, three times every so often.
3.4 Energy storage, using low grade thermal energy, lower bleed streams, ambient thermal energy, with/without heat pump approach, working fluid at extremely high pressure via heat addition at constant volume phase stored in a number of primary vessels, during night, low load, used as needed, to address revenue issue, load, by employing work making phase, and then thermal energy recovery, at will, indirectly via heat exchangers, and/or via directly introducing into the parent Rankine cycle condensate, or via flashing of the spent working fluid, hot water, in stages, and introducing the flashed steam into the parent Rankine cycle turbine train, or a dedicated turbine, a dedicated condenser or the parent Rankine cycle condenser, for heat rejection. In the energy storage, the phases can be staggered processes, heat addition at constant volume phase at night, low load, work making phase as needed, thermal energy recovery phase as convenient.
3.5 Sloppiness, the three phases, heat addition at constant volume phase, work making phase, fill/constant pressure expulsion phase not fully synchronized, number of primary vessels, go through to the three phases, using storage tanks, if needed, to carry out the three phases via fuzzy logic, as long as the thermal energy recovery can be assured to get net positive work.
4.0 The systems to produce constant power, as the extremely high pressure of the working fluid at the start of the work making phase goes down and down, say from 7K psi to 100, 50 psi.
4.1 Generate DC electricity, using it in the electrolysis so that Hydrogen is the product, as when electrolysis, as an option, DC output can vary.
4.2 Drive a DC generator, with varying RPM, field strength as the tool to produce constant DC power. DC is the send out energy, as DC transmission. DC recharging a battery bank, as energy storage, and a DC motor coupled with an AC generator sends out constant AC power.
4.3 AC approach, with activating the poles as needed vs. the RPM, vs. pole field strength, vs. engine RPM.
4.4 Engine design as a tool to address the uniform output, via RPM control, admission valve opening, and remaining open for controlled duration, varying cylinder sizes, that are summoned, in batches of four cylinders at a time, small cylinders bridging the power variation till four more larger cylinders open.
5.0 The heat sources for the heat addition at constant volume phase can vary.
5.1 Using low grade thermal energy, waste thermal energy, lower bleed streams, condenser waste thermal energy, ambient thermal energy used as is, or up graded via heat pump approach, by pre cooling of the working fluid, to as low a temperature as optimized, pre pressurizing the primary vessel.
5.2 Using low grade thermal energy, waste thermal energy, lower bleed streams, condenser waste thermal energy, ambient thermal energy used via upgrading using a heat pump approach, and by pre cooling of the working fluid, and pre pressurizing, as using more thermodynamic tools
5.3 Using solar heat via concentration, or as is for the heat addition at constant volume phase.

### 6.0 Optimizing the Heat Pump.

6.1 The compression part of the heat pump load, multi pressure level compression.
6.2 The flashing of the refrigerant approach, wherein the heater drain refrigerant is flashed to avoid the use of 2phase turbine, etc., and multi pressure compression of the flashed vapor (s) at different pressure (s).
6.3 The work extraction from heater drain, using screw expander, hydraulic motor, 2phase turbine.
6.4 Using thermal energy from wherever in the system, and using the thermal energy in evaporator (s) for the refrigerant liquid to refrigerant vapor, multi pressure evaporation using the low grade thermal energy, and then multi pressure compression.

### 7.0 Miscellaneous.

7.1 Designing the system with spare vessels, the vessels are designed with minimum of wall thicknesses, as a matter of economics, that results in fatigue, stress induced, pressure cycling based cracks over time, followed by offsite shipping of the deteriorated vessels, for re-melt, reuse of the metals for the fabrication of new vessels.
7.2 An extremely low pressure below piston, i.e. the pressure below the piston is vacuum as per optimization exercise.
7.3 A no fabric primary vessel option with a different approach for thermal energy recovery, which is the use of the spent working fluid thermal energy for refrigerant evaporation, as part of the heat pump approach.
8.1 The working fluids, are, gas, such as air, Nitrogen, Helium etc.
8.2 The working fluids, are liquids, such as water, water with glycol, suitable refrigerant.

### 9.0 Heat Rejection Options:

9.1 Heat Rejection options; heat rejection from the heat source, cold side exit from the recuperation heat exchanger:
9.2 The thermal energy source has certain temperature, say T-source, the low side temperature then is T-low, the high side temperature Thigh. After the recuperation heat exchanger cooling, the heat rejection can be via conventional, Conventional heat rejection to the ambient, via an heat exchanger.
9.3 Heat rejection into the evaporator of the heat pump.
9.4 Heat rejection via another dedicated refrigeration sub system, or the only refrigeration sub system.
9.5 Flashing of the thermal energy source working fluid from the cold side of the recuperation heat exchanger, especially if the working fluid is an refrigerant, and then vapor re compression to be used as thermal energy source, or rejected into the ambient, per optimization exercise.

### 10.0 Hardware:

10.1 The hardware. Vessels.
10.2 Conventional pressure vessels, such as a cylindrical with curved heads, the heads are concave or convex, a sphere, plate structures.
10.3 Vessels fabricated from structure steel cross sections such as “I” beams, etc. The vessel skeleton is thus designed, the open spaces, to the outside, filled in with contoured plate structures.
10.4 The pressure boundary of the vessel is flexible fabric pushing on the dirt that gets compacted, and stabilizes over time.
10.5 Producing work, hydraulic motors, screw expanders, cylinder, piston based engine, turbine.
10.6 Multiple work making units, in a cluster, on/off arrangement via working fluid in, shut off based.

### 11.0 Controls

11.1 The controls to orchestrate the overall thermodynamic cycle, the primary vessels, and the secondary vessels, if applicable, change places, go through the system, rationally, every so often, say every 5, 6, 10 minutes.
11.2 The controls will thus open/close a number of such valves, with the appropriate system piping, instrumentation such that there are three plants, and not one, in certain way of looking at it. Thus the system is completely reconfigured, per the disclosure, facilitating the three phases, heat addition at constant volume phase, work making phase, fill/constant pressure expulsion phase, over and over again, rotationally.
11.3 The system designed with slight staggering of the system realignment, as an option, avoiding any water hammer, piping vibrations etc. As an alternate, the system is completely shut down, as another option, for a very brief period, matter of seconds, realigned, using open/close valves, and the plant computer, controls, restarted with new alignment, all in very short amount of time, three times every so often.
11.4 Energy storage, using low grade thermal energy, lower bleed streams, ambient thermal energy, with/without heat pump approach, working fluid at extremely high pressure via heat addition at constant volume phase stored in a number of primary vessels, during night, low load, used as needed, to address revenue issue, load, by employing work making phase, and then thermal energy recovery, at will, indirectly via heat exchangers, and/or via directly introducing into the parent Rankine cycle condensate, or via flashing of the spent working fluid, hot water, in stages, and introducing the flashed steam into the parent Rankine cycle turbine train, or a dedicated turbine, a dedicated condenser or the parent Rankine cycle condenser, for heat rejection. In the energy storage, the phases can be staggered processes, heat addition at constant volume phase at night, low load, work making phase as needed, and thermal energy recovery phase as convenient.
11.5 Sloppiness, the three phases, heat addition at constant volume phase, work making phase, fill/constant pressure expulsion phase not fully synchronized, number of primary vessels, go through to the three phases, using storage tanks, if needed, to carry out the three phases via fuzzy logic, as long as the thermal energy recovery can be assured to get net positive work.

### 12.0 Making Uniform Power:

12.1 The systems to produce constant power, as the extremely high pressure of the working fluid at the start of the work making phase goes down and down, say from 7K psi to 100, 50 psi. Additionally more engine issues.
12.2 Generate DC electricity, using it in the electrolysis so that Hydrogen is the product, as when electrolysis, as an option, DC output can vary.
12.3 Drive a DC generator, with varying RPM, field strength as the tool to produce constant DC power. DC is the send out energy, as DC transmission. DC recharging a battery bank, as energy storage, and a DC motor coupled with an AC generator sends out constant AC power.
12.4 AC approach, with activating the poles as needed vs. the RPM, vs. pole field strength, vs. engine RPM.
12.5 Engine design as a tool to address the uniform output, via RPM control, admission valve opening, and remaining open for controlled duration, varying cylinder sizes, that are summoned, in batches of four cylinders at a time, small cylinders bridging the power variation till four more larger cylinders open.
12.6 The piston, cylinder based engine has double wall as a feature, the working fluid exhaust goes through the double wall, and picks up the heat of friction that eventually gets recovered in the recuperation heat exchanger.
12.7 Step change in the engine RPM, say 450, 900, 1800 RPM, accompanied with the different size cylinder opening in a sequential manner, with flywheel to smooth out the output.

### 13.0 Heat Sources:

13.1 The heat sources for the heat addition at constant volume phase can vary.
13.2 Using low grade thermal energy, waste thermal energy, lower bleed streams, condenser waste thermal energy, ambient thermal energy used as is, or up graded via heat pump approach, by pre cooling of the working fluid, to as low a temperature as optimized, pre pressurizing the primary vessel.
13.3 Using low grade thermal energy, waste thermal energy, lower bleed streams, condenser waste thermal energy, ambient thermal energy used via upgrading using a heat pump approach, and by pre cooling of the working fluid, and pre pressurizing, as using more thermodynamic tools
13.4 Using solar heat via concentration, or as is for the heat addition at constant volume phase.
13.5 Using low grade thermal energy, ambient thermal energy, as is, as the thermal energy source (s).
13.6 Using flue gas thermal energy as is, or via a heat pipe based approach, making vapors at successive pressure levels.
13.7 Using flue gas thermal energy, first via clean up, cool via nozzles, condense condensable, spin out condensable, stagnate and recompress the cleaned up flue gas, use thermal energy, expel via stack.

### 14.0 Optimizing the Heat Pump.

14.1 Types of heat pump (s), in thermodynamic sense; single phase, open loop, closed loop, working fluids, air, Nitrogen, Helium, CO2 etc.
14.2 Types of heat pump (s), in thermodynamic sense; 2phase heat pump (s), wherein there is a condenser, evaporator, vapor compression. The working fluid (s) are usually refrigerant (s), water can be a refrigerant.
14.3 The compression part of the heat pump load, multi pressure level compression.
14.4 The flashing of the refrigerant approach, wherein the heater drain refrigerant is flashed to avoid the use of 2phase turbine, etc., and multi pressure compression of the flashed vapor (s) at different pressure (s).
14.5 The work extraction from heater drain, using screw expander, hydraulic motor, 2phase turbine.
14.6 Using thermal energy from wherever in the system, and using the thermal energy in evaporator (s) for the refrigerant liquid to refrigerant vapor, multi pressure evaporation using the low grade thermal energy, and then multi pressure compression.

### 15.0 Miscellaneous.

15.1 Designing the system with spare vessels, the vessels are designed with minimum of wall thicknesses, as a matter of economics, that results in fatigue, stress induced, and pressure cycling based cracks over time, followed by offsite shipping of the deteriorated vessels, for re-melt, reuse of the metals for the fabrication of new vessels.
15.2 An extremely low pressure below piston, i.e. the pressure below the piston is vacuum as per optimization exercise.
15.3 A no fabric primary vessel option with a different approach for thermal energy recovery, which is the use of the spent working fluid thermal energy for refrigerant evaporation, as part of the heat pump approach.
15.4 Liquid Hydrogen as send out thermal energy source, making liquid Hydrogen via Hydrogen Helium mixture, expansion in a turbine, expansion in an ejector, Hydrogen latent heat does work, becomes liquid. Making liquid air as the working fluid for heat addition at constant volume approach, using air, Helium as the mixture, air latent heat gets used. Followed by recompression, to get to the original mixture condition, via more gas introduction that has been transformed to liquid.
15.5 The recuperation heat exchanger, cold side of the spent working fluid, exiting the recuperation heat exchanger, cool via ambient sink, use thermal energy in the heat pump evaporator, discharge into the thermal energy gathering sub system, if the main working fluid is the same refrigerant as the main thermal energy gathering sub system, (discharge) via 2phase turbine, throttling, resulting in a 2phase working fluid, compress vapor, condense. Plus further cool the liquid coming out of the recuperation heat exchanger, via a dedicated refrigeration sub system, to get to start with very cold working fluid, as fill working fluid.
16.1 The attached Energy Flow, FIGS. 1A and 1B, point out building blocks, an innovative heat pump, and an innovative power cycle.
16.2 A thermodynamic exercise, making MWe's from ambient heat sources.
16.3 The work making phase is most complex if constant work output is designed for, as the flow rate through the engine will vary a lot, from start to finish, and the flow rate has to evacuate the primary vessel in a cycle time. Therefore, as a remedy, four, or even more primary vessels to be designed into the system, so that there are two, or even more primary vessels for the work making phase, so that there can be sloppiness in the work making phase, all based upon teachings.
16.4 The teachings can be applied to Tank-less water heater, with heat addition at constant volume phase, then work making phase, with spent working fluid as the hot water, thus getting free work.
17.0 The TABLES are self explanatory, though discussion of some of the TABLES:
17.1 TABLES 6C shows how the pressure builds up during the heat addition at constant volume phase.
17.2 TABLE 6D shows how the pressure gets used during the work making phase.
17.3 TABLES 10A, 10B show the excess enthalpy in the recuperation heat exchanger, thermal energy source vs. thermal energy sink.
17.4 TABLE 14 shows the work(s) of compression for Isobutane when a two level refrigeration sub system is used in restoring the cold side of the recuperation heat exchanger thermal energy source is to be restored to the very cold temperature.
18.1 The piston to have loose fabric, where applicable to carry out the thermodynamic process.
18.2 The engine walls to have plastic liner etc. to minimize friction, with plastic or other material for the piston rings.
18.3 Using abandoned mines as pressure vessels, and bunkers etc. when feasible.

The above detailed description of preferred embodiments is intended only to acquaint others skilled in the art with the invention, its principles, and its practical application so that others skilled in the art may adapt and apply the invention in its numerous forms, as they may be best suited to the requirements of a particular use. This invention, therefore, is not limited to the above embodiments, and may be variously modified.

REFPROP is an acronym for REFerence fluid PROPerties. This program, developed by the National Institute of Standards and Technology (NIST) provides tables and plots of the thermodynamic and transport properties of industrially important fluids and their mixtures with an emphasis on refrigerants and hydrocarbons. The following tables apply REFPROP data where appropriate.

TABLE 1
Features

| | AA | BB | CC | DD | EE |
|---|---|---|---|---|---|
| 1 | Vessels; | Single wall; | Structural Steel | Structural Steel | Structural Steel |
| | Structure wise > | Conventional, | based. | based; using curved | based. Double |
| | | cylinder, sphere. | | plates. | wall. |
| 2 | Vessels | Underground | Packed in sand, | | |
| | Structure wise > | | dirt, etc. | | |
| 3 | Vessels | Primary Vessel, | Secondary | When double wall, a | |
| | Function Wise > | making free | Vessel, Indirect | cooling sub system | |
| | | pressure via heat | Push out of | for the outer liquid | |
| | | addition at | liquid into an | body, to keep the | |
| | | constant volume. | engine, via a | pressure part of the | |
| | | | fabric divider. | vessel at ambient | |
| | | | | temperature, as an | |
| | | | | option. | |
| 4 | Dividing up of | Fabric, Passive | Fabric, Active | Piston Option, | Cameras to have |
| | the Vessel(s), | | via ropes, | Movement via | visual |
| | Option(s) > | | pulleys etc.; | linear controls; plus | monitoring. |
| | | | including | pin hole to equalize | |
| | | | controlled rope | pressure. | |
| | | | pull. | | |
| 5 | Working Fluid | Flow rate control | Flow rate | BOTH. | No controls, and |
| | Circulator via | via RPM controls. | control via | | design for |
| | the primary | | control valves in | | constant flow, |
| | vessel > | | the discharge | | with very little |
| | | | line. | | pressure trim. |
| 6 | Recuperation | Several Parallel | | | |
| | Heat Exchanger > | paths to address | | | |
| | | Extremely High | | | |
| | | Pressure, and Tube | | | |
| | | sheet thickness | | | |
| | | etc. | | | |
| 7 | Main Heat | Several Parallel | With Drains | Without Drains | |
| | Exchanger for | paths to address | cooling zone. | cooling zone. | |
| | the heat | Extremely High | | | |
| | addition at | Pressure, and Tube | | | |
| | constant | sheet thickness | | | |
| | Volume > | etc. | | | |
| 8 | Heat sources | Water sources, | Re-Compression | Rankine Cycle | Increasing the |
| | for the Main | ground, sea, river, | of the vapors, | Bleeds. | back pressure of |
| | Heat Exchanger | condenser hot | condenser hot | | an existing |
| | for adding heat | well, etc., for | well vapors, | | turbine via |
| | at constant | evaporation of a | etc., etc. | | removal of a few |
| | volume > | refrigerant, | | | last rows of |
| | | followed by | | | blades, and then |
| | | compression of | | | using the higher |
| | | the refrigerant | | | pressure |
| | | vapors. | | | exhaust. |
| 9 | Heat sources | Lower Bleeds | Renewable, Low | Stack Heat; used | Stack Heat used |
| | for the Main | Heat; From a stand | grade Solar via | directly. | via a heat pipe |
| | Heat Exchanger | alone topping | mirrors, | | configuration. |
| | for adding heat | cycle. | concentration, | | |
| | at constant | | Geothermal. | | |
| | volume > | | | | |
| 10 | Stack Heat | Heat sources for | Ambient air. | Condenser Waste | ANY Low grade |
| | cleaned up via | the Main Heat | | heat; liquid and/or | heat, including |
| | cooling, spin | Exchanger for | | vapor. | ambient heat |
| | out. | adding heat at | | | elevated in heat |
| | | constant volume > | | | grade via heat |
| | | | | | pump approach. |
| 11 | Working Fluids | Preferably Water; | Others; Oils, | | |
| | Receiving heat: > | water with Glycol | Refrigerants. | | |
| | | for very cold | | | |
| | | applications. | | | |
| 12 | Working Fluids | Stays Below | Goes above | | |
| | Receiving heat | Critical | Critical | | |
| | final; | Temperature | Temperature | | |
| | conditions: > | | | | |
| 13 | Working Fluids | Stays Single phase, | Becomes two | | |
| | Receiving heat; | preferably. | phase, via screw | | |
| | final post | | expanders, | | |
| | expansion | | Hydraulic | | |
| | conditions > | | Motors. | | |
| 14 | Making Work, | Hot working fluid | Hot working | | |
| | System | used in the engine, | fluid pushes out | | |
| | Configuration > | i.e. no Secondary | another liquid, | | |
| | | Vessel. | i.e. Secondary | | |
| | | | Vessel is used. | | |
| 15 | Making Work, | Preferably Water | Others; Oils | | |
| | Push Out | | | | |
| | Liquids > | | | | |
| 16 | Making Work, | Piston Technology | Screw | Hydraulic Motors. | (Steam) Turbine |
| | Engines > | | Expanders. | | when Vapor as |
| | | | | | the working |
| | | | | | fluid. |
| 17 | Making | Vary Engine RPM | Flywheel | via DC storage, | Many cylinder |
| | Uniform Work; | vs. Generator | | acting as the energy | sizes, then |
| | tools > | RPM. | | storage flywheel, | cylinders are |
| | | | | and then to AC send | opened via |
| | | | | out. | controls; as the |
| | | | | | working fluid |
| | | | | | pressure goes |
| | | | | | down and down. |
| 18 | Making | Vary Field | Vary Field | | |
| | Uniform Work; | strength; DC | strength; AC | | |
| | tools > | generator; | generator; | | |
| | | producing same | producing same | | |
| | | power at varying | power at | | |
| | | RPM. | varying RPM. | | |
| 19 | Work | Make AC Power | Make DC Power | Make DC Power to | DC Power to AC |
| | Produced; | | | AC Power via | Power via |
| | Used as > | | | Motor/Generator | Inverter |
| 20 | Work | DC Power to | Hydrogen as | System as Peak | |
| | Produced; | Hydrogen via | energy send out | Power | |
| | Used as > | electrolysis. | commodity, as | Configuration. | |
| | | | gas, liquid. | | |
| 21 | Miscellaneous | Batched Process. | Pre Pressurizing | Configurations for | |
| | | (Other | of the Primary | Peak Power, Large | |
| | | Thermodynamic | Vessel(s). | Primary Vessel(s). | |
| | | cycles such as | | | |
| | | Rankine, Brayton, | | | |
| | | Otto are | | | |
| | | continuous | | | |
| | | processes. | | | |
| 22 | Main Batched | Add Heat At | Expand/Make | Primary Vessel: Re- | Secondary |
| | Sub Systems > | Constant volume | work | Fill with the working | Vessel: Re-Fill |
| | | | | fluid, and Constant | with the |
| | | | | Pressure Expulsion | working fluid, |
| | | | | of the spent | and Constant |
| | | | | working fluid. | Pressure |
| | | | | | Expulsion of the |
| | | | | | spent working |
| | | | | | fluid. |
| 23 | Primary Vessel | Extract Work via | Staged Flashing | | |
| | Sub cooled | screw expander. | to make vapor | | |
| | Heater Drains > | | for re- | | |
| | | | compression. | | |
| 24 | Refrigerant | Screw | Centrifugal | Piston Based | Others. |
| | Compression; | Compressors | Compressors. | | |
| | Machinery > | | | | |
| 25 | Refrigerant | Compression | Compression | Compression Mufti | Combination of |
| | Compression; | Single stage. | Mufti stage, | stage, Multi | both options. |
| | System wise > | | Single | Compressors. | |
| | | | Compressor. | | |
| 26 | CONTROLS > | To satisfy the | Flow | | |
| | | Batched system re- | Measurements | | |
| | | configuration; | to determine | | |
| | | essentially Three | when the phase | | |
| | | Phases. | is over. | | |
| 27 | Pre- | Dead head the | Stand alone sub | Make pressure via | |
| | pressurizing | Circulator | system | Heat Addition at | |
| | the Primary | | | Constant Volume. | |
| | Vessel > | | | | |
| 28 | Cluster of | > Pull via a | | | |
| | Cylinders as | carriage. | | | |
| | Vessel. | | | | |

TABLE 2
Batched Approach

| | Primary | Primary | Primary | Secondary | Secondary |
|---|---|---|---|---|---|
| Durations, Just an | Vessel | Vessel | Vessel | Vessel | Vessel |
| example. | 456A | 456B | 456C | 678A | 678B |
| 0 to 10 minutes | PHASE 1: | PHASE 2: | PHASE 3: Fill, | PHASE: Making | PHASE: Fill, |
| | Heat | Making Work. | Constant | Work. | Constant |
| | Addition at | | Pressure | | Pressure |
| | Constant | | Expulsion of | | Expulsion of |
| | Volume | | Spent | | Spent |
| | | | Working | | Working |
| | | | Fluid | | Fluid |
| 11 to 20 minutes | PHASE 2: | PHASE 3: Fill, | PHASE 1: | PHASE: Fill, | PHASE: |
| | Making | Constant | Heat | Constant | Making |
| | Work. | Pressure | Addition at | Pressure | Work. |
| | | Expulsion of | Constant | Expulsion of | |
| | | Spent | Volume | Spent Working | |
| | | Working Fluid | | Fluid | |
| 21 to 30 minutes | PHASE 3: | PHASE 1: Heat | PHASE 2: | PHASE: Making | PHASE: Fill, |
| | Fill, | Addition at | Making | Work. | Constant |
| | Constant | Constant | Work. | | Pressure |
| | Pressure | Volume | | | Expulsion of |
| | Expulsion of | | | | Spent |
| | Spent | | | | Working |
| | Working | | | | Fluid |
| | Fluid | | | | |

TABLE 3A

| | Cylinder Work |
|---|---|
| VALUES | |
| dia.; cylinder, inches | 12 |
| stroke; inches | 12 |
| RPM | 1,800 |
| Liquid PSI | 7,000 |
| RESULTS | |
| MWe | 32.20 |
| Water Lbs. per Hr. | 5,343,845 |
| Work BTU/Lb. Of Lq. | 20.57 |
| piston area; sq. in. | 113.10 |
| PIE | 3.14159 |
| force piston surface; Lbs. | 791,681 |
| Distance; stroke, Ft. | 1.00 |
| Work Ft. Lb.; per piston | 791,681 |
| push down | |
| Work BTU per REVOLUTION | 1,018 |
| Work BTU/per Hr. | 109,899,118 |
| MWe | 32.200 |
| Swept Vol.; Cu. Ft. | 0.79 |
| Water Lbs. per stoke | 49.48 |
| Water Lbs. per Hr. | 5,343,845 |
| Work BTU/Lb. Of Lq. | 20.57 |

TABLE 3B

| | Cylinder Work |
|---|---|
| VALUES | |
| dia.; cylinder, inches | 4 |
| stroke; inches | 4 |
| RPM | 1,800 |
| Liquid PSI | 100 |
| RESULTS | |
| MWe | 0.02 |
| Water Lbs. per Hr. | 197,920 |
| Work BTU/Lb. Of Lq. | 0.29 |
| piston area; sq. in. | 12.57 |
| PIE | 3.14159 |
| force piston surface; Lbs. | 1,257 |
| Distance; stroke, Ft. | 0.33 |
| Work Ft. Lb.; per piston | 419 |
| push down | |
| Work BTU per REVOLUTION | 1 |
| Work BTU/per Hr. | 58,148 |
| MWe | 0.017 |
| Swept Vol.; Cu. Ft. | 0.03 |
| Water Lbs. per stoke | 1.83 |
| Water Lbs. per Hr. | 197,920 |
| Work BTU/Lb. Of Lq. | 0.29 |

TABLE 3C
TABLE 3C; FIG. 22

| | Cylinder | Cylinder | Number | Cylinder |
|---|---|---|---|---|
| | Diameter | Stroke | Of | Capacity; |
| | in | in | Cylinders | in³ |
| Main Initial Cylinders, 1, 2, 3, 4 > | 12 | 12.00 | 4 | 5,428.67 |
| Step Cylinders 21, 22, 23, 24, four at a time, say TEN | 2.00 | 2.00 | 40 | 251.33 |
| (10), STEPS > | | | | |
| Capacity, Each time 4 cylinders open > | 2.00 | 2.00 | 4 | 25.13 |
| Next 4 Cylinders, 5, 6, 7, 8, OR In this calculation, | 4.31 | 4.31 | 4 | 251.33 |
| different size, 5′, 6′, 7′, 8′, four at a time > | | | | |

TABLE 4A
Table 4A

| | Primary |
|---|---|
| | Vessel Size |
| Plant MWe | 500 |
| Work per Lb. | 16 |
| Cycle, Minutes | 30 |
| Cycles per Hr. | 2 |
| MWHr Needed | 250 |
| Lqd. Lbs. | 53,328,125 |
| Cu. Ft. | 846,478 |
| Cube Size; Ft. | 95 |
| Secondary Vessel Cube Size; | 20.38 |
| about 1% of Primary Vessel > | |

TABLE 4D
Table 4D

| | Primary |
|---|---|
| | Vessel Size |
| Plant MWe | 500 |
| Work per Lb. | 16 |
| Cycle, Minutes | 5 |
| Cycles per Hr. | 12 |
| MWHr Needed | 41.67 |
| Lqd. Lbs. | 8,888,021 |
| Cu. Ft. | 141,080 |
| Cube Size; Ft. | 52 |
| Secondary Vessel Cube Size; | 11.22 |
| about 1% of Primary Vessel > | |

TABLE 4B
Table 4B

| | Primary |
|---|---|
| | Vessel Size |
| Plant MWe | 500 |
| Work per Lb. | 16 |
| Cycle, Minutes | 15 |
| Cycles per Hr. | 4 |
| MWHr Needed | 125 |
| Lqd. Lbs. | 26,664,063 |
| Cu. Ft. | 423,239 |
| Cube Size; Ft. | 75 |
| Secondary Vessel Cube Size; | 16.18 |
| about 1% of Primary Vessel > | |

TABLE 5

| | |
|---|---|
| Wall Thickness of Sphere as | 3.1416 |
| a vessel; PIE | |
| dia. Of Sphere; Feet | 50 |
| Vol. Of Sphere; Cu. Feet. | 65,450 |
| Surface Area of Sphere; Sq. | 7,854 |
| Feet | |
| Projected area of Sphere, to | 1,963 |
| internal Pressure; Sq. Feet | |
| Above In Sq. Inches | 282,743 |
| Internal Pressure, psi | 7,000 |
| force | 1,979,201,700 |
| Circumference Of Sphere; In | 157 |
| Feet | |
| Above in Inches | 1,885 |
| Tensile strength, PSI, used | 100,000 |
| Wall Thickness, in Inches | 11 |
| Cu. Ft. Of Metal | 6,872 |
| Sp. Weight of Steel; Lbs. per | 495 |
| Cu. Ft. | |
| Weight in Tons | 1,701 |
| $ per Ton | 1,000 |
| $ for 3 spheres | 5,102,629 |
| Lbs. Metal per Cu. Ft. of fluid | 52 |

TABLE 4C
Table 4C

| | Primary |
|---|---|
| | Vessel Size |
| Plant MWe | 500 |
| Work per Lb. | 16 |
| Cycle, Minutes | 10 |
| Cycles per Hr. | 6 |
| MWHr Needed | 83.33 |
| Lqd. Lbs. | 17,776,042 |
| Cu. Ft. | 282,159 |
| Cube Size; Ft. | 66 |
| Secondary Vessel Cube Size; | 14.13 |
| about 1% of Primary Vessel > | |

TABLE 6A

| | | | | Entropy | | | Cp |
|---|---|---|---|---|---|---|---|
| FIG. 2 | Pressure | Temperature | Enthalpy | (Btu/lbm- | Quality | Density | (Btu/lbm- |
| WATER | (PSIa) | (° F.) | (Btu/lbm) | ° R) | (lbm/lbm) | (lbm/ft³) | ° R) |
| Start cold; | 1000 | 40 | 10.9842 | 0.016 | Subcooled | 62.634 | 0.998 |
| NODE 1 | | | | | | | |
| Make Pressure; | 7000 | 139.557 | 124.949 | 0.192 | Undefined | 62.634 | 0.978 |
| NODE 4; 11 | | | | | | | |
| Make Work; | 1000 | 136.514 | 107.068 | 0.192 | Subcooled | 61.624 | 0.996 |
| NODE 12 | | | | | | | |

| | | | | | |
|---|---|---|---|---|---|
| Work | 17.881 | | Exp. Ratio | 101.638% | |
| Loss | 10 | Total Heat > | 113.9648 | Degree Of | 75.535% |
| | | | | Regeneration > | |
| Therefore | 27.881 | Regeneration > | 86.0838 | | |
| Heat | | | | | |
| Eff. | 64.13% | COP > | 4.053 | Ratio Work | 2.599 |
| | | | | to Work > | |

TABLE 6

| | | | | | | | |
|---|---|---|---|---|---|---|---|
| | | | | Entropy | | | Cp |
| | Pressure | Temperature | Enthalpy | (Btu/lbm- | Quality | Density | (Btu/lbm- |
| WATER | (PSIa) | (° F.) | (Btu/lbm) | ° R) | (lbm/lbm) | (lbm/ft³) | ° R) |

B-1

| | | | | | | | |
|---|---|---|---|---|---|---|---|
| Start cold | 50 | 40 | 8.18533 | 0.0162146 | Subcooled | 62.4338 | 1.0051 |
| Make | 7000 | 150.665 | 135.816 | 0.209971 | Undefined | 62.4338 | 0.978743 |
| Pressure | | | | | | | |
| Make | 50 | 146.83 | 115.01 | 0.209971 | Subcooled | 61.2611 | 1.00052 |
| Work | | | | | | | |
| | | Work | 20.806 | | Exp. Ratio | 101.914% | |
| | | Loss | 10 | | | | |
| | | Therefore | 30.806 | | | | |
| | | Heat | | | | | |
| | | Eff. | 67.54% | | | | |

B-2

| | | | | | | | |
|---|---|---|---|---|---|---|---|
| Start cold | 50 | 40 | 8.18533 | 0.0162146 | Subcooled | 62.4338 | 1.0051 |
| Pre-Pressurize | 3000 | 40.0947 | 16.8919 | 0.0162146 | Subcooled | 63.0457 | 0.985884 |
| Make More | 7000 | 114.538 | 100.513 | 0.150348 | Undefined | 63.0434 | 0.975537 |
| Pressure | | | | | | | |
| Make Work | 50 | 111.711 | 79.9054 | 0.150348 | Subcooled | 61.8422 | 0.998907 |

| | | | |
|---|---|---|---|
| Work | 20.6076 | Ratio Pre. | 100.980% |
| | | Pressurizing. | |
| Loss | 10 | Exp. Ratio | 101.942% |

| | |
|---|---|
| Therefore | 30.6076 |
| Heat | |
| Eff. | 67.33% |

TABLE 6C
as the pressure builds

| | | | Entropy | | | Cp |
|---|---|---|---|---|---|---|
| Pressure | Temperature | Enthalpy | (Btu/lbm- | Quality | Density | (Btu/lbm- |
| (psia) | (° F.) | (Btu/lbm) | ° R) | (lbm/lbm) | (lbm/ft³) | ° R) |
| 1000 | 40 | 10.9842 | 0.0161861 | Subcooled | 62.6339 | 0.998494 |
| 1500 | 64.1668 | 36.4623 | 0.0630943 | Subcooled | 62.6339 | 0.992785 |
| 2000 | 75.908 | 49.4796 | 0.0848795 | Subcooled | 62.6339 | 0.990324 |
| 2500 | 85.1609 | 59.9833 | 0.101588 | Subcooled | 62.6339 | 0.988472 |
| 3000 | 93.1275 | 69.1805 | 0.115653 | Subcooled | 62.6339 | 0.986915 |
| 3500 | 100.276 | 77.5417 | 0.128024 | Undefined | 62.6339 | 0.985532 |
| 4000 | 106.845 | 85.3091 | 0.139191 | Undefined | 62.6339 | 0.984263 |
| 4500 | 112.979 | 92.6266 | 0.149443 | Undefined | 62.6339 | 0.983075 |
| 5000 | 118.769 | 99.5882 | 0.15897 | Undefined | 62.6339 | 0.981946 |
| 5500 | 124.281 | 106.259 | 0.167905 | Undefined | 62.6339 | 0.980863 |
| 6000 | 129.561 | 112.687 | 0.176343 | Undefined | 62.6339 | 0.979816 |
| 6500 | 134.644 | 118.908 | 0.184357 | Undefined | 62.6339 | 0.978797 |
| 7000 | 139.557 | 124.949 | 0.192003 | Undefined | 62.6339 | 0.977803 |

TABLE 6D
as the pressure is used

| | | | Entropy | | | Cp |
|---|---|---|---|---|---|---|
| Pressure | Temperature | Enthalpy | (Btu/lbm- | Quality | Density | (Btu/lbm- |
| (psia) | (° F.) | (Btu/lbm) | ° R) | (lbm/lbm) | (lbm/ft³) | ° R) |
| 7000 | 140 | 125.382 | 0.192726 | Subcooled | 62.6261 | 0.977841 |
| 6500 | 139.746 | 123.903 | 0.192726 | Subcooled | 62.5455 | 0.97923 |
| 6000 | 139.491 | 122.422 | 0.192726 | Subcooled | 62.4643 | 0.980647 |
| 5500 | 139.237 | 120.938 | 0.192726 | Subcooled | 62.3825 | 0.982093 |
| 5000 | 138.983 | 119.453 | 0.192726 | Subcooled | 62.3 | 0.983567 |
| 4500 | 138.728 | 117.966 | 0.192726 | Subcooled | 62.2169 | 0.985071 |
| 4000 | 138.474 | 116.477 | 0.192726 | Subcooled | 62.1332 | 0.986606 |
| 3500 | 138.219 | 114.986 | 0.192726 | Subcooled | 62.0488 | 0.988173 |
| 3000 | 137.965 | 113.493 | 0.192726 | Subcooled | 61.9638 | 0.989771 |
| 2500 | 137.71 | 111.997 | 0.192726 | Subcooled | 61.8781 | 0.991402 |
| 2000 | 137.456 | 110.5 | 0.192726 | Subcooled | 61.7917 | 0.993067 |
| 1500 | 137.201 | 109.001 | 0.192726 | Subcooled | 61.7046 | 0.994767 |
| 1000 | 136.947 | 107.499 | 0.192726 | Subcooled | 61.6168 | 0.996502 |
| 500 | 136.692 | 105.995 | 0.192726 | Subcooled | 61.5283 | 0.998274 |

TABLE 6E

| WORK/ | | | | Entropy | | | Cp |
|---|---|---|---|---|---|---|---|
| INCREMENTAL | Pressure | Temperature | Enthalpy | (Btu/lbm- | Quality | Density | (Btu/lbm- |
| WORKS | (psia) | (° F.) | (Btu/lbm) | ° R) | (lbm/lbm) | (lbm/ft³) | ° R) |
| | 7000 | 140 | 125.382 | 0.192726 | Subcooled | 62.6261 | 0.977841 |
| 11.889 | 3000 | 137.965 | 113.493 | 0.192726 | Subcooled | 61.9638 | 0.989771 |
| 2.993 | 2000 | 137.456 | 110.5 | 0.192726 | Subcooled | 61.7917 | 0.993067 |
| 3.001 | 1000 | 136.947 | 107.499 | 0.192726 | Subcooled | 61.6168 | 0.996502 |
| 1.504 | 500 | 136.692 | 105.995 | 0.192726 | Subcooled | 61.5283 | 0.998274 |
| 1.204 | 100 | 136.488 | 104.791 | 0.192726 | Subcooled | 61.4569 | 0.999718 |

TABLE 7A
Heat Pump

| | | | | Entropy | | | Cp |
|---|---|---|---|---|---|---|---|
| | Pressure | Temperature | Enthalpy | (Btu/lbm- | Quality | Density | (Btu/lbm- |
| R11 | (PSIa) | (° F.) | (Btu/lbm) | ° R) | (lbm/lbm) | (lbm/ft³) | ° R) |
| | 4.3427 | 20 | 166.21 | 0.406 | 1 | 0.118 | 0.135 |
| | 52.7452 | 150 | 181.957 | 0.401 | 1 | 1.215 | 0.160 |
| Cpr. In | 4.3427 | 20 | 166.21 | 0.406 | 1 | 0.118 | 0.135 |
| Cpr. Out | 52.7452 | 171.488 | 185.38 | 0.406 | Superheated | 1.159 | 0.158 |
| | 52.7452 | 150 | 181.957 | 0.401 | 1 | 1.215 | 0.160 |
| | 52.7452 | 150 | 111.197 | 0.285 | 0 | 85.800 | 0.222 |
| 2-Ph. | 52.7452 | 138 | 108.546 | 0.280 | Subcooled | 86.915 | 0.220 |
| turbine In | | | | | | | |
| 2-Ph. | 4.3427 | 20 | 105.785 | 0.280 | 0.268694 | 0.437 | Undefined |
| turbine Out | | | | | | | |

| | |
|---|---|
| W Cpr. | 19.17 |
| Work 2-Ph. | 2.761 |
| turbine | |
| Eff. 2-Ph. | 0.5 |
| turbine | |
| W net 2-ph. | 1.38 |
| turbine | |
| NET W. | 17.79 |
| Heat | 76.83 |
| COP | 4.32 |

TABLE 7B
Heat Pump; FIG. 2

| | Pressure | | | Entropy | | | Cp |
|---|---|---|---|---|---|---|---|
| | ISOBUTANE | Temperature | Enthalpy | (Btu/lbm- | Quality | Density | (Btu/lbm- |
| | (PSIa) | (° F.) | (Btu/lbm) | ° R) | (lbm/lbm) | (lbm/ft³) | ° R) |
| | 17.8542 | 20 | 234.634 | 0.549004 | 1 | 0.211647 | 0.377 |
| | 143.012 | 150 | 275.506 | 0.561026 | 1 | 1.5965 | 0.524 |
| Cpr. In; | 17.8542 | 20 | 234.634 | 0.549004 | 1 | 0.211647 | 0.377 |
| NODE 51 | | | | | | | |
| Cpr. Out; | 143.012 | 150 | 268.176 | 0.549004 | 0.938399 | 1.69554 | Undefined |
| NODE 52, 795 | | | | | | | |
| | 143.012 | 150 | 156.519 | 0.365862 | 0 | 30.8472 | 0.660 |
| 2-Ph. turbine | 143.012 | 138 | 148.702 | 0.352912 | Subcooled | 31.52 | 0.643 |
| In; NODE 796; 41 | | | | | | | |
| 2-Ph. turbine | 17.8542 | 19.9999 | 140.575 | 0.352912 | 0.393557 | 0.533045 | Undefined |
| Out; NODE 42 | | | | | | | |

| | |
|---|---|
| Cpr. W | 33.542 |
| 2-Ph. turbine | 8.127 |
| W | |
| Eff. | 0.5 |
| Net 2-Ph. | 4.0635 |
| turbine W | |
| NET Ht. Pump | 29.4785 |
| W | |
| Heat | 119.474 |
| COP | 4.05 |
| VS R11 | 4.32 |

TABLE 8
Cp mis-match

| | Cp; at Pressure | Cp; at | Cp; at | | |
|---|---|---|---|---|---|
| Temperature | 100 PSI. | Pressure 7K | Pressure 5K | EXCESS Cp, 100 | EXCESS Cp, 100 |
| (° F.) | (Btu/lbm-° R) | (Btu/lbm-° R) | (Btu/lbm-° R) | PSI vs. 7K PSI. | PSI vs. 5K PSI. |
| 40 | 1.00474 | 0.965148 | 0.974843 | 4.10% | 3.07% |
| 45 | 1.0033 | 0.966156 | 0.975311 | 3.84% | 2.87% |
| 50 | 1.00213 | 0.967091 | 0.97578 | 3.62% | 2.70% |
| 55 | 1.0012 | 0.967965 | 0.976252 | 3.43% | 2.56% |
| 60 | 1.00045 | 0.968787 | 0.976724 | 3.27% | 2.43% |
| 65 | 0.999862 | 0.969564 | 0.977196 | 3.12% | 2.32% |
| 70 | 0.999406 | 0.9703 | 0.977665 | 3.00% | 2.22% |
| 75 | 0.999062 | 0.970999 | 0.978132 | 2.89% | 2.14% |
| 80 | 0.998813 | 0.971665 | 0.978594 | 2.79% | 2.07% |
| 85 | 0.998645 | 97.23% | 0.97905 | 2.71% | 2.00% |
| 90 | 0.998545 | 0.972907 | 0.979499 | 2.64% | 1.94% |
| 95 | 0.998505 | 0.973487 | 0.979941 | 2.57% | 1.89% |
| 100 | 0.998517 | 0.974043 | 0.980376 | 2.51% | 1.85% |
| 105 | 0.998573 | 0.974576 | 0.980804 | 2.46% | 1.81% |
| 110 | 0.998669 | 0.975088 | 0.981224 | 2.42% | 1.78% |
| 115 | 0.998801 | 0.975582 | 0.981638 | 2.38% | 1.75% |
| 120 | 0.998966 | 0.976059 | 0.982046 | 2.35% | 1.72% |
| 125 | 0.999162 | 0.976521 | 0.98245 | 2.32% | 1.70% |
| 130 | 0.999386 | 0.976971 | 0.982851 | 2.29% | 1.68% |
| 135 | 0.999637 | 0.97741 | 0.98325 | 2.27% | 1.67% |
| 140 | 0.999916 | 0.977841 | 0.983648 | 2.26% | 1.65% |
| 145 | 1.00022 | 0.978266 | 0.984048 | 2.24% | 1.64% |
| 150 | 1.00055 | 0.978687 | 0.984451 | 2.23% | 1.64% |
| 155 | 1.00091 | 0.979107 | 0.984859 | 2.23% | 1.63% |
| 160 | 1.0013 | 0.979527 | 0.985274 | 2.22% | 1.63% |
| 165 | 1.00172 | 0.979949 | 0.985697 | 2.22% | 1.63% |
| 170 | 1.00216 | 0.980375 | 0.98613 | 2.22% | 1.63% |
| 175 | 1.00264 | 0.980809 | 0.986575 | 2.23% | 1.63% |
| 180 | 1.00315 | 0.98125 | 0.987034 | 2.23% | 1.63% |
| 185 | 1.00369 | 0.981702 | 0.987508 | 2.24% | 1.64% |
| 190 | 1.00427 | 0.982166 | 0.988 | 2.25% | 1.65% |
| 195 | 1.00488 | 0.982643 | 0.988509 | 2.26% | 1.66% |
| 200 | 1.00553 | 0.983135 | 0.98904 | 2.28% | 1.67% |

TABLE 9
Recuperation Cold end BTU loss

| | | | Entropy | | | Cp |
|---|---|---|---|---|---|---|
| Pressure | Temperature | Enthalpy | (Btu/lbm- | Quality | Density | (Btu/lbm- |
| (PSIa) | (° F.) | (Btu/lbm) | ° R) | (lbm/lbm) | (lbm/ft³) | ° R) |
| 100 | 40 | 8.33325 | 0.0162139 | Subcooled | 62.4444 | 1.00474 |
| 100 | 150 | 118.305 | 0.215141 | Subcooled | 61.211 | 1.00055 |

| | |
|---|---|
| Maximum H drop | 109.97175 |
| Percentage loss | 8 |
| via recuperation | |
| BTU Loss | 8.79774 |

TABLE 10A
Excess Enthalpy; Source vs. Sink.

| | | | Entropy | | | Cp |
|---|---|---|---|---|---|---|
| Pressure | Temperature | Enthalpy | (Btu/lbm- | Quality | Density | (Btu/lbm- |
| (PSIa) | (° F.) | (Btu/lbm) | ° R) | (lbm/lbm) | (lbm/ft³) | ° R) |
| 100 | 40 | 8.33325 | 0.0162139 | Subcooled | 62.4444 | 1.00474 |
| 100 | 150 | 118.305 | 0.215141 | Subcooled | 61.211 | 1.00055 |
| 5000 | 40 | 22.5137 | 0.0157467 | Subcooled | 63.4455 | 0.974843 |
| 5000 | 150 | 130.294 | 0.21067 | Subcooled | 62.1013 | 0.984451 |

| | |
|---|---|
| H Rise Source | 109.97 |
| H Rise Sink | 107.78 |
| Excess Enthalpy; | 2.033% |
| Source vs. | |
| Sink.; % | |

TABLE 10B
Excess Enthalpy; Source vs. Sink.

| | | | Entropy | | | Cp |
|---|---|---|---|---|---|---|
| Pressure | Temperature | Enthalpy | (Btu/lbm- | Quality | Density | (Btu/lbm- |
| (PSIa) | (° F.) | (Btu/lbm) | ° R) | (lbm/lbm) | (lbm/ft³) | ° R) |
| 100 | 40 | 8.33325 | 0.0162139 | Subcooled | 62.4444 | 1.00474 |
| 100 | 150 | 118.305 | 0.215141 | Subcooled | 61.211 | 1.00055 |
| 7000 | 40 | 28.137 | 0.0153543 | Subcooled | 63.8332 | 0.965148 |
| 7000 | 150 | 135.165 | 0.208905 | Subcooled | 62.4461 | 0.978687 |

| | |
|---|---|
| H Rise Source | 109.97 |
| H Rise Sink | 107.03 |
| Excess Enthalpy; | 2.750% |
| Source vs. | |
| Sink.; % | |

TABLE 11

| | | | | Entropy | | | Cp |
|---|---|---|---|---|---|---|---|
| FIG. 6 | Pressure | Temperature | Enthalpy | (Btu/lbm- | Quality | Density | (Btu/lbm- |
| ISOBUTANE | (psia) | (° F.) | (Btu/lbm) | ° R) | (lbm/lbm) | (lbm/ft³) | ° R) |
| Start cold | 4.16294 | −40 | 48.4037 | 0.156528 | 0 | 38.9627 | 0.50049 |
| Make | 4830.31 | 20 | 93.1901 | 0.205141 | Subcooled | 38.9627 | 0.512878 |
| Pressure | | | | | | | |
| Make Work | 100 | 2.18804 | 70.2865 | 0.205141 | Subcooled | 37.4507 | 0.524799 |
| Flashing > | 4.16294 | −40 | 70.2865 | 0.208671 | 0.130814 | 0.41378 | Undefined |
| Vp. Part > | 0.130814 | | | | | | |
| compression | 21.8815 | 30 | 237.84 | 0.549019 | 1 | 0.256066 | 0.385264 |
| Pr. Needed > | | | | | | | |
| | 21.8815 | 4.94981 | 71.5347 | 0.208671 | Subcooled | 37.3022 | 0.527205 |
| Cpr. In > | 4.16294 | −40 | 215.686 | 0.555131 | 1 | 0.054633 | 0.332922 |
| Cpr. Out > | 21.8815 | 37.7943 | 240.856 | 0.555131 | Superheated | 0.251267 | 0.388795 |
| | 21.8815 | 30 | 237.84 | 0.549019 | 1 | 0.256066 | 0.385264 |
| | 21.8815 | 30 | 84.9503 | 0.23679 | 0 | 36.3236 | 0.54416 |
| | 21.8815 | −20 | 58.5759 | 0.180007 | Subcooled | 38.24 | 0.511813 |
| | 4.16294 | −40 | 58.2572 | 0.180007 | 0.0589035 | 0.90717 | Undefined |

| | |
|---|---|
| Work | 22.9036 |
| Cpr. W. > | 25.17 |
| Vp. Part > | 0.130814 |
| Cpr. W. per | 3.29258838 |
| Lb. Working | |
| Fluid > | |
| NET W. > | 21.87741162 |
| Heat Of Ht. | 182.2801 |
| Pump > | |
| COP | 7.241958681 |

TABLE 12
Work Comparison;

| | | | Entropy | | | Cp |
|---|---|---|---|---|---|---|
| Pressure | Temperature | Enthalpy | (Btu/lbm- | Quality | Density | (Btu/lbm- |
| (psia) | (° F.) | (Btu/lbm) | ° R) | (lbm/lbm) | (lbm/ft³) | ° R) |
| 7000 | 140 | 125.382 | 0.192726 | Subcooled | 62.6261 | 0.977841 |
| 100 | 136.488 | 104.791 | 0.192726 | Subcooled | 61.4569 | 0.999718 |
| | Work > | 20.591 | | | | |
| 7000 | 40 | 28.137 | 0.0153543 | Subcooled | 63.8332 | 0.965148 |
| 100 | 39.5727 | 7.90394 | 0.0153543 | Subcooled | 62.4445 | 1.00488 |
| | Work > | 20.23306 | | | | |
| 10000 | 140 | 132.739 | 0.190261 | Subcooled | 63.1244 | 0.917346 |
| 100 | 135.02 | 103.323 | 0.190261 | Subcooled | 61.4824 | 0.9534 |
| | Work > | 29.416 | | | | |
| 10000 | 40 | 36.4149 | 0.0145808 | Subcooled | 64.3935 | 0.947524 |
| 100 | 39.1886 | 7.51792 | 0.0145808 | Subcooled | 62.4445 | 1.005 |
| | Work > | 28.89698 | | | | |

TABLE 13
ISOBUTANE, Very Low Temperature Refrigeration Cycle;

| | | | Entropy | | | Cp |
|---|---|---|---|---|---|---|
| Pressure | Temperature | Enthalpy | (Btu/lbm- | Quality | Density | (Btu/lbm- |
| (psia) | (° F.) | (Btu/lbm) | ° R) | (lbm/lbm) | (lbm/ft³) | ° R) |
| 0.545776 | −100 | 197.646 | 0.577654 | 1 | 0.0082483 | 0.296387 |
| 53.3805 | 80 | 253.879 | 0.552043 | 1 | 0.596862 | 0.432249 |
| 0.545776 | −100 | 197.646 | 0.577654 | 1 | 0.0082483 | 0.296387 |
| 53.3805 | 112.515 | 268.115 | 0.577654 | Superheated | 0.550842 | 0.444085 |
| 53.3805 | 80 | 253.879 | 0.552043 | 1 | 0.596862 | 0.432249 |
| 53.3805 | 80 | 113.166 | 0.291305 | 0 | 34.245 | 0.583404 |
| 0.545776 | −100 | 94.6545 | 0.291305 | 0.42252 | 0.0195162 | Undefined |

| | |
|---|---|
| Cpr. In | 197.646 |
| Cpr. Out | 268.115 |
| Cpr. W | 70.469 |
| Exp. In | 113.166 |
| Exp. Out | 94.6545 |
| Exp. W. | 18.5115 |
| Exp. Eff. | 0.5 |
| Exp. W. NET | 9.25575 |
| NETW. | 61.21325 |
| Hot | 268.115 |
| Cold | 113.166 |
| Heat | 154.949 |
| COP | 2.53129837 |

TABLE 14
ISOBUTANE TWO Pr. Cpr. Work(s);

| | | | Entropy | | | Cp |
|---|---|---|---|---|---|---|
| Pressure | Temperature | Enthalpy | (Btu/lbm- | Quality | Density | (Btu/lbm- |
| (psia) | (° F.) | (Btu/lbm) | ° R) | (lbm/lbm) | (lbm/ft³) | ° R) |
| 3.60671 | −45 | 214.14 | 0.556252 | 1 | 0.0478227 | 0.329634 |
| 3.11213 | −50 | 212.601 | 0.55749 | 1 | 0.0417032 | 0.326397 |
| 45.3275 | 70 | 250.682 | 0.551113 | 1 | 0.510115 | 0.422003 |
| 45.3275 | 76.4719 | 253.42 | 0.556252 | Superheated | 0.501758 | 0.42426 |
| 45.3275 | 78.0376 | 254.085 | 0.55749 | Superheated | 0.499791 | 0.424833 |

| | |
|---|---|
| W1 > | 39.28 |
| W2 > | 41.484 |

TABLE 15
FIG. 37; 41, Det. A.

| | | | | Entropy | | | Cp |
|---|---|---|---|---|---|---|---|
| | Pressure | Temp. | Enthalpy | (Btu/lbm- | Quality | Density | (Btu/lbm- |
| WATER | (psia) | (° F.) | (Btu/lbm) | ° R) | (lbm/lbm) | (lbm/ft³) | ° R) |
| Start cold; | 50 | 40 | 8.18533 | 0.0162146 | Subcooled | 62.4338 | 1.0051 |
| NODE 1 | | | | | | | |
| Make Pressure; | 5874.68 | 140 | 122.611 | 0.193663 | Subcooled | 62.4338 | 0.981054 |
| NODE 4, 11 | | | | | | | |
| Make Work; | 50 | 137.021 | 105.199 | 0.193663 | Subcooled | 61.4382 | 0.99993 |
| NODE 12 | | | | | | | |
| Node 25 | 50 | 50 | 18.2221 | 0.0361031 | Subcooled | 62.4166 | 1.00245 |

| | | | | |
|---|---|---|---|---|
| Work | 17.412 | % leaving | 1.59% | < Expansion |
| | | vessel for work | | Ratio |
| | | in the Engine > | | |
| Loss | 10.03677 | Total Heat > | 114.42567 | |
| Therefore | 27.44877 | Recuperation > | 86.9769 | |
| Heat | | | | |
| Eff. | 63.43% | % Recuperation > | 76.01% | |

TABLE 15A
FIG. 37; FIG. 41 Det. A.

| | | | | Entropy | | | Cp |
|---|---|---|---|---|---|---|---|
| | Pressure | Temp. | Enthalpy | (Btu/lbm- | Quality | Density | (Btu/lbm- |
| WATER | (psia) | (° F.) | (Btu/lbm) | ° R) | (lbm/lbm) | (lbm/ft³) | ° R) |
| Start cold; | 20 | 40 | 8.09654 | 0.016215 | Subcooled | 62.4274 | 1.00531 |
| NODE 1 | | | | | | | |
| Make Pressure; | 5837.54 | 140 | 122.52 | 0.193694 | Subcooled | 62.4274 | 0.981162 |
| NODE 4, 11 | | | | | | | |
| Make Work; | 1000 | 137.526 | 108.077 | 0.193694 | Subcooled | 61.6067 | 0.996537 |
| NODE 12 | | | | | | | |
| Node 25 | 20 | 50 | 18.1353 | 0.0361075 | Subcooled | 62.4105 | 1.00263 |

| | | | | |
|---|---|---|---|---|
| Work | 14.443 | % leaving | 1.31% | < Expansion |
| | | vessel for work | | Ratio |
| | | in the Engine > | | |
| Loss | 10.03876 | Total Heat > | 114.42346 | |
| Therefore | 24.48176 | Recuperation > | 89.9417 | |
| Heat | | | | |
| Eff. | 58.99% | % Recuperation > | 78.60% | |

TABLE 15B
FIG. 37; FIG. 41 Det. A.

| | | | | Entropy | | | Cp |
|---|---|---|---|---|---|---|---|
| | Pressure | Temp. | Enthalpy | (Btu/lbm- | Quality | Density | (Btu/lbm- |
| WATER | (psia) | (° F.) | (Btu/lbm) | ° R) | (lbm/lbm) | (lbm/ft³) | ° R) |
| Start cold; | 1000 | 40 | 10.9842 | 0.0161861 | Subcooled | 62.6339 | 0.998494 |
| NODE 1 | | | | | | | |
| Make Pressure; | 7045.85 | 140 | 125.495 | 0.192688 | Subcooled | 62.6339 | 0.977713 |
| NODE 4, 11 | | | | | | | |
| Make Work; | 1000 | 136.924 | 107.476 | 0.192688 | Subcooled | 61.6172 | 0.996501 |
| NODE 12 | | | | | | | |
| Node 25 | 1000 | 50 | 20.9594 | 0.0359525 | Subcooled | 62.6106 | 0.996684 |

| | | | | |
|---|---|---|---|---|
| Work | 18.019 | % leaving | 1.62% | < Expansion |
| | | vessel for work | | Ratio |
| | | in the Engine > | | |
| Loss | 9.9752 | Total Heat > | 114.5108 | |
| Therefore | 27.9942 | Recuperation > | 86.5166 | |
| Heat | | | | |
| Eff. | 64.37% | % Recuperation > | 75.55% | |

TABLE 15C
FIG. 41

| | | | | Entropy | | | Cp |
|---|---|---|---|---|---|---|---|
| | Pressure | Temp. | Enthalpy | (Btu/lbm- | Quality | Density | (Btu/lbm- |
| WATER | (psia) | (° F.) | (Btu/lbm) | ° R) | (lbm/lbm) | (lbm/ft³) | ° R) |
| Start cold; | 1000 | 40 | 10.9842 | 0.0161861 | Subcooled | 62.6339 | 0.998494 |
| NODE 1 | | | | | | | |
| Make Pressure; | 12940.2 | 190 | 188.161 | 0.265171 | Subcooled | 62.6339 | 0.967049 |
| NODE 3, 11 | | | | | | | |
| Make Work; | 1000 | 181.859 | 152.329 | 0.265171 | Subcooled | 60.7283 | 1.00015 |
| NODE 12 | | | | | | | |
| Node 25 | 1000 | 50 | 20.9594 | 0.0359525 | Subcooled | 62.6106 | 0.996684 |

| | | | | |
|---|---|---|---|---|
| Work | 35.832 | % leaving | 3.04% | < Expansion |
| | | vessel for work | | Ratio |
| | | in the Engine > | | |
| Loss | 9.9752 | Total Heat > | 177.1768 | |
| Therefore | 45.8072 | Recuperation > | 131.3696 | |
| Heat | | | | |
| Eff. | 78.22% | % Recuperation > | 74.15% | |

TABLE 16
Heat Pump; FIG. 37; FIG. 41 Det. A.

| | Pressure | | | Entropy | | | Cp |
|---|---|---|---|---|---|---|---|
| | ISOBUTANE | Temperature | Enthalpy | (Btu/lbm- | Quality | Density | (Btu/lbm- |
| | (PSIa) | (° F.) | (Btu/lbm) | ° R) | (lbm/lbm) | (lbm/ft³) | ° R) |
| | 17.8542 | 20 | 234.634 | 0.549004 | 1 | 0.211647 | 0.377 |
| | 143.012 | 150 | 275.506 | 0.561026 | 1 | 1.5965 | 0.524 |
| Cpr. In; | 17.8542 | 20 | 234.634 | 0.549004 | 1 | 0.211647 | 0.377 |
| NODE 51 | | | | | | | |
| Cpr. Out; | 143.012 | 150 | 268.176 | 0.549004 | 0.938399 | 1.69554 | Undefined |
| NODE 52 | | | | | | | |
| NODE 53 | 143.012 | 150 | 156.519 | 0.365862 | 0 | 30.8472 | 0.660 |
| 2-Ph. turbine | 143.012 | 138 | 148.702 | 0.352912 | Subcooled | 31.52 | 0.643 |
| In; NODE 41 | | | | | | | |
| 2-Ph. turbine | 17.8542 | 19.9999 | 140.575 | 0.352912 | 0.393557 | 0.533045 | Undefined |
| Out; NODE 42 | | | | | | | |

| | |
|---|---|
| Cpr. W | 33.542 |
| 2-Ph. turbine | 8.127 |
| W | |
| Eff. | 0.5 |
| Net 2-Ph. | 4.0635 |
| turbine W | |
| NET Ht. Pump | 29.4785 |
| W | |
| Heat | 119.474 |
| COP | 4.05 |
| VS R11 | 4.32 |

TABLE 17
FIG. 38; FIG. 41 Det. B. refrigeration. Mode

| | | | | Entropy | | | Cp |
|---|---|---|---|---|---|---|---|
| | Pressure | Temperature | Enthalpy | (Btu/lbm- | Quality | Density | (Btu/lbm- |
| | (psia) | (° F.) | (Btu/lbm) | ° R) | (lbm/lbm) | (lbm/ft³) | ° R) |
| ISOBUTANE; | | | | | | | |
| NODES | | | | | | | |
| 1 | 20 | −20 | 58.5707 | 0.180016 | Subcooled | 38.2391 | 0.511825 |
| 4; 11 | 4458.67 | 40 | 102.431 | 0.227654 | Subcooled | 38.2391 | 0.523935 |
| 12 | 20 | 21.7954 | 80.5047 | 0.227654 | Subcooled | 36.6475 | 0.538443 |
| 25 | 20 | −10 | 63.7188 | 0.191593 | Subcooled | 37.867 | 0.517833 |
| 26 | 20 | −20 | 58.5707 | 0.180016 | Subcooled | 38.2391 | 0.511825 |
| 3 | | | 75.3566 | | | | |
| | | W. | 21.9263 | | | | |
| | | Ref. | 27.0744 | | | | |
| | | Available | | | | | |
| | | Ref. Deficit | 5.1481 | | | | |
| | | COP | 4.494445758 | | | | |
| | | Neg. W. | 1.145436007 | | | | |
| | | NET W. | 20.78086399 | | | | |
| ISOBUTANE | | | | | | | |
| refrigeration. Cy. | | | | | | | |
| ISOBUTANE; | | | | | | | |
| NODES | | | | | | | |
| | 9.11528 | −10 | 225.082 | 0.550559 | 1 | 0.113112 | 0.353809 |
| | 72.6443 | 100 | 260.224 | 0.554257 | 1 | 0.805229 | 0.454399 |
| 51 | 9.11528 | −10 | 225.082 | 0.550559 | 1 | 0.113112 | 0.353809 |
| 52 | 72.6443 | 100 | 258.154 | 0.550559 | 0.984688 | 0.817443 | Undefined |
| 41 | 72.6443 | 100 | 125.042 | 0.312719 | 0 | 33.3464 | 0.60191 |
| 42 | 9.11528 | −9.99998 | 118.132 | 0.312719 | 0.337333 | 0.333356 | Undefined |

| | |
|---|---|
| W. compression | 33.072 |
| 50 | |
| W. 2-phae | 6.91 |
| turbine; 43 | |
| Eff. | 0.5 |
| Net W. 2-ph. | 3.455 |
| turbine; 43 | |
| NET W. | 29.617 |
| Heat | 133.112 |
| COP | 4.494445758 |

TABLE 18
FIG. 38, FIG. 41 Det. B. ISOBUTANE

| | | | | Entropy | | | Cp |
|---|---|---|---|---|---|---|---|
| | Pressure | Temperature | Enthalpy | (Btu/lbm- | Quality | Density | (Btu/lbm- |
| | (psia) | (° F.) | (Btu/lbm) | ° R) | (lbm/lbm) | (lbm/ft³) | ° R) |
| HEAT SOURCE | | | | | | | |
| Ambient air: | | | | | | | |
| 0° F.; NODES | | | | | | | |
| 1; 26 | 50 | −73.3848 | 32.1329 | 0.115606 | Subcooled | 40.1664 | 0.482773 |
| 4; 11 | 5000 | −20.0014 | 73.5954 | 0.16077 | Undefined | 40.1664 | 0.493558 |
| 12; 24 | 50 | −36.2631 | 50.41 | 0.16077 | Subcooled | 38.8478 | 0.502313 |
| 25 | 50 | −63 | 37.1735 | 0.128482 | Subcooled | 39.8021 | 0.488019 |
| | w | | 23.1854 | | | | |
| | Heat Rejected.; | | 5.0406 | | | | |
| | refrigeration. Load | | | | | | |
| | COP | | 7.625279279 | | | | |
| | refrigeration. Work | | 0.661038083 | | | | |
| | Penalty; IGNORED > | | | | | | |
| | Therefore Heat | | 28.226 | | | | |
| | Eff. | | 82.14% | | | | |
| refrigeration. | | | | | | | |
| Cycle: | | | | | | | |
| | 7.11634 | −20 | 221.929 | 0.551704 | 1 | 0.08987 | 0.346614 |
| 51 | 1.49096 | −73 | 205.616 | 0.564845 | 1 | 0.021047 | 0.312103 |
| 52 | 7.11634 | −3.2207 | 227.816 | 0.564845 | Superheated | 0.086305 | 0.35523 |
| | 7.11634 | −20 | 221.929 | 0.551704 | 1 | 0.08987 | 0.346614 |
| 41 | 7.11634 | −20 | 58.5348 | 0.180076 | 0 | 38.2328 | 0.51191 |
| 42 | 1.49096 | −72.9999 | 56.8376 | 0.180076 | 0.142219 | 0.147522 | Undefined |

| | |
|---|---|
| compressor. W. | 22.2 |
| heat | 169.2812 |
| COP | 7.625279279 |

TABLE 19

| | | | | | |
|---|---|---|---|---|---|
| Cylinder Cross section; Square | 100 | Cylinder Length; | 100 | Lbs. Of water; EACH | 630,000 |
| Feet > | | Feet > | | cycle > | |
| WORK BTU/Lb. > | 12 | MWe Each Stroke > | 2.22 | | |

1-23. (canceled)

24. A system for recovering work from a heat source, said system comprising:
first, second and third subsystems, each said subsystem including a fixed volume primary vessel having first and second ports and a dynamic separator operable to separate a first variable volume in fluid communication with the first port from a second variable volume in fluid communication with the second port;
displacement means for displacing working fluid;
a heat exchanger in thermodynamic communication with the heat source having a working fluid inlet in fluid communication with a valve means configurable to be in fluid communication with the first port of the fixed volume primary vessel of a selected subsystem and a working fluid outlet in fluid communication with a valve means configurable to be in fluid communication with the second port of the fixed volume primary vessel of a selected subsystem;
a pressure-to-work device;
valve means configurable to place the pressure-to-work device in pressure communication with the second port of the fixed volume primary vessel of a selected subsystem; and
a control system configured to:
(a) effect a first add heat phase by actuating the valve means and displacement means such that working fluid in the first variable volume of the first subsystem's fixed volume primary vessel is circulated through the heat exchanger and into the second variable volume of the first subsystem's fixed volume primary vessel whereby the working fluid pressure is raised;
(b) effect a first work making phase by actuating valve means such that the second port of the second subsystem is placed in pressure communication with the pressure-to-work device whereby the working fluid pressure in the second subsystem provides pressure to the pressure-to-work device to create work;
(c) effect a first re-fill phase by actuating valve means such that working fluid can be introduced into the first port of the third subsystem and spent working fluid can be expelled from the second port of the third subsystem.

25. (canceled)

26. The system of claim 24, wherein the dynamic separator is a fabric anchored about an internal central perimeter of the fixed volume primary vessel and of adequate surface area to substantially displace to one end of the primary vessel, maximizing the first variable volume, and to the other end of the primary vessel, maximizing the second variable volume.

27. The system of claim 24, wherein the control system is further configured to, after the first phases are completed:
(d) effect a second add heat phase by actuating the valve means and displacement means such that working fluid in the first variable volume of the third subsystem's fixed volume primary vessel is circulated through the heat exchanger and into the second variable volume of the third subsystem's fixed volume primary vessel whereby the working fluid pressure is raised;
(e) effect a second work making phase by actuating valve means such that the second port of the first subsystem is placed in pressure communication with the pressure-to-work device whereby the working fluid pressure in the first subsystem provides pressure to the pressure-to-work device to create work; and
(f) effect a second re-fill phase by actuating valve means such that working fluid can be introduced into the first port of the second subsystem and spent working fluid can be expelled from the second port of the second subsystem, and
further configured to, after the second phases are completed:
(g) effect a third add heat phase by actuating the valve means and displacement means such that working fluid in the first variable volume of the second subsystem's fixed volume primary vessel is circulated through the heat exchanger and into the second variable volume of the second subsystem's fixed volume primary vessel whereby the working fluid pressure is raised;
(h) effect a third work making phase by actuating valve means such that the second port of the third subsystem is placed in pressure communication with the pressure-to-work device whereby the working fluid pressure in the third subsystem provides pressure to the pressure-to-work device to create work; and
(i) effect a third re-fill phase by actuating valve means such that working fluid can be introduced into the first port of the first subsystem and spent working fluid can be expelled from the second port of the first subsystem.

28. The system of claim 27, further comprising a recuperation heat exchanger configured to transmit the heat of the spent working fluid from a re-fill phase to the working fluid being heated in an add heat phase.

29. The system of claim 27, further comprising a fixed volume secondary vessel having first and second ports and a dynamic separator operable to separate a first variable volume in fluid communication with the first port from a second variable volume in fluid communication with the second port, wherein, in a work-making phase, placing the second port of a fixed volume primary vessel in pressure communication with the pressure-to-work device includes (i) placing the second port of the fixed volume primary vessel in fluid communication with the first port of the secondary vessel and (ii) placing the second port of the secondary vessel in fluid communication with the pressure-to-work device.

30. The system of claim 27, further comprising a heat pump subsystem, the hot side of which is a component of the heat source, wherein the heat pump subsystem is configured to raise a grade of a low grade thermal energy source.

31. (canceled)

32. The system of claim 27, wherein the working fluid is water.

33. The system of claim 27, wherein the working fluid is oil.

34. The system of claim 27, wherein the working fluid comprises water and an antifreeze.

35. (canceled)

36. The system of claim 27, wherein the pressure-to-work device is a piston-based engine.

37. The system of claim 27, wherein the pressure-to-work device is a screw expander.

38. The system of claim 27, wherein the pressure-to-work device is a hydraulic motor.

39. The system of claim 27, wherein the working fluid at the first pressure comprises a vapor phase and the pressure-to-work device is a turbine.

40. The system of claim 27, wherein for each subsystem (i) the fixed volume primary vessel comprises a cylinder, (ii) the dynamic separator comprises a piston disposed to traverse the cylinder, and (iii) the displacement means includes the piston and a means for causing the piston to traverse the cylinder in a selected direction.

41-42. (canceled)

43. The system of claim 40, wherein the means for causing a respective piston to traverse a respective cylinder includes a screw drive engaged with the respective piston.

44. The system of claim 40, wherein a small hole is disposed in the piston to provide pressure equalization between the respective first volume and second volume.

45. The system of claim 27, wherein the valve means are actuated by cams.

46-49. (canceled)

50. A system for recovering work from a heat source, said system comprising:
first, second and third subsystems, each said subsystem including a cylinder having first and second ports and a piston disposed therein to separate a first variable volume in fluid communication with the first port from a second variable volume in fluid communication with the second port;
a piston displacement apparatus;
a heat exchanger in thermodynamic communication with the heat source having a working fluid inlet in fluid communication with a valve block configurable to be in fluid communication with the first port of the cylinder of a selected subsystem and a working fluid outlet in fluid communication with a valve block configurable to be in fluid communication with the second port of the cylinder of a selected subsystem;
a pressure-to-work device;
a valve block configurable to place the pressure-to-work device in pressure communication with the second port of the cylinder of a selected subsystem; and
a control system configured to:
(a) effect a first add heat phase by actuating the valve blocks and piston displacement apparatus such that working fluid in the first variable volume of the first subsystem's cylinder is circulated through the heat exchanger and into the second variable volume of the first subsystem's cylinder whereby the working fluid pressure is raised;
(b) effect a first work making phase by actuating the valve blocks such that the second port of the second subsystem is placed in pressure communication with the pressure-to-work device whereby the working fluid pressure in the second subsystem provides pressure to the pressure-to-work device to create work;
(c) effect a first re-fill phase by actuating the valve blocks such that working fluid can be introduced into first port of the third subsystem and spent working fluid can be expelled from the second port of the third subsystem.

51. The system of claim 50, wherein the pressure-to-work device is a piston-based engine.

52-53. (canceled)

54. The system of claim 50, wherein the working fluid at the first pressure comprises a vapor phase and the pressure-to-work device is a turbine.
